(19) United States
(12) Patent Application Publication
(10) Pub. No.: US 2024/0095645 A1
(43) Pub. Date: Mar. 21, 2024

(54) ADMINISTRATION SERVICES FOR GOALS PLATFORMS

(71) Applicant: Degree, Inc., San Francisco, CA (US)

(72) Inventors: Sven Martin Andreas Elfgren, San Francisco, CA (US); Friedrich I. Riha, Oakland, CA (US); Elliot Piersa Dahl, Nashville, TN (US); Eric Koslow, San Francisco, CA (US); Nicole Jensen McMullin, Larkspur, CA (US); Natasha Hede, San Francisco, CA (US); Connie Lynn Chen, Daly City, CA (US); Alexa Jean Kriebel, San Diego, CA (US); Chije Wang'ati, JR., Washington, DC (US); Megan McGowan, Albany, CA (US); Ami Tushar Bhatt, Dublin, CA (US); Jeffrey Ryan Gurr, Torrance, CA (US); Tyler Kowalewski, Chicago, IL (US); Rahul Rangnekar, San Francisco, CA (US); Byron Sha Yang, San Jose, CA (US); Jerry Wu, San Francisco, CA (US); Ricky Rizal Zein, Brooklyn, NY (US); Romain Beauxis, San Francisco, CA (US); Adnan Chowdhury, San Francisco, CA (US); Priya Balasubramanian, Fremont, CA (US); Gilles Yvetot, San Francisco, CA (US); Shaylan Hawthorne, Seattle, WA (US); Adnan Pirzada, San Francisco, CA (US); Matthew Michael Parides, San Francisco, CA (US); Jenna Nicole Soojin Lee, San Francisco, CA (US); Ian William Richard, San Francisco, CA (US); Laura Elizabeth Pearson, San Francisco, CA (US); Christian Nguyen, San Francisco, CA (US); Tovin Thomas, San Francisco, CA (US); Adam Carter, San Francisco, CA (US); David Achee, San Francisco, CA (US); David Christopher Sally, Piedmont, CA (US); Miranda Howitt, San Francisco, CA (US); Vincent Yao, San Francisco, CA (US); Seth Goldenberg, Berkeley, CA (US); Aimee Jin Peng, San Francisco, CA (US); William Qingdong Yan, San Francisco, CA (US); Matthew Stephen Wysocki, San Francisco, CA (US); Michael Ryan Shohoney, Monona, WI (US); Ryan Maas, Greenville, SC (US); Asha Camper Singh, San Francisco, CA (US); Leonardo Faria, San Francisco, CA (US); Elliot Piersa Dahl, Nashville, TN (US)

(21) Appl. No.: 18/471,913

(22) Filed: Sep. 21, 2023

Related U.S. Application Data
(60) Provisional application No. 63/376,596, filed on Sep. 21, 2022.

(51) Int. Cl. G06Q 10/0639

(52) U.S. Cl. CPC G06Q 10/06398

(57) ABSTRACT

A method of generating customizable goal representation is disclosed. A request from a user to view a goal representation is received. A flexible goal ontology is accessed that comprises one or more goal entities, one or more goal relationships between the goal entities, or one or more goal properties, the one or more goal properties including one or more metadata attributes relating to the one or more goal entities. A set of mapping rules is obtained that defines mappings between one or more goals. The set of mapping rules is evaluated to assemble a customized goal representation tailored to the user. The customized goal representation is updated based on a revaluation of the mapping rules affected by changes to the one or more goal entities, the one or more goal relationships, or the one or more properties.

### CROSS REFERENCE TO RELATED APPLICATIONS

This application claims the benefit of U.S. Provisional Application No. 63/376,596, filed Sep. 21, 2022, which is incorporated by reference herein in its entirety.

### TECHNICAL FIELD

The present application relates generally to the technical field of computer system administration and, in one specific example, to implementing and/or configuring computer services, applications, user interfaces, and/or tools to facilitate administration of a goals platform and/or a compensation platform deployed within one or more computer networks.

### BACKGROUND

Organizations may deploy one or more software applications within one or more computer networks to facilitate management of employees of the organization. Such software systems may include human resource (HR) systems, which may be configured to, for example, store and manage confidential employee data, handle employee-centric HR processes, such as recruitment and/or performance, and or handle offboarding. Additionally, some HR platforms may be configured to keep track of employee engagement and performance.

### BRIEF DESCRIPTION OF THE DRAWINGS

FIG. 1 is a network diagram depicting a system 100 within which various example embodiments may be deployed.

FIG. 2 is a block diagram illustrating example modules of the service(s) 120.

FIG. 3 is a schematic of a user interface depicting a company goal type.

FIG. 4 is a schematic of a user interface depicting a department goal type.

FIG. 5 is a schematic of a user interface depicting a group goal type.

FIG. 6 is a schematic demonstrating how to navigate a user interface to choose a department for and change the owner of a goal.

FIG. 7 is a schematic of a user interface displaying the “Individual” section of an owner's Goals page.

FIG. 8 is a schematic of a user interface displaying a drop-down menu containing levels of importance for sorting goals.

FIG. 9 is a schematic demonstration how to navigate a user interface to filter goals by type.

FIG. 10 is a schematic of a user interface displaying equally weighted key results of an objective.

FIG. 11 is a schematic of a user interface displaying unequally weighted key results of an objective.

FIG. 12 is a schematic of a user interface displaying unequally weighted key results of an objective and indicating that the key result is weighted at 0%.

FIG. 13 is a schematic of a user interface displaying cascading goals with one key result.

FIG. 14 is a schematic of a user interface displaying cascading goals with two key results.

FIG. 15 is a table illustrating the main differences between cascading and non-cascading goals.

FIG. 16 is a schematic demonstrating how to navigate a user interface to display non-cascading goals in a list view or cascade view.

FIG. 17 is a schematic of a user interface displaying non-cascading goals in list view.

FIG. 18 is a schematic of a user interface displaying non-cascading goals in cascade view.

FIG. 19 is a schematic of a user interface displaying a Goal Creation page when goals are non-cascading.

FIG. 20 is a schematic of a user interface displaying goal reporting with cascading goals turned off.

FIG. 21 is a schematic demonstrating how to navigate a user interface to display cascading goals in a list view, cascade view, or tree view.

FIG. 22 is a schematic of a user interface displaying multiple cascading goals in cascade view.

FIG. 23 is a schematic of a user interface displaying cascading goals in tree view.

FIG. 24 is a schematic of a user interface displaying a Goal Creation page when goals are cascading.

FIG. 25 is a schematic of a user interface displaying goal reporting with cascading goals turned on.

FIG. 26 is a schematic of a user interface displaying the your org page from the goal settings setup walkthrough.

FIG. 27 is a schematic of a user interface displaying the Activation page from the goal settings setup walkthrough.

FIG. 28 is a schematic of a user interface displaying the Cadence page from the goal settings setup walkthrough.

FIG. 29 is a schematic of a user interface displaying a selection of “Yes” on the Alignment page from the goal settings setup walkthrough.

FIG. 30 is a schematic of a user interface displaying a selection of “No” on the Alignment page from the goal settings setup walkthrough.

FIG. 31 is a schematic of a user interface displaying the Customize page from the goal settings setup walkthrough.

FIG. 32 is a schematic of a user interface displaying the Reminders page from the goal settings setup walkthrough.

FIG. 33 is a schematic of a user interface displaying the Review page from the goal settings setup walkthrough.

FIG. 34 is a schematic of a user interface displaying the final page from the goal settings setup walkthrough with the option to either explore goals or adjust the Admin settings.

FIG. 35 is a schematic demonstrating how to navigate a user interface to enable cascading goals.

FIG. 36 is a schematic of a user interface displaying a confirmation page for enabling cascading goals.

FIG. 37 is a schematic demonstrating how to navigate a user interface to change goals status definitions.

FIG. 38 is a schematic of a user interface displaying an edit modal for changing a goals status definition.

FIG. 39 is a schematic demonstrating how to navigate a user interface to integrate with Salesforce.

FIG. 40 is a schematic demonstrating how to navigate a user interface to adjust goal fields.

FIG. 41 is a schematic demonstrating how to navigate a user interface to save changes made to goal fields.

FIG. 42 is a schematic of a user interface displaying alerts indicating that required fields have not been selected.

FIG. 43 is a schematic demonstrating how to navigate a user interface to enable weighted goals for the whole organization.

FIG. 44 is a schematic of a user interface displaying a toggle button for allowing key results to have custom weighting.

FIG. 45 is a schematic demonstrating how to navigate a user interface to rename the goals display name.

FIG. 46 is a schematic of a user interface displaying a profile page containing the new goals display name.

FIG. 47 is a schematic of a user interface displaying a home page containing the new goals display name.

FIG. 48 is a schematic demonstrating how to navigate a user interface to rename objectives and key results.

FIG. 49 is a schematic of a user interface displaying a goal creation page containing the new names of the objectives and key results.

FIG. 50 is a schematic of a user interface displaying a goal explorer page containing the new names of the objectives and key results.

FIG. 51 is a schematic demonstrating how to navigate a user interface to adjust the default goal visibility.

FIG. 52 is a schematic of a user interface displaying a create objective page with the visibility field set to private.

FIG. 53 is a schematic demonstrating how to navigate a user interface to allow public goals in the org chart.

FIG. 54 is a schematic of a user interface displaying the org chart with goals shown in one employee card.

FIG. 55 is a schematic demonstrating how to navigate a user interface to create a new tag.

FIG. 56 is a schematic demonstrating how to navigate a user interface to manage tags.

FIG. 57 is a schematic demonstrating how to navigate a user interface to create a goal for a direct report.

FIG. 58 is a schematic of a user interface displaying a goal creation page containing a draft goal and the option to publish or save as draft.

FIG. 59 is a schematic demonstrating how to navigate a user interface to create a goal for a peer from the home page.

FIG. 60 is a schematic of a user interface displaying a goal creation page containing a drop-down menu for selecting owners for a goal.

FIG. 61 is a schematic demonstrating how to navigate a user interface to access goal reporting pages.

FIG. 62 is a schematic of a user interface displaying a participation reporting page containing a drop-down menu for filtering the view of goals.

FIG. 63 is as schematic of a user interface displaying a filtered view of the participation reporting page.

FIG. 64 is a schematic of a user interface displaying a participation reporting page grouped by individual.

FIG. 65 is a schematic of a user interface displaying a participation reporting page grouped by department.

FIG. 66 is a schematic of a user interface displaying a participation reporting page containing additional reporting information for objectives and key results.

FIG. 67 is a schematic of a user interface displaying a status reporting page containing a visual breakdown of objectives and key results.

FIG. 68 is a schematic demonstrating how to navigate a user interface to track the goal progress of a department, group, manager, and/or manager's team on the status reporting page.

FIG. 69 is a schematic of a user interface displaying a status reporting page with goals grouped by individual.

FIG. 70 is a schematic of a user interface displaying a status reporting page with goals grouped by department.

FIG. 71 is a schematic of a user interface displaying the status reporting page with a matrix containing a breakdown of goal statuses for several employees.

FIG. 72 is a schematic of a user interface displaying a participation reporting page filtered by manager.

FIG. 73 is a schematic of a user interface displaying the overview tab in a manager page containing participation reporting.

FIG. 74 is a schematic of a user interface displaying the members tab in a manager page containing participation reporting.

FIG. 75 is a schematic demonstrating how to navigate a user interface to create a department goal from the goals page.

FIG. 76 is a schematic demonstrating how to navigate a user interface to create a department goal from the goal creation page.

FIG. 77 is a schematic of a user interface displaying a goal creation page including a field to designate type.

FIG. 78 is a schematic demonstrating how to navigate a user interface to view team goals.

FIG. 79 is a schematic demonstrating how to navigate a user interface to view a direct report's goals.

FIG. 80 is a schematic demonstrating how to navigate a user interface to create a group goal from the goals page.

FIG. 81 is a schematic demonstrating how to navigate a user interface to create a group goal from the goal creation page.

FIG. 82 is a schematic of a user interface displaying a goal creation page including a field to designate type.

FIG. 83 is a schematic of a user interface displaying a newly created goal with an objective and key results.

FIG. 84 is a matrix describing the differences between a goal's objectives and key results.

FIG. 85 is a schematic demonstrating how to navigate a user interface to create an objective in the goal creator.

FIG. 86 is a schematic of a user interface displaying an objective creation page including a text box for describing the objective.

FIG. 87 is a schematic demonstrating how to navigate a user interface to create an objective in the goal explore page.

FIG. 88 is a schematic of a user interface displaying the option to add supported goals to an objective.

FIG. 89 is a schematic of a user interface displaying the goals homepage.

FIG. 90 is a schematic demonstrating how to navigate a user interface to create a goal within the goals homepage sidebar.

FIG. 91 is a schematic demonstrating how to navigate a user interface to align a goal to a parent goal within the goals homepage sidebar.

FIG. 92 is a schematic demonstrating how to navigate a user interface to update a goal or key result within the goals homepage sidebar.

FIG. 93 is a schematic demonstrating how to navigate a user interface to edit a goal or key result within the goals homepage sidebar.

FIG. 94 is a schematic demonstrating how to navigate a user interface to end a goal or key result within the goals homepage sidebar.

FIG. 95 is a schematic demonstrating how to navigate a user interface to delete a goal or key result within the goals homepage sidebar.

FIG. 96 is a schematic demonstrating how to navigate a user interface to reactivate an ended goal or key result.

FIG. 97 is a schematic demonstrating how to navigate a user interface to create a key result in the goal creator.

FIG. 98 is a schematic of a user interface displaying a key results creation page including a text box for describing the key result.

FIG. 99 is a schematic demonstrating how to navigate a user interface to create a key result in the goal explore page.

FIG. 100 is a schematic demonstrating how to navigate a user interface to align an objective or key result to a parent in the goal creation page.

FIG. 101 is a schematic of a user interface displaying the option to add supporting goals to a parent goal in the goal creation page.

FIG. 102 is a schematic demonstrating how to navigate a user interface to add a parent goal within the goals explore page.

FIG. 103 is a schematic demonstrating how to navigate a user interface to create a supporting goal from the goal explore page.

FIG. 104 is a schematic demonstrating how to navigate a user interface to publish a goal draft.

FIG. 105 is a schematic of a user interface displaying the objective creation page including a drop-down box to select tags for a goal.

FIG. 106 is a schematic demonstrating how to navigate a user interface to view tags from the people page.

FIG. 107 is a schematic of a user interface displaying a create key result page with the option to select Jira Integration to measure progress.

FIG. 108 is a schematic of a user interface displaying a search error.

FIG. 109 is a schematic of a user interface displaying the option to switch to JQL for a search.

FIG. 110 is a schematic of a user interface displaying a Jira set up page containing a list of issues in Jira based on a JQL query.

FIG. 111 is a schematic of a user interface displaying a Jira set up page containing options to designate start and target amounts for a list of issues.

FIG. 112 is a schematic of a user interface displaying a goal creation page after Jira has been integrated.

FIG. 113 is a schematic demonstrating how to navigate a user interface to disconnect Jira from a goal.

FIG. 114 is a schematic of a user interface displaying an edit goal page containing the option to remove Jira Integration from the goal.

FIG. 115 is a schematic of a user interface displaying a confirmation popup containing equally weighted key results for a goal.

FIG. 116 is a schematic of a user interface displaying a confirmation popup containing unequally weight key results for a goal.

FIG. 117 is a schematic of a user interface displaying a confirmation popup containing one key result with a weight, and the option to distribute remaining weights evenly to the other key results.

FIG. 118 is a schematic of a user interface displaying a confirmation popup containing key results after remaining weights have been distributed.

FIG. 120 is a schematic demonstrating how to navigate a user interface to apply custom weights from the goals page.

FIG. 119 is a schematic of a user interface displaying an edit weights modal.

FIG. 121 is a schematic of a user interface displaying a create key result page with the option to select Salesforce Integration to measure progress.

FIG. 122 is a schematic of a user interface displaying a Salesforce connection preview page containing the option to search for a report.

FIG. 123 is a schematic of a user interface displaying a Salesforce connection page containing the option to select a measurement to track progress and set a start and target amount.

FIG. 124 is a schematic demonstrating how to navigate a user interface to create a company goal from the goals page.

FIG. 125 is a schematic demonstrating how to navigate a user interface to create a company goal from the goal creation page.

FIG. 126 is a schematic demonstrating how to navigate a user interface to designate a key result type.

FIG. 127 is a schematic demonstrating how to navigate a user interface to add a key result or objective with cascading goals.

FIG. 128 is a schematic of a user interface displaying the goals update screen.

FIG. 129 is a schematic demonstrating how to navigate a user interface to access group goals from the goals page.

FIG. 130 is a schematic of a user interface displaying the goals explore page with the option to add and remove filters.

FIG. 131 is a schematic of a user interface displaying the goals explore page with the option to filter by group goals.

FIG. 132 is a schematic demonstrating how to navigate a user interface to view a department's goals from the goals page.

FIG. 133 is a schematic demonstrating how to navigate a user interface to view a department's goals from the departments page.

FIG. 134 is a schematic demonstrating how to navigate a user interface to view the company's goals from the goals page.

FIG. 135 is a schematic demonstrating how to navigate a user interface to view the company's goals from the company page.

FIG. 136 is a schematic of a user interface displaying a home page with a reminder to update a goal.

FIG. 137 is a schematic demonstrating how to navigate a user interface to add progress to a goal from the goals page context panel.

FIG. 138 is a schematic demonstrating how to navigate a user interface to add progress to a goal within the goal details page by adding an update in the “Whats New?” field and selecting a status.

FIG. 139 is a schematic demonstrating how to navigate a user interface to add progress to a goal within the goal explore context panel.

FIG. 140 is a schematic demonstrating how to navigate a user interface to add progress to a goal within the goal explore context panel by adding an update in the “Whats New?” field and selecting a status.

FIG. 141 is a schematic demonstrating how to navigate a user interface to edit an objective or key result from the goals page context panel.

FIG. 142 is a schematic demonstrating how to navigate a user interface to make changes to goal fields from the goal explore context panel.

FIG. 143 is a schematic demonstrating how to navigate a user interface to edit an objective from the goals page context panel.

FIG. 144 is a schematic demonstrating how to navigate a user interface to edit an objective from the goal creation page.

FIG. 145 is a schematic of a user interface displaying the goal details page containing support goals.

FIG. 146 is a schematic demonstrating how to navigate a user interface to be taken to the goal creation page from the goal details page.

FIG. 147 is a schematic demonstrating how to navigate a user interface to be taken to the goal editor from the goal details page.

FIG. 148 is a schematic of a user interface displaying the goal editor with a remove button for disconnecting Salesforce.

FIG. 149 is a schematic demonstrating how to navigate a user interface to delete a goal from the goal explore page.

FIG. 150 is a schematic of a user interface displaying a confirmation popup modal for deleting a goal.

FIG. 151 is a schematic demonstrating how to navigate a user interface to be taken to the goal details page from the goal explore context panel.

FIG. 152 is a schematic demonstrating how to delete a goal from the goal details page.

FIG. 153 is a schematic demonstrating how to navigate a user interface to end a goal from the goal explore context panel.

FIG. 154 is a schematic of a user interface displaying a confirmation popup modal for ending a goal.

FIG. 155 is a schematic demonstrating how to navigate a user interface to be taken to the goal details page from the goal explore context panel.

FIG. 156 is a schematic demonstrating how to end a goal from the goal details page.

FIG. 157 is a schematic of an “on track” status for a goal.

FIG. 158 is a schematic of a “progressing” status for a goal.

FIG. 159 is a schematic of an “off track” status for a goal.

FIG. 160 is a schematic of an “on track” goal progress bar.

FIG. 161 is a schematic of a “progressing” goal progress bar.

FIG. 162 is a schematic of an “off track” goal progress bar.

FIG. 163 is a schematic of a user interface displaying a popup page displaying options to end a goal as complete or incomplete.

FIG. 164 is a schematic of a user interface displaying a goal explore page with a goal marked as complete.

FIG. 165 is a schematic of a user interface displaying a goal explore page with a goal marked as incomplete.

FIG. 166 is a schematic demonstrating how to navigate a user interface to filter the goal explore list by status.

FIG. 167 is a schematic demonstrating how to navigate a user interface to reactivate a goal from the goal explore context panel.

FIG. 168 is a schematic demonstrating how to navigate a user interface to be taken to the goal details page from the goal explore context panel.

FIG. 169 is a schematic demonstrating how to navigate a user interface to reactivate a goal from the goal details page.

FIG. 170 is a schematic of a Gmail inbox with the system plugin.

FIG. 171 is a schematic of a Gmail inbox displaying employing goals via the system plugin.

FIG. 172 is a schematic of a user interface displaying a goals update screen with the option to add a goals comment to a supporting goal.

FIG. 173 is a schematic of a user interface displaying a goals update screen with the option to add a goal status update.

FIG. 174 is a schematic of a mobile device user interface displaying an employee's active goals.

FIG. 175 is a schematic of a mobile device user interface displaying an individual goal profile page.

FIG. 176 is a schematic of an icon representing a public objective.

FIG. 177 is a schematic of an icon representing a completed public objective.

FIG. 178 is a schematic of an icon representing an incomplete public objective.

FIG. 179 is a schematic of an icon representing a private objective.

FIG. 180 is a schematic of an icon representing a completed private objective.

FIG. 181 is a schematic of an icon representing an incomplete private objective.

FIG. 182 is a schematic of an icon representing a public key result.

FIG. 183 is a schematic of an icon representing a completed public key result.

FIG. 184 is a schematic of an icon representing an incomplete public key result.

FIG. 185 is a schematic of an icon representing a private key result.

FIG. 186 is a schematic of an icon representing a completed private key result.

FIG. 187 is a schematic of an icon representing an incomplete private key result.

FIG. 188 is a schematic demonstrating how to navigate a user interface to enter the goals page from the discovery navigation bar.

FIG. 189 is a schematic of a user interface displaying the explore page and its main features.

FIG. 190 is a schematic of a user interface displaying an individual goal in the goal explore context panel.

FIG. 191 is a schematic of a user interface displaying a goals detail page containing an audit log.

FIG. 192 is a schematic demonstrating how to navigate a user interface to enter cascade view in the goal explore page.

FIG. 193 is a schematic demonstrating how to navigate a user interface to expand a goal's structure when tree view is enabled in the goal explore page.

FIG. 194 is a schematic demonstrating how to navigate a user interface to create a saved view in the goal explore page.

FIG. 195 is a schematic of a user interface displaying a popup modal with the option to name a saved view.

FIG. 196 is a schematic demonstrating how to navigate a user interface to access saved views in the goal explore page.

FIG. 197 is a schematic demonstrating how to navigate a user interface to edit a saved view from the goal explore page.

FIG. 198 is a schematic of a user interface displaying a popup modal with the option to rename or delete a saved view.

FIG. 199 is a schematic demonstrating how to navigate a user interface to view a goals detail page from the goal explore context panel.

FIG. 200 is a schematic of a user interface displaying a goals detail page containing an audit log.

FIG. 201 is a schematic of a user interface displaying a notification center.

FIG. 202 is a schematic of an email notification stating that a comment was posted on a goal.

FIG. 203 is a schematic of a Slack notification stating that a comment was posted on a goal.

FIG. 204 is a schematic of an email notification stating that someone liked an update made to a goal.

FIG. 205 is a schematic of a Slack notification stating that someone liked an update made to a goal.

FIG. 206 is a schematic of an email notification stating that a goal co-owner posted an update on a goal.

FIG. 207 is a schematic of a Slack notification stating that a goal co-owner posted an update on a goal.

FIG. 208 is a schematic of an email notification stating that an employee has been added as an owner of a goal.

FIG. 209 is a schematic of an email notification stating that an employee needs to update goals.

FIG. 210 is a schematic of a Slack notification stating that an employee needs to update goals.

FIG. 211 is a schematic of a goal digest email.

FIG. 212 is a schematic of a user interface displaying a home page containing a list of tasks to complete.

FIG. 213 is a schematic of a user interface displaying a goal details page.

FIG. 214 is a schematic of a user interface displaying a home page containing a list of tasks to complete for a goal cycle.

FIG. 215 is a schematic of a user interface displaying a create new goals page.

FIG. 216 is a schematic of a goal digest email.

FIG. 217 is a schematic demonstrating how to navigate a user interface to enable or disable goal digest from the discovery navigation bar.

FIG. 218 is a schematic demonstrating how to navigate a user interface to disable the Goals Slack notifications for the individual.

FIG. 219 is a schematic demonstrating how to navigate a user interface to disable individual Goals Slack notifications for the company.

FIG. 220 is a schematic demonstrating how to navigate a user interface to disable goals feed Slack notifications.

FIG. 221 is a flow chart displaying permissions for various entities.

FIG. 222 is a schematic of a user interface displaying a company page.

FIG. 223 is a schematic of a user interface displaying an all departments page.

FIG. 224 is a schematic of a user interface displaying a my department page.

FIG. 225 is a schematic of a user interface displaying the navigation component of a goals overview page.

FIG. 226 is a schematic of a user interface displaying a header component of a my department page.

FIG. 227 is a schematic of a user interface displaying a header component of an all departments page.

FIG. 228 is a schematic of a user interface displaying a header component of a company page.

FIG. 229 is a schematic of a user interface displaying a drop-down component of an all departments page.

FIG. 230 is a schematic of a user interface displaying a drop-down component of a company page.

FIG. 231 is a schematic of a user interface displaying drop-down components for creating a goal.

FIG. 232 is a schematic of a user interface displaying insights on the progress of goals.

FIG. 233 is a schematic of a user interface displaying insights on a company's goals.

FIG. 234 is a schematic of a user interface displaying time insights.

FIG. 235 is a schematic of a user interface displaying time insights.

FIG. 236 is a schematic of a user interface displaying an explore goals page.

FIG. 237 is a schematic of a user interface displaying progress for various goals.

FIG. 238 is a schematic of a user interface displaying information for various goals.

FIG. 239 is a schematic of a user interface displaying an employee's goals page.

FIG. 240 is a schematic of a user interface displaying a list of an employee's goals.

FIG. 241 is a schematic of a portion of a user interface indicating unread notifications for my goals.

FIG. 242 is a schematic of a portion of a user interface displaying unread notifications for goals which need to be updated.

FIG. 243 is a schematic of a portion of a user interface displaying the discovery navigation bar.

FIG. 244 is a schematic of a portion of a user interface displaying a goal explore page header.

FIG. 245 is a schematic of a portion of a user interface displaying an update goals notification.

FIG. 246 is a schematic of a portion of a user interface displaying a my goals page header.

FIG. 247 is a schematic of a portion of the user interface displaying a matrix of a goal and supporting key results.

FIG. 248 is a schematic of a user interface displaying a list of goals and supporting key results.

FIG. 249 is a schematic of a user interface displaying a my goals page.

FIG. 250 is a schematic of a user interface displaying the compensation settings page.

FIG. 251 is a schematic of a user interface displaying a page for uploading an employee's CSV.

FIG. 252 is a schematic demonstrating how to navigate a user interface to create a new compensation band.

FIG. 253 is a schematic of a user interface displaying required fields for the creation of a new compensation band.

FIG. 254 is a schematic demonstrating how to navigate a user interface to bulk upload compensation bands from the compensation bands page.

FIG. 255 is a schematic demonstrating how to navigate a user interface to bulk upload compensation bands from the compensation settings page.

FIG. 256 is a matrix containing an example compensation band CSV.

FIG. 257 is a schematic of a user interface displaying a compensation bands page with the option to assign employees to the bands.

FIG. 258 is a schematic of a user interface displaying a compensation settings page with the option to upload a CSV for employees assigned to bands.

FIG. 259 is a schematic demonstrating how to navigate a user interface to remove an employee from a compensation band from within the compensation bands page.

FIG. 260 is a schematic demonstrating how to navigate a user interface to share compensation bands with a manager from the compensation bands page.

FIG. 261 is a schematic of a user interface displaying a share modal to indicate which employee's compensation bands should be shared with a manager.

FIG. 262 is a schematic of a user interface displaying compensation bands for a team.

FIG. 263 is a table displaying the admin roles and their levels of access to compensation data and functionality.

FIG. 264 is a schematic of a user interface displaying a setup page for creating a compensation cycle.

FIG. 265 is a schematic of a user interface displaying a rules and ratings page for creating a compensation cycle.

FIG. 266 is a schematic of a user interface displaying a participants page for creating a compensation cycle.

FIG. 267 is a schematic of a user interface displaying a promotion nomination modal for indicating promotions in a compensation cycle.

FIG. 268 is a schematic demonstration how to navigate a user interface to upload a CSV from within the participants page.

FIG. 269 is a schematic of a user interface displaying a data check page for creating a compensation cycle.

FIG. 270 is a schematic of a user interface displaying a roles table for creating a compensation cycle.

FIG. 271 is a schematic of a user interface displaying a budget page for creating a compensation cycle.

FIG. 272 is a projected distribution chart showing a budget breakdown.

FIG. 273 is a schematic of a user interface displaying a distribute page for creating a compensation cycle.

FIG. 274 is a schematic of a user interface displaying a verify page for creating a compensation cycle.

FIG. 275 is a schematic of a user interface displaying compensation statistics.

FIG. 276 is a schematic of a user interface displaying a portion of an employee card.

FIG. 277 is a schematic of example pay bands from an employee card.

FIG. 278 is a schematic of a user interface displaying a raise recommendation section from an employee card.

FIG. 279 is a schematic of a user interface displaying the footer section from an employee card.

FIG. 280 is a schematic of a user interface displaying a popup modal for adding an explanation to a recommendation in an employee's card.

FIG. 281 is a schematic of a user interface displaying the my direct reports section from an employee card.

FIG. 282 is a schematic of a user interface displaying the my organization section from an employee card.

FIG. 283 is a schematic of a user interface displaying a confirmation page for reviewing compensation adjustments.

FIG. 284 is a schematic of a user interface displaying a notifications settings page with the option to send compensation notifications through Slack, Microsoft Teams, or email.

FIG. 285 is a schematic of a notification requesting a user to customize a launch message to compensation cycle participating managers.

FIG. 286 is a schematic of a notification that the results of a compensation cycle are available for review.

FIG. 287 is a schematic demonstrating how to navigate a user interface to add admins to a compensation cycle.

FIG. 288 is a schematic demonstrating how to navigate a user interface to adjust the status of participants in a compensation cycle.

FIG. 289 is a schematic of a user interface displaying a budget distribution chart from a budget page.

FIG. 290 is a schematic of a user interface displaying a budget page for an active compensation cycle.

FIG. 291 is a schematic of a user interface displaying the all compensation changes tab for a compensation cycle page.

FIG. 292 is a schematic of example pay bands from an employee card.

FIG. 293 is a schematic demonstrating how to navigate a user interface to group a compensation table by manager or none.

FIG. 294 is a schematic of a user interface displaying a portion of a compensation table where notes may be added regarding a change in an employee's compensation.

FIG. 295 is a schematic demonstrating how to navigate a user interface to end a compensation cycle.

FIG. 296 is a schematic demonstrating how to navigate a user interface to share the results of a compensation cycle.

FIG. 297 is a schematic of a user interface displaying a task on the home page indicating that compensation cycle results have been shared.

FIG. 298 is a schematic of a user interface displaying a matrix of compensation cycle results.

FIG. 299 is a block diagram illustrating a mobile device 29900, according to an example embodiment.

FIG. 300 is a block diagram of an example computer system 30000 on which methodologies and operations described herein may be executed, in accordance with an example embodiment.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

Even after deploying various tools, such as one or more HR systems, organizations may have difficulty effectively using the data items contained in these systems effectively. For example, an organization may be unable to use the HR systems (or have difficulty using the HR systems) to link data items pertaining to or representing the organization's strategic priorities to data items pertaining to or representing each employee. Without being able to use its tools efficiently to link such data items, it may be difficult for an organization to align its employees around the organization's strategic priorities. Similarly, and it may be difficult for the organization to recognize and/or equitably reward employees for their work, especially as it relates to the organization's strategic priorities.

It can be a difficult technical problem to determine how to connect data items related to work and/or goals of employees to data items pertaining to the broader business strategy of an organization, such that an organization can, for example, optimally celebrate and reward employees for their efforts.

The system described herein enables administrators (e.g., business leaders within an organization) to, using advanced data management tools, align their employees around their company's strategic priorities and activate every employee to execute against them. In example embodiments, the system helps an organization bridge one or more gaps between people operations and business operations through management of data items that represent or define Objectives and Key Results (OKRs) of an organization and the interlinking of such OKR data items with other data items, such as those representing goals of an employee.

In example embodiments, the system may be configured to be integrated with external systems, such as Jira and Salesforce, such that goals and OKRs are synchronized across the organization's systems and the organization's progress measurement and reporting stays up to date in real time without the need for manual updating.

In example embodiments, the system may provide one or more interactive graphical user interfaces (GUIs), such as Actionable Goals Home and Explore pages, that may provide frictionless goal setting, measurement, tracking, and achievements on an elevated surface with seamless actions right in a sidebar.

In example embodiments, the system may provide advanced controls for operationalizing goals. For example, the system may enable a streamlined goal-setting process that runs on the organization's schedule using Goal Cycles. With automated time periods, the system may build Goal Cycles automatically and move from one to the next automatically. And with Weighted Goals, the system can accurately reflect and measure the organization's priorities by importance across the entire organization.

In example embodiments, the system may provide reporting power tools for users. Users may be assigned one more roles or personas, such as administrator, chief of staff, employee, manager, manager of manager (“MoM”), executive, executive assistance, operations leader, department head, business leader, people manager, data consumer, and so on. Each user and/or role assigned to the user may be associated with different access rights. For example, reporting dashboards may be accessible to managers or business leaders to report on goal status and identify where they can take action to keep the company on track.

In addition to helping employees align their work success with business success, the system provides various tools to help those employees feel recognized for that success. In example embodiments, various tools are provided for recognizing and celebrating individuals for their work, which, in turn, may lead to increased satisfaction and/or productivity and decreased turnover. Recognition may come in many forms, such as public praise or awards, increased responsibility and, of course, compensation. But employees may not just be looking out for themselves; they may also want to know their colleagues and friends are also being rewarded for their work.

In example embodiments, the system facilitates development of compensation strategies that provide flexibility to attract and reward top performers while including checks and guidance that ensure compensation practices are equitable and aren't perpetuating bias.

In example embodiments, the system provides tools that support compensation decision-making and communication. For example, the tools may help to streamline the compensation process, integrate with performance data, and provide insight into pay trends across the company. Users, such as members of one or more HR teams, may manage their compensation review process in a centralized, secure hub and seamlessly integrate an employee's performance information into the decision-making process. Other users, such as managers and company leaders, may be given more insight into individual and team-wide pay trends as well as more context to navigate salary conversations with direct reports. Additionally, employees may be able to view their own compensation information directly.

In example embodiments, technical solutions for aligning employee goals with company objectives and streamlining compensation review workflows are described. For example, the described system provides a number of unconventional technical solutions that go beyond generic computer implementation. The system includes specialized interfaces and workflows for creating and tracking goals that are specifically designed for smaller mobile screens. For example, the “Goals Explore” interface allows mobile users to quickly update or edit goals using sidebars and context panels, avoiding the need to navigate through complex menus.

The system also enables integration with third-party systems using tailored APIs and protocols to synchronize goal data. For instance, one or more external system APIs (e.g., SalesForce API and/or Jira API) automatically updates progress on synced goals when a change occurs in Salesforce, without needing manual duplication of efforts and/or integrate issue tracking with goals to automatically update goal progress as issues are opened/closed in the external systems.

To link goals data in the backend, the system may utilize an unconventional mapping table structure to store associations between employee goal IDs and company objective IDs. This allows progress to cascade between linked goals while maintaining data integrity. The system may also implement artificial intelligence to recommend goal alignments using machine learning trained on historical goals data.

The specialized interfaces also provide tailored goal insights, such as contextual sidebars with quick actions based on goal type and permissions. The system generates overview analytics tailored to different user roles, surfacing key progress indicators on executive and department leader dashboards.

For compensation management, the system includes technical improvements such as seamless integration with third-party HR systems using APIs to centralize compensation data. The system provides a specialized compensation interface allowing administrators to adjust proposed compensation changes across the organization while instantly viewing projected effects on the budget.

The system may leverage AI to analyze compensation trends, identifying discrepancies across protected classes to enable equitable pay practices. The interface displays context-specific insights into pay equity during compensation decisions. The system also technically integrates performance data into compensation workflows, linking ratings to pay guidance.

The compensation module streamlines approval workflows, implementing role-based permissions for managers to review proposed changes. The system facilitates compensation communication through automated report generation tailored to different user roles.

The specialized interfaces, integrations, data structures, and/or AI implementations provide a technical solution that goes beyond generic computer hardware and improves upon prior conventional systems.

A method of generating customizable goal representation is disclosed. A request from a user to view a goal representation is received. A flexible goal ontology is accessed. The flexible goal ontology comprises one or more goal entities, one or more goal relationships between the goal entities, and one goal properties, the one or more goal properties including one or more metadata attributes relating to the one or more goal entities. A set of mapping rules is obtained. The set of mapping rules defines mappings between one or more goals based on the one or more properties and the one or more relationships in the goal ontology. The set of mapping rules is evaluated to dynamically assemble a customized goal representation tailored to the user. The customized goal representation is incrementally updated based on a revaluation of the mapping rules affected by changes to the one or more goal entities, the one or more goal relationships, and the one or more properties. The customized goal representation is transmitted to a client device associated with the user for graphical rendering based on a context of the user.

A method of implementing administrative services for a compensation platform is disclosed. One or more interactive compensation representation views are generated based on an evaluation of mapping rules against a flexible ontology and current data state, the flexible ontology comprising customizable compensation components, relationships, and properties. One or more compensation representation views are dynamically updated in real-time in response to changes in compensation data, user context, or access permissions without requiring manual regeneration of the one or more compensation representations. The one or more interactive compensation representation views include a user interface element displayed in response to a user selection of compensation data, wherein the user interface element provides direct access to compensation information relevant to the selected compensation data without requiring a change to another screen or another user context.

In example embodiments, the system provides a specialized compensation interface allowing administrators to adjust proposed compensation changes across the organization while instantly viewing projected effects on the budget. The interface displays context-specific insights into pay equity during compensation decisions. The system also technically integrates performance data into compensation workflows, linking ratings to pay guidance.

In example embodiments, the compensation module streamlines approval workflows, implementing role-based permissions for managers to review proposed changes. The system facilitates compensation communication through automated report generation tailored to different user roles.

In example embodiments, the system allows modeling compensation with a flexible ontology to capture semantics and terminology specific to the organization. Compensation is modeled using an extensible ontology allowing organizations to define custom compensation components, relationships, formulas, and semantics. For example, complex equity award types can be represented. This exceeds hardcoded compensation element definitions.

In example embodiments, hierarchical compensation data views like bands and grades are generated on demand by evaluating declarative mapping rules against the flexible compensation model. This allows dynamically materializing tailored compensation hierarchies.

In example embodiments, compensation actions are logged in an immutable audit trail with user context and explanatory notes. Audit reports provide transparency into compensation decisions, answering questions like why an employee's pay changed. This exceeds basic change logging.

In example embodiments, managers can provide contextual notes explaining the rationale behind compensation actions which are persisted for review and auditing. Rationale helps identify potential biases and ensures equitable pay. Conventional systems lack contextual explainability.

In example embodiments, the system enables defining fine-grained access policies for compensation data and actions based on parameters like user attributes, compensation properties, and organization hierarchies. For example, manager compensation visibility can be limited. This facilitates access control precision exceeding coarse role-based access.

In example embodiments, incremental compensation data changes are captured from upstream systems and propagated bidirectionally using change data capture and messaging for real-time synchronization. This delivers timelier update propagation compared to bulk data transfers.

In example embodiments, analyzing access patterns allows detecting compensation policy violations to trigger reviews. For example, managers accessing subordinate pay outside review cycles may be flagged. This enables real-time compliance monitoring rather than periodic audits.

In example embodiments, compensation dashboards are embedded directly into the interactive interfaces providing intuitive visibility into pay trends and outliers. This brings insights to managers rather than requiring accessing separate analytics systems.

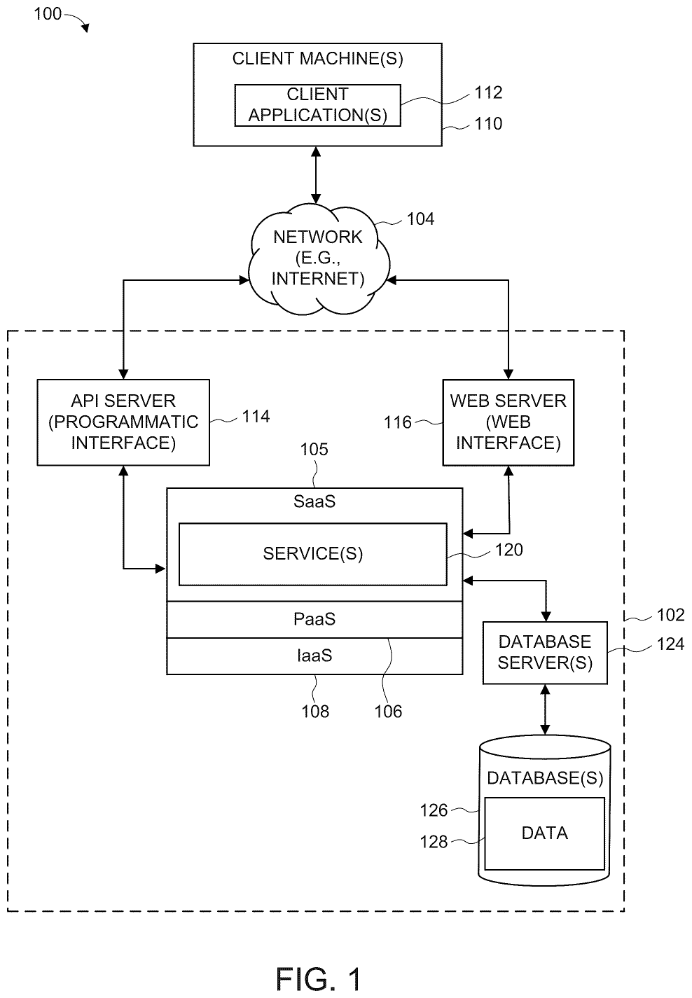

FIG. 1 is a network diagram depicting a system 100 within which various example embodiments may be deployed.

A networked system 102, in the example form of a cloud computing service, such as Microsoft Azure or other cloud service, provides server-side functionality, via a network 104 (e.g., the Internet or Wide Area Network (WAN)) to one or more endpoints (e.g., client machines 110). The networked system 102 is also referred to herein as “Lattice,” the “system,” or the “platform.” FIG. 1 illustrates client application(s) 112 on the client machines 110. Examples of client application(s) 112 may include a web browser application, such as the Internet Explorer browser developed by Microsoft Corporation of Redmond, Washington, or other applications supported by an operating system of the device, such as applications supported by Windows, iOS or Android operating systems. Examples of such applications include e-mail client applications executing natively on the device, such as an Apple Mail client application executing on an iOS device, a Microsoft Outlook client application executing on a Microsoft Windows device, or a Gmail client application executing on an Android device. Examples of other such applications may include calendar applications and file sharing applications. Each of the client application(s) 112 may include a software application module (e.g., a plug-in, add-in, or macro) that adds a specific service or feature to the application.

An API server 114 and a web server 116 are coupled to, and provide programmatic and web interfaces respectively to, one or more software services, which may be hosted on a software-as-a-service (SaaS) layer or platform 105. The SaaS platform 105 may be part of a service-oriented architecture, being stacked upon a platform-as-a-service (PaaS) layer 106 which, may be, in turn, stacked upon a infrastructure-as-a-service (IaaS) layer 108 (e.g., in accordance with standards defined by the National Institute of Standards and Technology (NIST)).

While the service(s) 120 are shown in FIG. 1 to form part of the networked system 102, in alternative embodiments, the service(s) 120 may form part of a service that is separate and distinct from the networked system 102.

Further, while the system 100 shown in FIG. 1 employs a cloud-based architecture, various embodiments are, of course, not limited to such an architecture, and could equally well find application in a client-server, distributed, or peer-to-peer system, for example. The various service(s) 120 (e.g., server applications) could also be implemented as standalone software programs. Additionally, although FIG. 1 depicts machines 110 as being coupled to a single networked system 102, it will be readily apparent to one skilled in the art that client machines 110, as well as client applications 112, may be coupled to multiple networked systems, such as payment applications associated with multiple payment processors or acquiring banks (e.g., PayPal, Visa, MasterCard, and American Express).

Web applications executing on the client machine(s) 110 may access the various service(s) 120 via the web interface supported by the web server 116. Similarly, native applications executing on the client machine(s) 110 may accesses the various services and functions provided by the service(s) 120 via the programmatic interface provided by the API server 114. For example, the third-party applications may, utilizing information retrieved from the networked system 102, support one or more features or functions on a website hosted by the third party. The third-party website may, for example, provide one or more promotional, marketplace or payment functions that are integrated into or supported by relevant applications of the networked system 102.

The service(s) 120 may be hosted on dedicated or shared server machines (not shown) that are communicatively coupled to enable communications between server machines. The service(s) 120 themselves are communicatively coupled (e.g., via appropriate interfaces) to each other and to various data sources, so as to allow information to be passed between the service(s) 120 and so as to allow the service(s) 120 to share and access common data. The service(s) 120 may furthermore access one or more databases 126 via the database servers 124. In example embodiments, various data items are stored in the database(s) 126, such as data 128, including goals data items and/or compensation data items described herein. In example embodiments, the data 128 includes one or more data items or metadata items that are viewable and/or editable via one or more user interfaces described herein. The data 128 may include data items that are interrelated, connected, or interlinked, to, for example, provide connections between goals (and/or performances) of employees and objective of an organization, as described in more detail herein.

Navigation of the networked system 102 may be facilitated by one or more navigation applications. For example, a search application (as an example of a navigation application) may enable keyword searches of data items included in the one or more database(s) 126 associated with the networked system 102. Various other navigation applications may be provided to supplement the search and browsing applications.

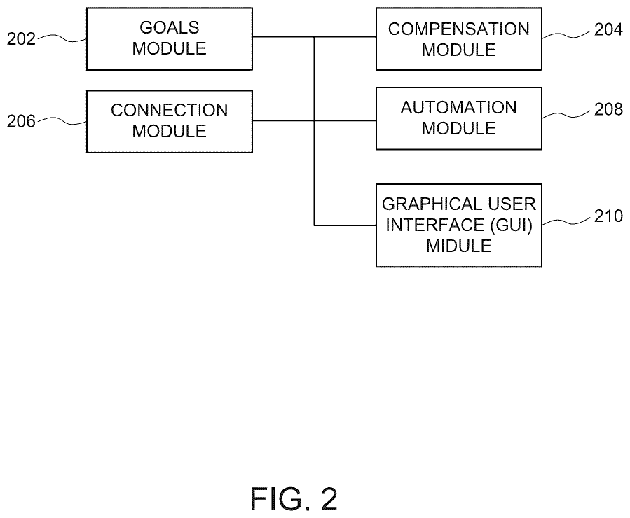

FIG. 2 is a block diagram illustrating example modules of the service(s) 120.

A goals module 202 is configured to provide users with access to goals services, including services for setting goals, integrating goals with external systems (e.g., Salesforce, Slack, and/or Microsoft Teams), acting on goal progress data in real time to keep an organization on track against key objectives, and/or increase employee engagement by connecting success of employees to success of the organization, as described in more detail herein.

A compensation module 204 is configured to provide users with access to compensation services, including streamlining setup, launch, and tracking workflows to seamlessly include performance data in a compensation review process in a secure, centralized hub; connecting performance and compensation, including creating compensation guidelines and performance ratings, compensation ratios, and so on, to empower clarity and consistency across an organization; making compensation decisions more transparent and equitable by helping users provide context about specific recommendations and actions; and providing more transparency for users by closing out compensation reviewing, sharing outcomes with managers in just a few clicks, and generating compensation communications so that everyone can understand exactly how their compensation package is changing, as described in more detail herein.

A connection module 206 is configured to connect, link, or interrelate data items pertaining to goals of employees of an organization with data items pertaining to objectives of the organization, as described in more detail herein.

An automation module 208 is configured to automate various tasks, such as, for example, adding progress to objectives, creating goal cycles based on cadence and/or time periods, updating progresses (e.g., based on third-party system integrations), assigning group owners, calculating progresses from key results, automatically inputting recommendations, automatically updating user interfaces in real time, and so on, as described herein. In example embodiments, some automation may be used in machine learning. For example, a machine-learning model may be trained to output a value (e.g., a time period, cadence, and so on) that optimizes the performance of the organization with respect to one or more objectives. The inputs to the machine-learning model may include one or more relevant data items (e.g., from data 128). The machine-learning model may then be applied to generate the value based on novel input data.

A dynamic graphical user interface (GUI) module 210 is configured to provide one or more specialized graphical user interfaces, as described herein, to, for example, allow users to manage and/or link data pertaining to goals, compensation, and/or OKRs. In example embodiments, the one or more specialized user interfaces and/or elements included in the one or more specialized user interfaces, and/or combinations thereof, are asserted to be unconventional. Additionally, the one or more specialized user interfaces described include one or more features that specially adapt the one or more specialized user interfaces for devices with small screens, such as mobile phones or other mobile devices.

The system includes goals services and/or tools configured to make it easy for employees to track their personal and professional objectives and link them to other company and department initiatives. Using the goals services allows users (e.g., including admins) to easily track the goals within their organization and helps other users (e.g., including managers) track their teams' progress.

By setting goals, employees can better understand how they make an impact on the company and their career. They can also work closely with their managers to better figure out their strengths and weaknesses and objectives they should focus on.

In example embodiments, employees can create individual and group goals, not department or company goals; department heads can create department goals; and admins can create individual, group, department, and company goals.

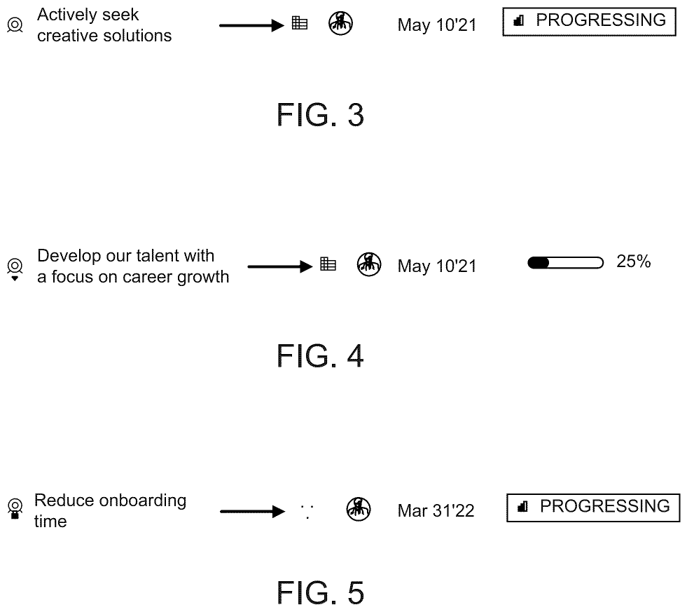

FIG. 3 is a schematic of a user interface depicting a company goal type.

FIG. 4 is a schematic of a user interface depicting a department goal type.

FIG. 5 is a schematic of a user interface depicting a group goal type.

Employees will be able to see all public department and company goals by navigating to the Goals Homepage>Company goals in a user interface for the goals services.

Employees may be able to see other employees' public goals by going to their profile pages or in a Goal Explore section user interface, which may be within an all-saved-view section of the user interface.

Managers and/or managers of managers may be able to see all of their reports' goals regardless of whether they're private. Private goals may only be seen by the individual, their manager, manager of managers, and/or admins.

In example embodiments, goal creators are always able to see the goal whether or not they are the goal owner, admin, or manager.

Admins may be able to see all individual, company, and department goals regardless of being private or public.

Employees can be reviewed based on their goal performance by bringing active or ended goals into a review template.

In example embodiments, goals will only live on an employee's goals page in “Individual” when they are the goal's owner.

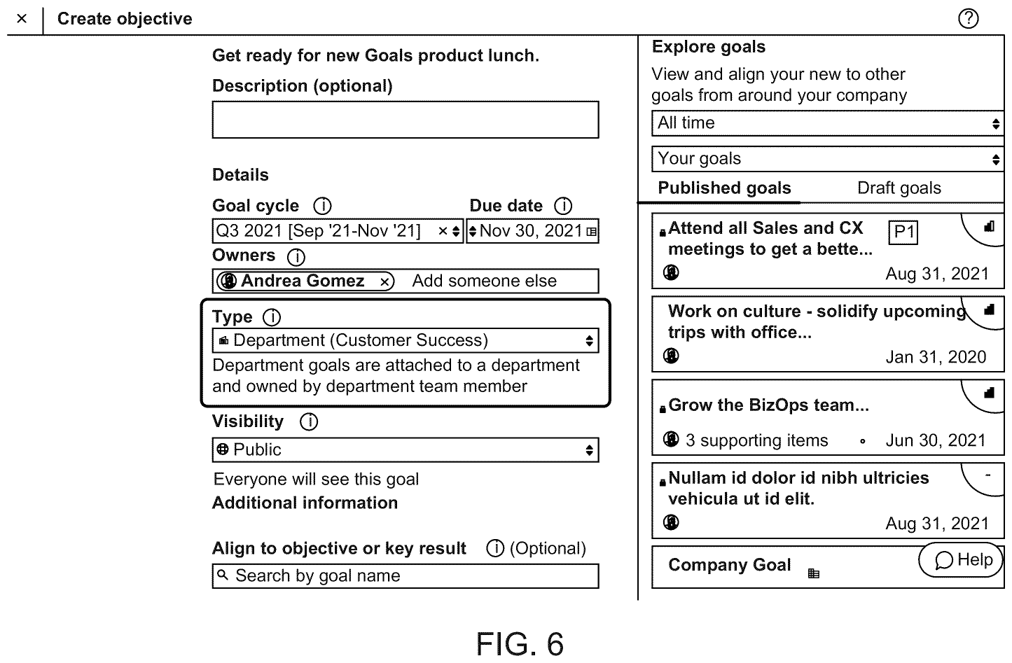

FIG. 6 is a schematic demonstrating how to navigate a user interface to choose a department for and change the owner of a goal.

Anyone who creates a goal can add owners to the goal or change the owner of the goal. For example, if an admin wants to create a department goal for a manager or an employee, they can do so by following the example steps below.
Creating the goal.
Choosing the department and changing the owner.
Then, the goal will live on the new owner's goals page in “Individual”.

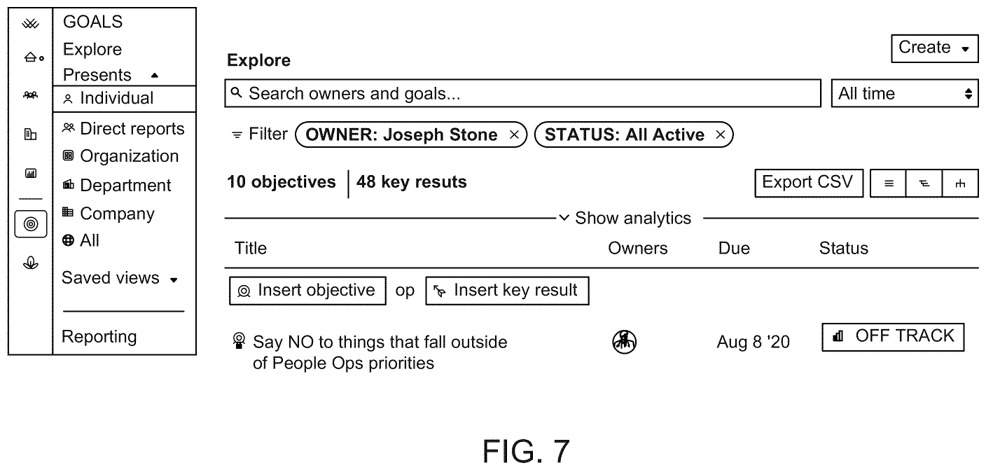

FIG. 7 is a schematic of a user interface displaying the “Individual” section of an owner's Goals page.

Who Can Edit or Delete Goals?

Only Admins can edit and delete all goals. Employees can edit or delete goals that they own. Managers can edit or delete direct reports' goals. Managers of managers can edit or delete indirect reports' goals. Goal creators can edit or delete goals they've made even if they don't own them.

Who Can Update a Goal?

Anyone can update a public goal that they're an owner of. Only employees who have viewing access to private goals can update them (if they are the owner, manager of owner+their managers, or admin).

Complete an Ended Goal

The end date of a goal is when the goal is marked “complete.” In example embodiments, goals will not auto-complete; this leaves room to exceed the goal target.

Using Goal Tags

Goal tags may be used to organize goals around major initiatives.

For example, suppose a company is expanding into Europe (which can be very cross-functional). In that case, admins can create a tag titled ‘European-expansion.’ When an employee creates a related goal, they can apply this tag. Those with visibility access to those goals will be able to filter goals by tags.

Using Goal Priorities

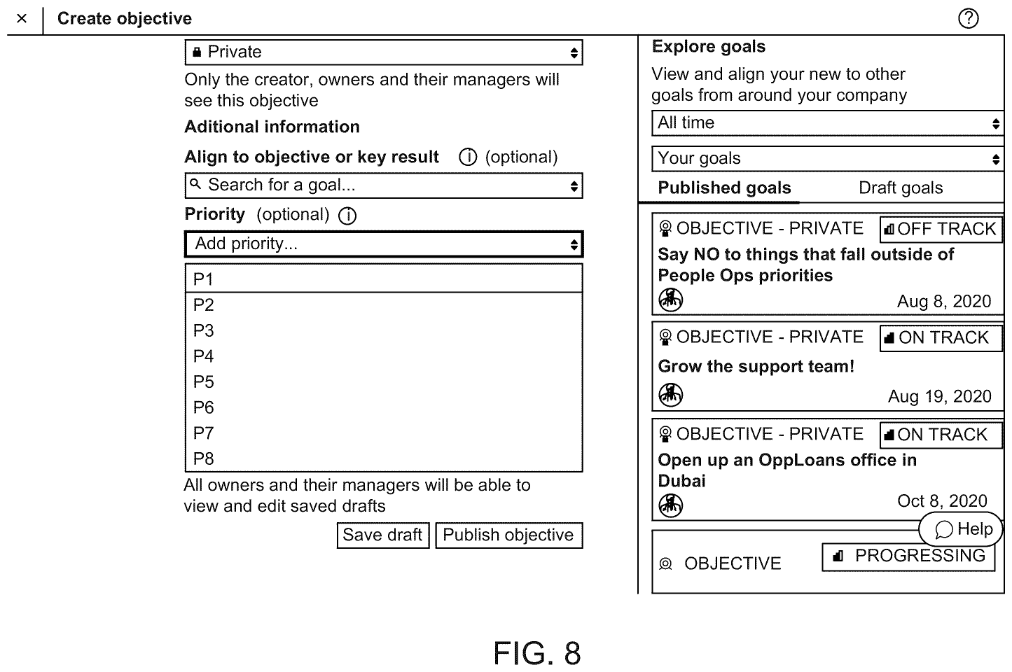

FIG. 8 is a schematic of a user interface displaying a drop-down menu containing levels of importance for sorting goals.

Goals can be sorted by assigning a level of importance to them under a “Priority” checkbox. This label allows the goals to be listed in order of priority when viewed on a Profile page.

Filtering Goals

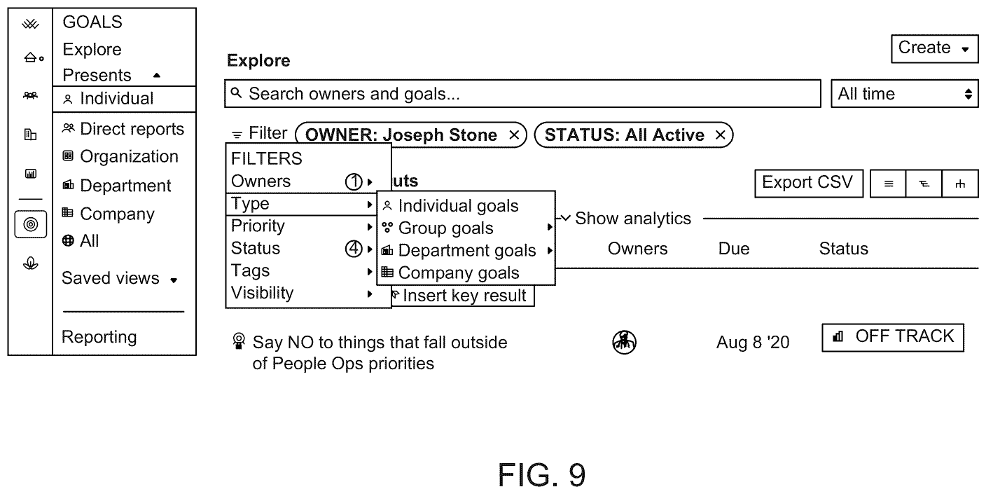

FIG. 9 is a schematic demonstration how to navigate a user interface to filter goals by type.

Goals can be filtered within the Goals page, which, for example, can be accessed by clicking a goals icon on a discovery navigation pane on the left-hand side of the user interface. Goals can be filtered by different attributes such as type, priority, status, tags, visibility, and owners.
Exporting Goals

Users can export goals from a Goals Explore page, which may provide a list of public and private goals (that the users have access to) with the following fields:
1. ID.
2. OKR type.
3. Goal name.
4. Goal cycle.
5. Goal type.
6. Department.
7. Owners
8. Created at (UTC).
9. Parent ID.
10. Parent goal.
11. Priority.
12. Tags.
13. Description.
14. Status.
15. State.
16. Starting amount.
17. Progress amount.
18. Goal amount.
19. Start date.
20. Due date.
21. Last updated.
22. Whether the goal is private or public.
23. Supporting goal IDs.
24. Support goals.
25. Employee ID.
26. Employee email.

Users can create goals following the OKR format. When creating an OKR:
Objectives are considered qualitative goals and will inherit the progress of their quantitative child/supporting goals.
Key results are considered quantitative goals and will roll up progress to their objectives.
Binary key results are considered quantitative and will inherit the progress of their child/supporting goals.

Weighing Key Results Equally

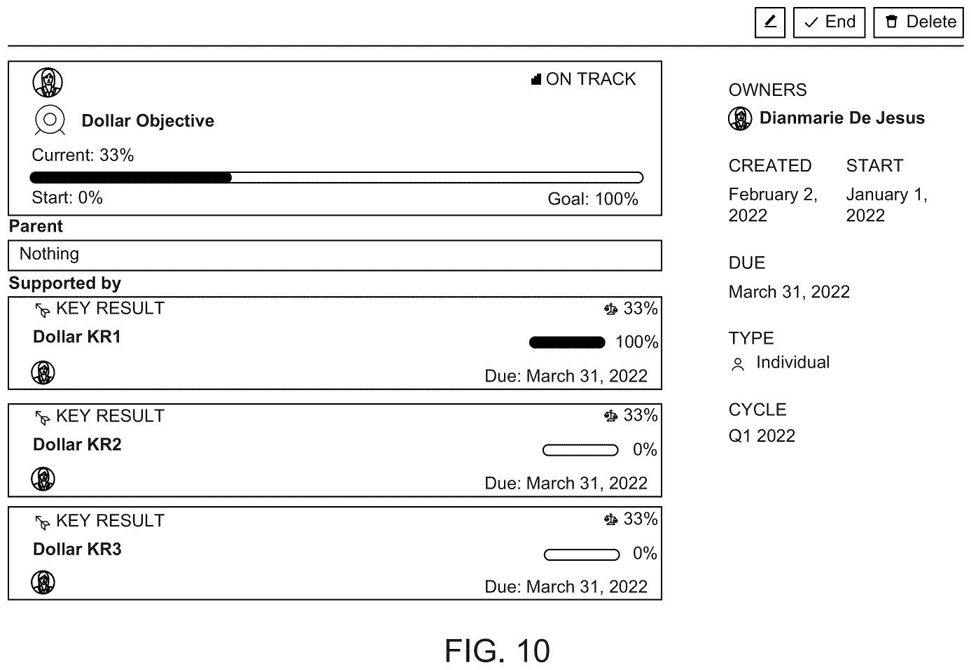

FIG. 10 is a schematic of a user interface displaying equally weighted key results of an objective.

Each key result may be equally weighted. For example, if there are three key results, each one may be worth 33% of the total objective.

As shown in FIG. 10, if we create our objective, the three different key results roll up to this goal.
1. Dollar KR 1 with an end goal of $300.
2. Dollar KR 2 with an end goal of $500
3. Dollar KR 3 with an end goal of $1000.

Let's say we update “Dollar KR 1” to be fully achieved. Below, we can see that Dollar KR 2 and Dollar KR 3 are still at 0% completed, and Dollar KR 1 is 100% completed.

The overall objective is now 33% complete since each key result is worth one-third of the total.

Weighing Key Results Unequally

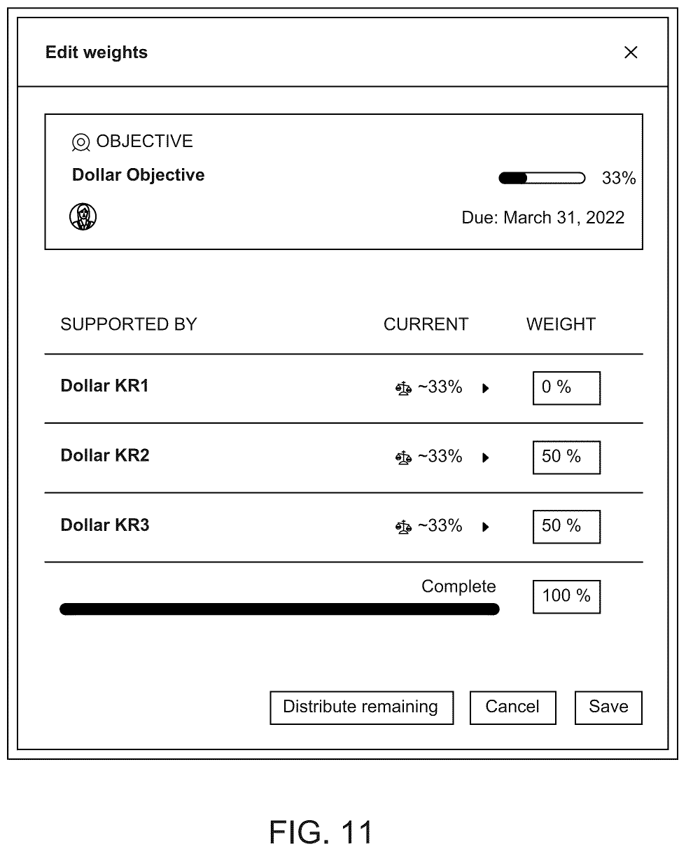

FIG. 11 is a schematic of a user interface displaying unequally weighted key results of an objective.

Sometimes there may be key results or child objectives that should not be weighted equally, causing the percentage calculated for the overall objective to appear incorrect. This can be solved by setting the objective to something other than binary and manually updating it.

In the example above, we may not want to view the goal as 33.33% complete since the key results should not have equal weight in the overall objective.

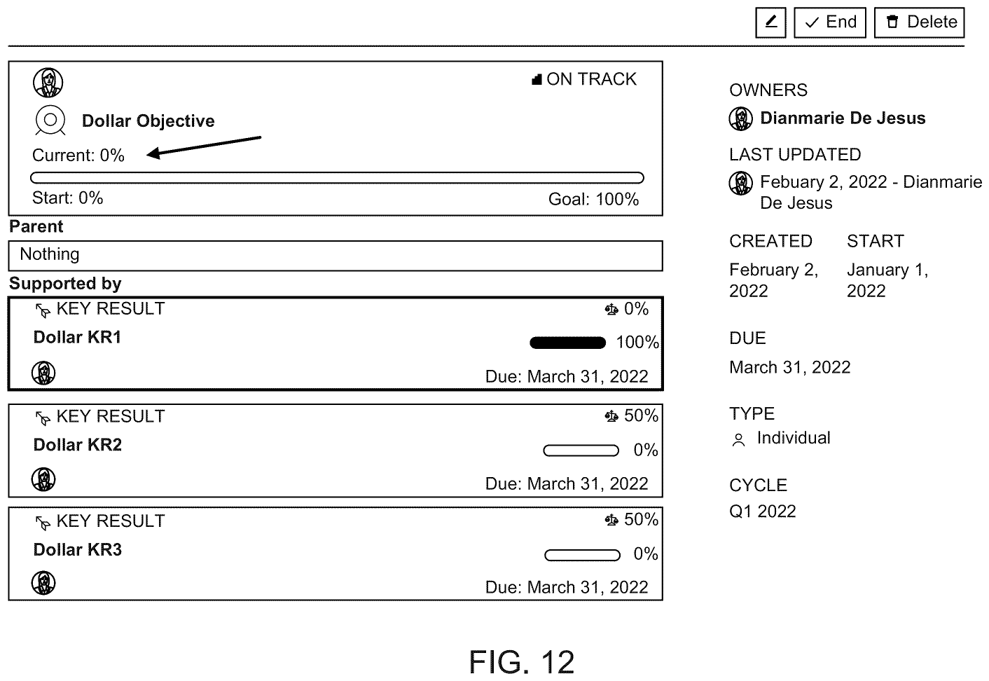

FIG. 12 is a schematic of a user interface displaying unequally weighted key results of an objective and indicating that the key result is weighted at 0%.

To set this up, set custom weighted goals. Here is an example procedure for doing so:
1. Select Goals on the discovery navigation.
2. Find and click on the goal to edit to open the context panel.
3. Select Edit weights.
4. The exact editing weights modal shown above will appear. Here, users can make edits and Save.

In this example, we have set the Dollar KR1 key result weight to be 0%, while keeping Dollar KR2 and Dollar KR3 at 50% each. When we update our Dollar KR 1 to be 100, the overall objective doesn't progress. This is because the key result is weighted at 0%.

Cascading Goals

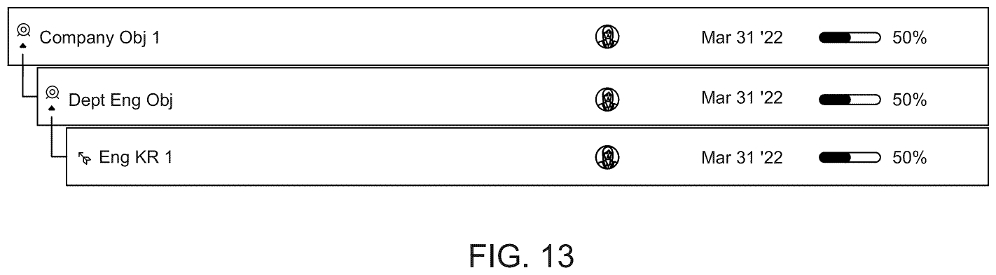

FIG. 13 is a schematic of a user interface displaying cascading goals with one key result.

Cascading goals, if enabled, allows users to align child objectives to parent objectives. In these cases, the progress will work as follows: Example 1: Objective 1>Objective 2>Key result 1.
Key results automatically add progress to objectives.
Key result 1 (Eng KR 1) will flow into Objective 2 (Dept Eng Obj).
Objective 2 (Dept Eng Obj) will flow into Objective 1 (Company Obj 1).

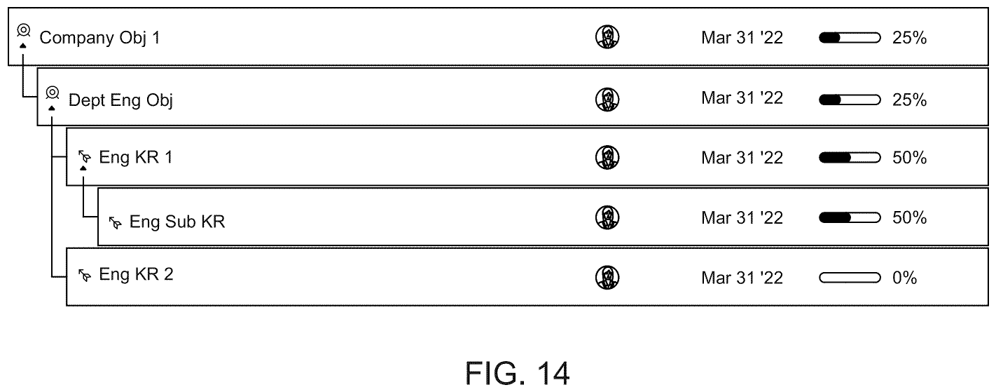

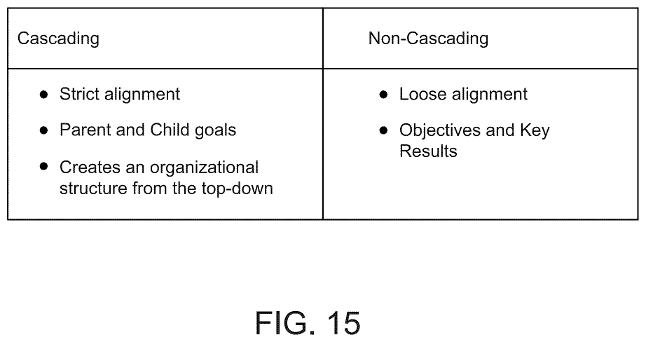

FIG. 14 is a schematic of a user interface displaying cascading goals with two key results.

Example 2: Objective 1>Objective 2>Key result 1>Key result 2.
The parent key result needs to be set to binary to accept the flow of the child key result, therefore, Key result 1 (Eng KR1) will need to be set to binary.
Key result 2 (Eng Sub KR) will flow to Key result 1 (Eng KR1) if Key result 1 is binary.
Key results automatically add progress to objectives.
Key result 1 (Eng KR1) will flow into Objective 2 (Dept Eng Obj).
Objective 2 (Dept Eng Obj) will flow into Objective 1 (Company Obj 1)

In example embodiments, there are four goal types: company, group, department, and individual.
1. Company goals can be created by admins or individuals with a goals global permission custom role.
2. Department goals can be created by department heads as well as admins.
3. Group goals can be created by all users regardless of their group affiliation. Note: an admin must create at least one group for the ability to create group goals to be available.
4. Individual goals can be created by any employee in the system.

What is the Difference Between Cascading and Non-Cascading Goals?

FIG. 15 is a table illustrating the main differences between cascading and non-cascading goals.

Cascading goals create strict alignment by establishing a set of overall organizational goals that flow down; this ideally ensures that every team and individual works towards one set of objectives. Non-cascading goals are simply the opposite! There is no clear alignment between the organizational goals and the individual employee goals. Goals are more focused on individually-specified objectives and key results, which will often not directly align with the organizational goals.

Non-Cascading Goals

Users will know when Cascading Goals is turned OFF because all goals will format by a list view. Objectives will not and cannot align with other objectives. Key results can be aligned to their parent objective up to one level.

Non-Cascading Goal Example:
Objective Make Degree an International Company.
   Key Result 1: Open a Degree Location in Dubai.
   Key Result 2. Hire 10 Sales employees.

If Cascading Goals is turned OFF, users will notice that their Explore page will include a list of objectives or key results aligned to key results.

The non-cascading goals page will include a list view and a cascade view.

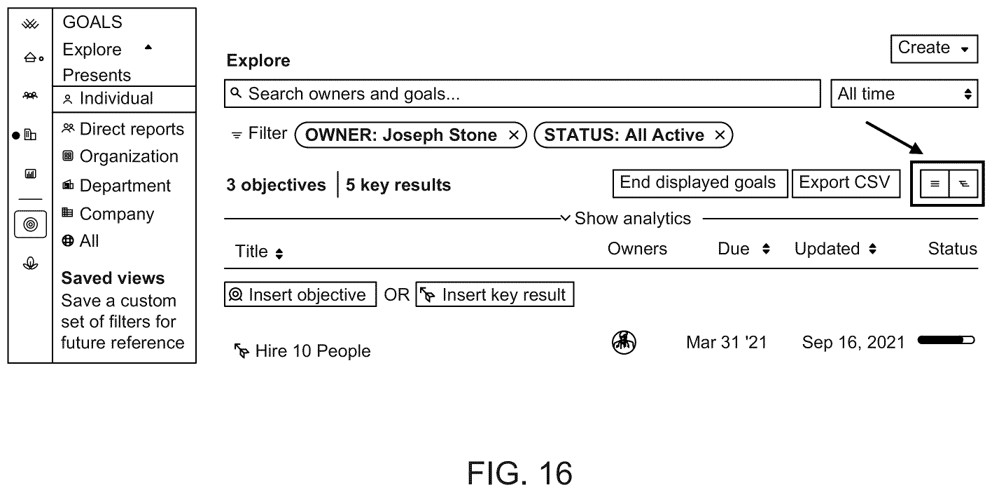

FIG. 16 is a schematic demonstrating how to navigate a user interface to display a non-cascading goals page in list view or cascade view.

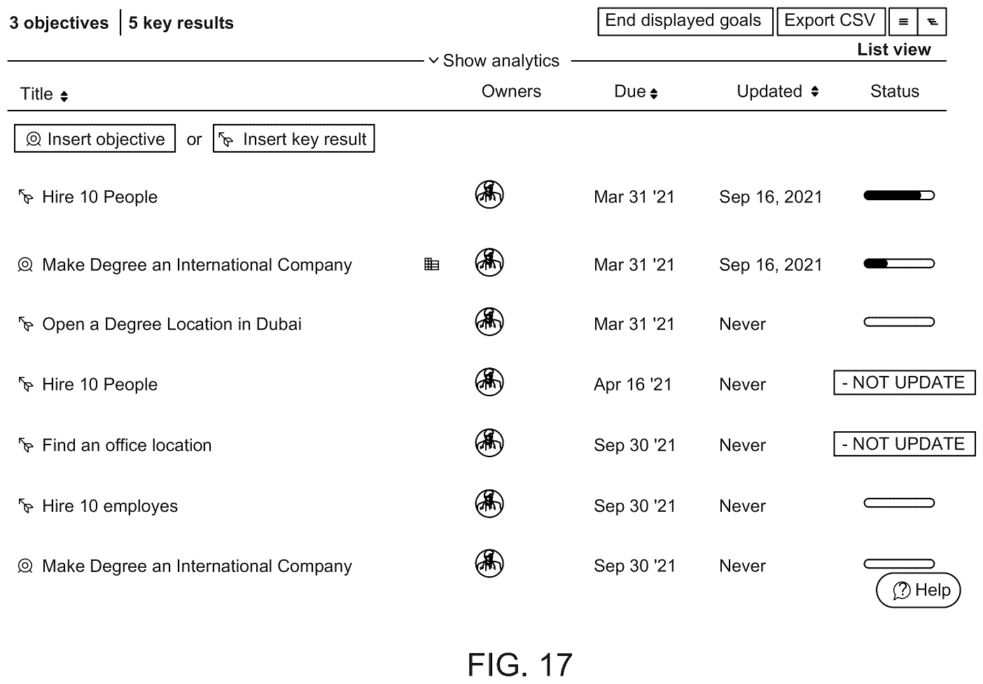

FIG. 17 is a schematic of a user interface displaying non-cascading goals in list view.

In the List view, notice objectives and key results are not aligned to any other objective.

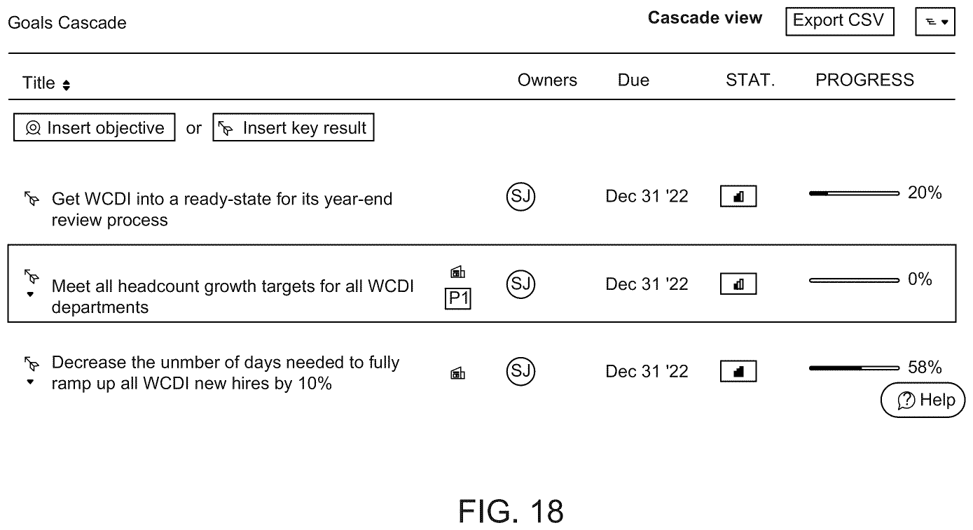

FIG. 18 is a schematic of a user interface displaying non-cascading goals in cascade view.

In the Cascade view, objectives show alignment with their key results. When expanding a parent objective, employees will only have the option to add a key result, but not an objective.

Create a Goal with Non-Cascading Goals

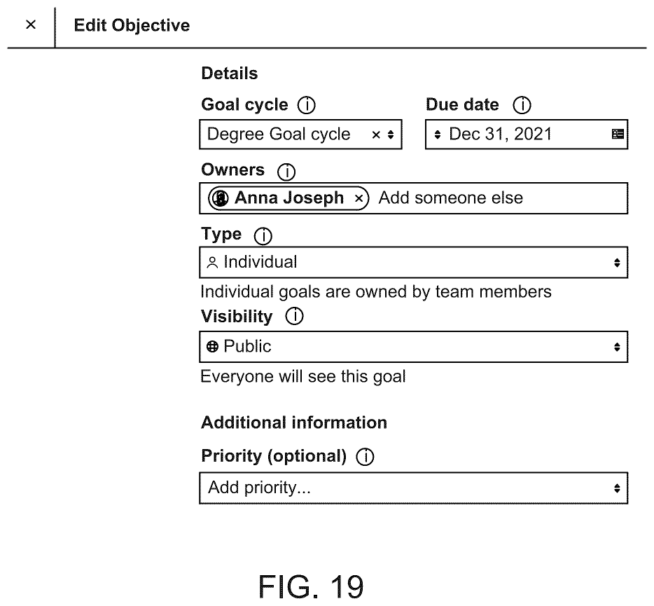

FIG. 19 is a schematic of a user interface displaying a Goal Creation page when goals are non-cascading.

When employees create their objectives or key results and goals are non-cascading, their Goal Creation page will look as follows. Here, the employee's goal is only for their one individual goal and does not indicate any connection to any other goals.

There is no option to align to a parent goal when creating a goal. However, users will be able to create key results from this page.

Reporting with Non-Cascading Goals

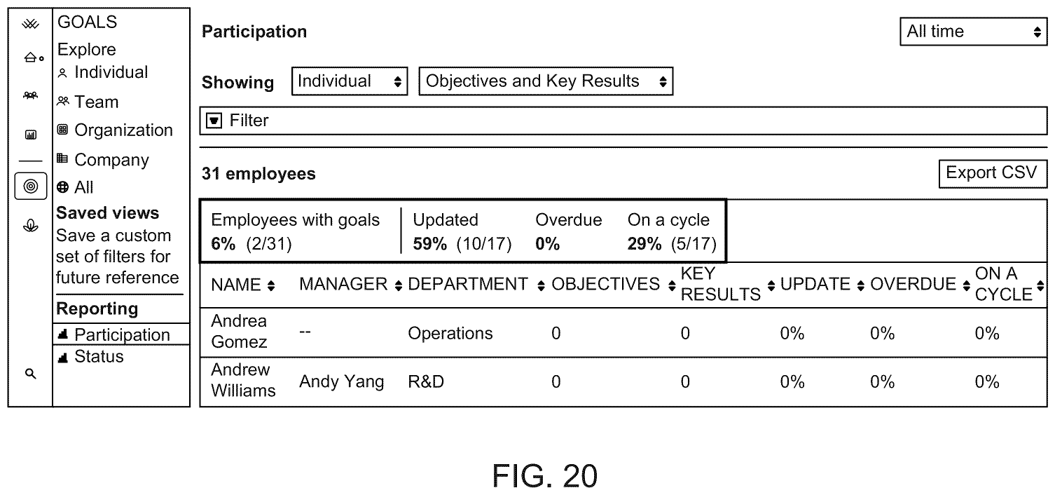

FIG. 20 is a schematic of a user interface displaying goal reporting with cascading goals turned off.

For reporting with Cascading Goals turned OFF, the goals may be reported individually. There is no reporting based on alignment.

Cascading Goals

Users will know they have Cascading Goals turned ON when all objectives and key results have the ability to align with other goals.

The Goal Explore Page with Cascading Goals

If Cascading Goals is turned ON, users will notice that their Explore page will include a list of child objectives and key results aligned to parent objectives.

Cascading Goal Example:
Parent Objective: Make Degree an International Company.
   Child Objective: Open a Degree Location in Dubai.
      Key Result 1: Find an office space.
      Key Result 2: Hire 10 Sales employees.

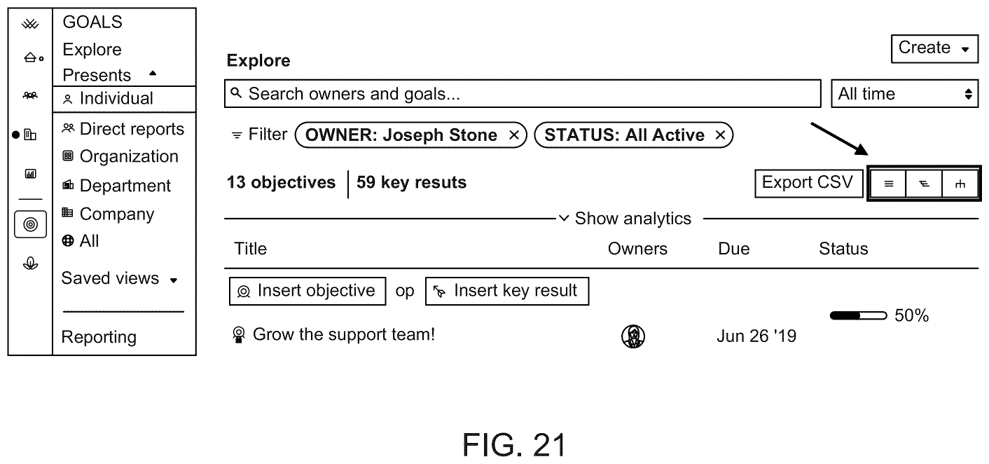

FIG. 21 is a schematic demonstrating how to navigate a user interface to display cascading goals in a list view, cascade view, or tree view.

The Cascading Goals page will include:
A list view.
A cascade view.
A tree view.

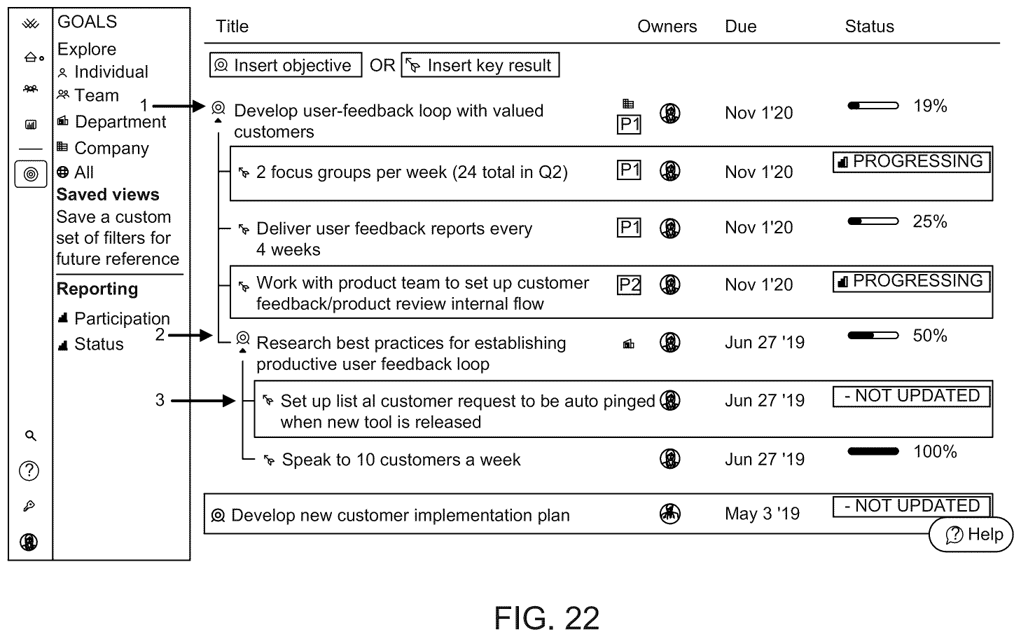

FIG. 22 is a schematic of a user interface displaying multiple cascading goals in cascade view.

Users will know they have Cascading Goals ON when users have the ability to view goals in Cascade view format; the view will look as depicted in FIG. 22. The Cascade view format allows users to visually see what goals are aligned to one another and can align to 2+ levels.

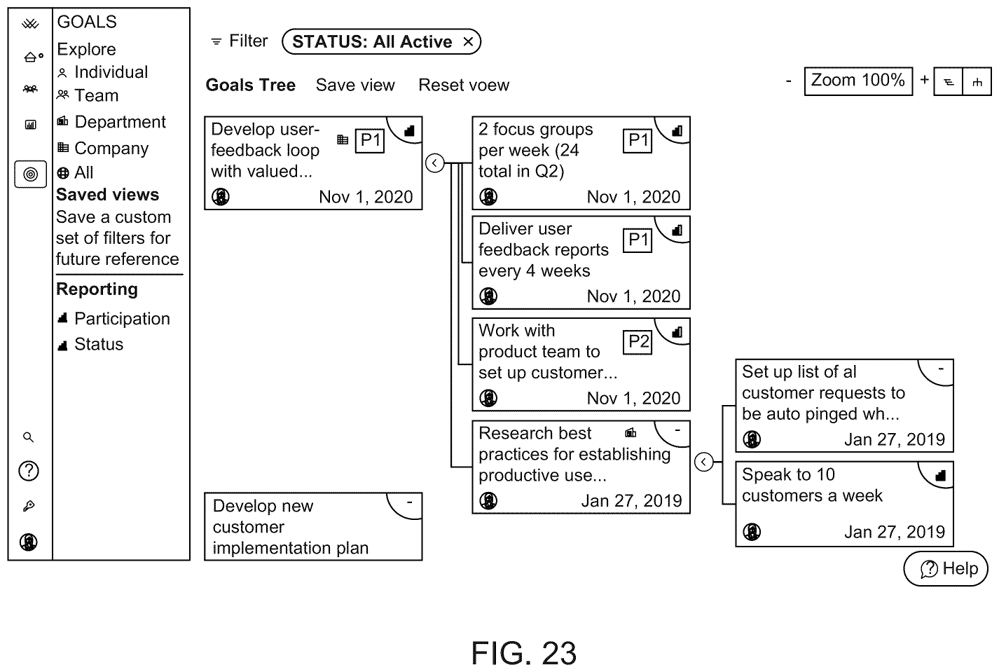

FIG. 23 is a schematic of a user interface displaying cascading goals in tree view.

Users also have the ability to align goals in a tree view format. The tree view format allows users to visually connect the goals together. Below is an example of aligned goals in a tree view format.

Create a Goal with (Cascading Goals

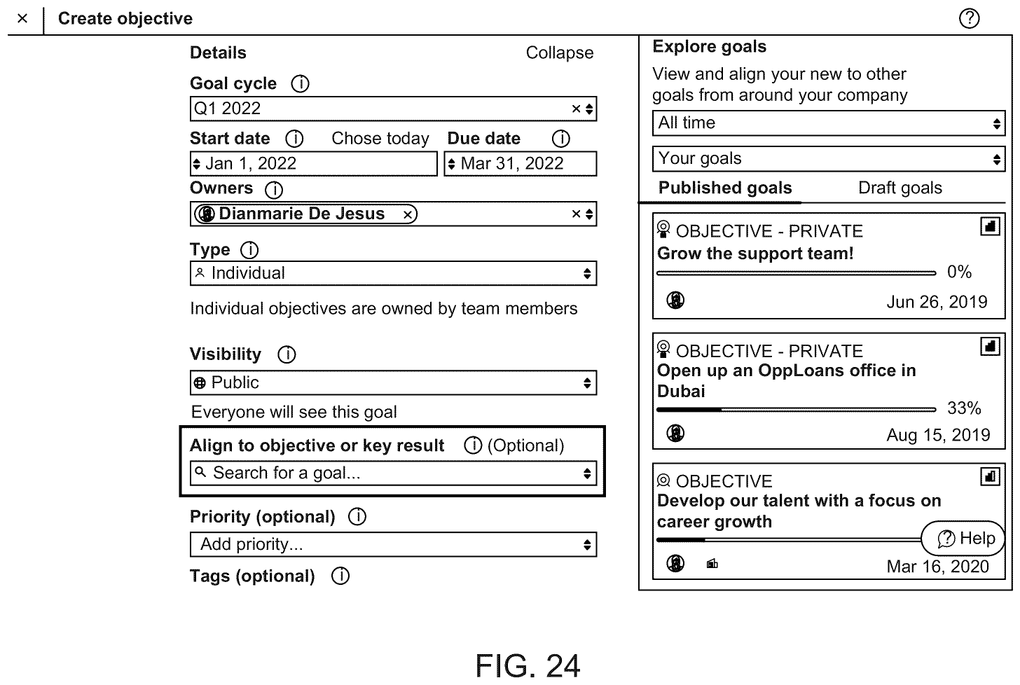

FIG. 24 is a schematic of a user interface displaying a Goal Creation page when goals are cascading.

When employees are creating their goals and goals are cascading, their Goal Creation page may look as depicted in FIG. 24. Users will notice the option Align to a parent goal appears under Details, allowing the goal the employee is creating to align under a parent goal. Users may also be able to add supporting objectives when creating a goal.

Reporting with Cascading Goals

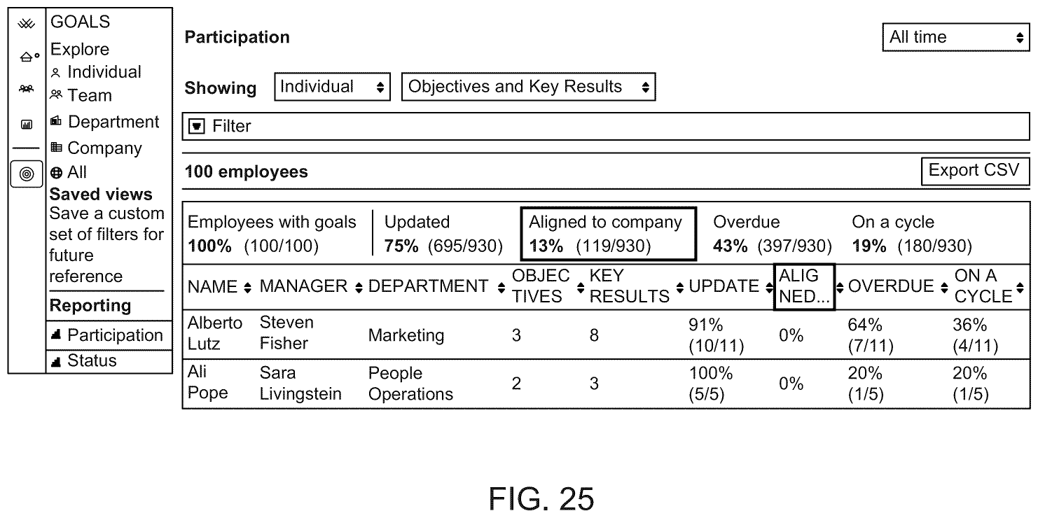

FIG. 25 is a schematic of a user interface displaying goal reporting with cascading goals turned on.

For reporting with Cascading Goals turned ON, users can view which goals are aligned to the company goals.

With Cascading Goals turned ON, all child objectives and key results are counted with the overall parent goals. Please also note the number of goals will reflect the same way in the report view.

Goals for Administrators

The system provides a goal settings setup walkthrough (e.g., for admins accessing the goals tool for the first time). The guide will walk through customization and launch settings to ensure the rollout is a success.

The goal settings setup may be required for all admins; however, it may only happen once. Even after launch, the settings may be editable within a goals settings page accessible by admins.

Your Org

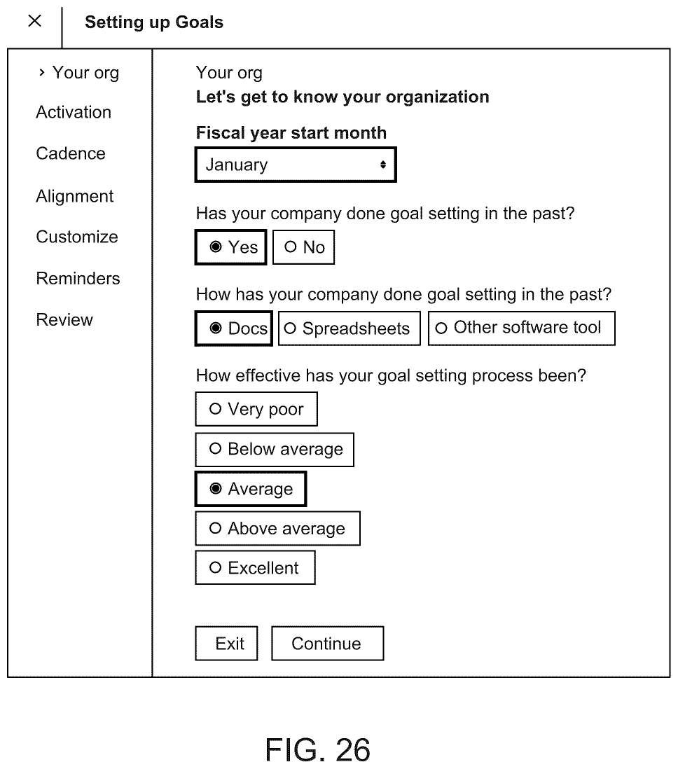

FIG. 26 is a schematic of a user interface displaying the Your Org page from the goal settings setup walkthrough.

The following are the initial steps for setting up goal settings:
1. Select the fiscal year start month to assist in creating the goal cycles.
2. Select whether the company has done goal setting in the past.
   If yes, select whether the goals were done using docs, spreadsheets, or another software tool, and how effective the process has been.
   If no, select how important goal setting will be as part of the people program when rolling out the system.

Activation Page

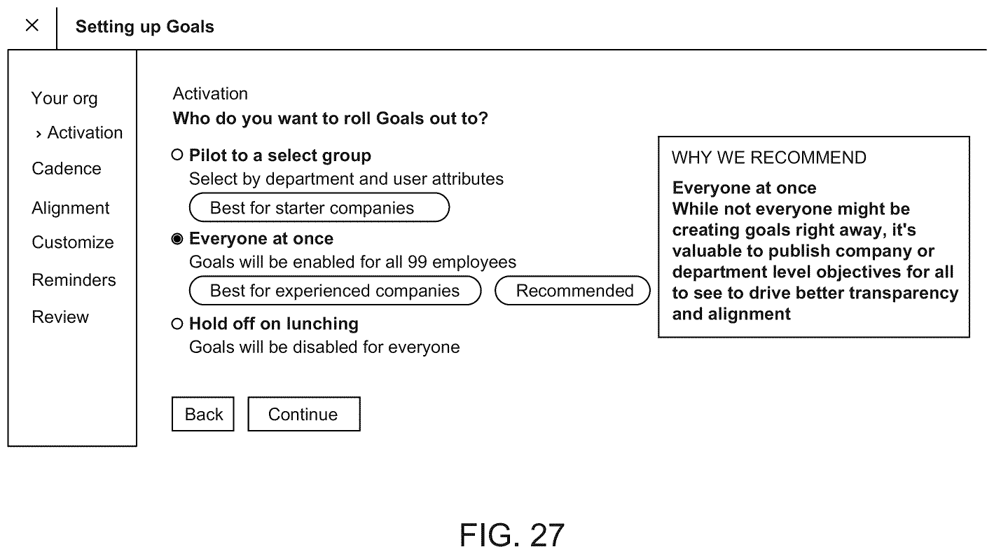

FIG. 27 is a schematic of a user interface displaying the Activation page from the goal settings setup walkthrough.

Choose who users want to roll goals out to.
Pilot to a select group: This is recommended if users have not rolled out goals before to their organization. Piloting allows users to gather feedback on the process and iterate before enabling to their full org. If chosen, the system may prompt users to select an attribute that contains the group they wish to enable goals for
Everyone at once: This is recommended if users have rolled out goals to the company before. Enabling for everyone at once allows users to publish company and department-level objectives to drive better transparency and alignment in the company. Note: employees are not required to create a goal once goals is enabled.
Hold off on launching: This is recommended if users do not have a launch plan in place for rolling out goals to their org and want more time to create a process before enabling it to the rest of their org. If chosen, users will still be required to finish the setup process. Note: users can adjust their choices after finishing the setup.

Cadence Page

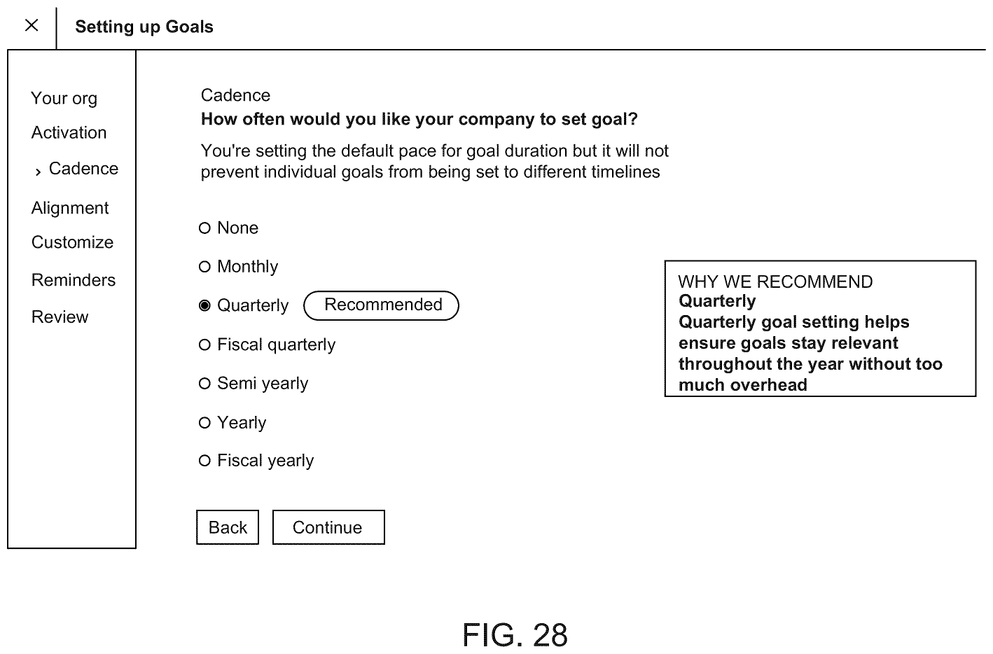

FIG. 28 is a schematic of a user interface displaying the Cadence page from the goal settings setup walkthrough.

Select how often users would like the company to set goals. Deciding on a pace for goal duration will assist the system in automatically creating goal cycles based on the cadence.

Alignment Page

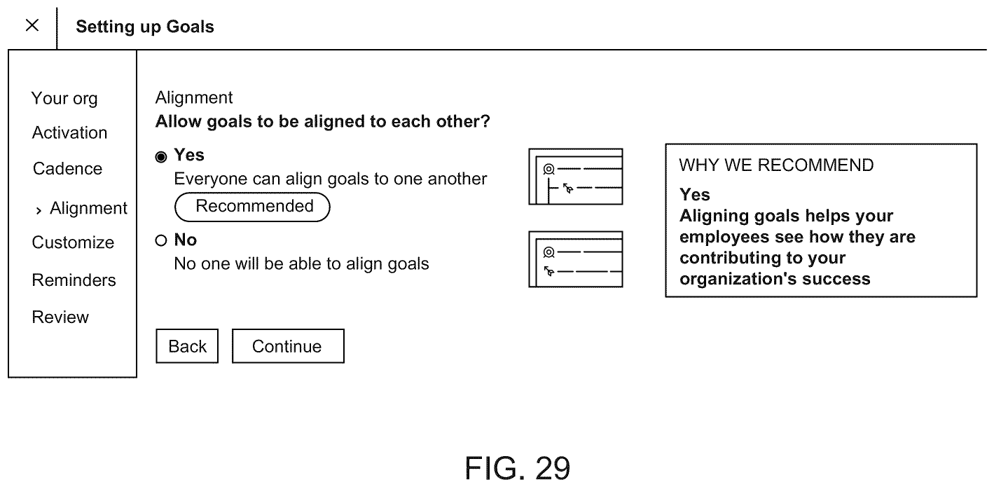

FIG. 29 is a schematic of a user interface displaying a selection of “Yes” on the Alignment page from the goal settings setup walkthrough.

Select whether users would like goals to be aligned to one another and accept the progress of their supporting goals:
If yes, cascading goals will be enabled for the account.
If no, cascading goals will be disabled for the account.

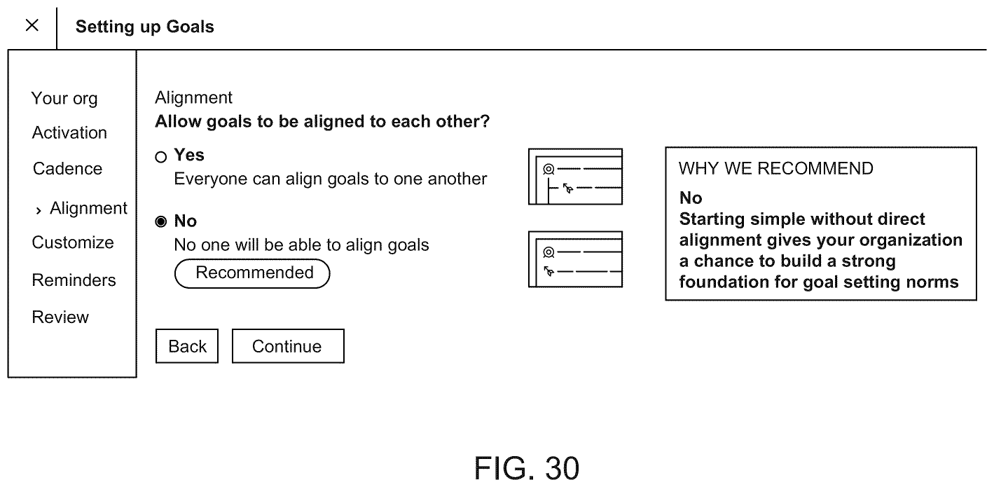

FIG. 30 is a schematic of a user interface displaying a selection of “No” on the Alignment page from the goal settings setup walkthrough.

Note: If users have given these responses to the following questions, the system will recommend keeping goal-setting simple by not aligning goals:
No to the question Has your company done goal settings in the past?
Very poor/Below average to the question How effective has your goal process been?

Customize Page

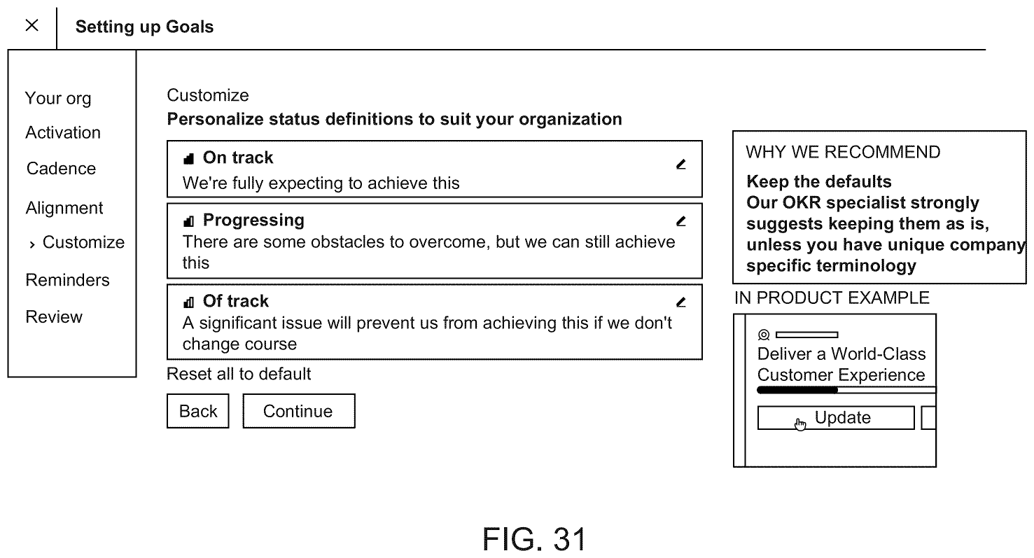

FIG. 31 is a schematic of a user interface displaying the Customize page from the goal settings setup walkthrough.

If a user's company has unique terminology to label a goal's status, the system allows users to customize each status title and description.

Reminders Page

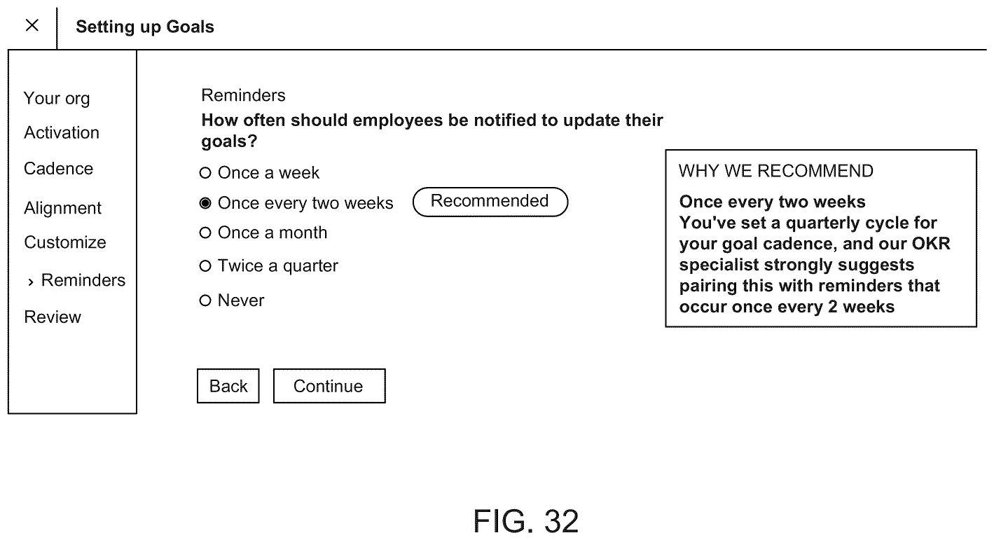

FIG. 32 is a schematic of a user interface displaying the Reminders page from the goal settings setup walkthrough.

Choose how often employees should be notified to update their goals. The system will send reminder emails to employees based on the chosen cadence. If employees have updated their goals during the cadence, they will not receive a reminder.

Review Page

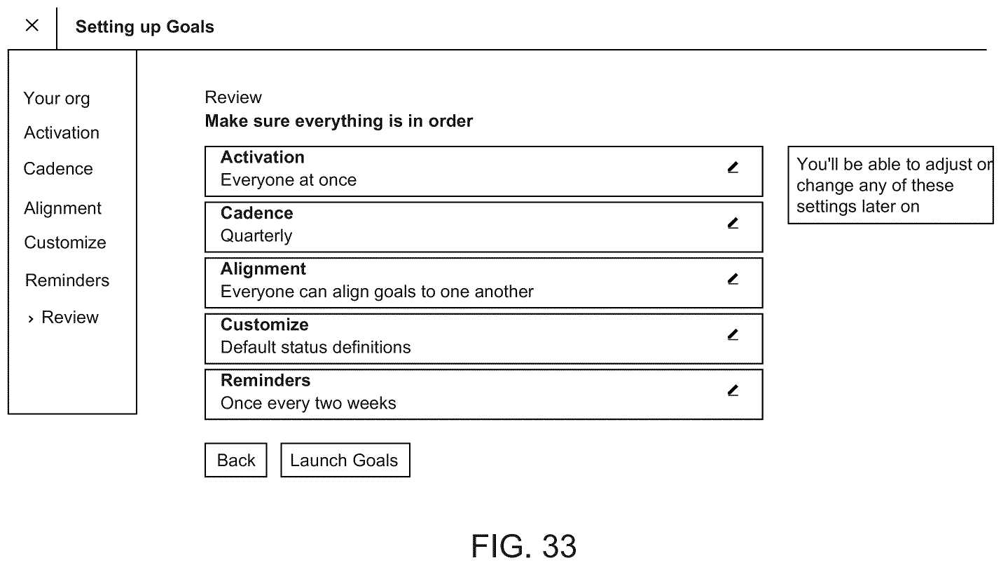

FIG. 33 is a schematic of a user interface displaying the Review page from the goal settings setup walkthrough.

Verify or edit the settings before launching. Note users will be able to adjust the settings after launching goals.

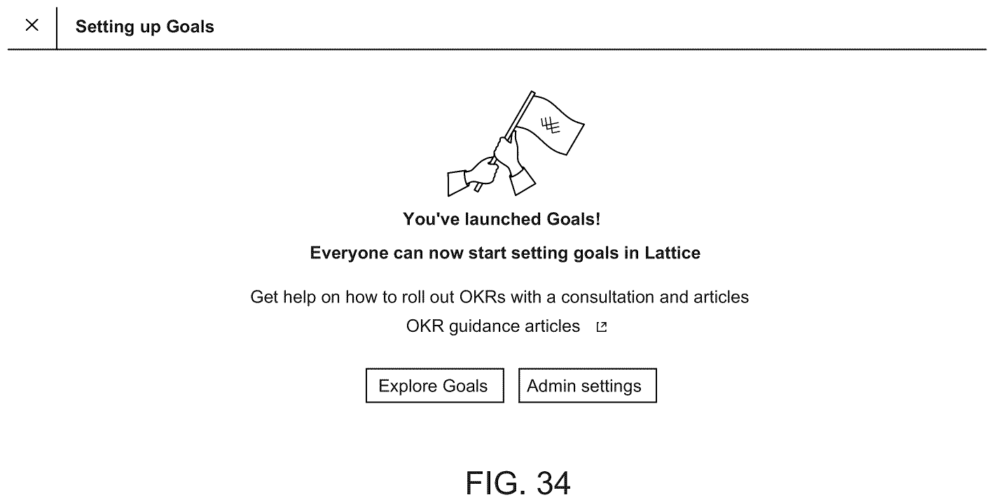

FIG. 34 is a schematic of a user interface displaying the final page from the goal settings setup walkthrough with the option to either explore goals or adjust the Admin settings.

Cascading goals allow employees to align personal achievement with the entire business's success and see how their work impacts the company.

Enabling Cascading Goals Unlocks:
Aligned goals.
Rich key results with assigned owners and attributes.
Goal tree.

Enabling cascading may permanently alter the goals data. Disabling will keep alignment for previous goals and prevent alignment for future goals.

Enable Cascading Goals

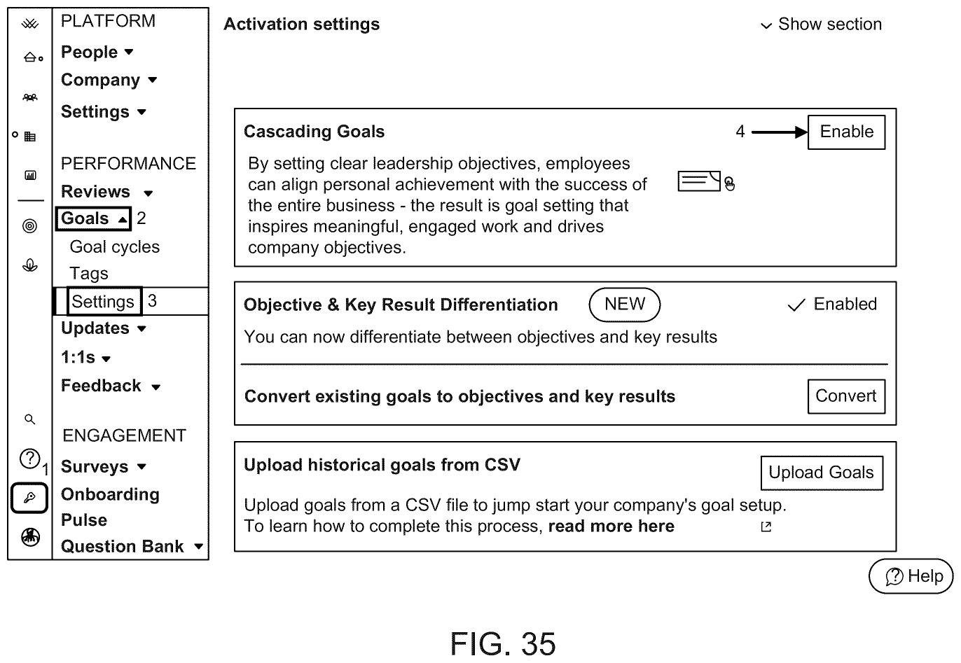

FIG. 35 is a schematic demonstrating how to navigate a user interface to enable cascading goals.

The following are steps to enable cascading goals:
1. Navigate to Admin>Goals>Settings.
2. Under Cascading Goals, select Enable.
3. Confirm by selecting Yes, enable.

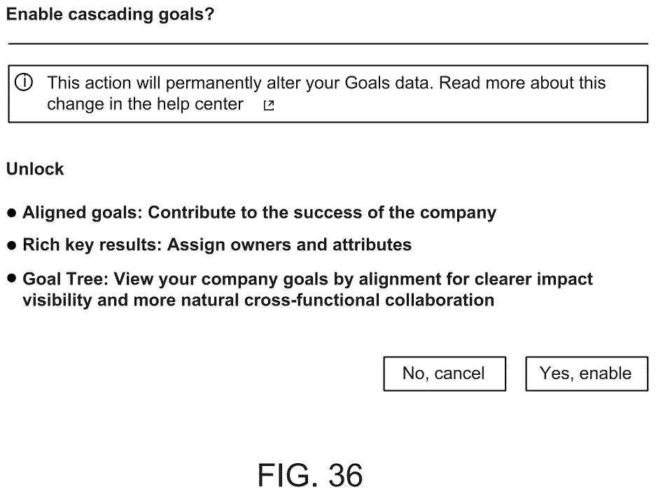

FIG. 36 is a schematic of a user interface displaying a confirmation page for enabling cascading goals.

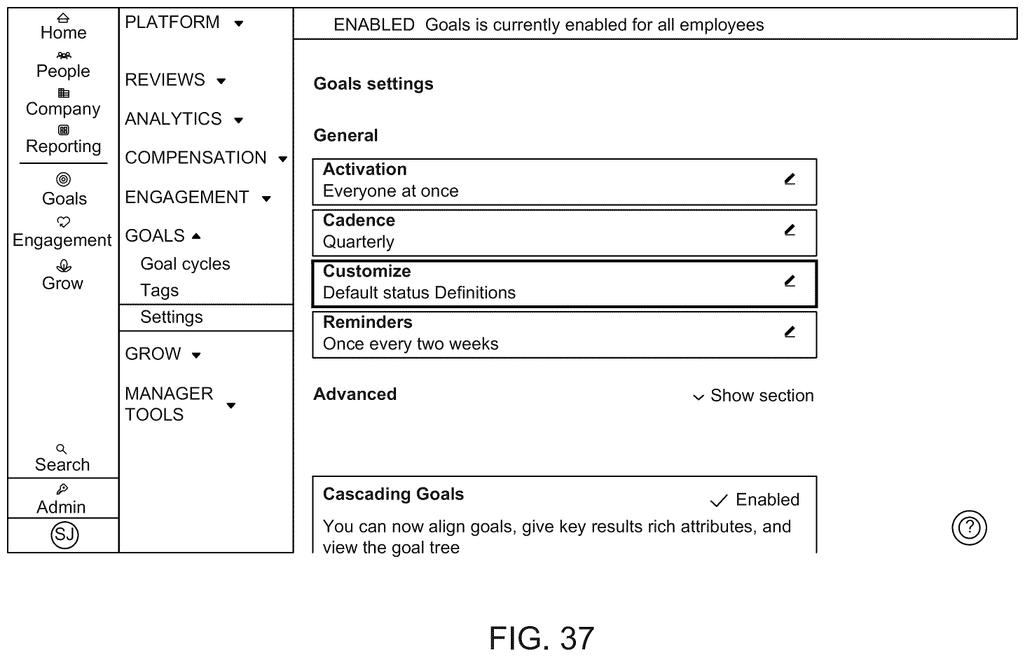

FIG. 37 is a schematic demonstrating how to navigate a user interface to change goals status definitions.

The system provides defined goal status names, such as On track, Progressing, and Off track by default. However, an organization may use different names and definitions; therefore, the system allows administrators to customize how employees will see the statuses.

Change Goals Status Definitions

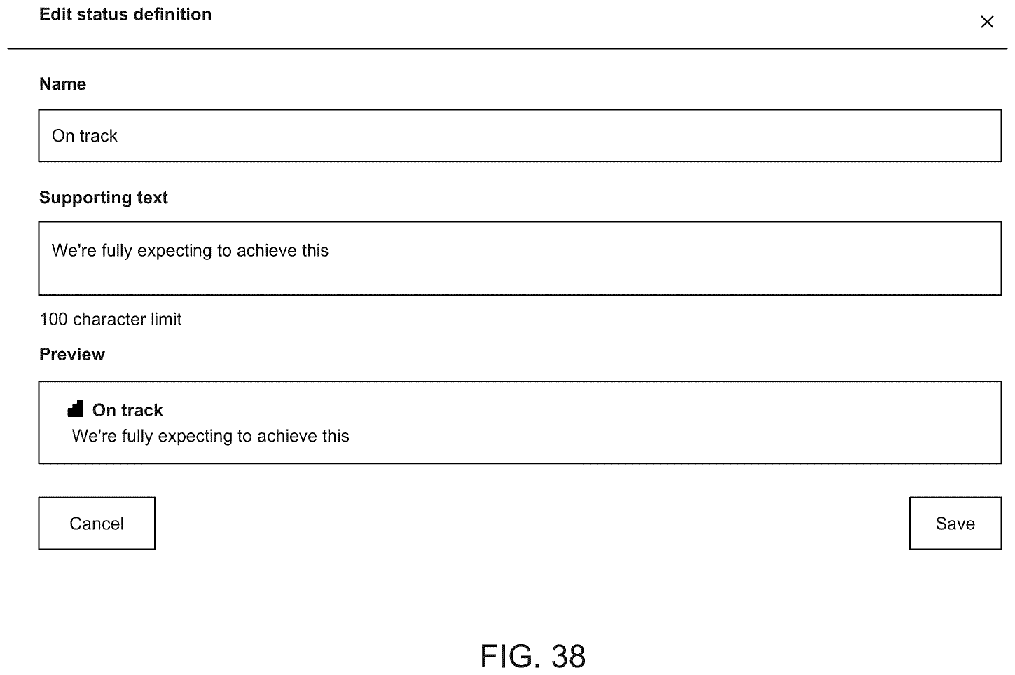

FIG. 38 is a schematic of a user interface displaying an edit modal for changing a goals status definition.

The following are steps to change goals status definitions:
1. Navigate to Admin>Goals>Settings.
2. Under General, select Customize.
3. Select the pencil icon to open the edit modal next to the desired status.
4. Update the Name and Supporting text and confirm the view is correct using the Preview.
5. Select Save.
6. Click Apply.

The system may integrate with external systems, such as Jira, Salesforce, Slack, and Microsoft Teams, to ensure goals stay front and center and are updated continuously.

For example, the system's Salesforce integration allows users to connect their goals and have them automatically update progress when Salesforce is updated.

To connect with Salesforce, users must be an admin in the system and Salesforce. Giving a Salesforce admin IT permissions in the system will allow them to connect the Salesforce integration without giving them visibility to employee data.

Connect Salesforce

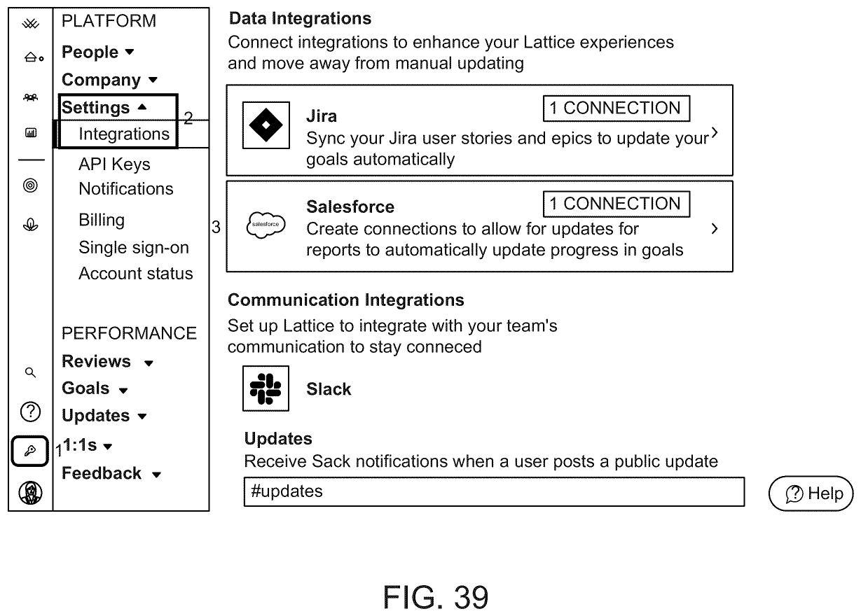

FIG. 39 is a schematic demonstrating how to navigate a user interface to integrate with Salesforce.

The following are steps to integrate with Salesforce:
1. Navigate to Admin>Settings>Integrations.
2. Under Data Integrations, select Salesforce.
3. Click Create connection.
4. Sign in to the Salesforce account.
5. Enter a connection name.
6. (optional): If users wish to limit the usage of the Salesforce connection, expand the Limit connection Access section and select the Departments or Users that should have access.
7. Create.

Next, connect a goal to Salesforce. Users may want to make specific goal fields optional, required, or hidden, so we have given all admins the ability to customize the optionality from their Goal Settings page.

In example embodiments, if users edit a goal that was created before a certain field was required, when users edit the goal they will be prompted to fill out the required field.

Adjusting Goal Fields

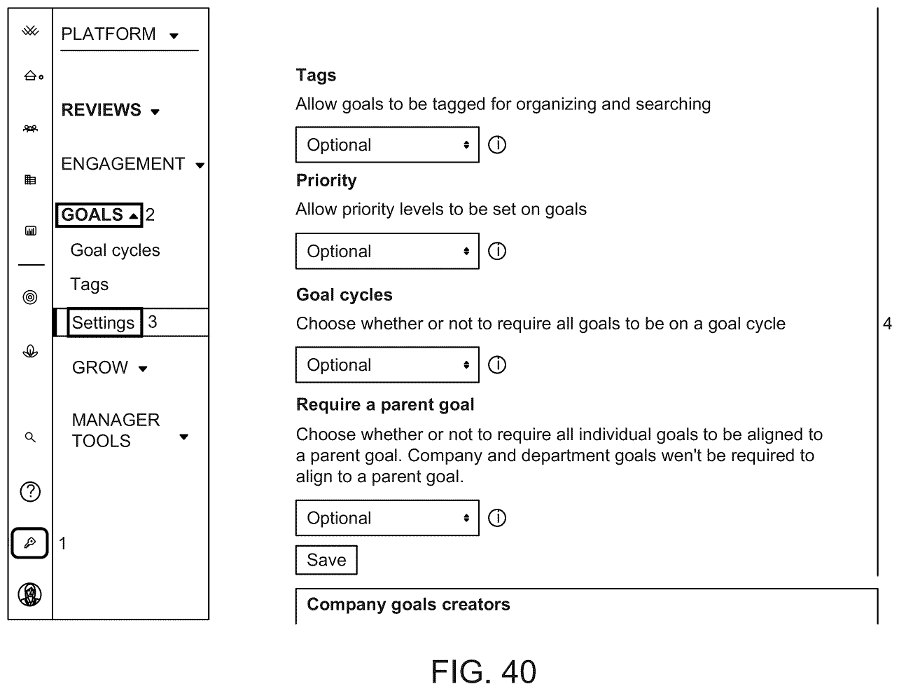

FIG. 40 is a schematic demonstrating how to navigate a user interface to adjust goal fields.

The following are steps to adjust goal fields:
1. Navigate to Admin>Goals>Settings.
2. Under Advanced, users can set the following:
   Tags: Required, Optional, Hidden
   Priority: Optional, Hidden
   Goal cycles: Required, Optional
3. Require a parent goal (if applicable): Required, Optional
4. Save changes at the top of the screen.

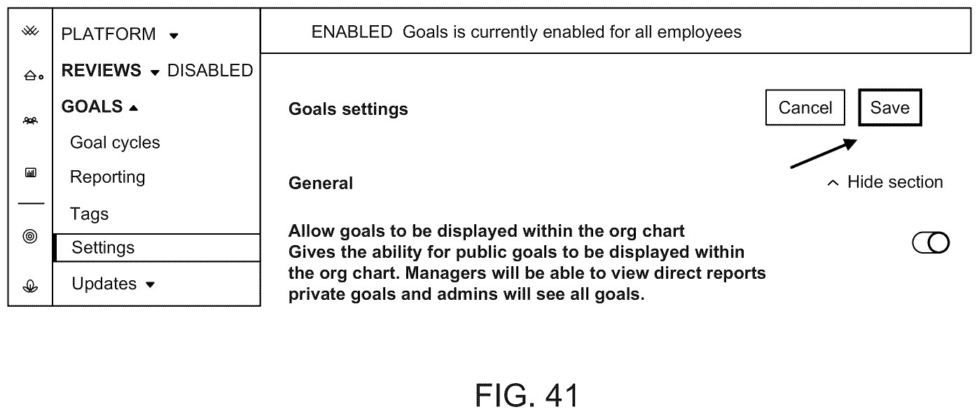

FIG. 41 is a schematic demonstrating how to navigate a user interface to save changes made to goal fields.

Required Fields

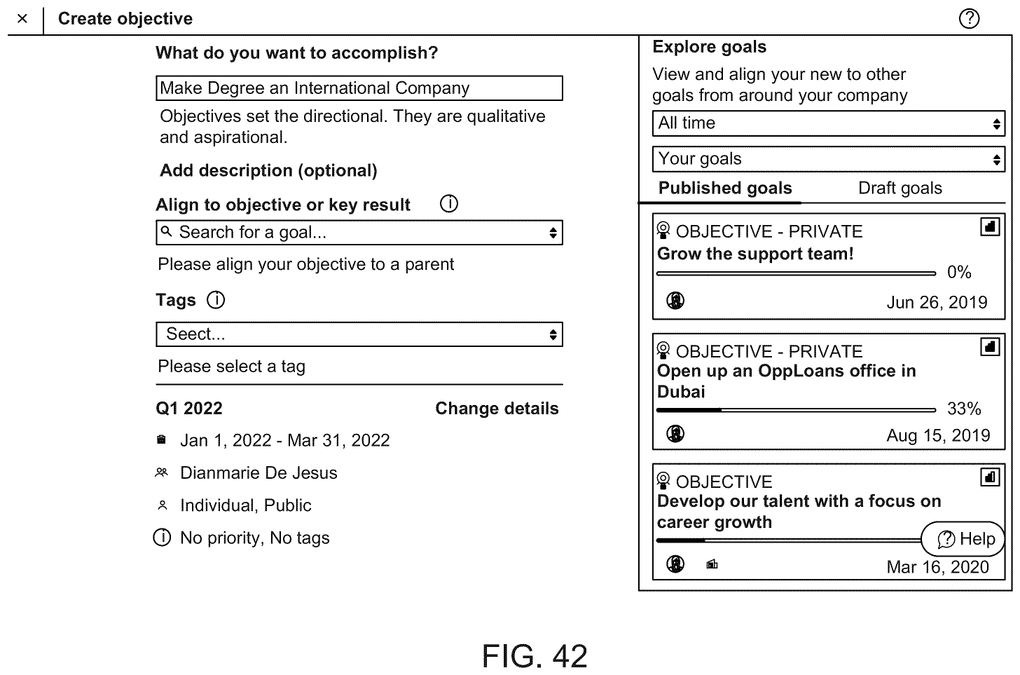

FIG. 42 is a schematic of a user interface displaying alerts indicating that required fields have not been selected.

If a field has been set to be required, it will appear within the goal creation main page. Employees will receive an alert preventing them from creating the goal until the fields are selected.

Weighted goals allow goal owners to customize and communicate the relative importance of each key result. Owners can customize how much each child impacts its parent's progress across multiple levels.

Enabling Weighted Goals for an Organization

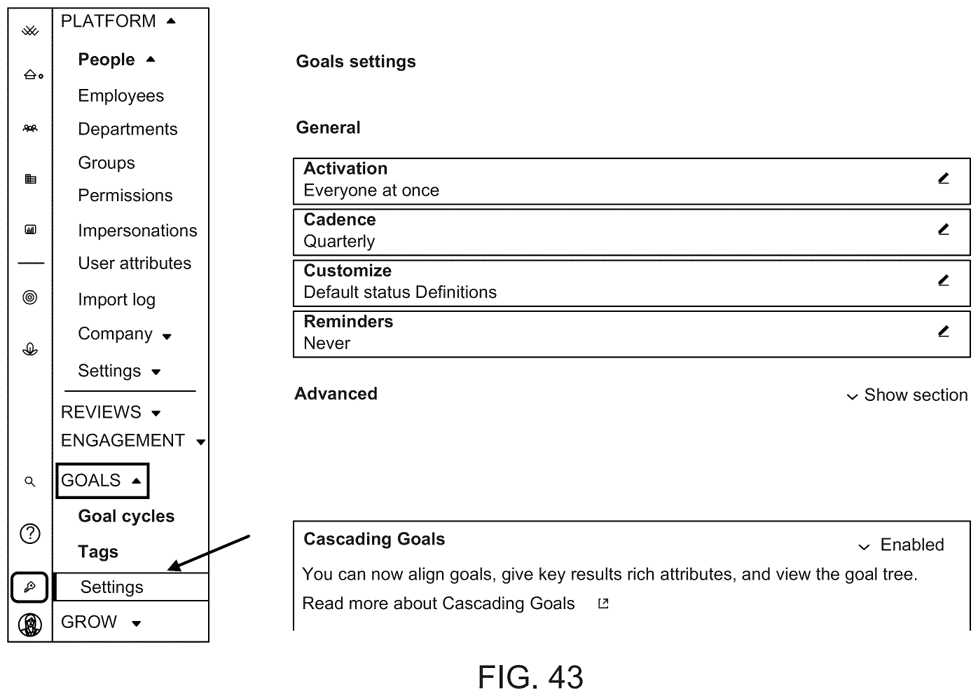

FIG. 43 is a schematic demonstrating how to navigate a user interface to enable weighted goals for the whole organization.

Before goal owners can begin using weighted goals, an admin must turn on the feature for the whole organization by taking the following steps:
1. Navigate to Admin>Goals>Settings.
2. Under Advanced, toggle on the Allow key results to have custom weighting option.

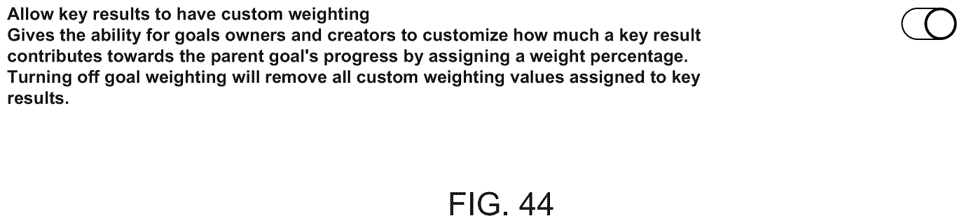

FIG. 44 is a schematic of a user interface displaying a toggle button for allowing key results to have custom weighting.

In example embodiments, if users decide to turn off goal weighting at any point in the future, it will remove all custom weighting assigned and revert to the default calculation.

Users may refer to goals as something else at their company, such as SMART Goals or OKRs. If users would like to change the display name of objectives and key results or the goals tool in various places throughout the system, follow the steps below

Renaming the Display Name

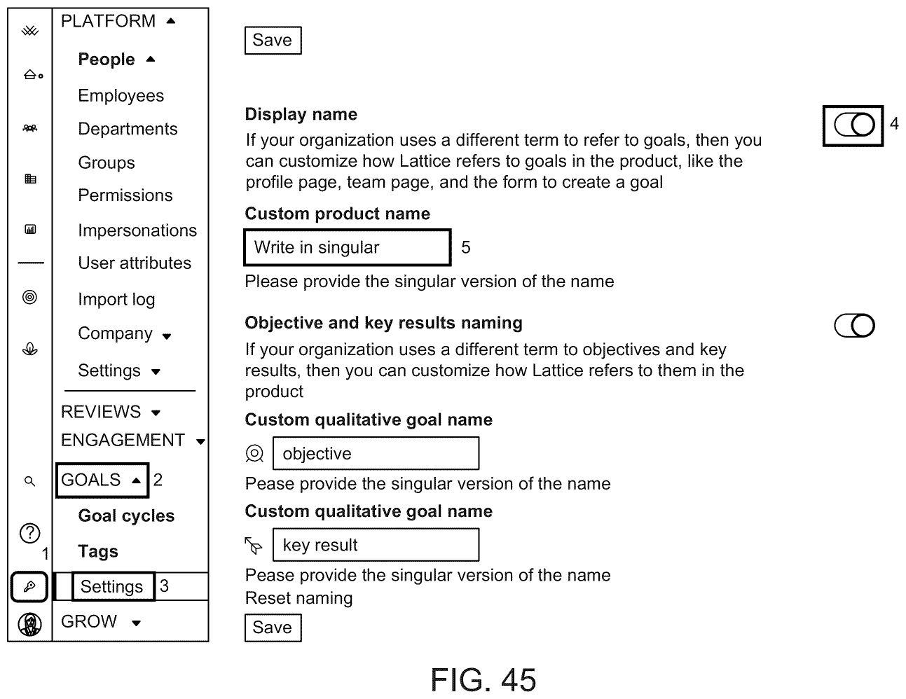

FIG. 45 is a schematic demonstrating how to navigate a user interface to rename the goals display name.

The system defaults the naming for the tool to be “Goals.” However, the organization may use a different term to refer to goals, and users have the option to customize this language using the steps below:
1. Navigate to Admin>Goals>Settings.
2. Under Advanced, toggle on Display name.
3. Type in the singular version of the new goal name.
4. Click Save.

The display name of the goals will be changed everywhere Goals was shown previously.

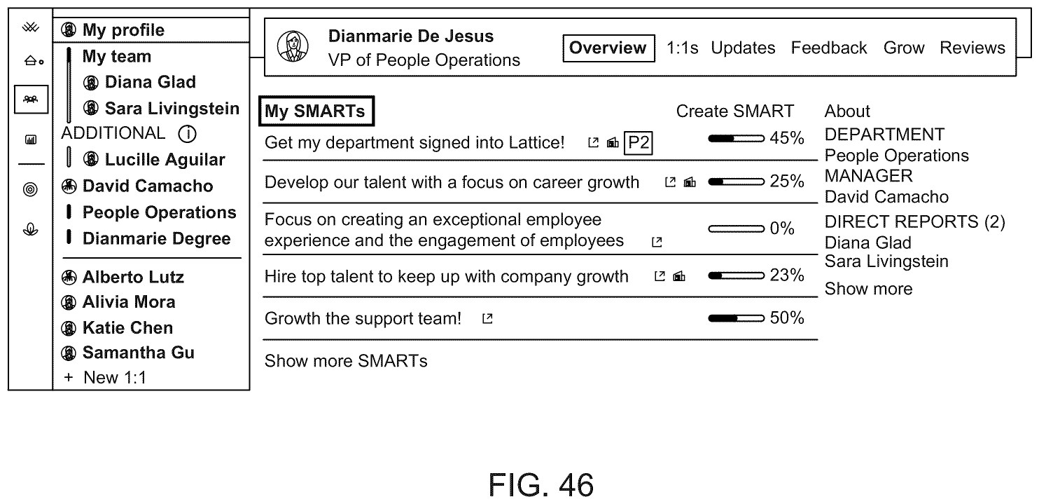

FIG. 46 is a schematic of a user interface displaying a profile page containing the new goals display name.

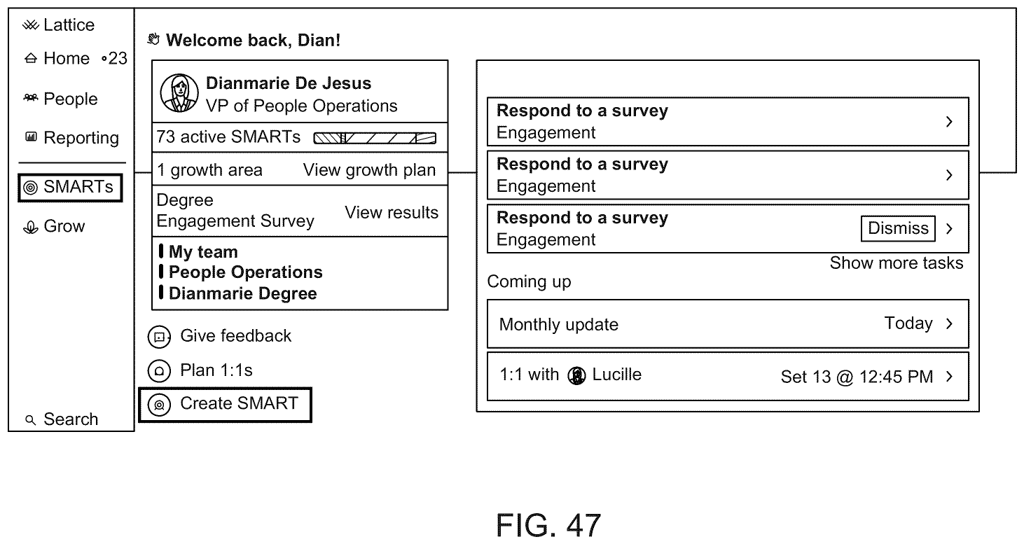

FIG. 47 is a schematic of a user interface displaying a home page containing the new goals display name.

Renaming Objective and Key Results

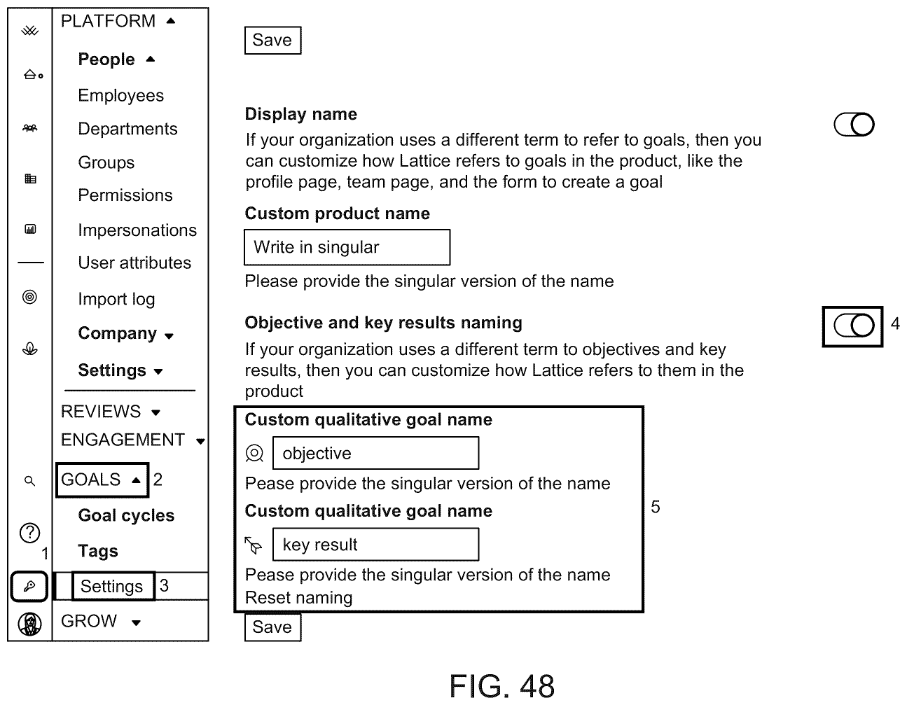

FIG. 48 is a schematic demonstrating how to navigate a user interface to rename objectives and key results.

The system defaults the naming for goals to be based on objectives and key results. However, the organization may use a different term to refer to these, and users have the option to customize this language using the steps below:
1. Navigate to Admin>Goals>Settings.
2. Under Advanced, toggle on Objective and key results naming.
3. Type in the singular version of the new objective and key result name.
   Objectives: goals that are qualitative that can have parent or child goals (either other objectives or key results).
   Key Results: goals that are quantitative (#, $, %, and binary) that can have parent or child goals (either other key results or objectives).
4. Click Save.

The names “objective” and “key result” will be changed everywhere they were shown previously.

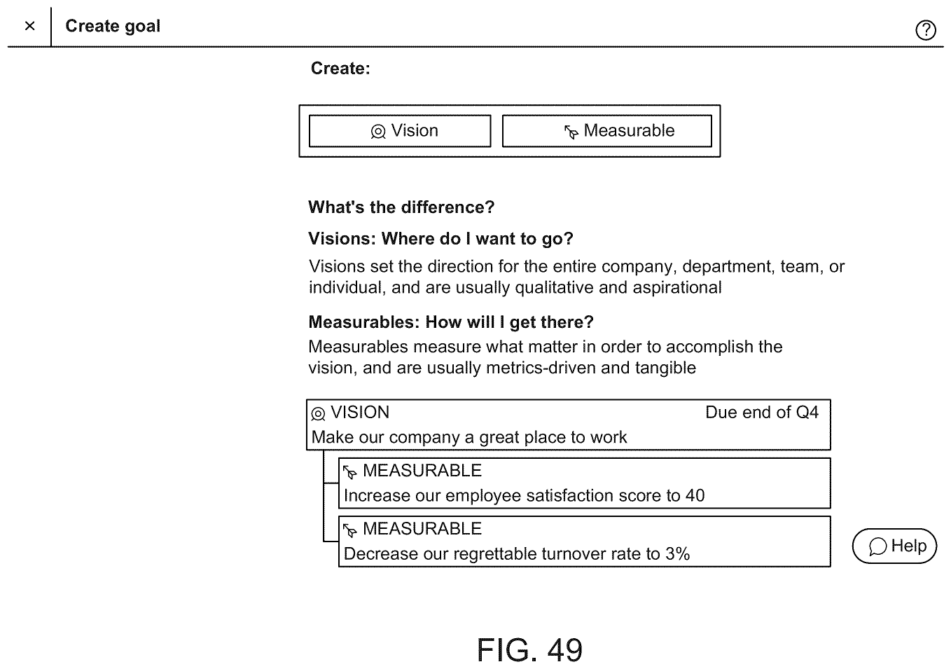

FIG. 49 is a schematic of a user interface displaying a goal creation page containing the new names of the objectives and key results.

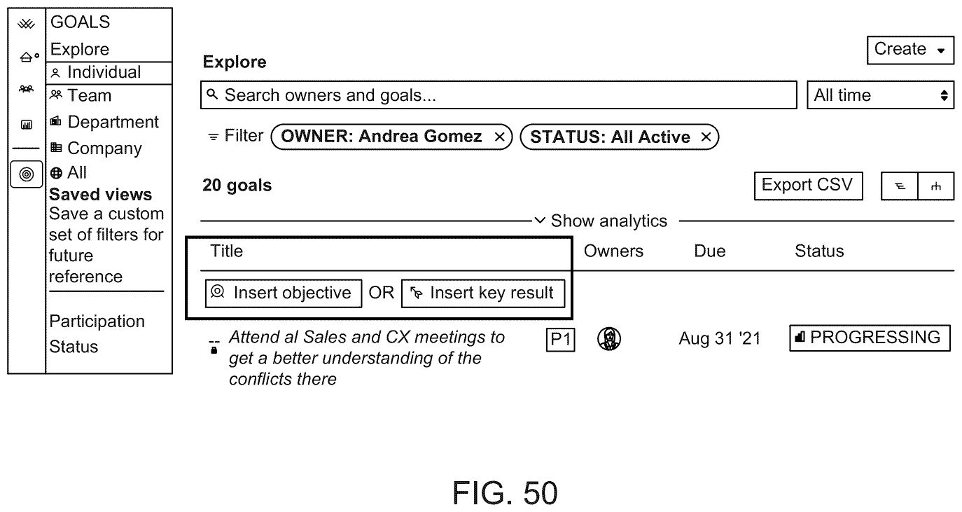

FIG. 50 is a schematic of a user interface displaying a goal explorer page containing the new names of the objectives and key results.

Adjust Default Goal Visibility

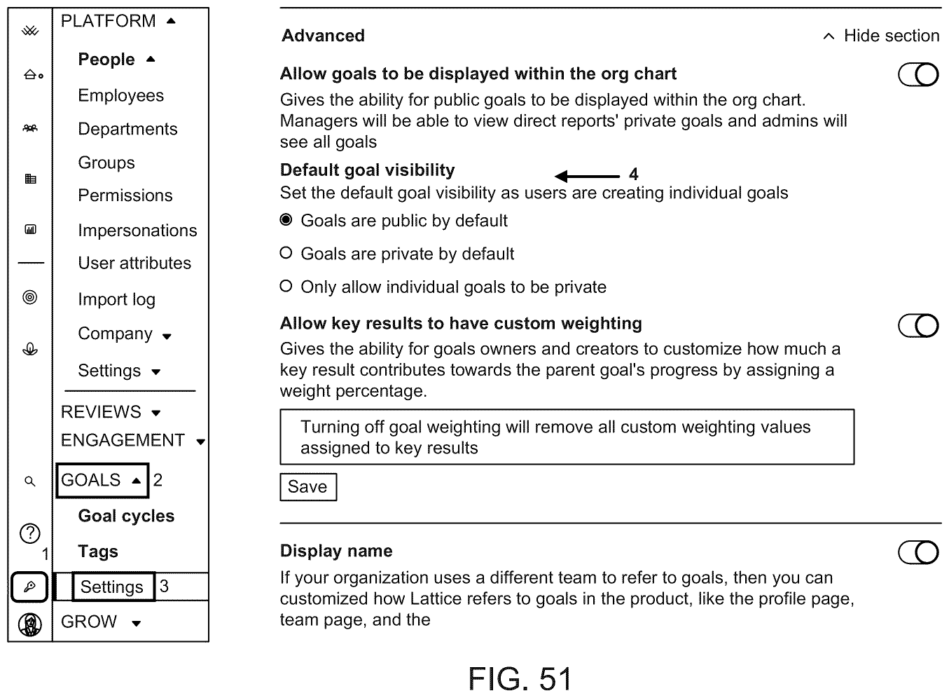

FIG. 51 is a schematic demonstrating how to navigate a user interface to adjust the default goal visibility.

The following are steps to adjust default goal visibility:
1. Navigate to Admin>Goals>Settings.
2. Navigate to Advanced>Default goal visibility.
3. Set to Goals are private by default or Only allow individual goals to be private.
4. At the top of the page, click Save.

Goal Creation

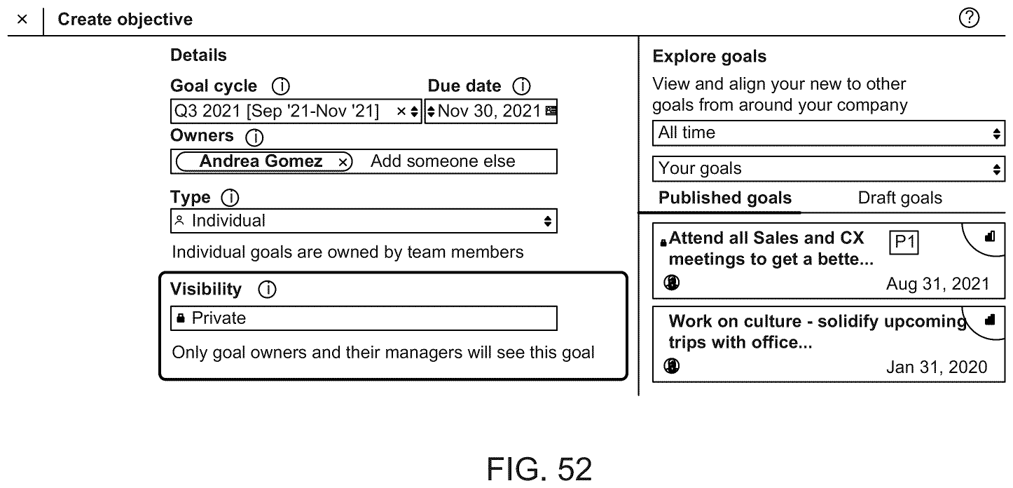

FIG. 52 is a schematic of a user interface displaying a create objective page with the visibility field set to private.

Once users have updated the default goal visibility, all new individual goals will either have the visibility setting default to private, or the visibility field will be set to private and become uneditable.

The system allows users to show the public goals each owner owns within the org chart.

Goals in the org chart will respect the company's and employees' current goal visibility settings. This means:
Admins will be able to view private goals.
Managers will be able to view direct reports private goals (top-down visibility is enabled as well, meaning managers of managers will be able to see their indirect reports' goals).
Employees will be able to view private goals that they share with other employees.
Employees will be able to view all public goals.

Allow Public Goals in the Org Chart

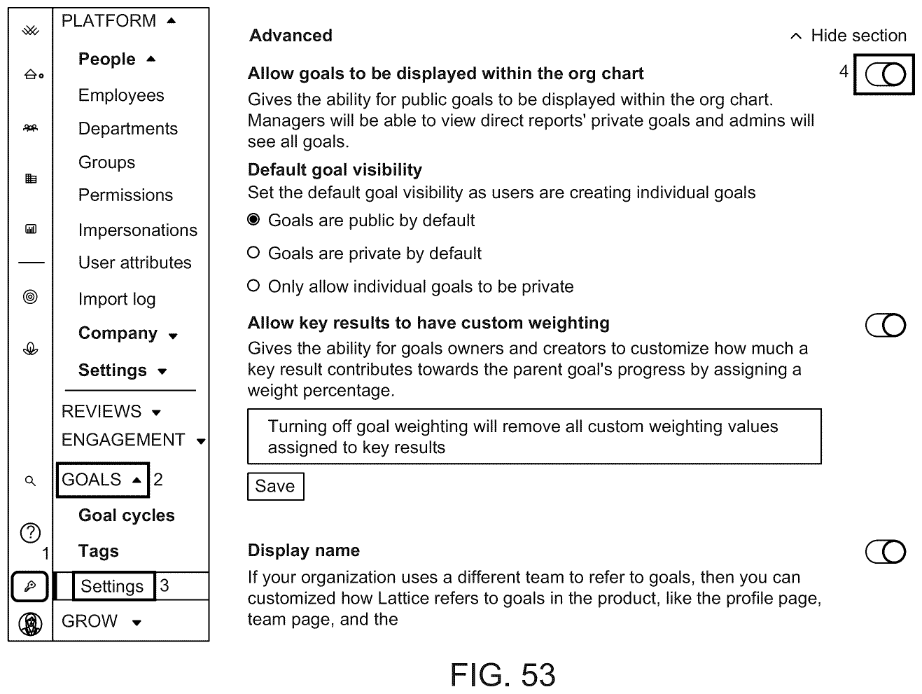

FIG. 53 is a schematic demonstrating how to navigate a user interface to allow public goals in the org chart.

The following are steps to allow public goals in the org chart:
1. Navigate to Admin>Goals>Settings.
2. Under Advanced, toggle on Allow Goals to be displayed within the Org Chart.
3. Click Save.

View from the Org Chart

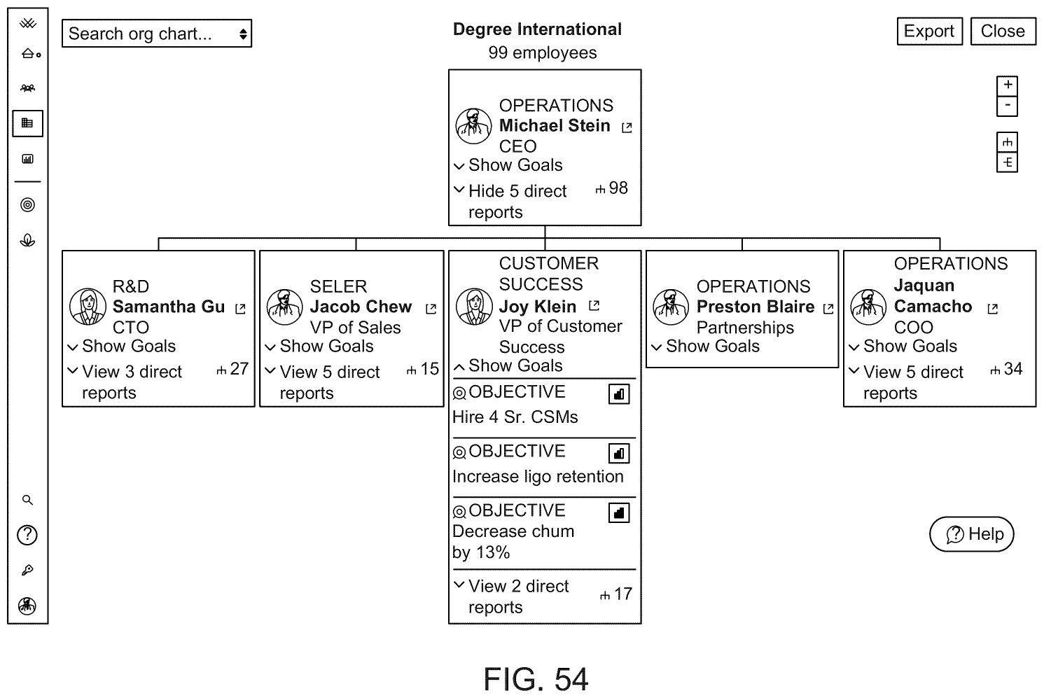

FIG. 54 is a schematic of a user interface displaying the org chart with goals shown in one employee card.

When viewing the org chart, users can click Show Goals within any employee card to view the goals they have visibility into.

When this is selected, employees' top three active goals by priority will be displayed in the org chart. If an employee's goals do not have a priority, the first three active goals that the employee created will be shown.

Why Use Tags?

Goal tags can be used to organize goals around significant initiatives. For example, suppose a company is expanding into Europe (which can be very cross-functional). In that case, admins can create a tag titled ‘European-expansion.’ Then, when an employee creates a goal, they can add this tag to their goal, and everyone will see that their goal is aligned with a larger department or company objective.

In example embodiments, only admins can create tags; managers and individuals cannot create tags.

Creating Tags

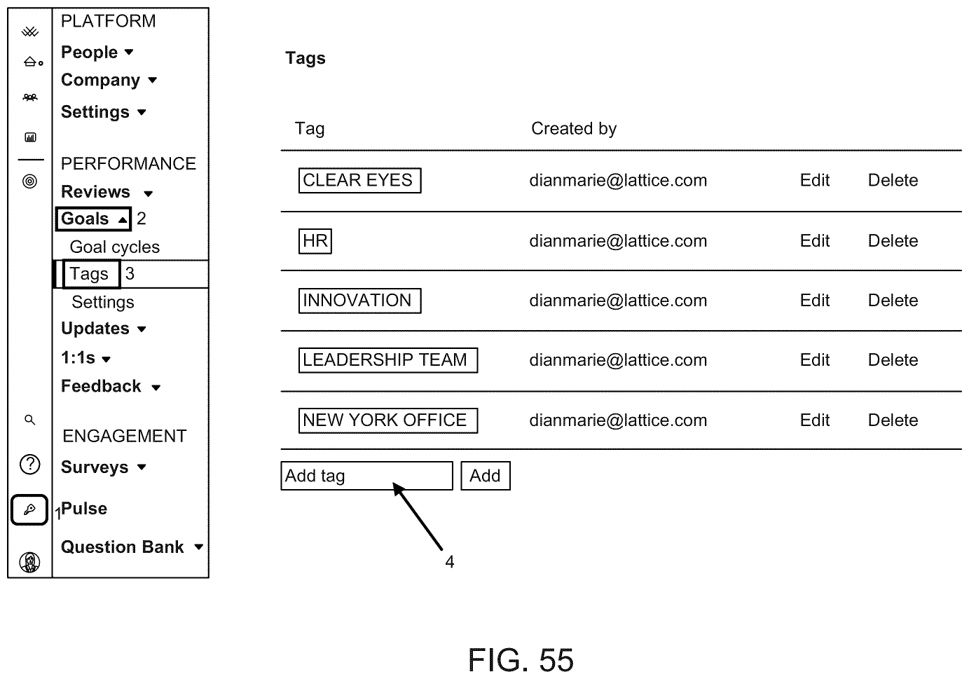

FIG. 55 is a schematic demonstrating how to navigate a user interface to create a new tag.

An admin can create a new tag by following the steps below:
1. Navigate to Admin>Goals>Tags.
2. Enter the new tag name in the Add tag bar and click Add

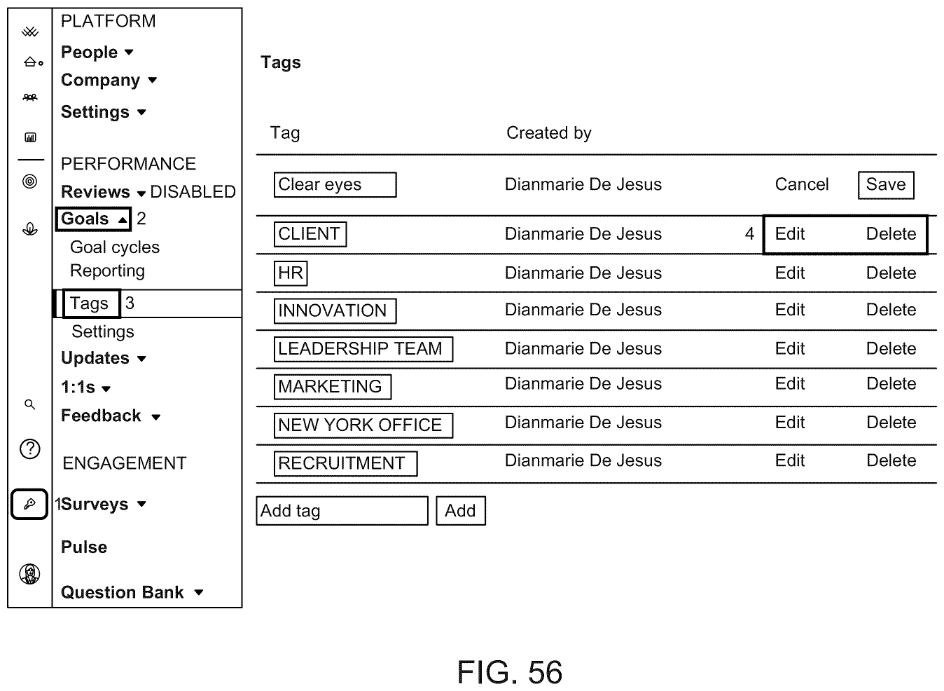

FIG. 56 is a schematic demonstrating how to navigate a user interface to manage tags.

After creating and using goal tags, users may want to make adjustments to meet their organization's needs.

Only admins can create and manage tags; managers and individuals cannot create or manage tags.

Edit Goal Tags

Editing a goal tag will rename the tag in all existing and draft goals.

The following are steps to edit goal tags:
1. Navigate to Admin>Goals>Tags.
2. Click Edit next to the tag to rename.
3. Click Save.

Delete Goal Mags

Deleting a goal tag is permanent. The tag will be removed from all existing and draft goals.

The following are steps to delete a goal tag:
1. Navigate to Admin>Goals>Tags
2. Click Delete next to the tag to rename
3. A confirmation popup will appear—click Confirm.

Goals for Managers

In example embodiments, all system users can create goals for their colleagues. Whether a manager is creating a goal for their direct report or a project lead is creating a goal for their team, all employees can create a goal for anyone else in the company.

Create a Goal for a Direct Report

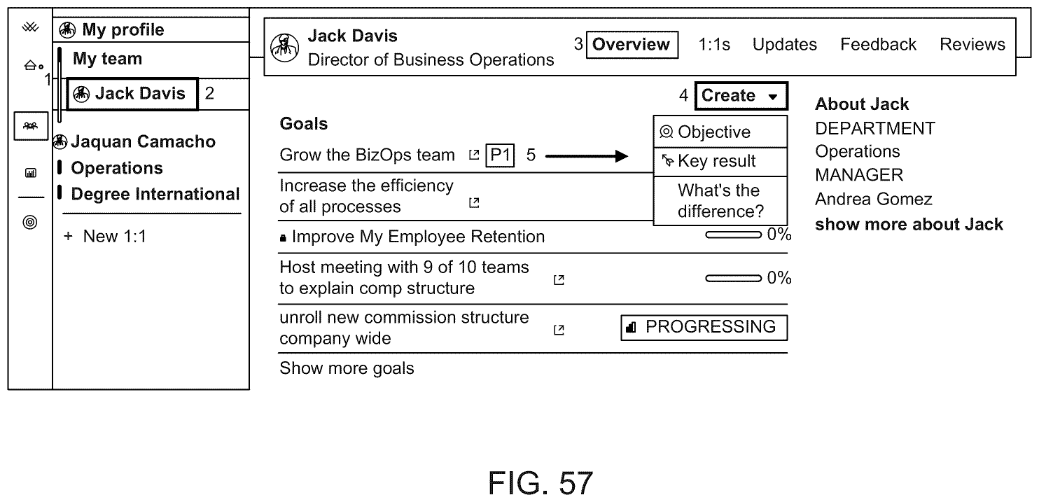

FIG. 57 is a schematic demonstrating how to navigate a user interface to create a goal for a direct report.

The following are steps to create a goal for a direct report:
1. Navigate to the People page>Direct Report>Overview.
2. Select Create and choose to create an Objective or Key result.
3. The Goal Creation page will open—select Change details.
4. Enter the desired fields.
5. The owner will default to the direct report no matter if users choose to create an objective or key result. Users have the option to add additional owners.
6. Select Publish or Save as Draft.

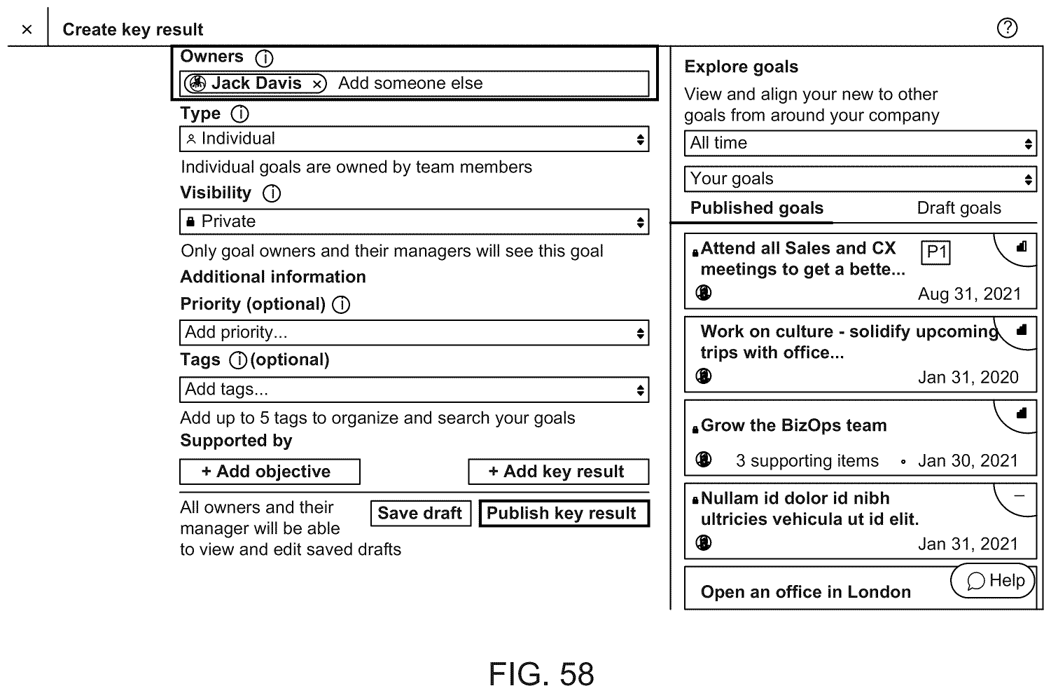

FIG. 58 is a schematic of a user interface displaying a goal creation page containing a draft goal and the option to publish or save as draft.

In example embodiments, all goal owners and their managers can view and edit any saved drafts.

Create a Goal for a Peer

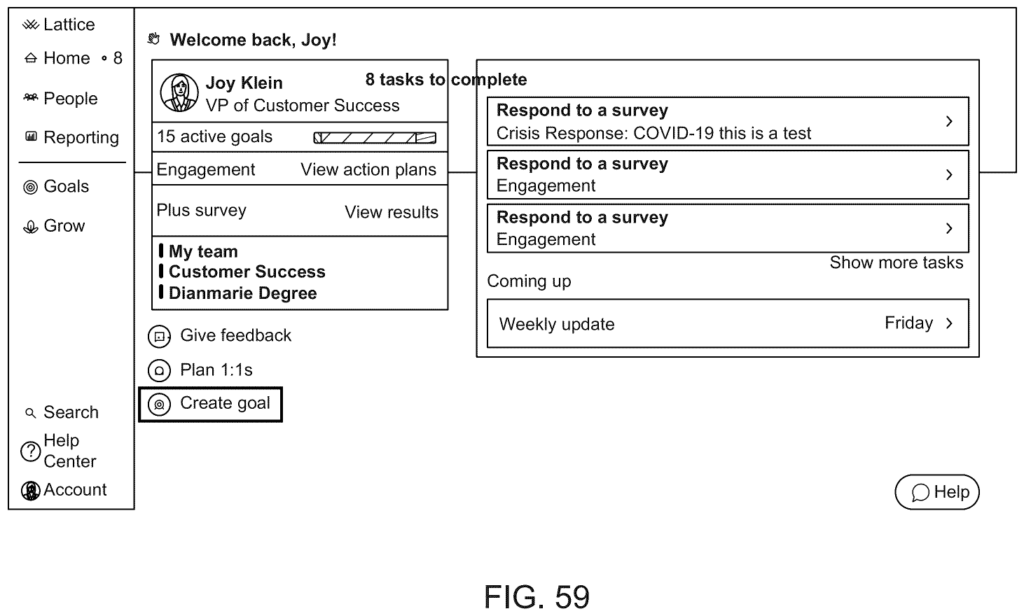

FIG. 59 is a schematic demonstrating how to navigate a user interface to create a goal for a peer from the home page.

The following are steps to create a goal for a peer:
1. Navigate to the Home page>Create goal.
2. Choose to create an Objective or Key result
3. The Goal Creation page will open—enter the desired fields.
4. Whether users choose to create an objective or key result, the Owner will default to the goal creator. Remove the goal creator, if needed, and add the employee as the new owner.
5. Continue creating the goal and then Publish or Save as Draft.

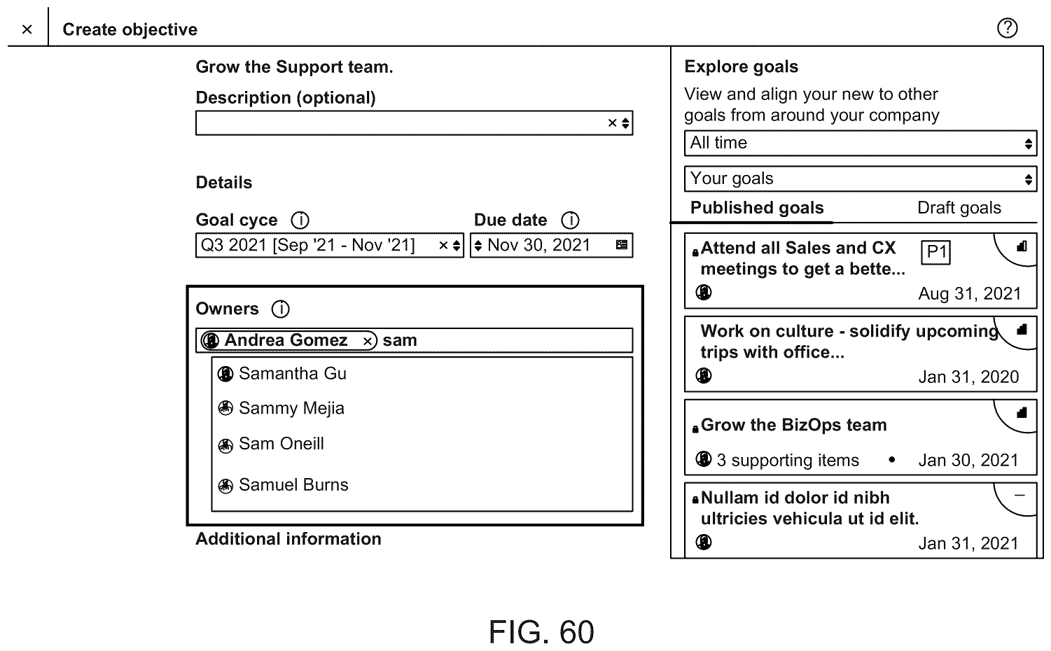

FIG. 60 is a schematic of a user interface displaying a goal creation page containing a drop-down menu for selecting owners for a goal.

Please note: All goal owners and their managers can view and edit any saved drafts.

There are many different ways to view how employees or a team are using goals. Below is a breakdown of the various reports and filters users can use in the system to help get the most out of the tool.

Admins and managers will have access to the reporting pages for goals. Admins will be able to view and filter for private and public goals for the entire company, while managers will be able to view and filter for private and public goals for their direct and indirect reports.

Accessing Goal Reporting

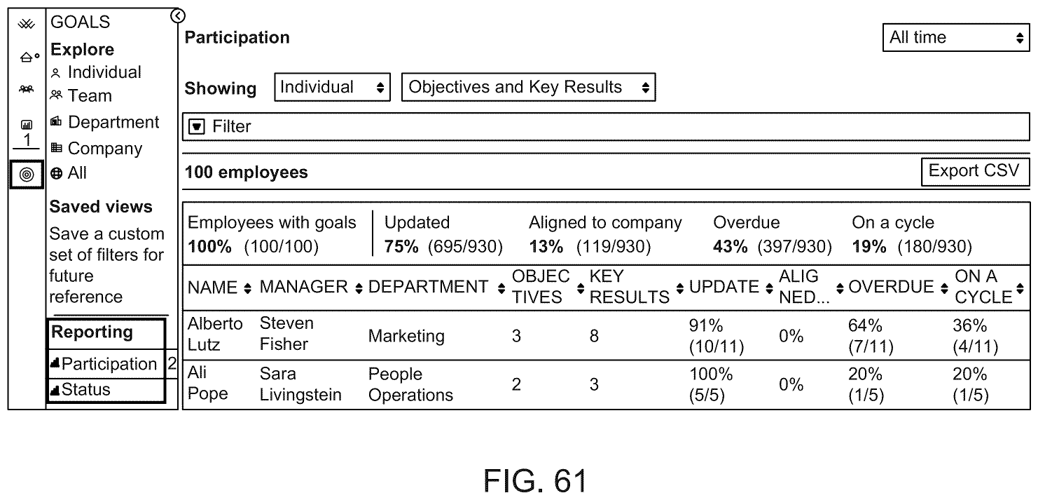

FIG. 61 is a schematic demonstrating how to navigate a user interface to access goal reporting pages.

The Goal Reporting page provides:
A count of goals that represents unique goals, regardless of how many owners the goal has.
A count of goals that includes archived users.

Please note that goal reporting does not include any ended goals.

Goal reports are accessible by navigating to Goals>Reporting. From here there are two reporting pages users can use to track their organization's goals: Participation & Status.

Filtering and Grouping Goals

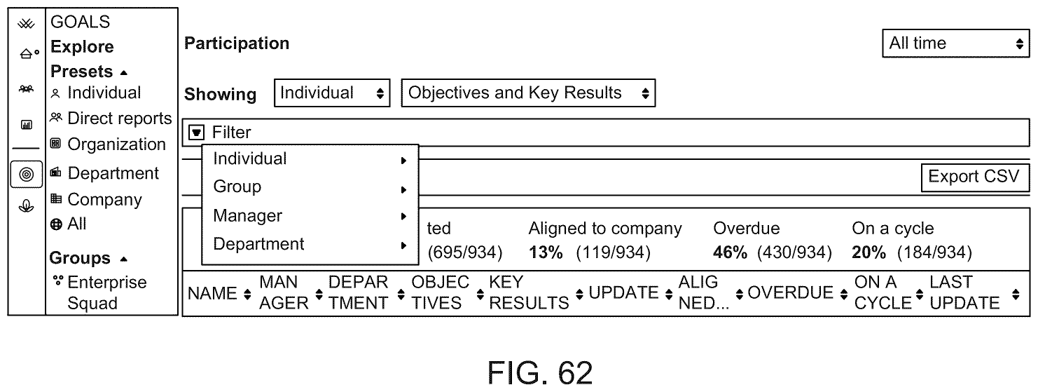

FIG. 62 is a schematic of a user interface displaying a participation reporting page containing a drop-down menu for filtering the view of goals.

Near the top of the Reporting page, users will see the ability to filter the view of goals. All date filters look at the due date of the goal.

For example, users could choose a filter to view only the goals owned by specific individuals on the People Operations team across all times.

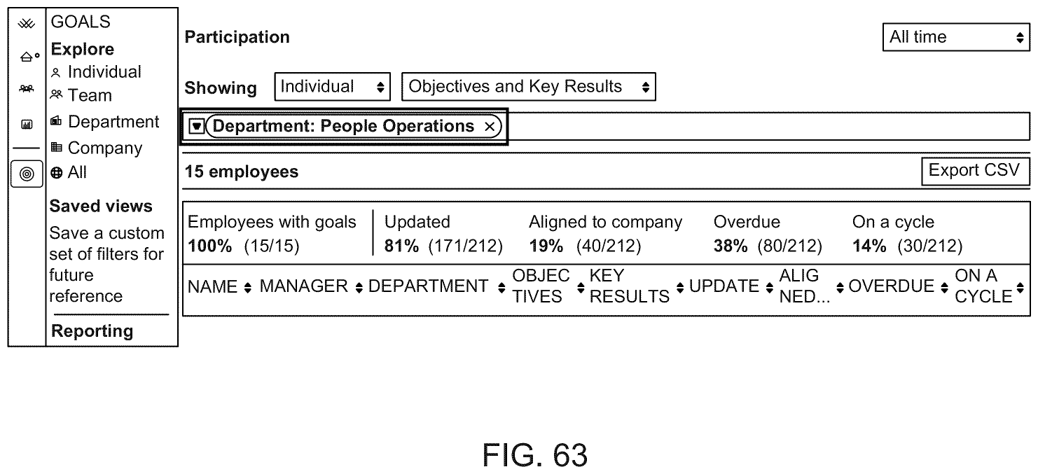

FIG. 63 is as schematic of a user interface displaying a filtered view of the participation reporting page.

The following are steps to group the goals by an individual, group, manager, or department:
1. Next to the “Showing” label, select the desired grouping from the dropdown.
2. In the top right-hand corner, select the time range for which the goals are to be displayed Note: the time range will only show goals with due dates during the particular time range selected.

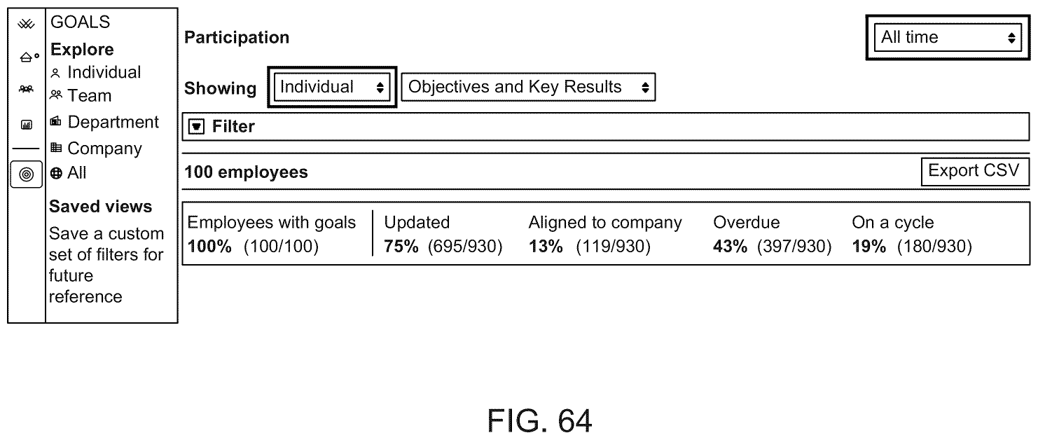

FIG. 64 is a schematic of a user interface displaying a participation reporting page grouped by individual.

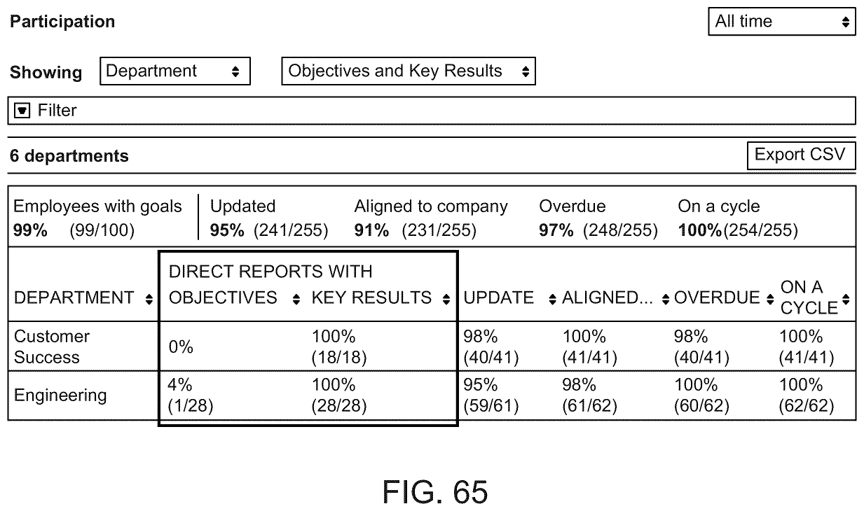

FIG. 65 is a schematic of a user interface displaying a participation reporting page grouped by department.

When users group goals by department, they will see data for members of different departments in aggregate, so users can see which parts of the business are participating in the goal-setting program. This shows data for all goal types owned by members in a department, not only department type goals.

The section titled “DIRECT REPORTS WITH” corresponds to the members of that department who own at least one objective and key result out of the total members of the department.

The section to the right, beginning with “UPDATED,” shows the total numbers of goals owned per employee that are updated, aligned, overdue, or on a cycle. Therefore, if there are two members in one department who own the same goal, this section will count that as two goals.

When users group goals by manager, they will see data for managers' direct reports.

When users group goals by group, they will see all goals of individuals that belong to the assigned groups, regardless of goal type. Reporting Breakdown

Participation: Goal participation is defined as the following:
A count of goals that represents individual users who are owners on a goal (e.g., a goal could have three owners and this counts as three goals in this report)
This count of goals will NOT include the goals of archived users.

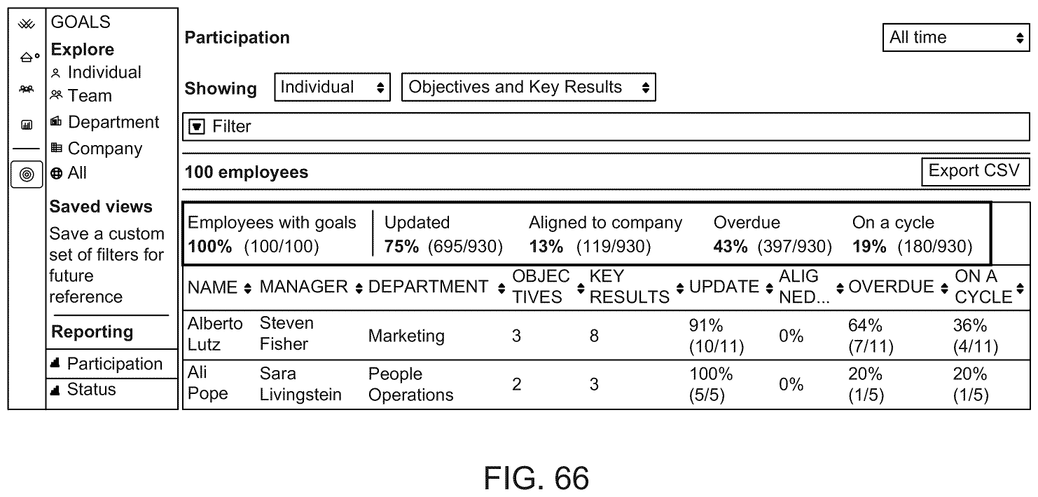

FIG. 66 is a schematic of a user interface displaying a participation reporting page containing additional reporting information for objectives and key results.

Additionally, under filtering, admins and managers will also have access to view additional reporting information for objectives and key results as outlined below:
Employees with goals: Employees that are goal owners for at least one objective or key result in the system in the selected timeframe. This is calculated by the number of employees with an objective and key results divided by the total number of employees in the system.
Updated: Objectives and/or key results that have been updated in the system. This is calculated by the number of OKRs updated divided by the total amount of OKRs in the system in the selected timeframe.
Aligned to company: The number of objectives and/or key results that have been aligned to a company goal, including any goal that eventually feeds into the company goals. Shown above is the number of goals aligned to company goals divided by overall goals in the system. Note: this will only be shown if users have enabled cascading goals for their org.
Overdue: Objectives and/or key results that have not been completed by their designated due date. This is calculated by the number of objectives and key results that are overdue divided by total objectives and key results in the system.
On a cycle: Objectives and/or key results that are part of a goal cycle. The number of objectives and key results in a goal cycle divided by the number of total objectives and key results in the system.

Status: Under the Status page, users will see a visual breakdown for the objectives and key results over time, color segmented by their status. This is useful to check on the statuses within the organization or team over a given time period.

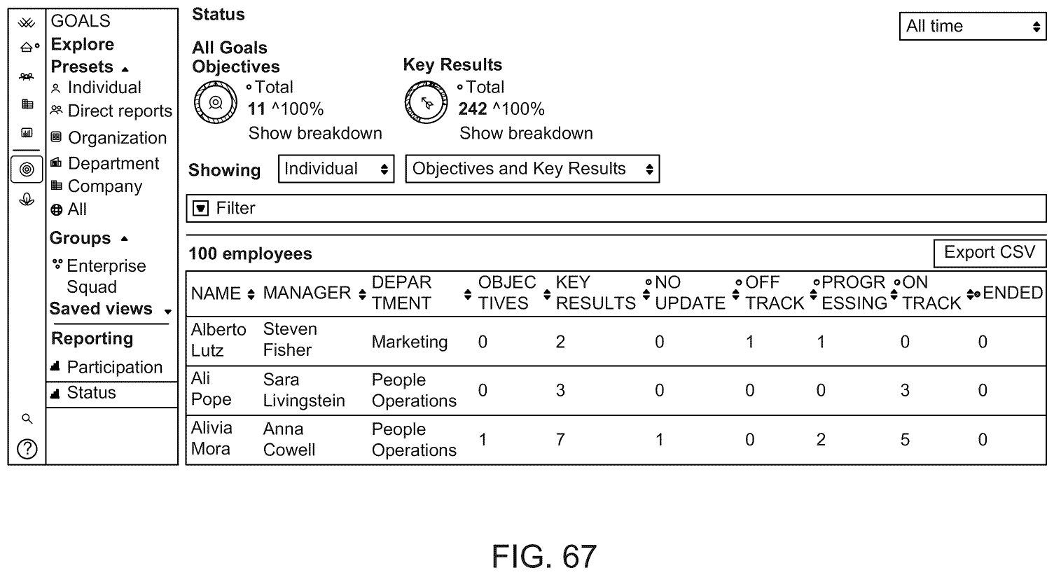

FIG. 67 is a schematic of a user interface displaying a status reporting page containing a visual breakdown of objectives and key results.

The Status page accounts for the following.
Each goal will be placed in the segment in which it was last updated.
When filtering on a custom date range or a fiscal quarter, we filter out any goal whose due date is outside the time frame.
When filtering on a goal cycle, we don't filter on the due date. We include all goals assigned to the goal cycle, whether or not they are overdue.

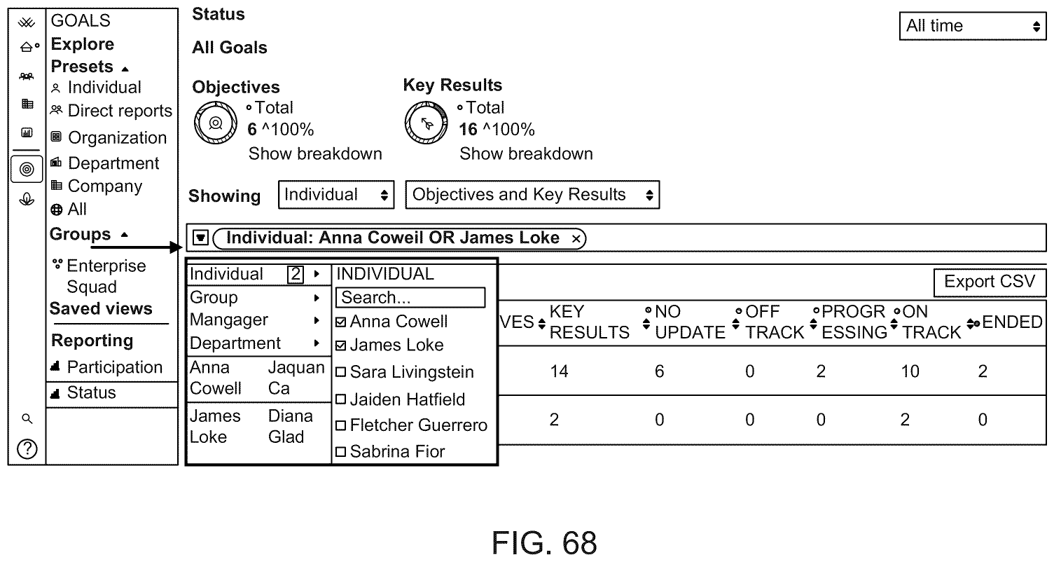

FIG. 68 is a schematic demonstrating how to navigate a user interface to track the goal progress of a department, group, manager, and/or manager's team on the status reporting page.

The Status page allows admins and managers to easily track the department, group, manager, and/or manager's team goal progress. Users can use the table below to pinpoint individuals, managers, and departments.

Users can change how goals are grouped, whether objectives or key results are displayed, and the time period. Users can group by department and manager.

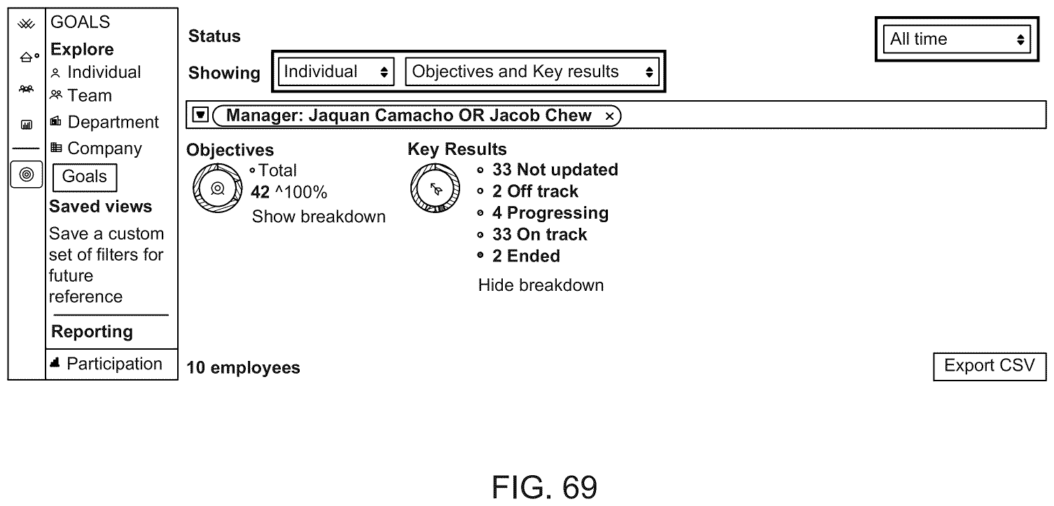

FIG. 69 is a schematic of a user interface displaying a status reporting page with goals grouped by individual.

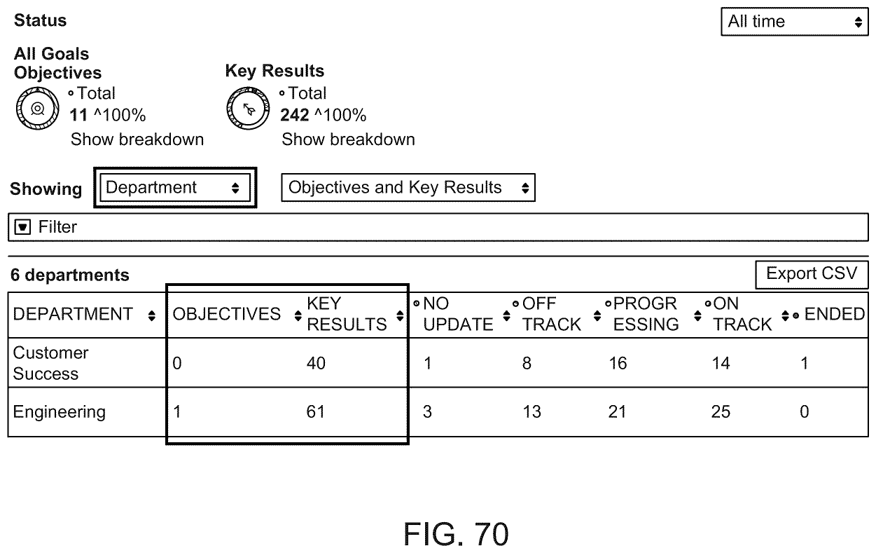

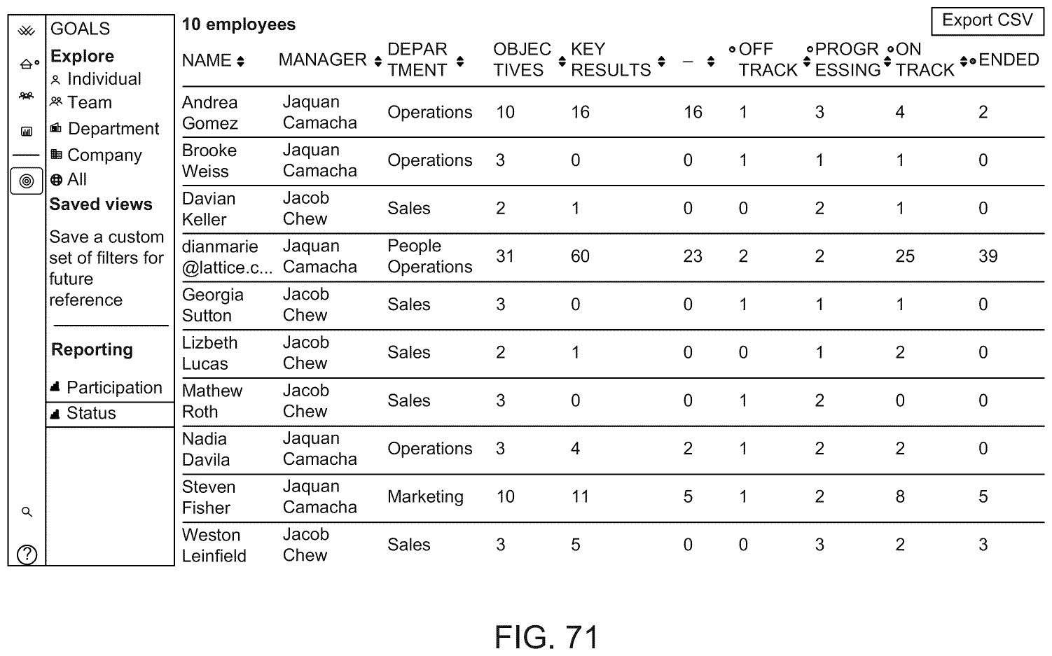

FIG. 70 is a schematic of a user interface displaying a status reporting page with goals grouped by department.

When grouping by department in status, the data will show the number of goals owned by members in that department. This includes all goal types, not just department goals.

If there is one goal owned by two members in the same department, the columns OBJECTIVES and KEY RESULTS will count as one goal in the table depicted in FIG. 70. All other columns to the right, beginning with NO UPDATE, share the status of all the goals owned by members within a department.

FIG. 71 is a schematic of a user interface displaying the status reporting page with a matrix containing a breakdown of goal statuses for several employees.

The status reporting page contains a breakdown of:
Goal owner's name.
Manager.
Department.
The number of objectives and key results.
Updated goals.
Goal progress.
The number of ended goals

Goal Pages

The Goals Reporting pages allow users to click on specific data points within the reporting table to view a list of objectives or key results that correspond to a particular individual, group, department, or manager:
Participation
   Name
   Manager
   Group
   Department
   Objectives
   Key results
Status
   Name
   Manager
   Group
   Department
   Objectives
   Key results
   Statuses

Individual, Group, Manager, and Department Goal pages will respect the filters users add to the Reporting pages.

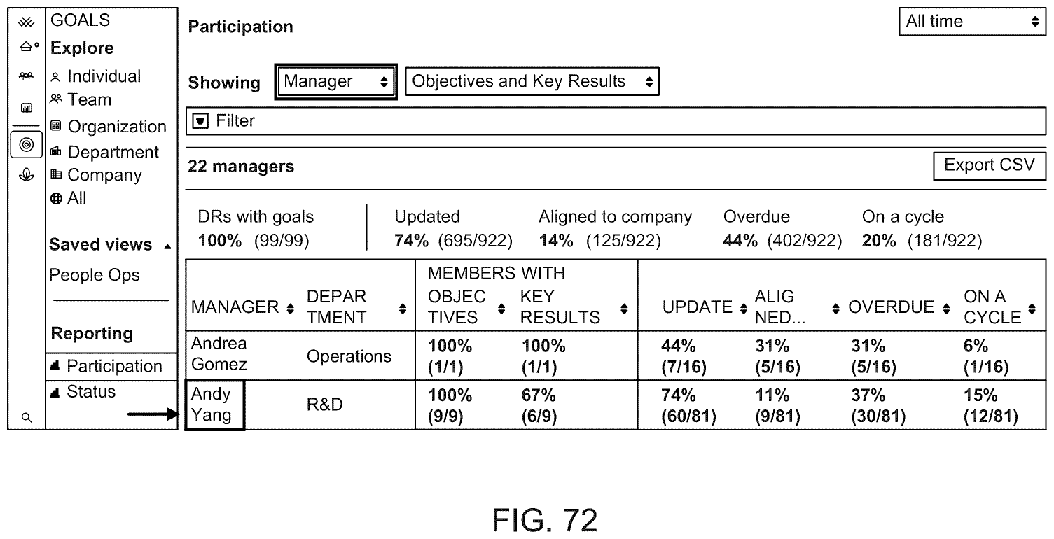

FIG. 72 is a schematic of a user interface displaying a participation reporting page filtered by manager.

Clicking on the manager's name within the table will take the user to that manager's Manager page. Within the Overview tab, users can view all goals created by the manager's direct reports Users can drill down even further within the Members tab by viewing and clicking through reporting for each direct report on the manager's team.

Overview

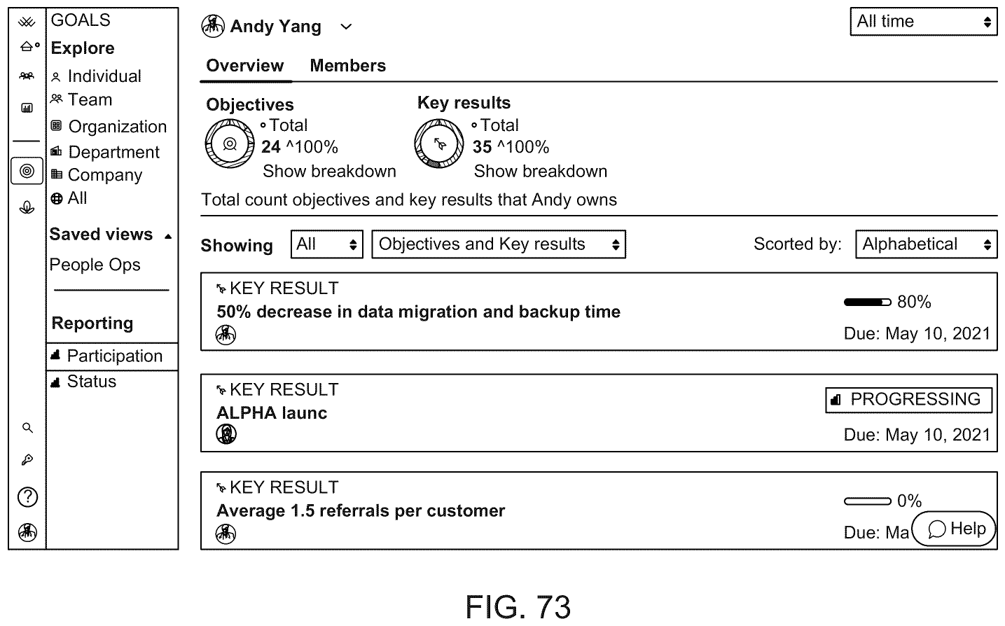

FIG. 73 is a schematic of a user interface displaying the overview tab in a manager page containing participation reporting.

Members

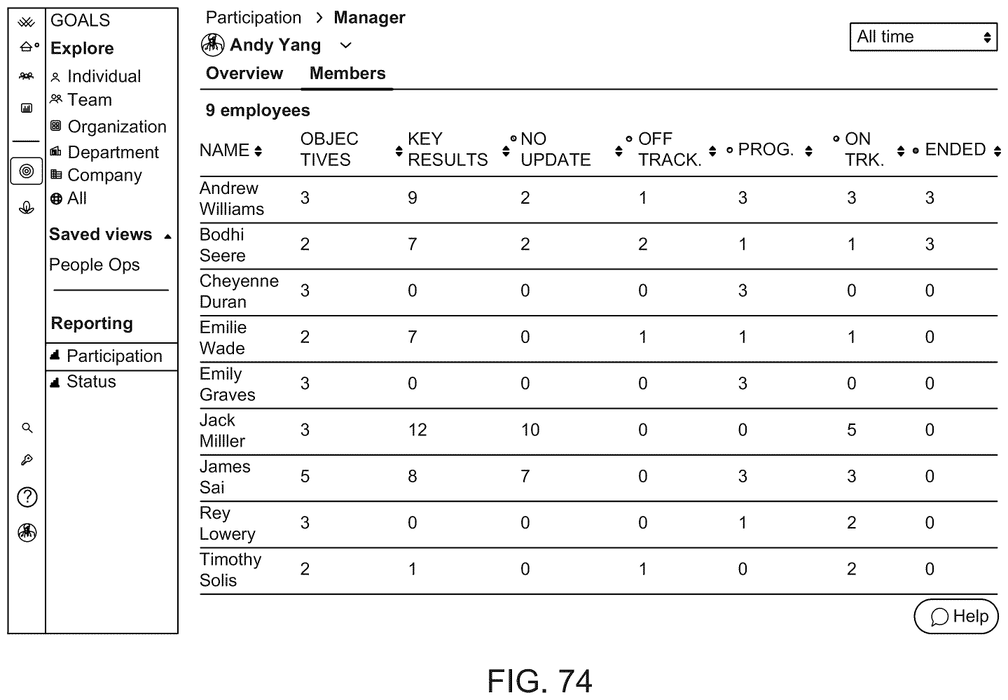

FIG. 74 is a schematic of a user interface displaying the members tab in a manager page containing participation reporting.

Company goals can be created from different locations within the system, such as the following:
The Goals page.
The Goal Creation page.

To create a department-level goal, users will need to be either an admin or department head. Only goal owners will be notified when a department goal is published and will be responsible for editing and adding progress to the goal.

What is a Public Versus Private Department Goal?

Goal visibility is set during the goal creation process under Visibility.
A public departmental goal is visible to everyone within the system from within the company page.
A private to selected departments goal is only visible to specifically selected departments with the Departments page. Users can add additional departments if necessary.

Create a Department (Goal from the Goals Page

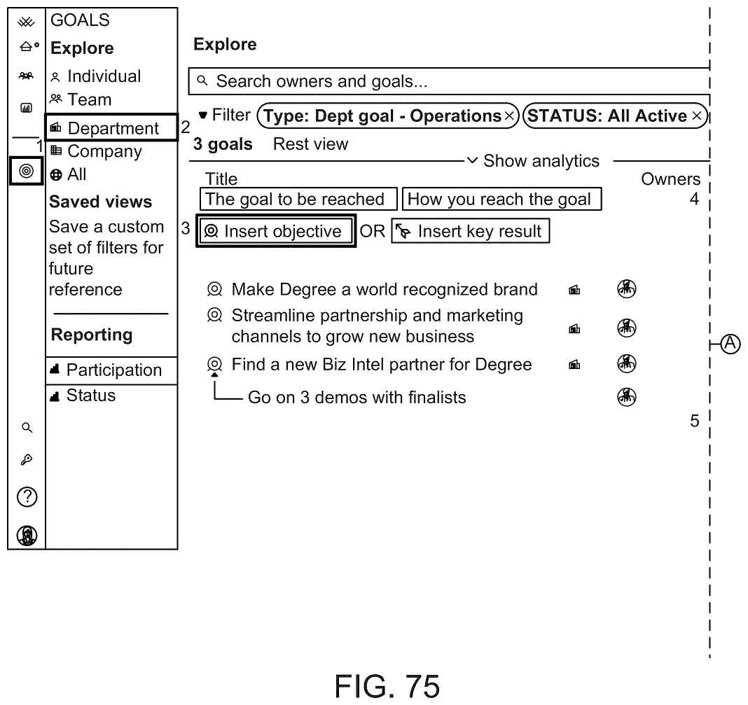

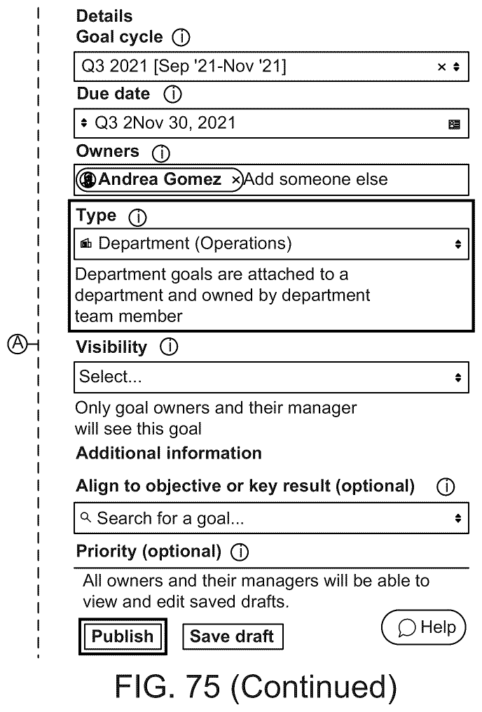

FIG. 75 is a schematic demonstrating how to navigate a user interface to create a department goal from the goals page.

The following are steps to create a department goal from the goals page:
1. Navigate to the Goals page>Department.
2. Click Insert objective or Insert key result to open the quick action context panel.
3. Select Change details.
4. Add in the desired fields—within the Type field, confirm it is selected to Department.
5. Click Publish.

Create a Department Goal from the Goal Creation Page

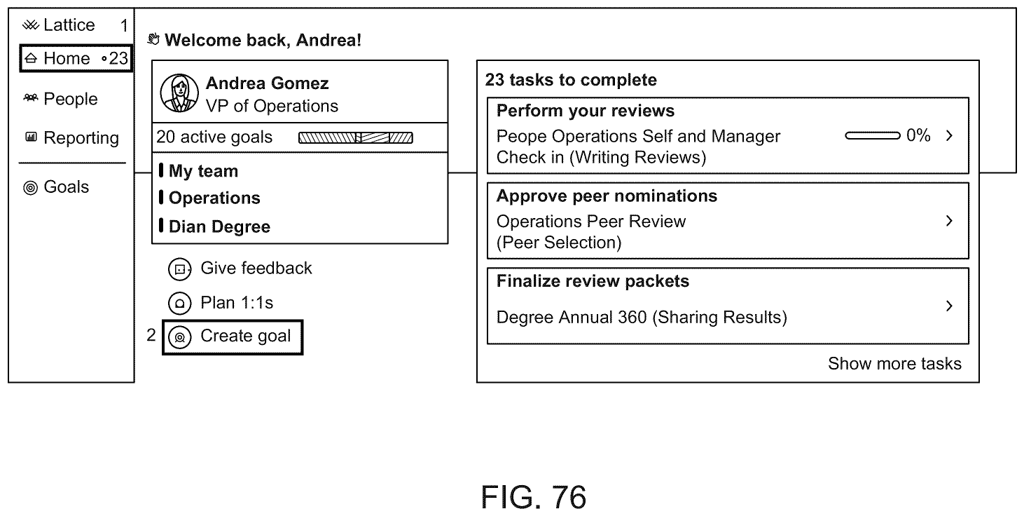

FIG. 76 is a schematic demonstrating how to navigate a user interface to create a department goal from the goal creation page.

The following are steps to create a department goal from the goal creation page:
1. Navigate to the Home page>Create goal.
2. Click Objective or Key result to open the objective creation page.
3. Select Change details.
4. Add in the desired fields within the Type field, select Department.
5. Click Publish.

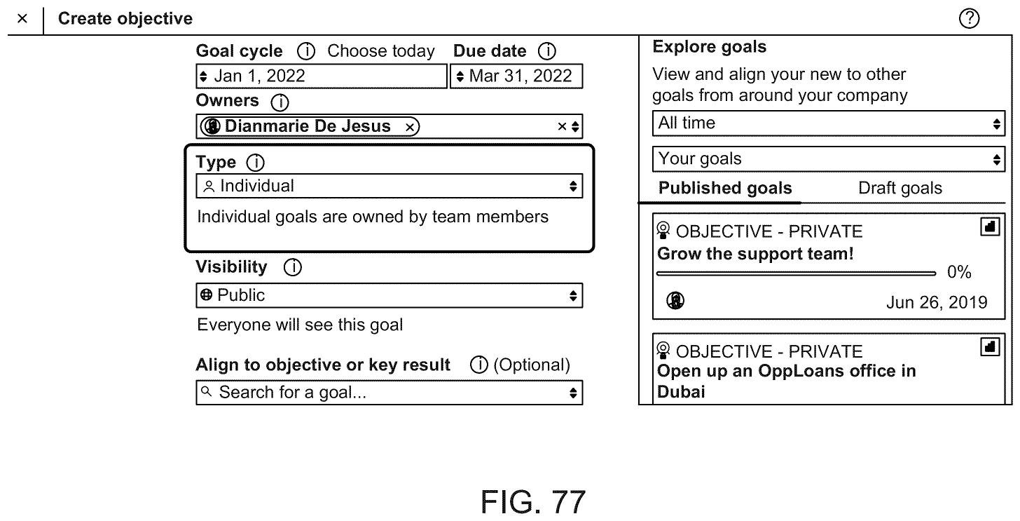

FIG. 77 is a schematic of a user interface displaying a goal creation page including a field to designate type.

As a manager, a user may want to see the public and private goals the user's direct reports have set for themselves. Keeping track of the team's goals allows users to view updates and monitor progress.

Team Goals

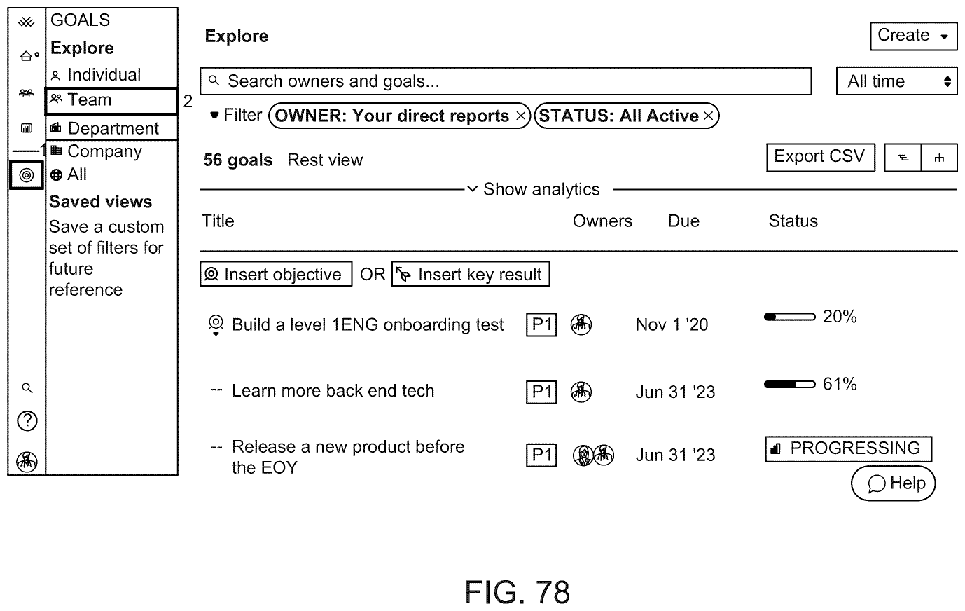

FIG. 78 is a schematic demonstrating how to navigate a user interface to view team goals.

The following are steps to view team goals:
1. Navigate to the Goals page from the discovery navigation.
2. Click on Team on the left-hand secondary navigation.

From here, users can remove or add filters from the Explore page to view the desired goals.

Individual Direct Report Goals

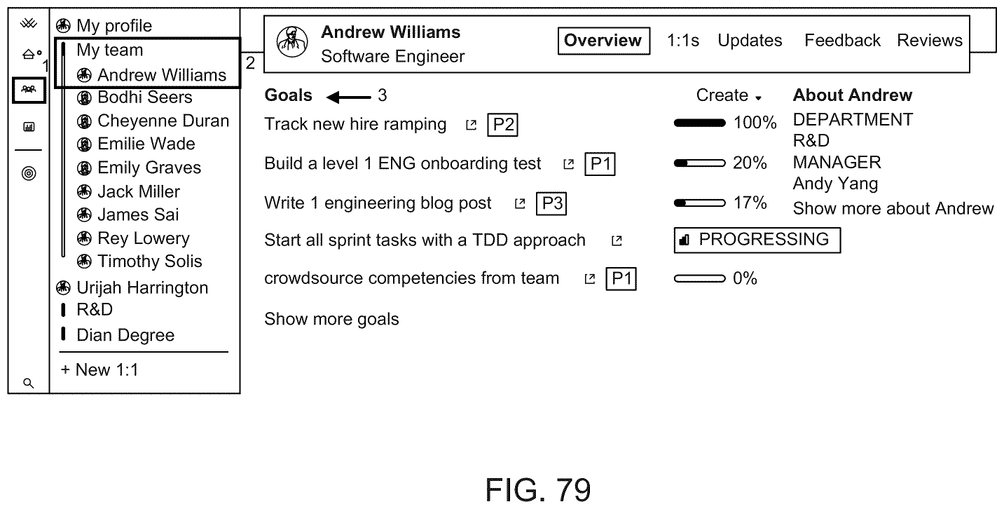

FIG. 79 is a schematic demonstrating how to navigate a user interface to view a direct report's goals.

The following are steps to view a direct report's goals:
1. Navigate to the People page from the discovery navigation.
2. Under the My team section, enter the profile of the direct report by clicking on their name.
3. Within the Overview page, view the Goals section.

### Goals for Employees

Group goals allow cross-functional teams and sub-departments to share visibility to a specific goal. With group goal type, the system helps teams meet where they are and set goals at the appropriate level.

Users can create group goals from at least two different locations within the system:
The Goals page.
The Goal Creation page

In example embodiments, only admins can create and manage groups; However, all users will be able to create group goals for users in the system.

Group goals do not automatically assign all members of the group as goal owners. Group type and owners are independent. Only goal owners will be notified when a group goal is published and will be responsible for editing and adding progress to the goal.

What is a Public Versus Private Group Goal?

Goal visibility is set during the goal creation process under Visibility.
A public group goal is visible to everyone within the system from within the Company page
A private to selected group goal is only visible to a specifically selected group within the Explore page. Users can add additional groups if necessary.

Create a Group Goal from the Goals Page

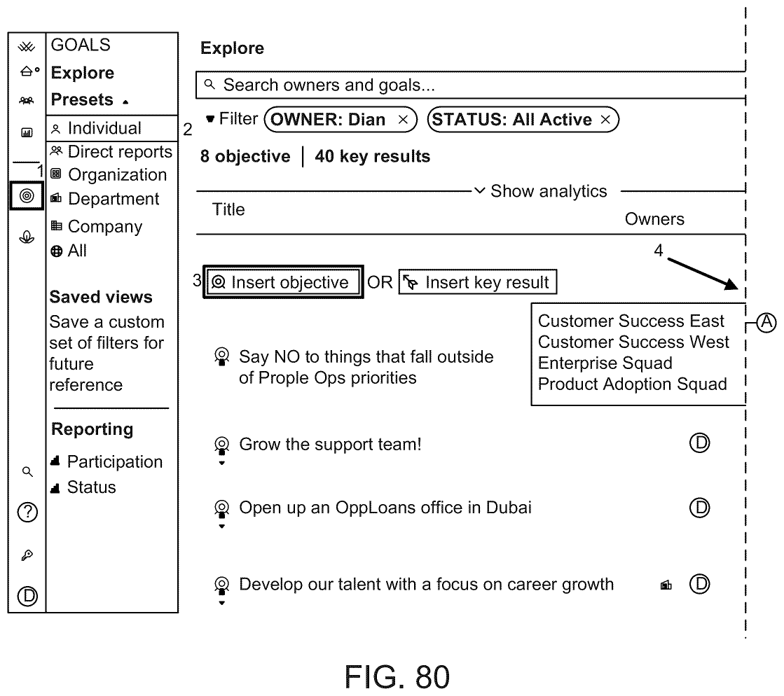

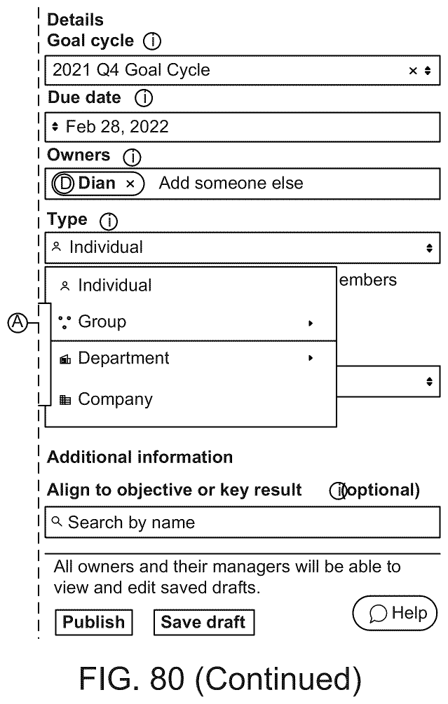

FIG. 80 is a schematic demonstrating how to navigate a user interface to create a group goal from the goals page.

The following are steps to create a goal from the goals page:
1. Navigate to the Goals page>Individual
2. Click Insert objective or Insert Key result to open the quick action context panel.
3. Select Change details.
4. Add in the desired fields—within the Type field, confirm it is selected to Group>select the desired group.
5. Click Publish.

Create a Group Goal from the Goal Creation Page

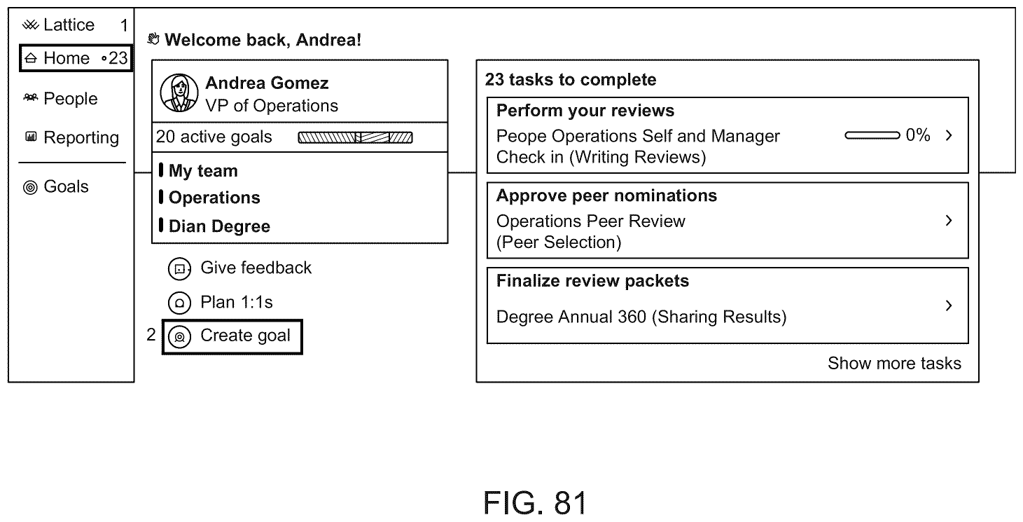

FIG. 81 is a schematic demonstrating how to navigate a user interface to create a group goal from the goal creation page.

The following are steps to create a goal from the goal creation page:
1. Navigate to the Home page>Create goal.
2. Click Objective or Key result to open the Objective Creation page.
3. Select Change details.
4. Add in the desired fields—within the Type field, select Group>select desired group.
5. Click Publish.

Note: If the goal type is required, users will be able to access the field within the Goal Creation main page.

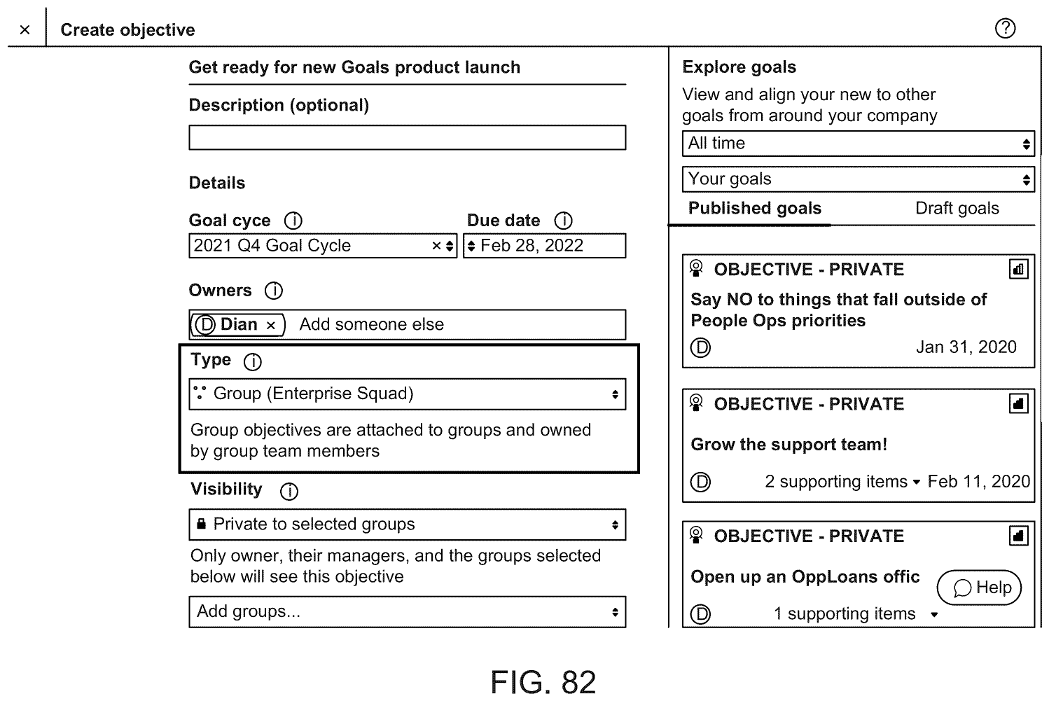

FIG. 82 is a schematic of a user interface displaying a goal creation page including a field to designate type.

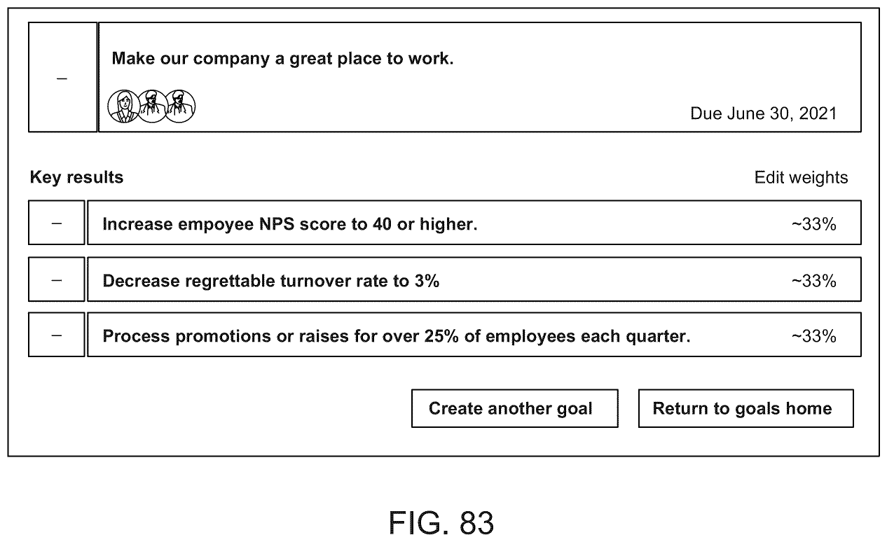

FIG. 83 is a schematic of a user interface displaying a newly created goal with an objective and key results.

Goals help empower employees to control their performance and development with clear, measurable objectives. Goals allow users to communicate what the users are focusing on and define the developmental milestones or share initiatives users are working on that align with the company's priorities.

Objectives and Key Results

Creating a goal means creating objectives and key results:
Objectives are qualitative goals that will inherit the progress of supporting key results or child objectives. Objectives help set the direction for the entire company, department, team, or individual and are usually aspirational. When creating an objective, users will not have the option to select a measurement due to the nature of objectives.
Key results are quantitative (#, $, %, binary) goals that measure progress to attainment Key results help measure what users need to accomplish the objective and are usually metrics-driven and tangible.

Create a Goal

Goal creation means creating objectives and key results using the OKR framework.

Goals help empower employees to control their performance and development with clear, measurable objectives. Goals allow users to communicate what they are focusing on and define the developmental milestones or share initiatives they are working on that align with the company's priorities.

Difference Between Objectives and Key Results

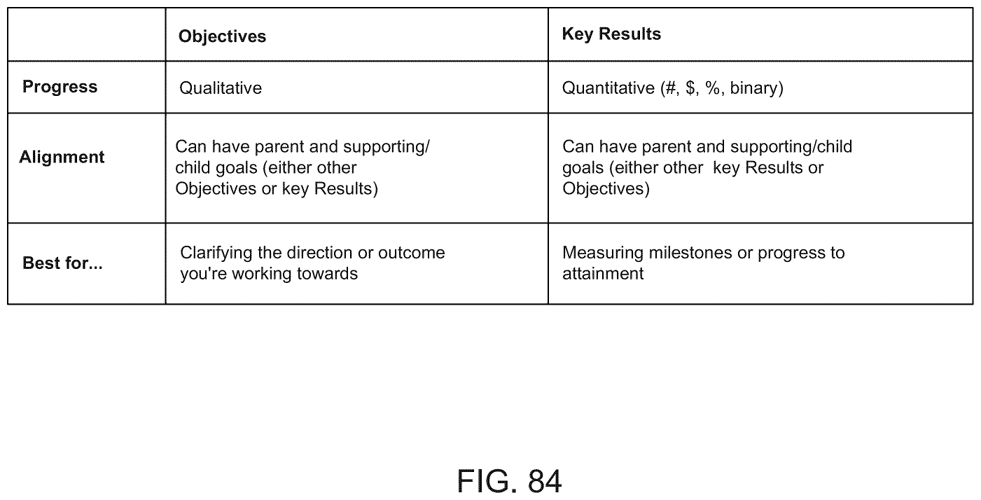

FIG. 84 is a matrix describing the differences between a goal's objectives and key results.

Creating a goal with goal differentiation means creating objectives and key results.

Create an Objective

There are at least two places in the system where users can create an objective:
Goal creator.
Goal Explore page.

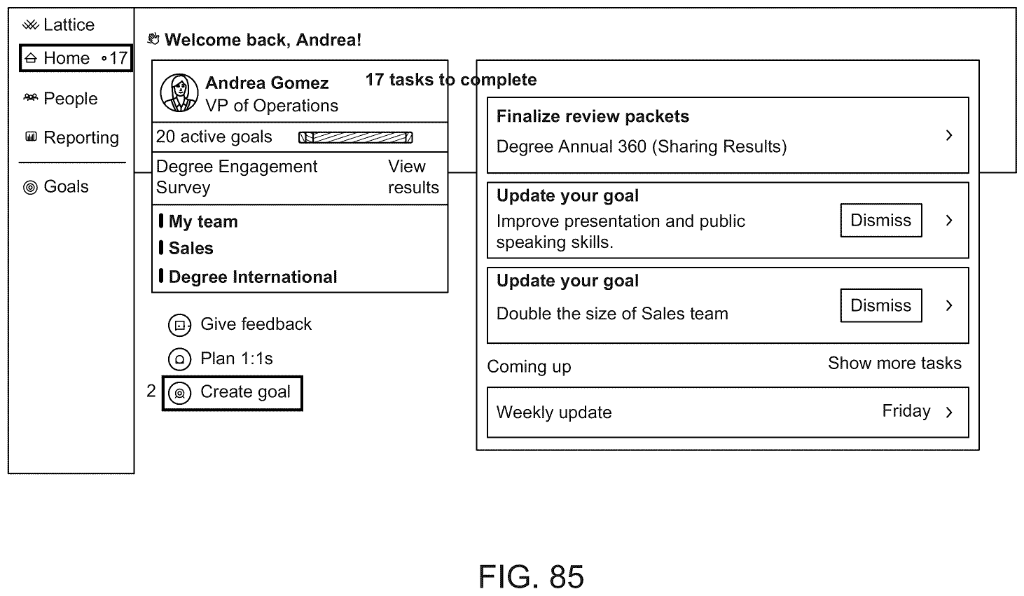

FIG. 85 is a schematic demonstrating how to navigate a user interface to create an objective in the goal creator.

To create an objective in the goal creator navigate to Home>Create goal>Select Objective.

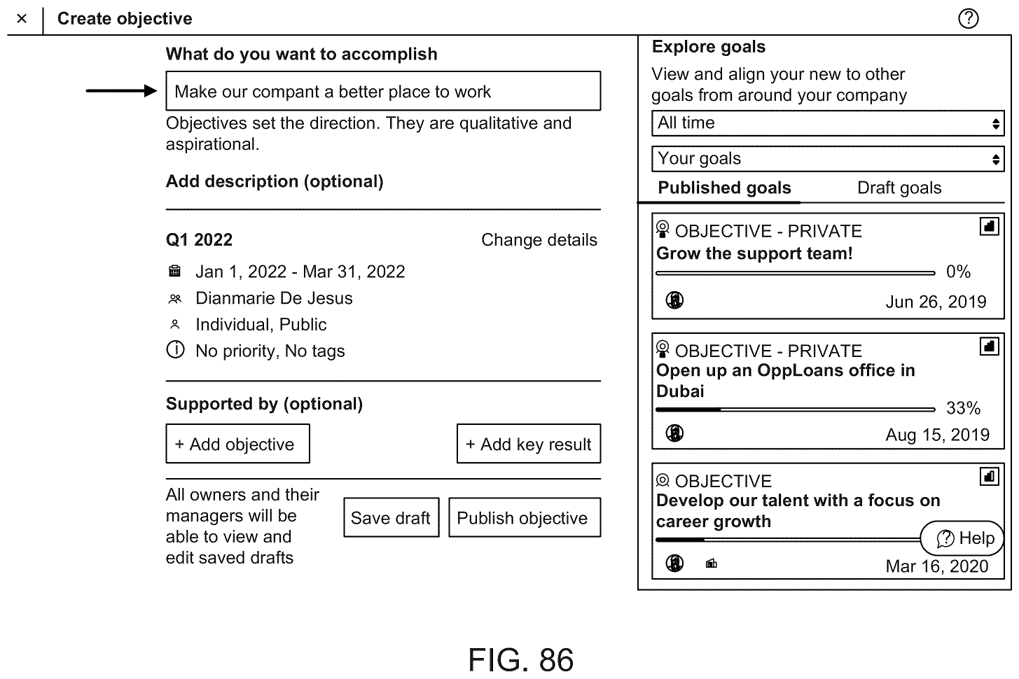

FIG. 86 is a schematic of a user interface displaying an objective creation page including a text box for describing the objective.

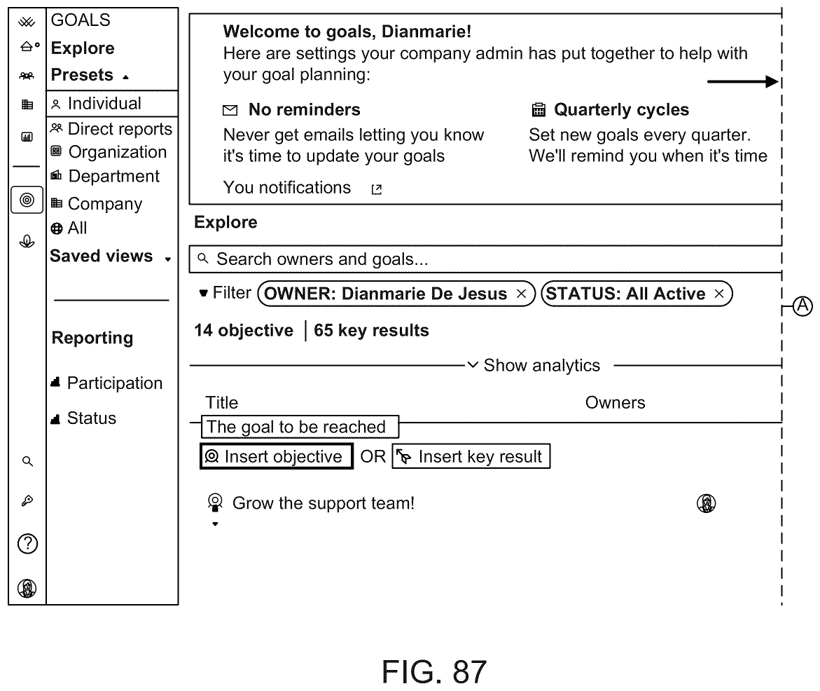

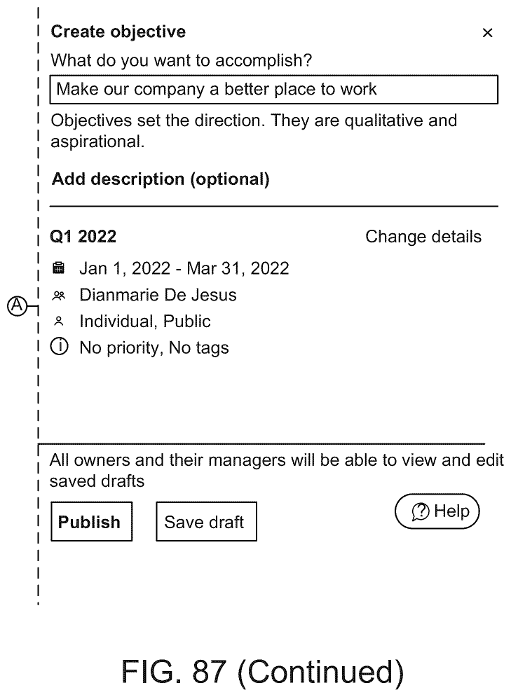

FIG. 87 is a schematic demonstrating how to navigate a user interface to create an objective in the goal explore page.

The following are steps to create an objective in the goal explore page:
1. Navigate to Goals>Click Insert objective.
2. Enter an Objective title.
3. (optional): Write a Description.
4. (optional): Select a Goal Cycle.
5. Establish a Start date. Select the date the objective is expected to start. This is a required field, users can default to the date of creation by selecting Choose today.
6. Establish a Due Date.
7. Select Owners.
8. Select the goal Type.
9. Choose Visibility.
10. (if cascading goals is enabled). Add a Parent objective or key result.
11. Set a goal Priority.
12. Select applicable Tags
13. (via the Goal Creator page). Add Supported goals.
14. Publish or Save Draft.

Users may optionally write a description to remind themselves and their teammates about some details of the goal.

If an admin has created a goal cycle, users may be asked to select a cycle that this objective falls under. This is a time period in which the goals are being worked on. If users have any questions about this, we recommend reaching out to the admin!

When establishing a due date for the objective, we default to the end of the current quarter or the end of the goal cycle. Users may use the date-picker calendar to select another end date in the future.

Most goals created in the system are personal goals, owned by one person. However, goals can also be owned by more than one person.

Objectives can be for an individual, a department, a group, or the company. Keep in mind, the types of objectives users see will depend upon the permissions their admin has granted them.

Objectives can be public (visible to the entire company), private (only visible to the user, their manager, their manager's manager), or private to selected departments (only visible to goal owners and members of the departments selected).

A parent goal (or a cascading goal) is a way to align the goal with other goals within the organization. Under the “Align to objective or key result” option, search the parent goal that users want to align their goal to. Users can align to both objectives and key results.

In example embodiments, parent goals may only be visible if an admin has turned on cascading coals.

Users may optionally set a priority for the objective (P1-P10), which will be displayed next to the goal on certain pages throughout the site. Goals will also be listed in order of priority (P1 first).

Tags are optional but help classify and organize goals. Admins create these!

When creating an objective, add key results or metrics that impact the overall goal. Key results help determine if users are tracking properly against their goal.
If cascading goals is enabled, users will also be able to add a supporting objective that aligns to the current objective.
If cascading goals is disabled, users will only see the option to add a key result.

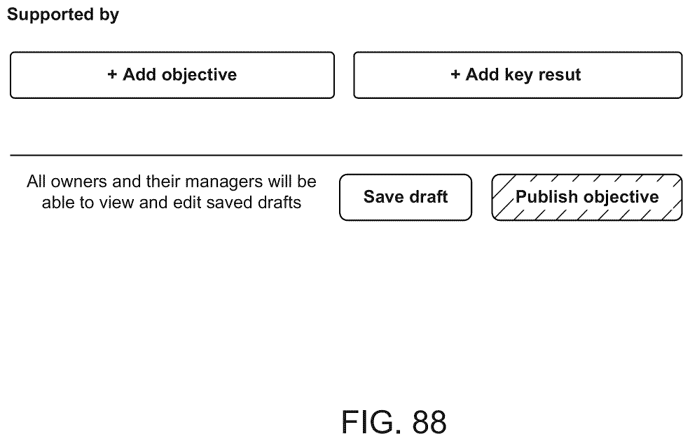

FIG. 88 is a schematic of a user interface displaying the option to add supported goals to an objective.

If users are creating an objective via the Goal Explore page, they will be prompted to add supporting goals after publishing the objective.

Goal drafts are visible to the owners and their managers but are not visible to the rest of the company.

The Goals homepage allows users to complete quick actions on their goals directly within the Explorer. Simplify the goal process by allowing employees to quickly create, update, and edit their individual goals from the Goals Explore page context panel.

One or more goal actions may be available in the sidebar, such as, for example, any of the following goal actions:
Create
Align goal to parent goal (cascading)
Update
Edit
End
Delete
Reactivate

A context panel may be provided within the List and Cascade views. Users will only be able to complete quick actions for goals they are goal owners for or have edit access to.

Department heads can quickly create a goal within the Department goals filter, while admins and company goal creators can create a goal within the Department and Company goals filters.

Quick Actions in the Goals Homepage

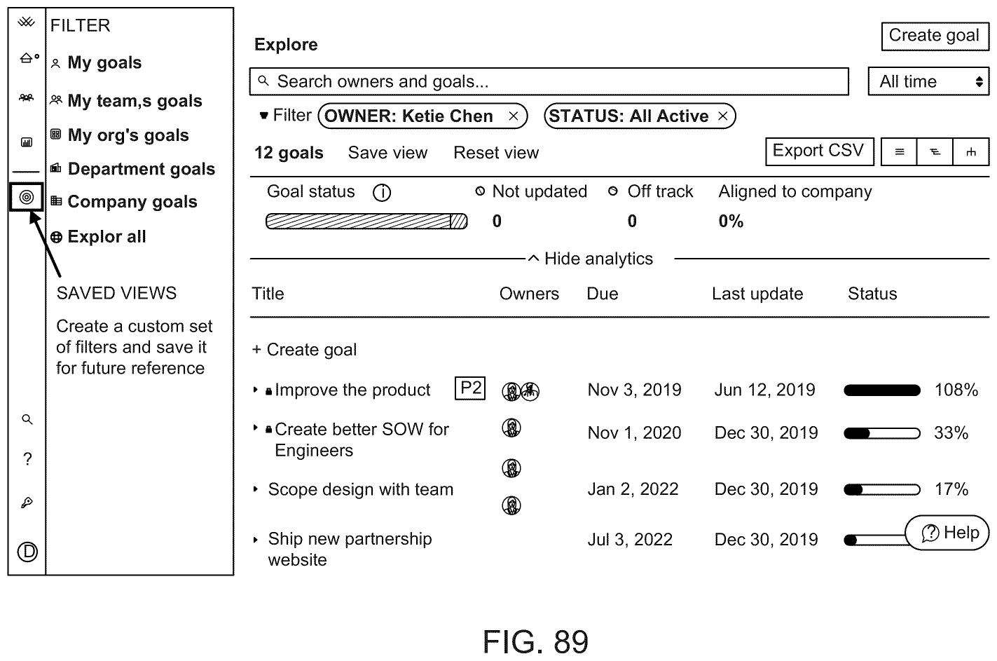

FIG. 89 is a schematic of a user interface displaying the goals homepage.

The following are steps to open the sidebar for a goal:
1. To create a goal, enter the Goals Homepage from the discovery navigation.
2. Click on the desired goal to open the sidebar.

Please note that available fields may be different depending on the settings set by the admin.

Create a Goal within the Goals Homepage

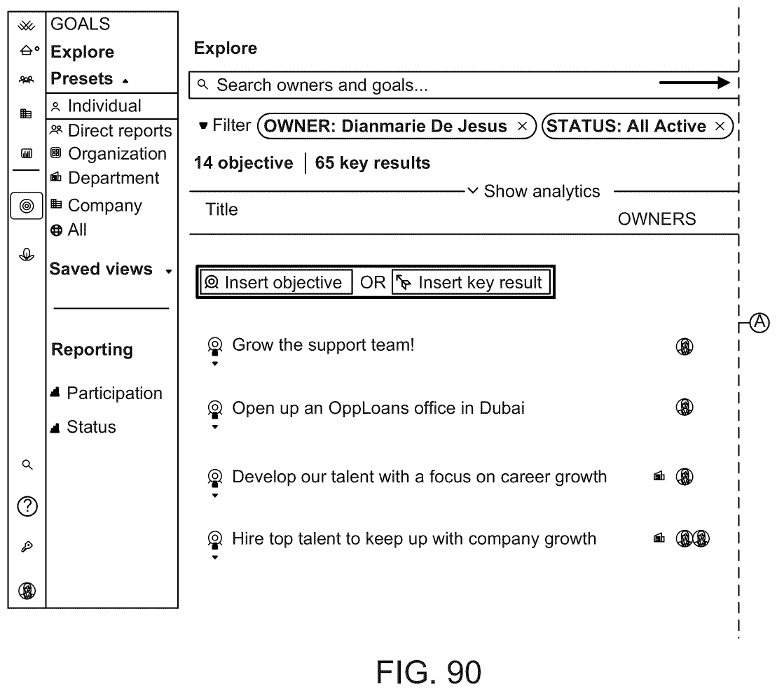

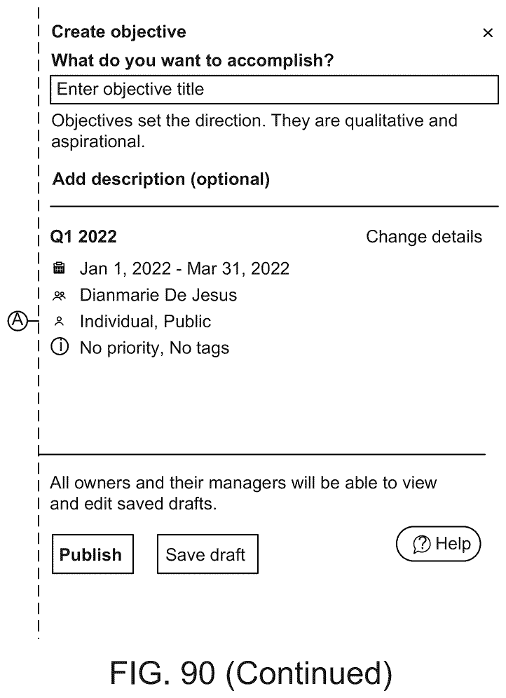

FIG. 90 is a schematic demonstrating how to navigate a user interface to create a goal within the goals homepage sidebar.

There are two places where users can create a goal within the Goals homepage:
1. Using the Create button for the full page editor
2. Using the top-level Insert objective or Insert key result buttons to quick-create.

The following are steps to quick create a goal:
1. To quick-create a goal, click the top-level Insert objective or Insert key result button.
2. In the right-hand sidebar, fill out the relevant fields to create the goal. For an in-depth explanation of each field, check out How to Create a Goal.
3. Publish.

How to Align a Goal to Parent Goal (Cascading)

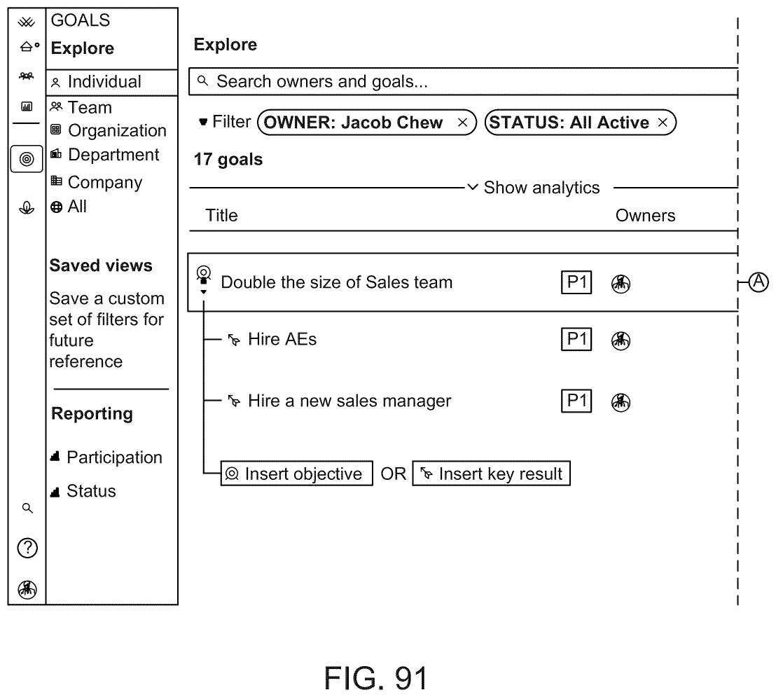

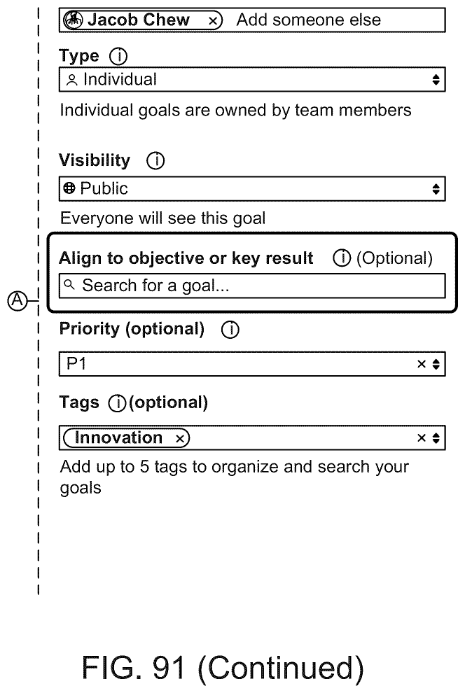

FIG. 91 is a schematic demonstrating how to navigate a user interface to align a goal to a parent goal within the goals homepage sidebar.

If goal differentiation and cascading goals are enabled, users will have the option to edit the goal and align to an objective or key result within the context panel.

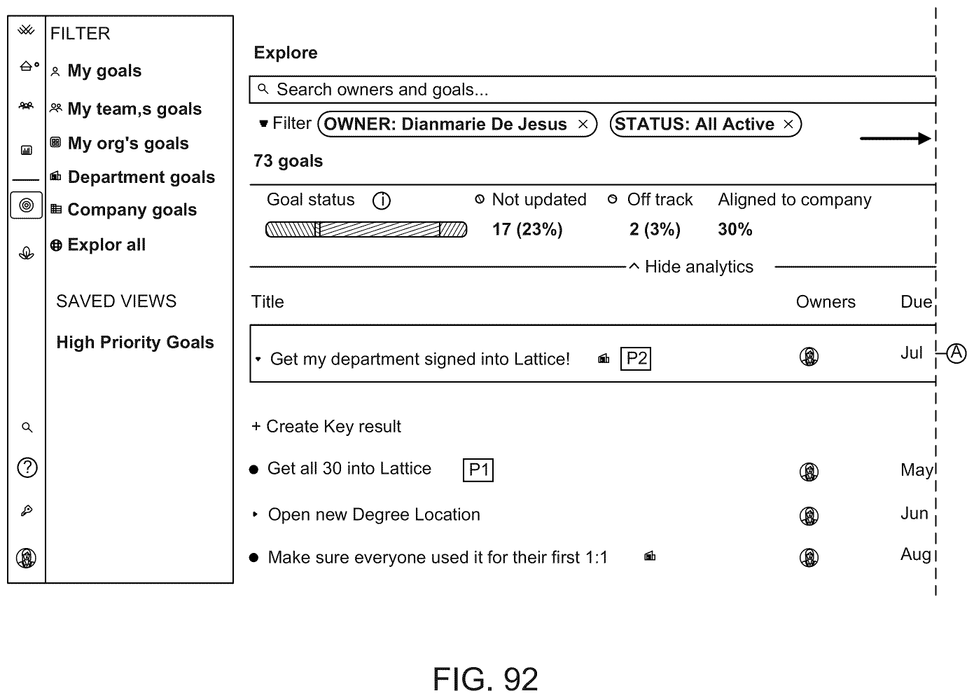

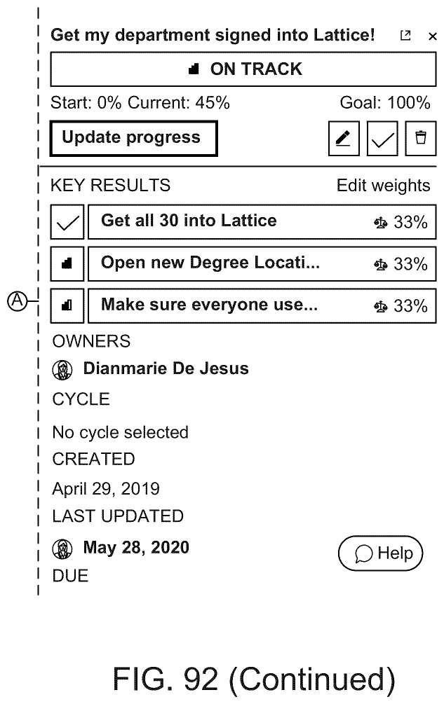

FIG. 92 is a schematic demonstrating how to navigate a user interface to update a goal or key result within the goals homepage sidebar.

The following are steps to update a goal or key result within the goals homepage sidebar:
1. Select the desired goal.
2. Click Update within the sidebar.
3. Add progress made in the “What's new?” section and assign the goal as Off track, Progressing, or On track.
4. Post update.

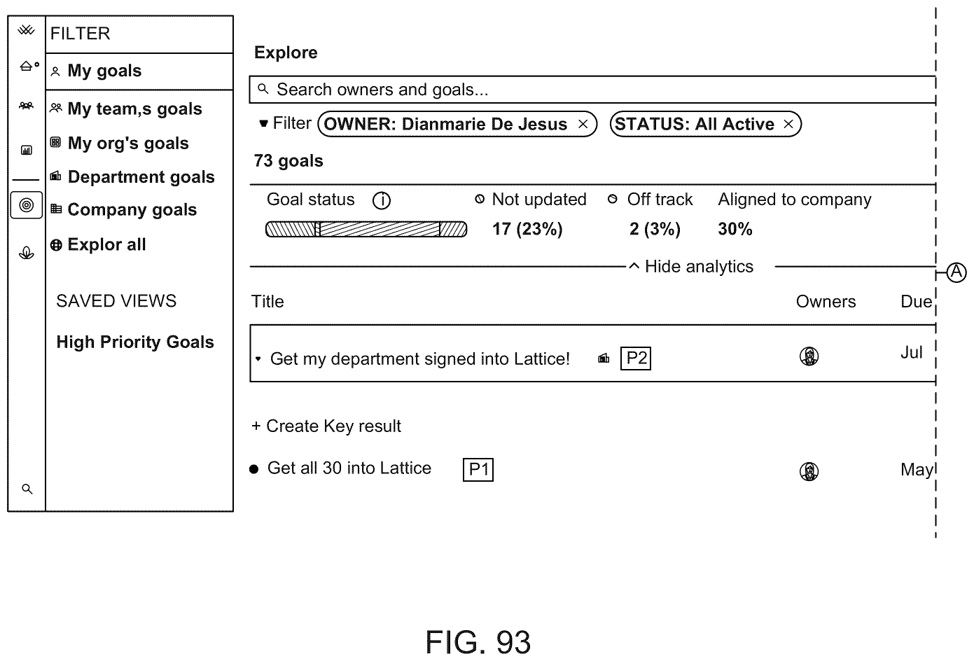

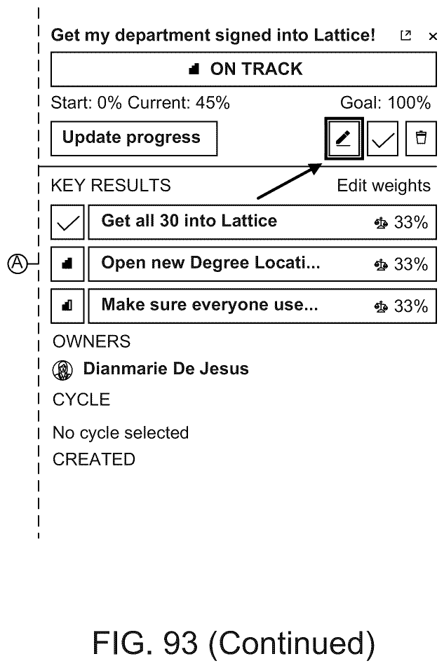

FIG. 93 is a schematic demonstrating how to navigate a user interface to edit a goal or key result within the goals homepage sidebar.

The following are steps to edit a goal or key result within the goals homepage slider:
1. Select the desired goal.
2. Click on the pencil icon to edit.
3. Make edits within the sidebar editor.
4. Save.

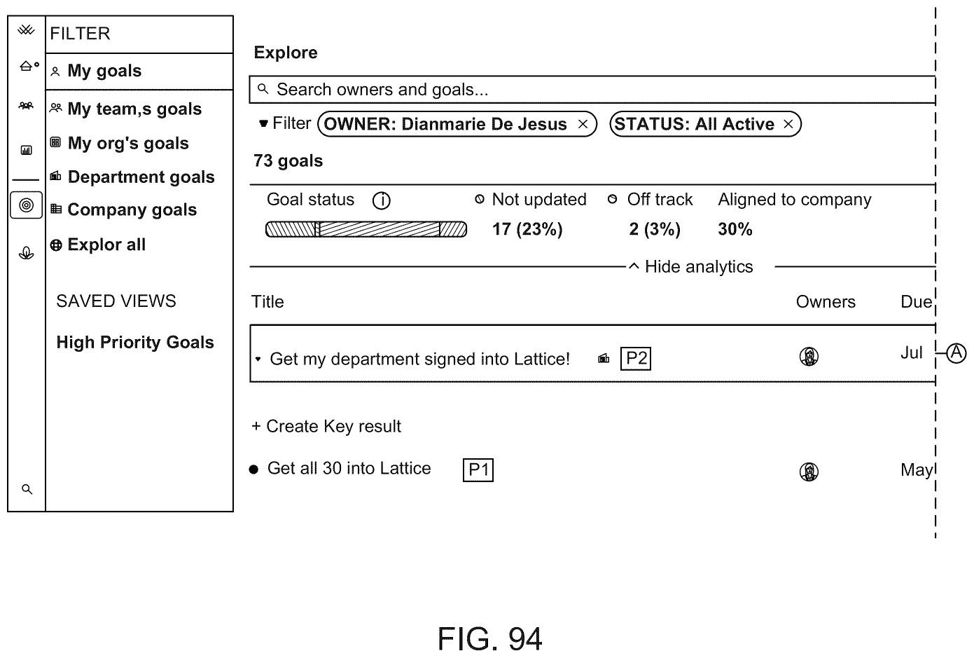

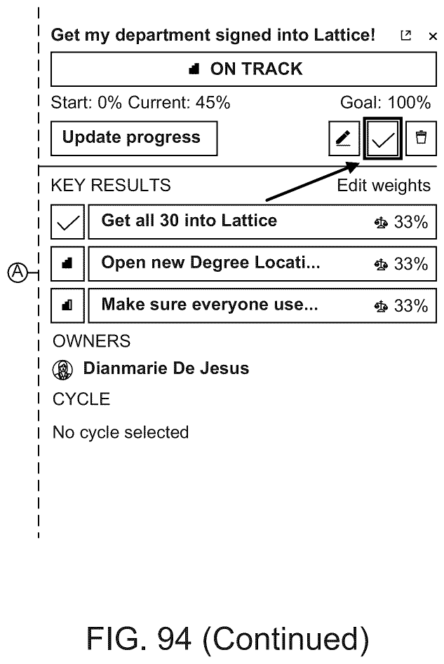

FIG. 94 is a schematic demonstrating how to navigate a user interface to end a goal or key result within the goals homepage sidebar.

The following are steps to end a goal or key result within the goals homepage sidebar:
1. Select the desired goal.
2. Click on the checkmark icon to end.
3. Mark the goal as Complete or Incomplete.
4. End goal.

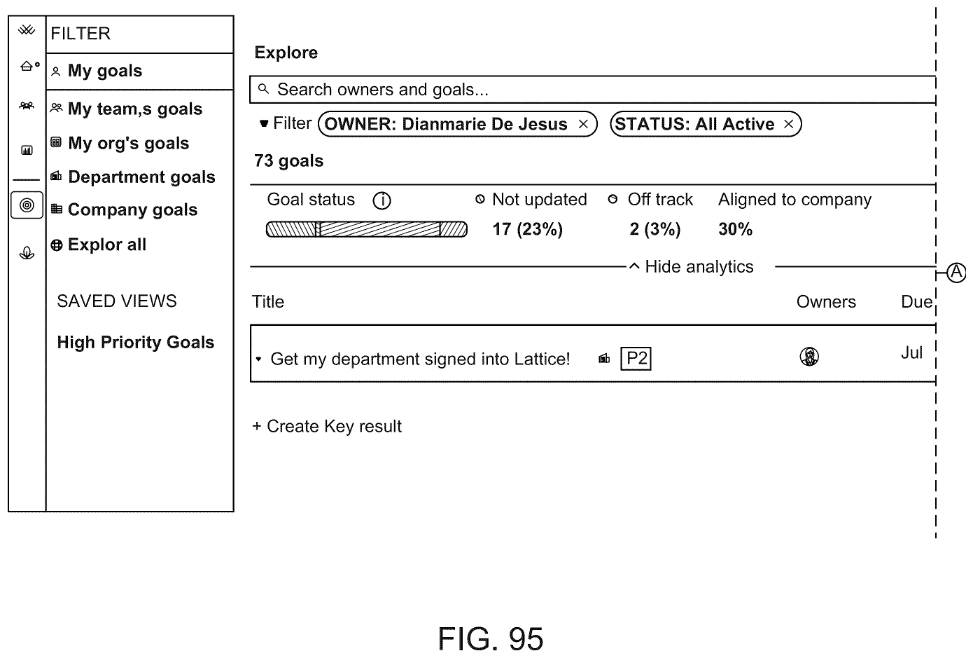

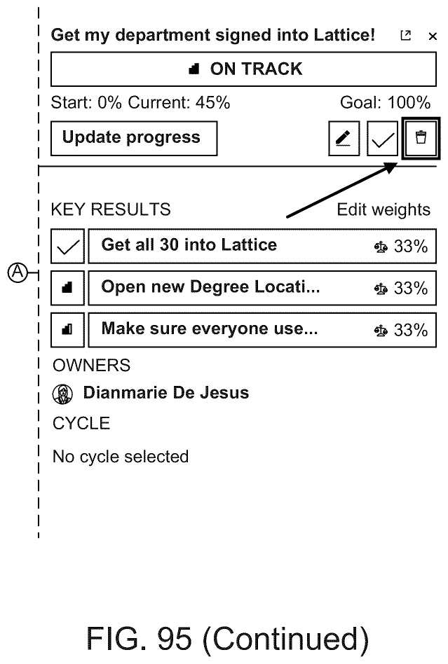

FIG. 95 is a schematic demonstrating how to navigate a user interface to delete a goal or key result within the goals homepage sidebar.

The following are steps to delete a goal or key result within the goals homepage sidebar:
1. Select the desired goal
2. Click on the trashcan icon to delete.
3. Confirm and Delete goal.

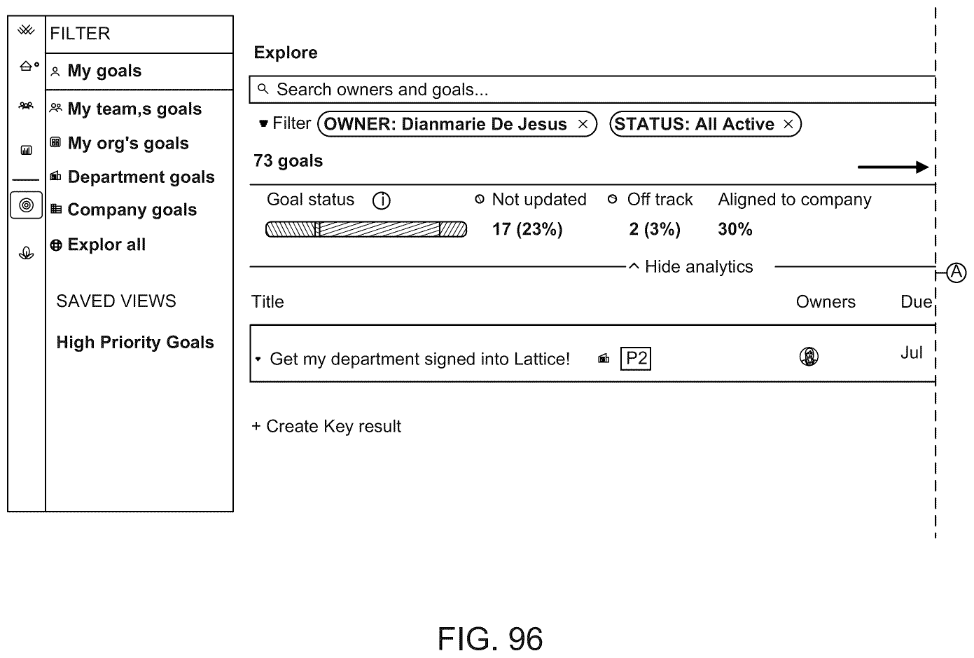

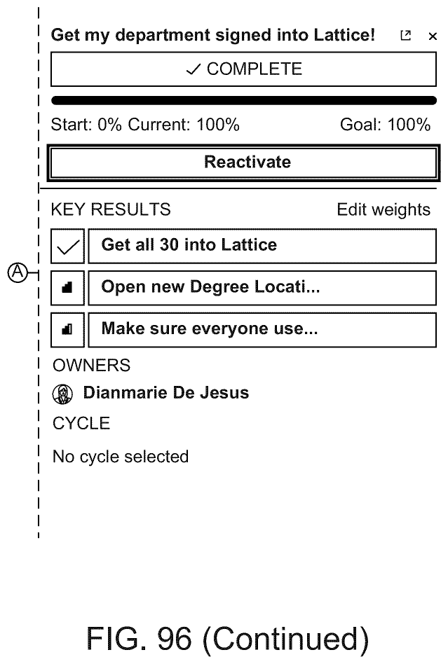

FIG. 96 is a schematic demonstrating how to navigate a user interface to reactivate an ended goal or key result.

The following are steps to reactivate an ended goal or key result:
1. Select the desired ended goal.
2. Click on the Reactivate button.

Goals help empower employees to control their performance and development with clear, measurable objectives. Goals allow users to communicate what they are focusing on and define the developmental milestones or share initiatives they are working on that align with the company's priorities.

Note that, unlike objectives, key results will not inherit the progress of other key results unless the parent key result is measured as binary.

Create a Key Result

There are at least two places in the system where a key result can be created:
Goal creator.
Goal Explore page.

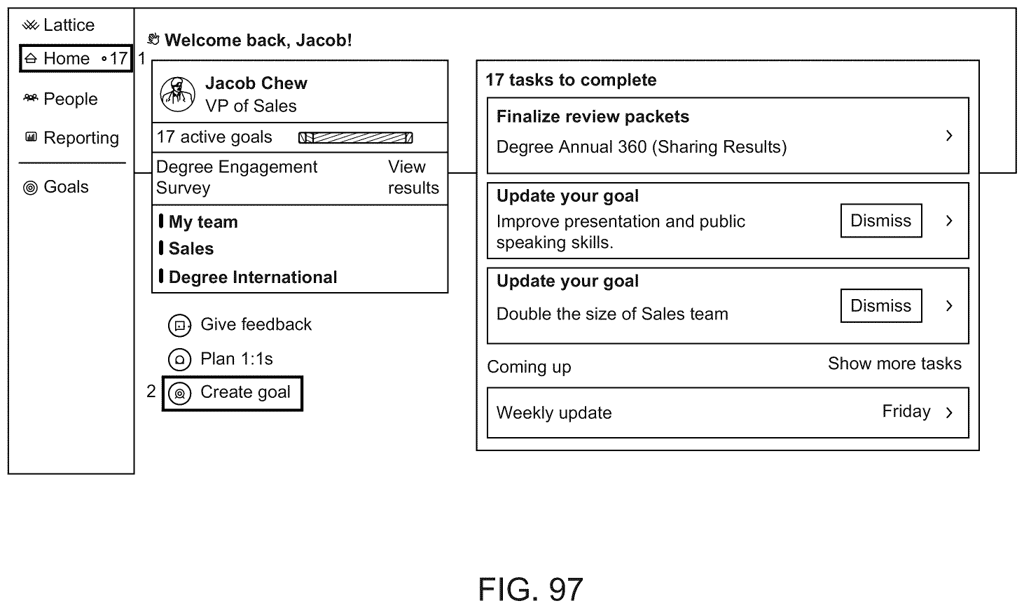

FIG. 97 is a schematic demonstrating how to navigate a user interface to create a key result in the goal creator.

To create a key result in the goal creator: Navigate to Home>Create goal>Select Key result. OR If users have already created an objective, they can click+Add key result at the bottom of the objective goal creation page.

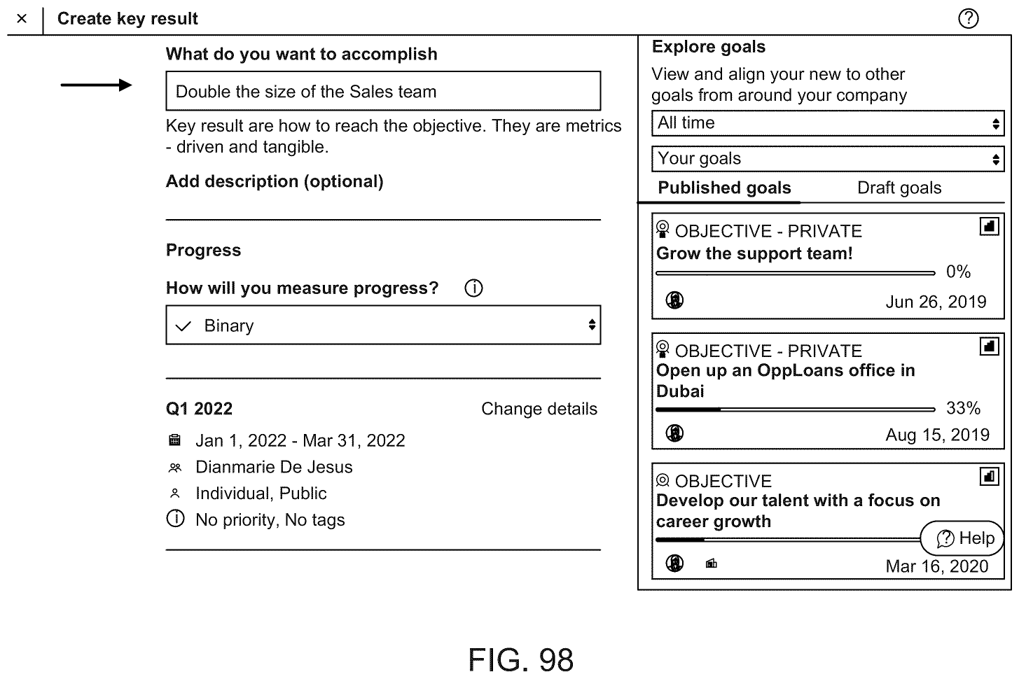

FIG. 98 is a schematic of a user interface displaying a key results creation page including a text box for describing the key result.

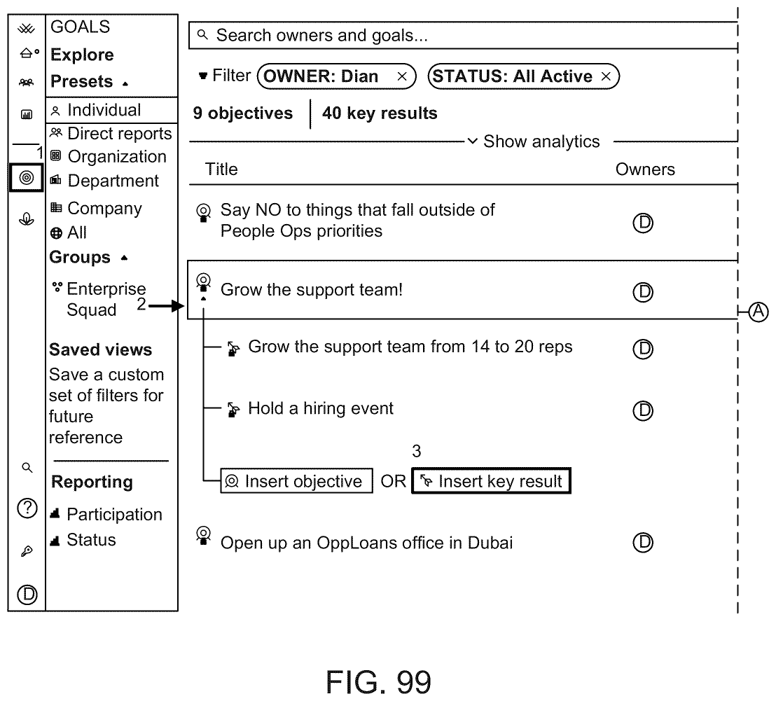

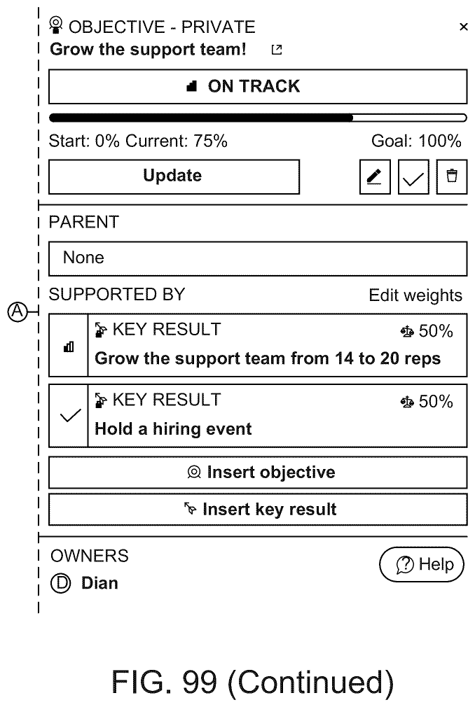

FIG. 99 is a schematic demonstrating how to navigate a user interface to create a key result in the goal explore page.

The following are steps to create a key result in the goal explore page:
1. Navigate to Goals>Click Insert key result. OR if users have a specific goal they would like to add key results to, they can click on the parent objective or key result to expand and then select Insert key result.
2. Enter a key result Tide.
3. (optional): Write a Description.
4. Decide how users will measure the overall progress of the key result. Metrics can be
   Binary: A key result that is definitively complete or incomplete, i.e., Grow international accounts
   Number #: A key result that is measured by a numeric measurement, i.e., Hire three new sales representatives.
   Percent %: A key result measured by percentage, i.e., Increase revenue by 20%.
   Dollar S: A key result that is clearly defined by currency, i.e., Sell $200,000 more supplies this quarter.
   Jira integration: An integration that allows users to measure by story points or issues.
   Salesforce integration: An integration that allows users to measure progress from the reports.
5. (optional). Select a Goal Cycle.
6. Establish a Start date.
7. Establish a Due Date.
8. Select Owners.
9. Select the goal Type.
10. Choose Visibility.
11. (e.g., if cascading goals is enabled): Add a Parent objective or key result. A parent goal (or a cascading goal) is a way to align the goal with other goals within the organization. Under the “Align to objective or key result” option, search the parent goal that users want to align the goal to.
12. Set a goal Priority.
13. Select applicable Tags.
14. Publish or Save Draft.

Users may optionally write a description to remind themselves and their teammates about some details of the key result.

Please note that parent goals will only be visible if the admin has turned on cascading goals.

If an admin has created a goal cycle, users may be asked to select a cycle that this key result falls under. This is a time period in which the goals are being worked on.

Select the date the key result is expected to start. To choose the day of creation, select Choose today.

When establishing a due date for the key result, we default to the end of the current quarter or the end of the goal cycle. Users may use the date-picker calendar to select another due date in the future. This due date can differ from the parent objective or key result.

Most goals created in the system are personal goals owned by one person. However, goals can also be owned by more than one person.

Key results can be for an individual, a group, a department, or the company. Keep in mind, the types of key results users see will depend upon the permissions an admin has granted them.

Key results can be public (visible to the entire company), private (only visible to a user, a user's manager, or the user's manager's manager), or private to selected departments (only visible to goal owners and members of the departments selected).

Users may optionally set a priority for the objective (P1-P10), which will be displayed next to the goal on certain pages throughout the site. Goals will also be listed in order of priority (P1 first).

Tags are optional but help classify and organize goals. Admins create these!

Goal drafts are visible to the owners and their managers but are not visible to the rest of the company.

If cascading goals have been enabled for the company, users will have the option to align the objective or key result to a parent goal. While the system still allows users to create independent goals that are not aligned with a higher-level goal, the cascading functionality enables users to link goals to each other with strict alignment.

Strict alignment allows the parent goal to inherit the progress of its children. Users can ensure alignment between the company's strategy and department/individual objectives by explicitly linking goals to one another.

Note that, unlike objectives, key results will not inherit the progress of other key results unless the parent key result is measured as binary.

There are at least two places in the system where a user can align an objective or key result to a parent:
Goal Creation page.
Goal Explore page.

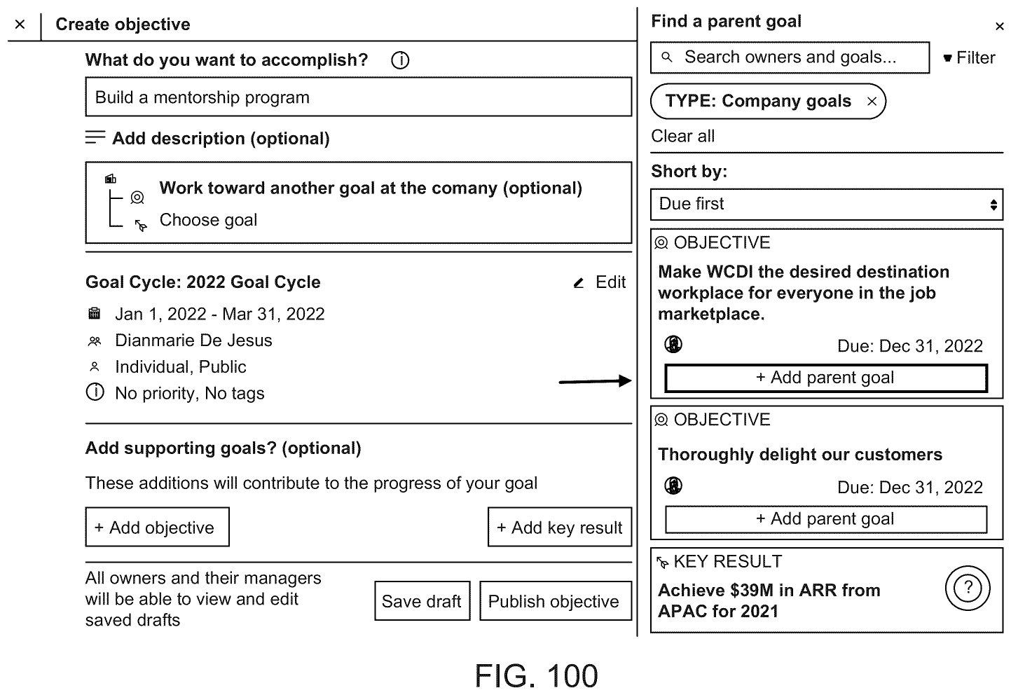

FIG. 100 is a schematic demonstrating how to navigate a user interface to align an objective or key result to a parent in the goal creation page.

The following are steps to cascade a goal from the Goal Creation page:
1. Navigate to Home>Create goal
2. Select to create an objective or key result. For a detailed walkthrough for creating an objective or key result from this page, check out Create a Goal.
3. Within the Work toward another goal at the company card, select Choose goal
4. The parent goal context panel will appear—find the desired parent goal to link by either:
   Filtering the list of goals.
   Searching for goal owners.
   Searching for goal titles.
   Selecting one of the recommended filters (Company goals, Department goals, My Manager's goals).
5. Click+Add parent goal to align.

Aligning Supporting Goals

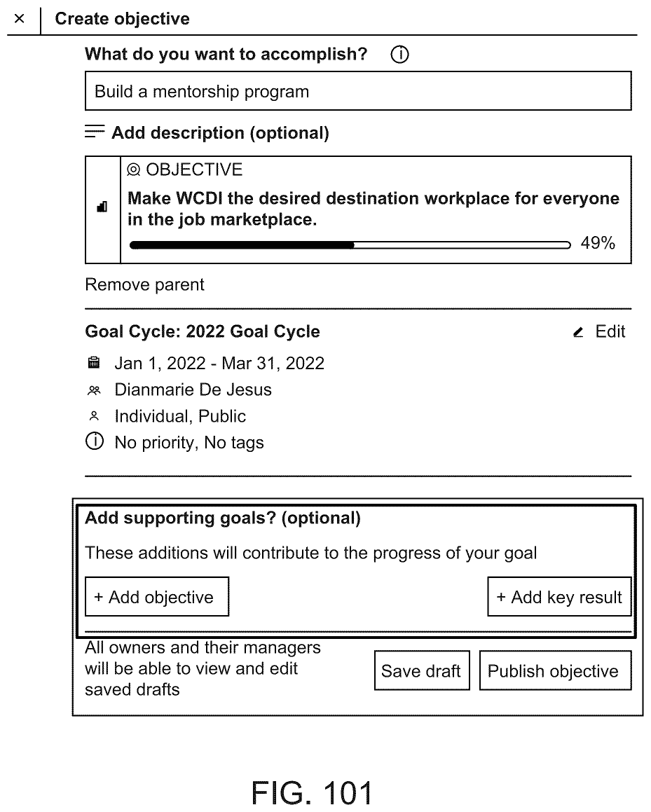

FIG. 101 is a schematic of a user interface displaying the option to add supporting goals to a parent goal in the goal creation page.

Under Add supporting goals?, users can create objectives or key results that will support and align with the goal. These will be considered the child goals. The progress of these child goals will contribute to the success of the goal. The goal will be viewed as the parent to these child goals.

Add supporting goals by selecting+Add objective or +Add key results.

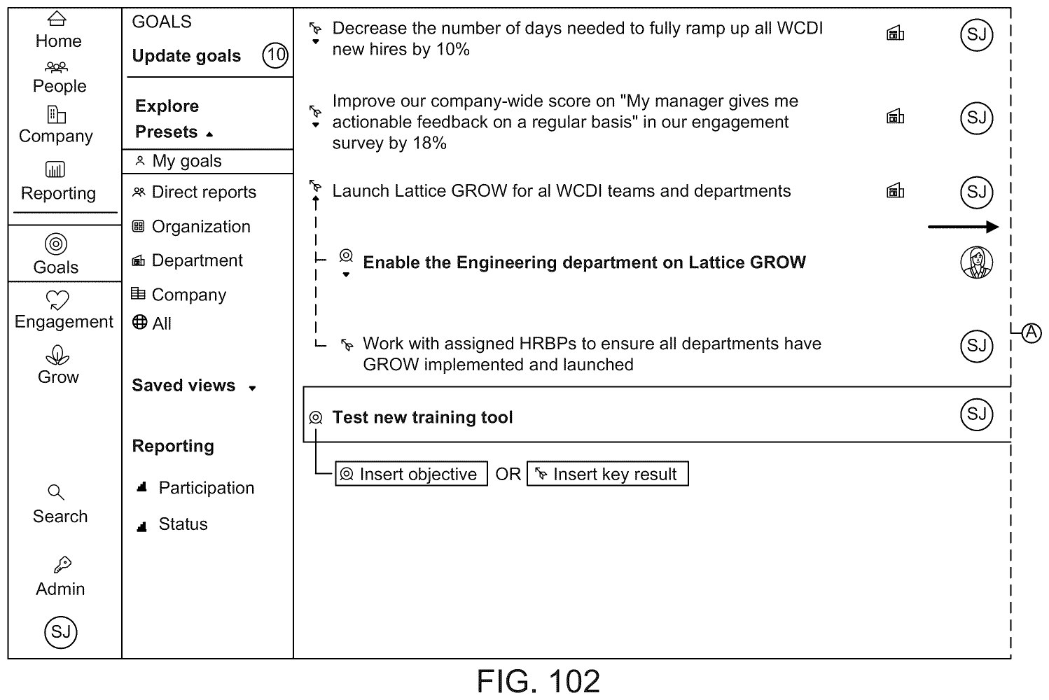

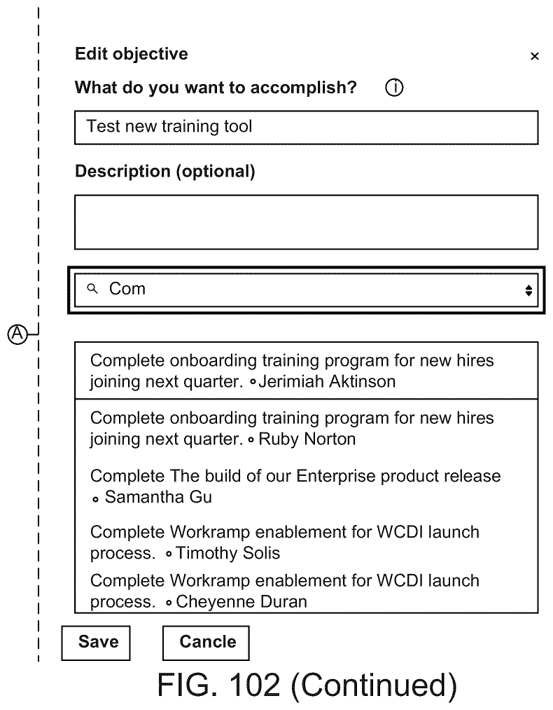

FIG. 102 is a schematic demonstrating how to navigate a user interface to add a parent goal within the goals explore page.

The following are steps to add a parent goal from the Goals Explore page:
1. Navigate to the Goals page.
2. Next to the Export CSV button, select and enter the Cascade view.
3. Click on the desired goal.
4. Within the goal context panel, select More>Edit.
5. Click on the Search for a goal . . . bar, to search and select the parent goal.
6. Click Save.

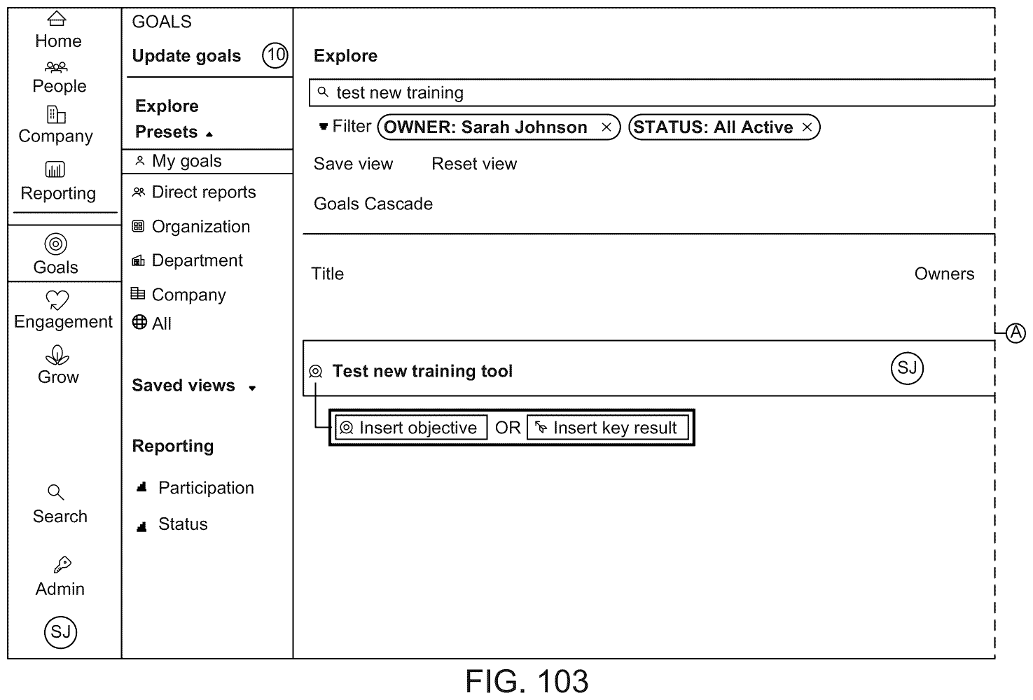

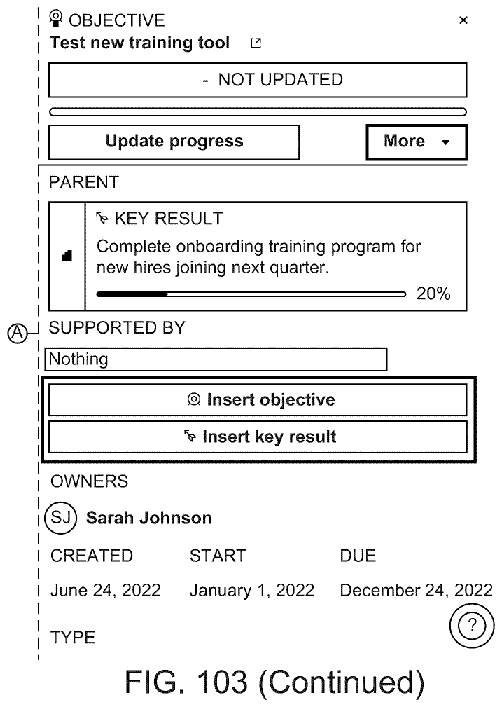

FIG. 103 is a schematic demonstrating how to navigate a user interface to create a supporting goal from the goal explore page.

The following are steps to create a supporting goal from the Goals Explore page:
1. Navigate to the Goals page
2. Next to the Export CSV button, select and enter the Cascade view.
3. Click on the desired goal.
4. Click Insert objective or Insert key result to select the supporting goal to align to their goal.
5. Create the supporting goal and select Publish.

Publish a Goal Draft

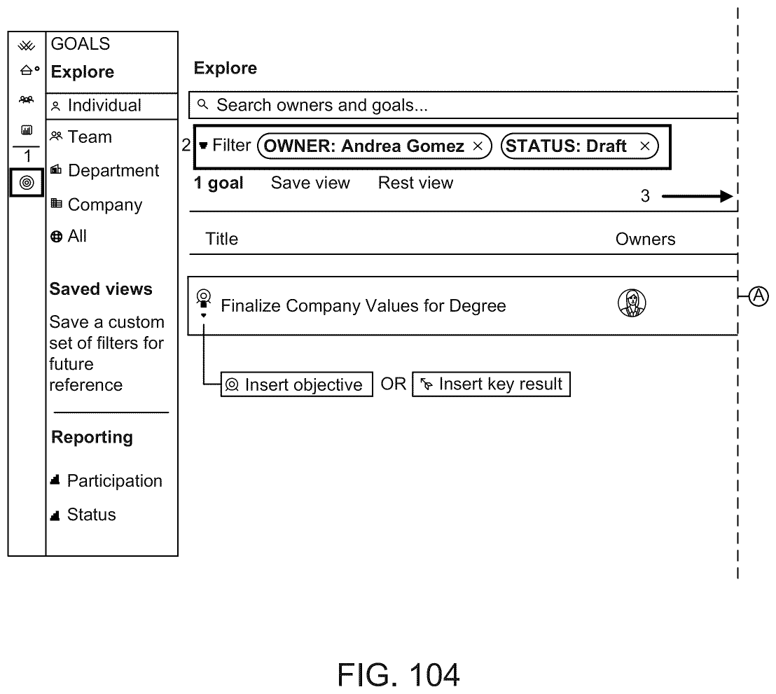

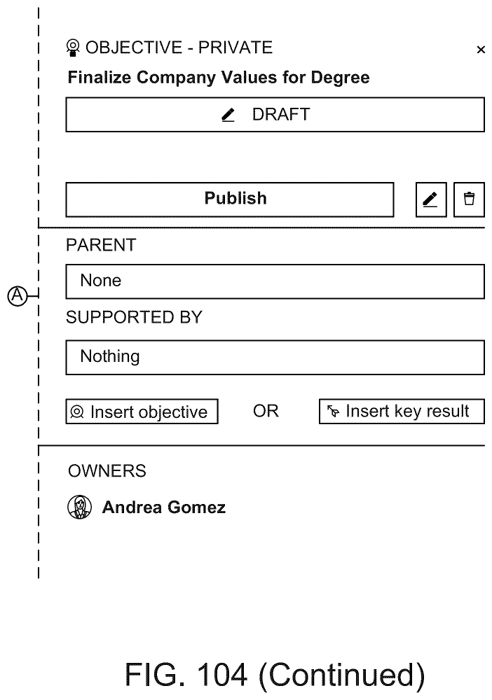

FIG. 104 is a schematic demonstrating how to navigate a user interface to publish a goal draft.

When creating a goal, users can save it as a draft to publish for later. Draft goals can be published at any time using the steps below:
1. Navigate to the Goals page and filter by Status>Draft.
2. Click on the desired draft goal to open the goal context panel.
3. A confirmation popup will appear—click Publish.

After publishing, users can begin tracking progress or also continue to edit the published goal.

Goal tags are a great way to group and organize the goals around significant initiatives or projects. When creating a goal, the account admin may have added tags that users can use to categorize the goal into a specific bucket. Learn how to add a tag to a goal below.

Only admins can create tags; managers and individuals cannot create tags

Add a Tag to a Goal

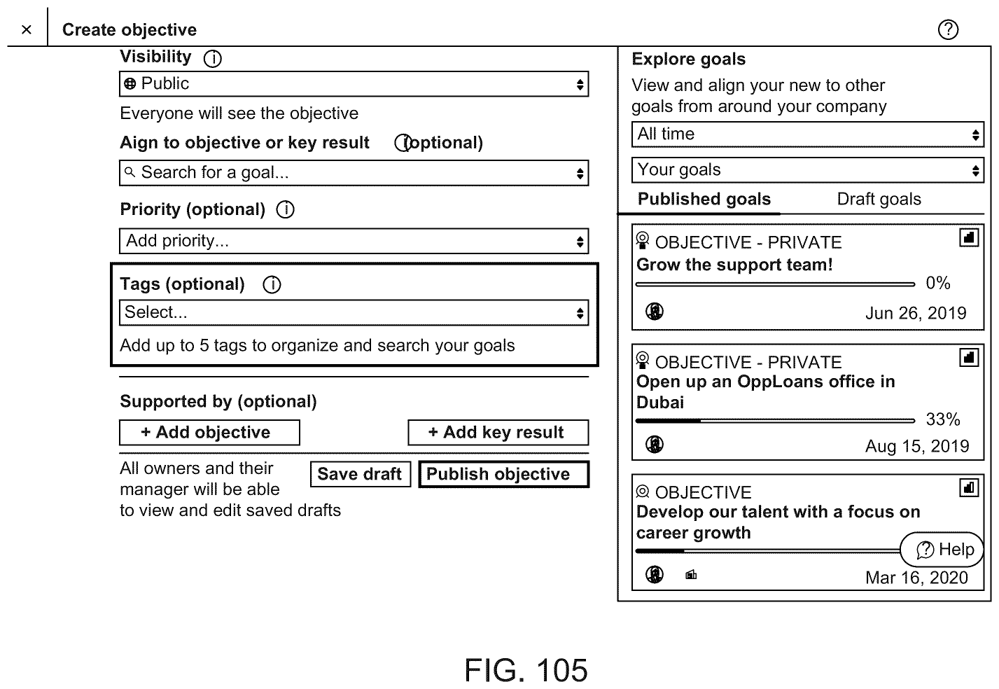

FIG. 105 is a schematic of a user interface displaying the objective creation page including a drop-down box to select tags for a goal.

The following are steps to add a tag to a goal:
1. Create a goal.
2. Under Change details>Tags, select up to 5 tags to organize the goals.

Note: If the account admin has made tags required, the Tags dropdown can be accessed via the goal creation main page.

View Tags

After goals tags have been created and are in use, they will be grouped on the People page. Users can view them by entering Company>Goals>Tags.

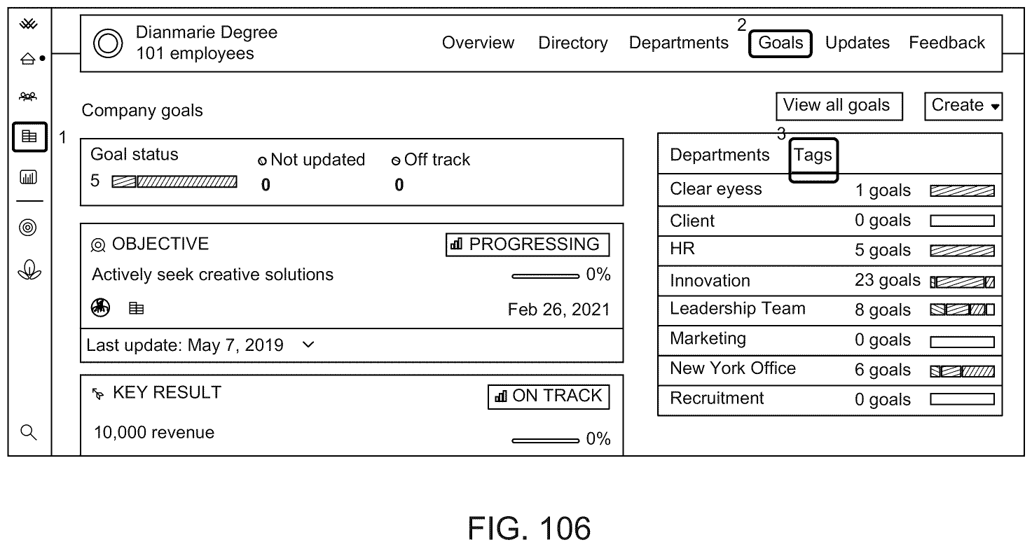

FIG. 106 is a schematic demonstrating how to navigate a user interface to view tags from the people page.

The system's Jira integration allows users to connect their system goals and have them automatically update progress when Jira is updated. Jira syncs with the system at the start of the hour, if there have been any updates, the goal's progress will be updated.

Connect Jira to a Goal

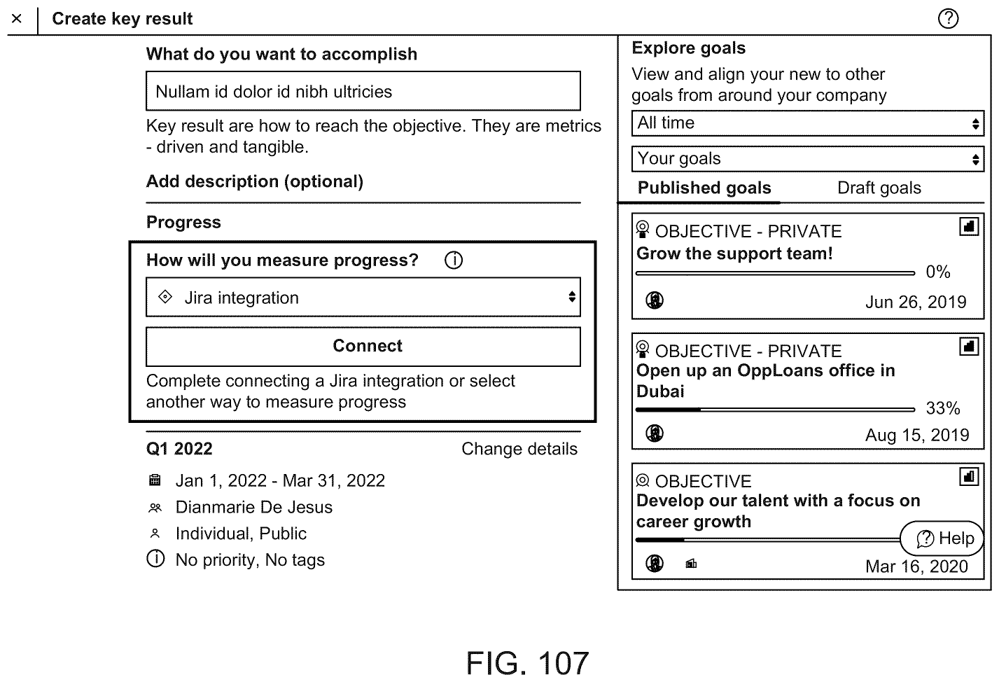

FIG. 107 is a schematic of a user interface displaying a create key result page with the option to select Jira Integration to measure progress.

The following are steps to connect Jira to a goal:
1. From the Home page, select Create goal>Key result.
2. Under How will you measure progress?, select Jira Integration and Connect.
3. Run a JQL Query within the textbox and Search.
4. A preview will appear—click See all [number] issues in Jira to confirm the query is correct. Select Next.
5. Select how to track progress and insert a Start and Target amount.
6. Connect and continue to create the goal.

If users come across a search error, note that they may not be searching using proper JQL.

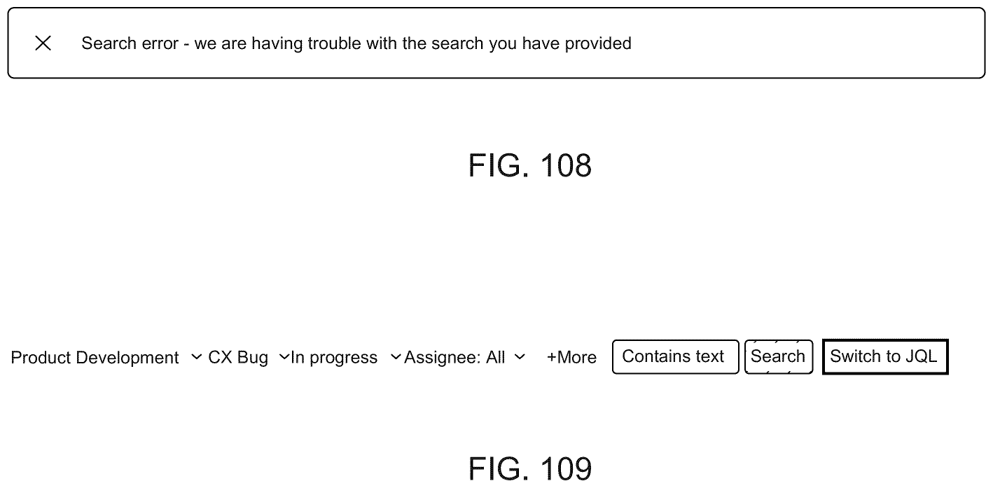

FIG. 108 is a schematic of a user interface displaying a search error.

FIG. 109 is a schematic of a user interface displaying the option to switch to JQL for a search.

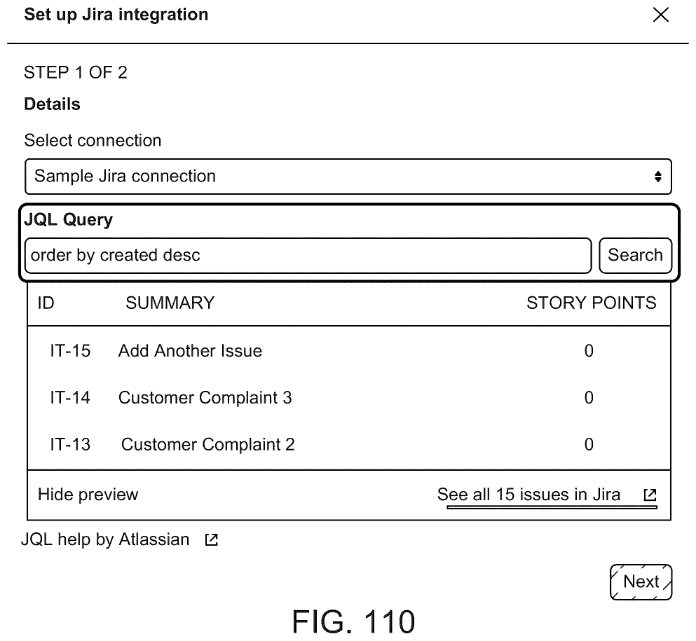

FIG. 110 is a schematic of a user interface displaying a Jira set up page containing a list of issues in Jira based on a JQL query.

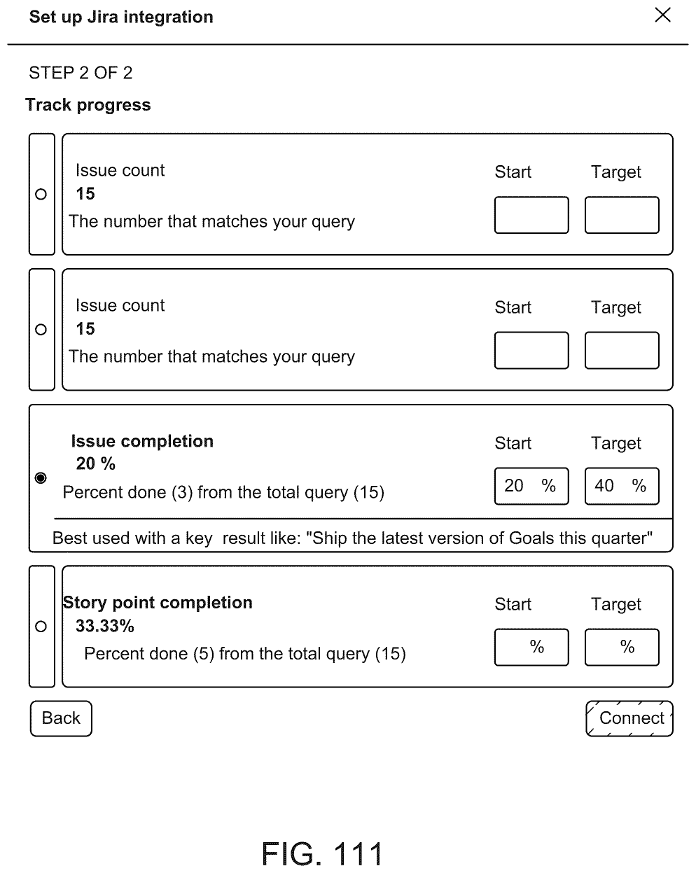

FIG. 111 is a schematic of a user interface displaying a Jira set up page containing options to designate start and target amounts for a list of issues.

The following is a list of progress types:
Issue count: The total number of issues within the query.
Story point count: The total number of story points within the query.
Issue completion: The % of issues completed within the query.
Story point completion: The % of story points completed due to completed issues within the query.

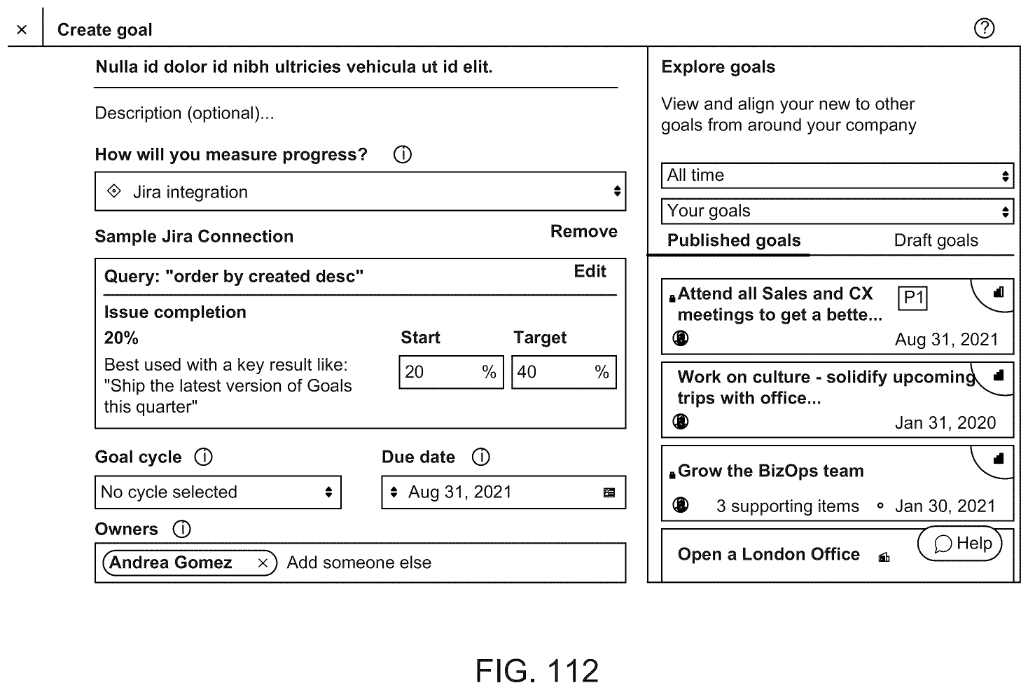

FIG. 112 is a schematic of a user interface displaying a goal creation page after Jira has been integrated.

The system's Jira integration allows users to connect their system goals and have them automatically update progress when Jira is updated. Users may want to disconnect the Jira connection if they find the query is no longer relevant or if they want to manually update the goal in the system.

Disconnecting Jira from a goal will stop all automatic updates and progress. Once disconnected, the goal will need to be updated manually from this point forward.

Disconnect Jira

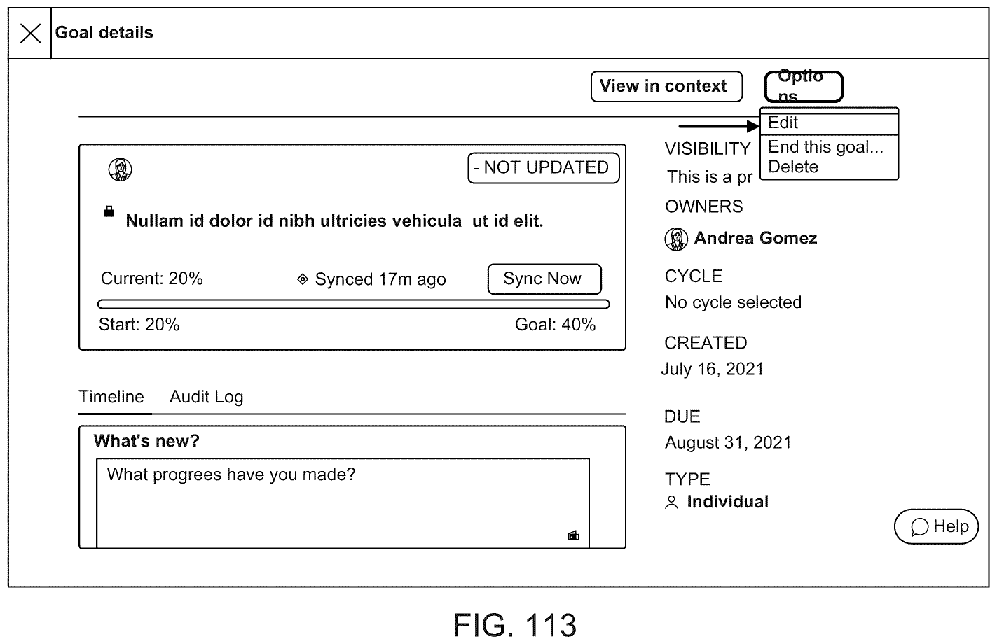

FIG. 113 is a schematic demonstrating how to navigate a user interface to disconnect Jira from a goal.

The following are steps to disconnect Jira from a goal:
1. From the Goal page, navigate and click on the desired goal.
2. Click on the arrow to expand the goal.
3. Select Options>Edit to be taken to the goal editor.
4. Under How will you measure progress?, select Remove.
5. A confirmation popup will appear—select Disconnect.

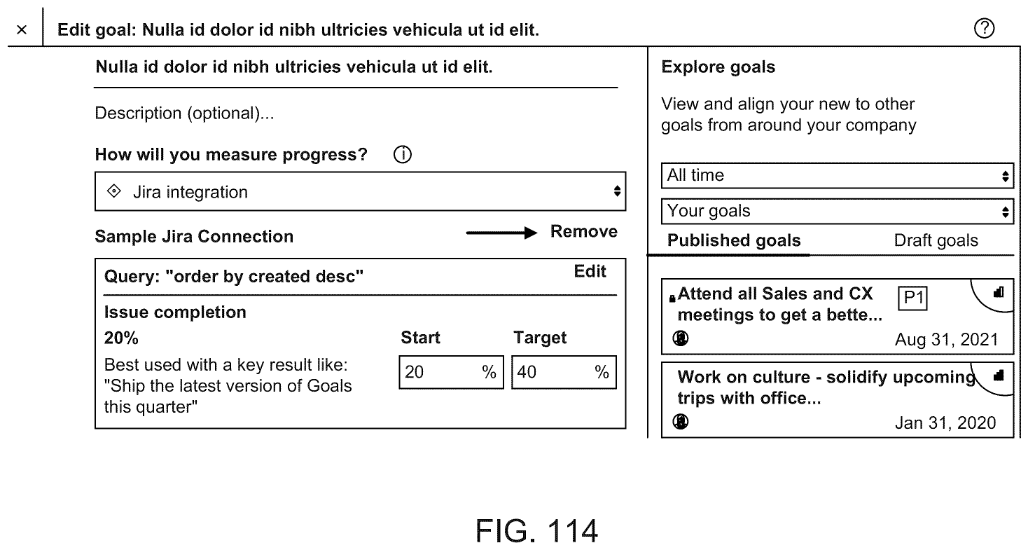

FIG. 114 is a schematic of a user interface displaying an edit goal page containing the option to remove Jira Integration from the goal.

Weighted goals allow goal owners to customize and communicate the relative importance of each child goal and key result. Owners can customize how much each child impacts its parents' progress across multiple levels.

There are at least two places a goal owner can change the weight of their key results:
After publishing a goal
From the Goals page.

Applying Custom Weighting after Publishing a Goal

Goal owners will have the opportunity to set custom weighting immediately after their goal has been published. Please note, custom weighting is only available for goals with a binary parent.

The following are steps to apply custom weighting after publishing a goal:
1. Publish the goal.
2. A confirmation popup will appear the key results will be weighted equally by default. To edit, select Edit weights.
3. Insert the weight distribution for each goal under the Weight column on the right-hand side
4. Click Save.

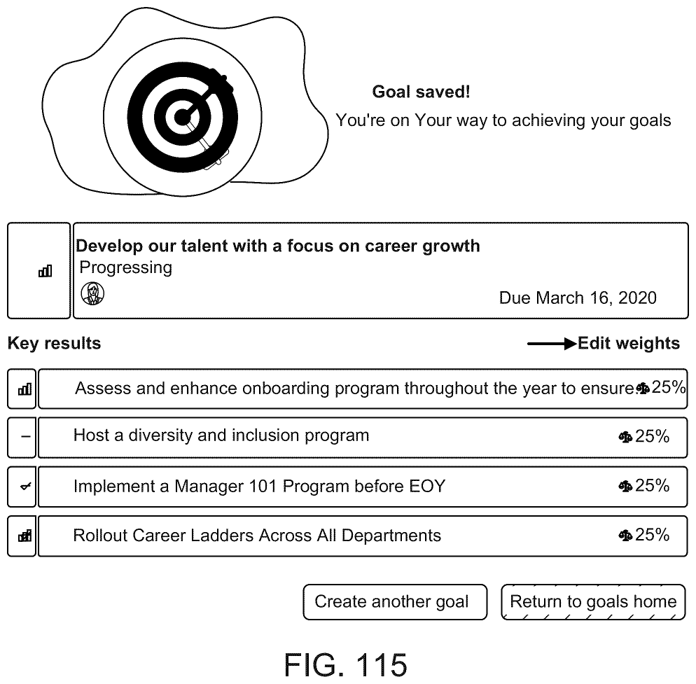

FIG. 115 is a schematic of a user interface displaying a confirmation popup containing equally weighted key results for a goal.

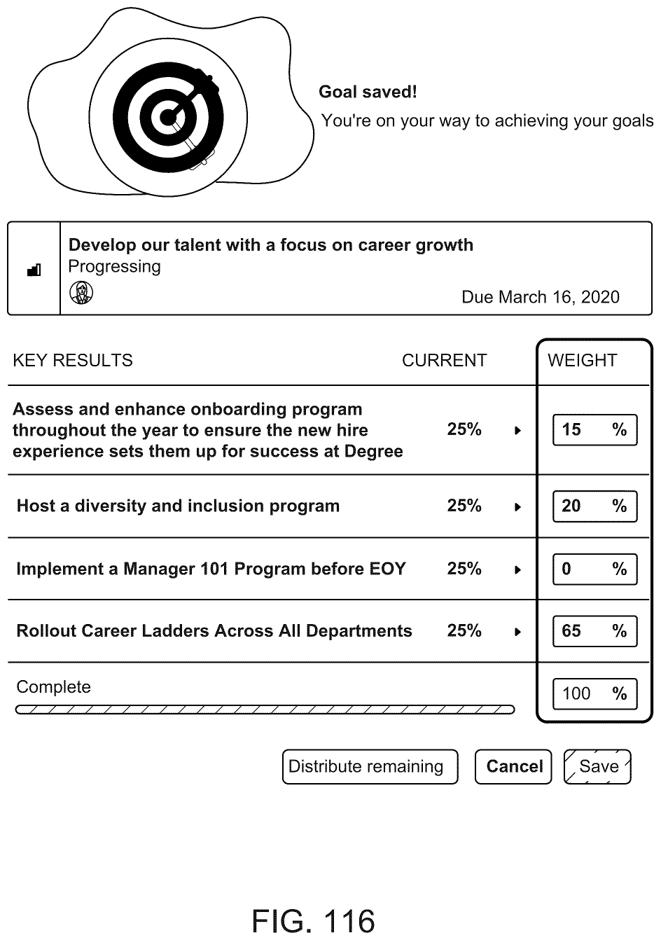

FIG. 116 is a schematic of a user interface displaying a confirmation popup containing unequally weight key results for a goal.

After setting the desired weight for a specific key result, the Distribute remaining button allows users to distribute quickly and evenly to all other key results. For example, Andrea, the goal owner below, is certain she wants to have her “Hire I assistant to the Director of BizOps” key result to be weighed at 20%, with the rest of the percent weights being measured evenly across the rest of her key results.

Here, she will enter 20% for her desired key result and leave all other fields blank. Then, she will select Distribute remaining.

This will distribute the remaining 80% evenly across key results.

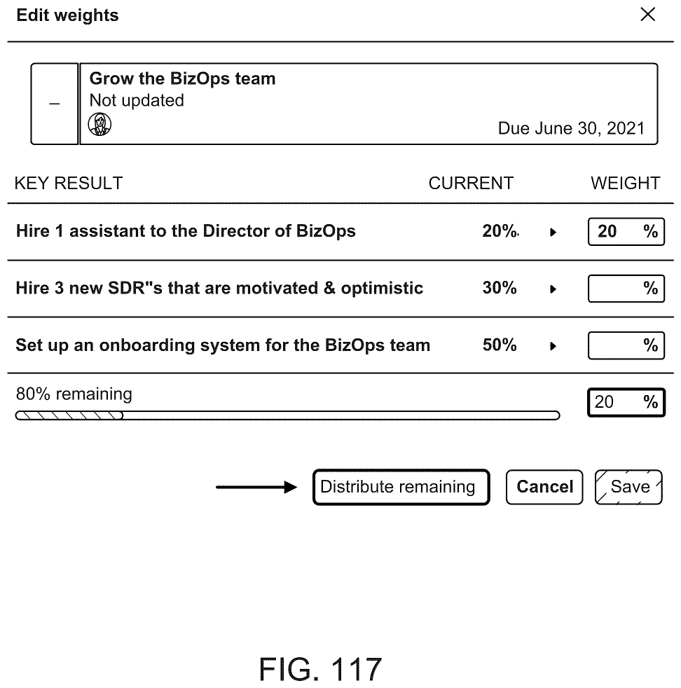

FIG. 117 is a schematic of a user interface displaying a confirmation popup containing one key result with a weight, and the option to distribute remaining weights evenly to the other key results.

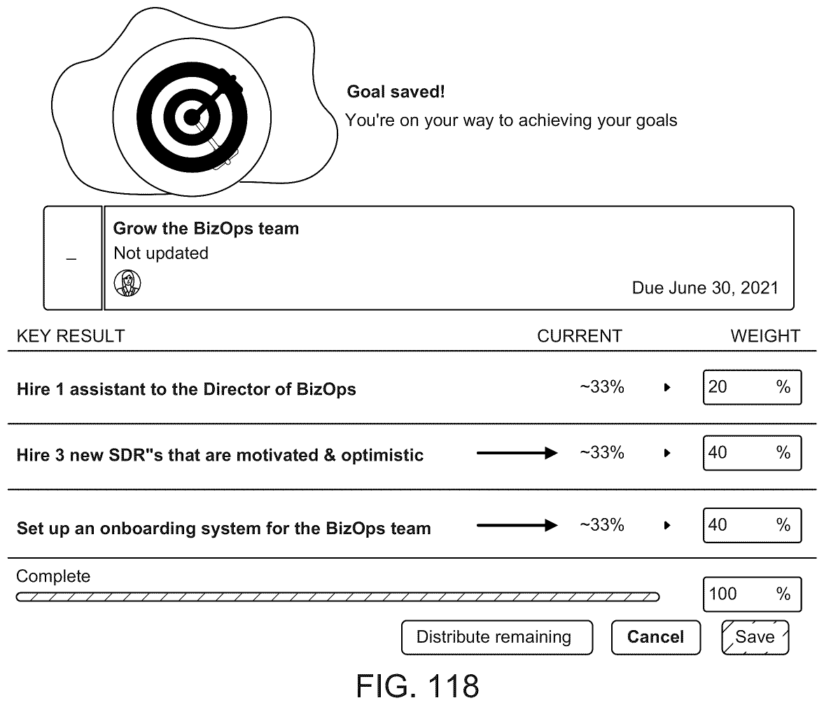

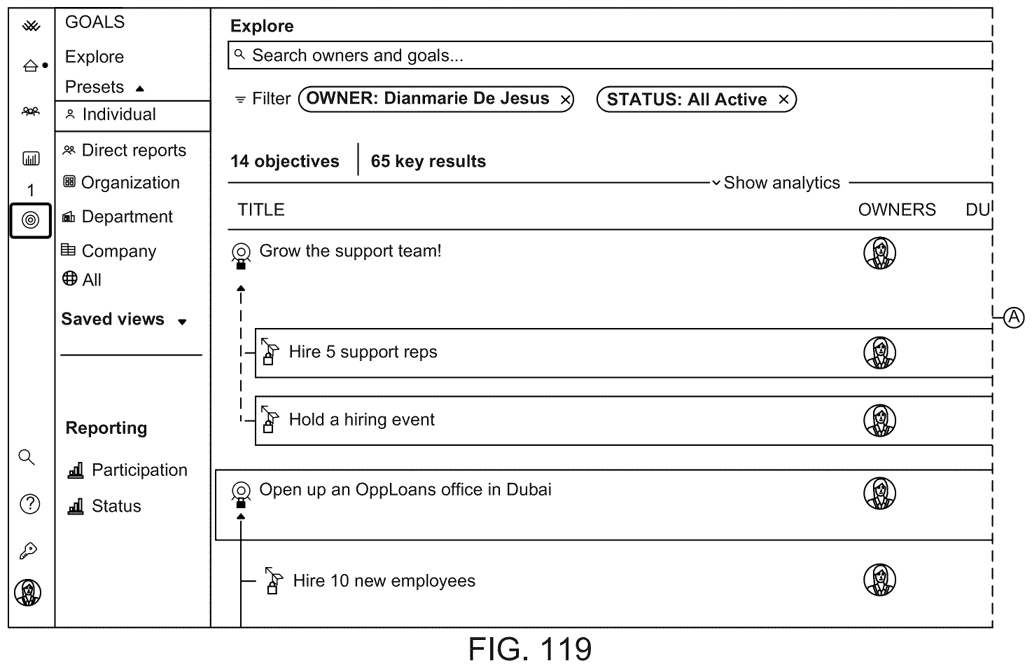

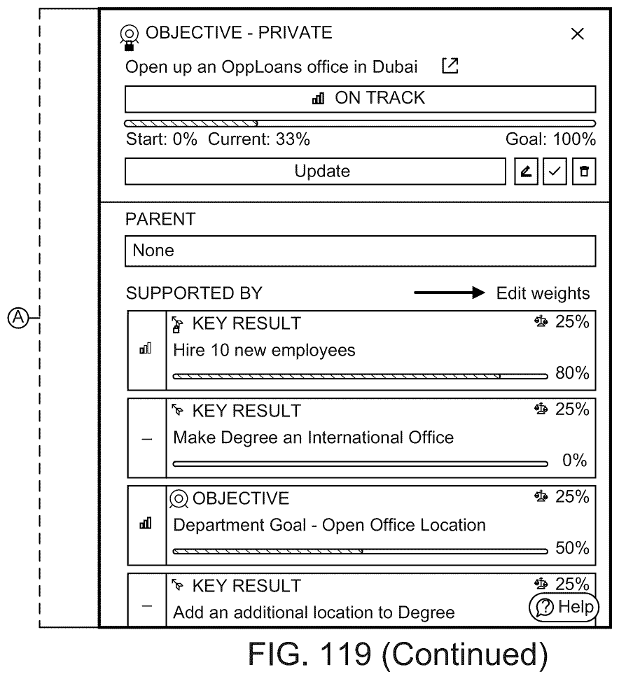

FIG. 118 is a schematic of a user interface displaying a confirmation popup containing key results after remaining weights have been distributed.

Applying Custom Weighting from the Goals Page

FIG. 119 is a schematic demonstrating how to navigate a user interface to edit custom weights from the goals page.

Goal owners can edit custom weights directly from the Goals page. To do this:
1. Select Goals on the discovery navigation.
2. Find and click on the goal to edit to open the context panel.
3. Select Edit weights.
4. The exact editing weights modal shown in FIG. 119 will appear. Here, users can make edits and Save.

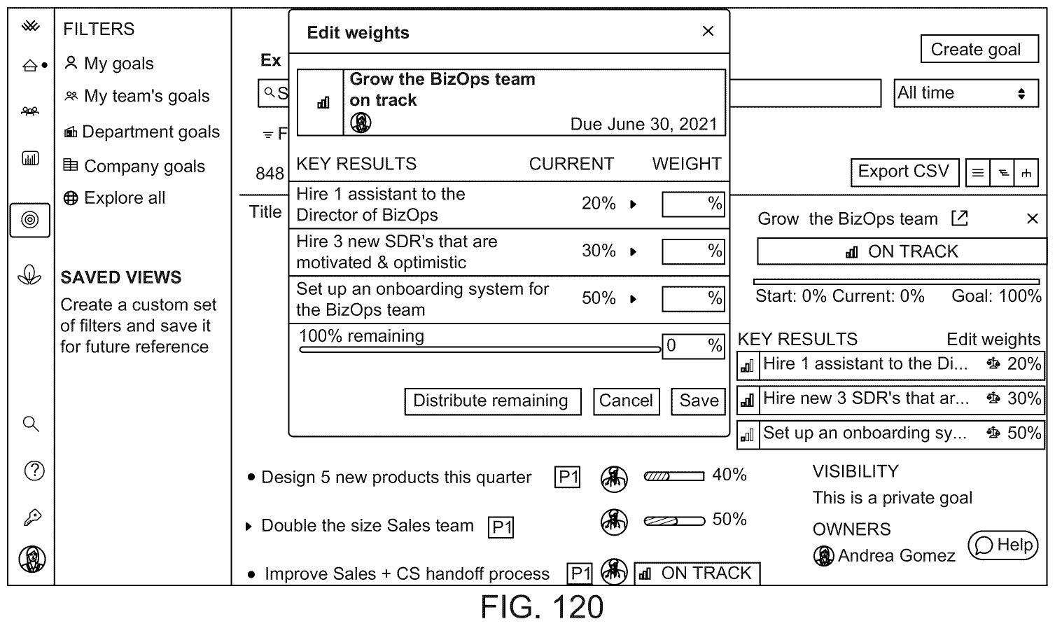

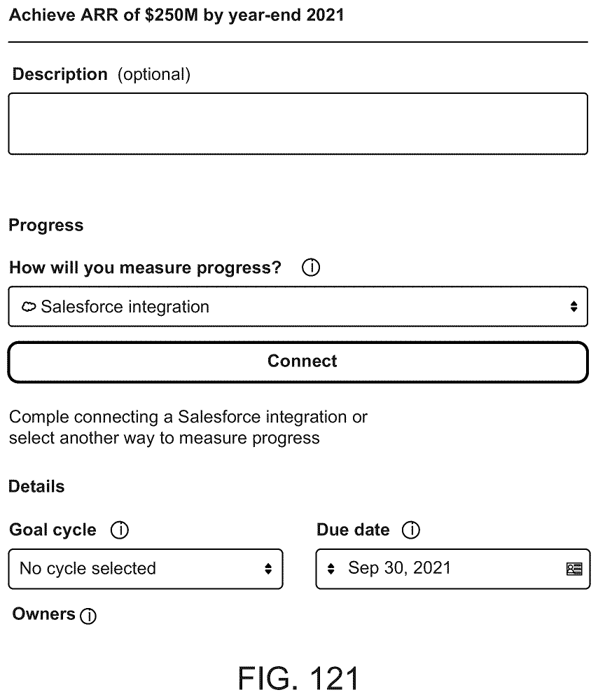

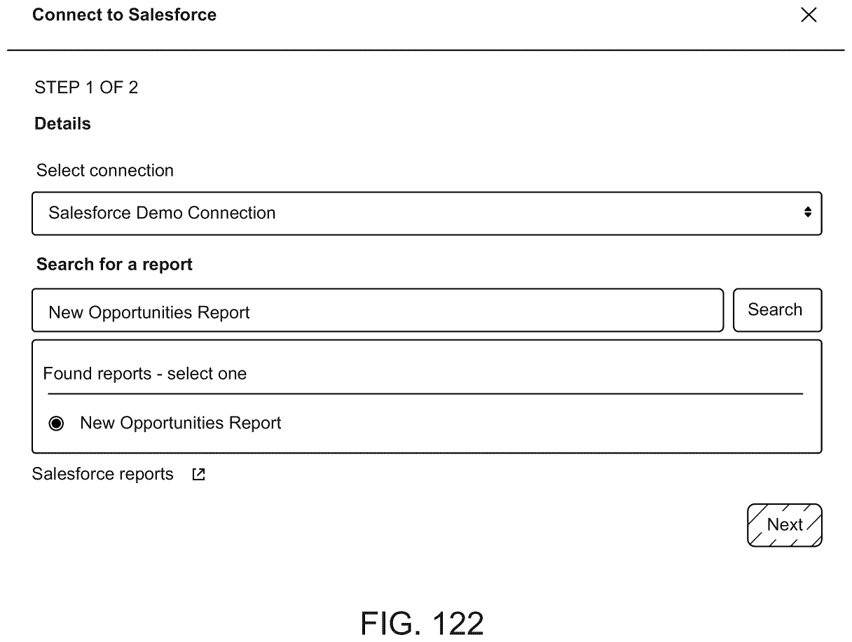

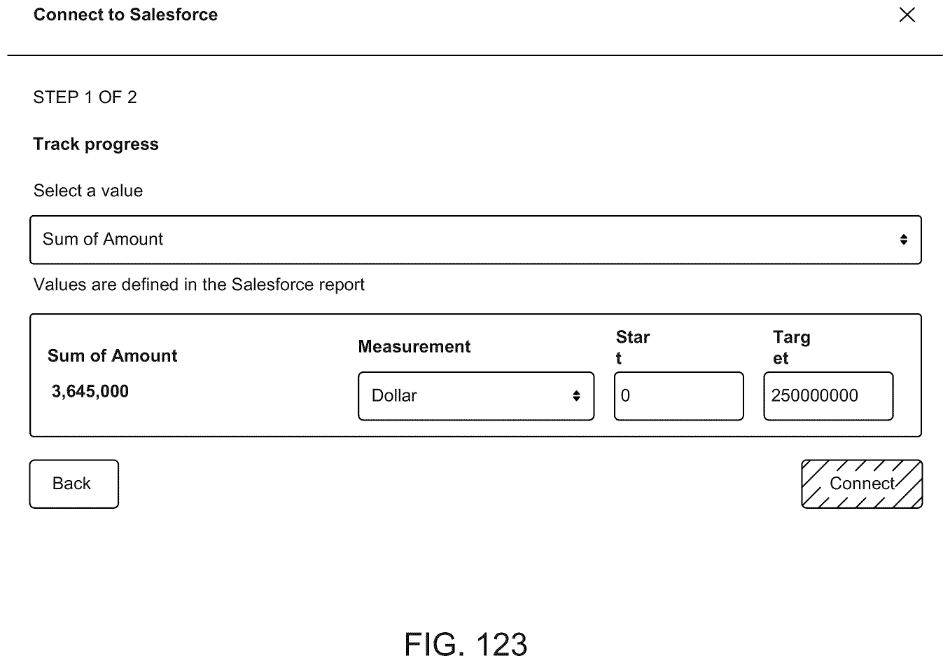

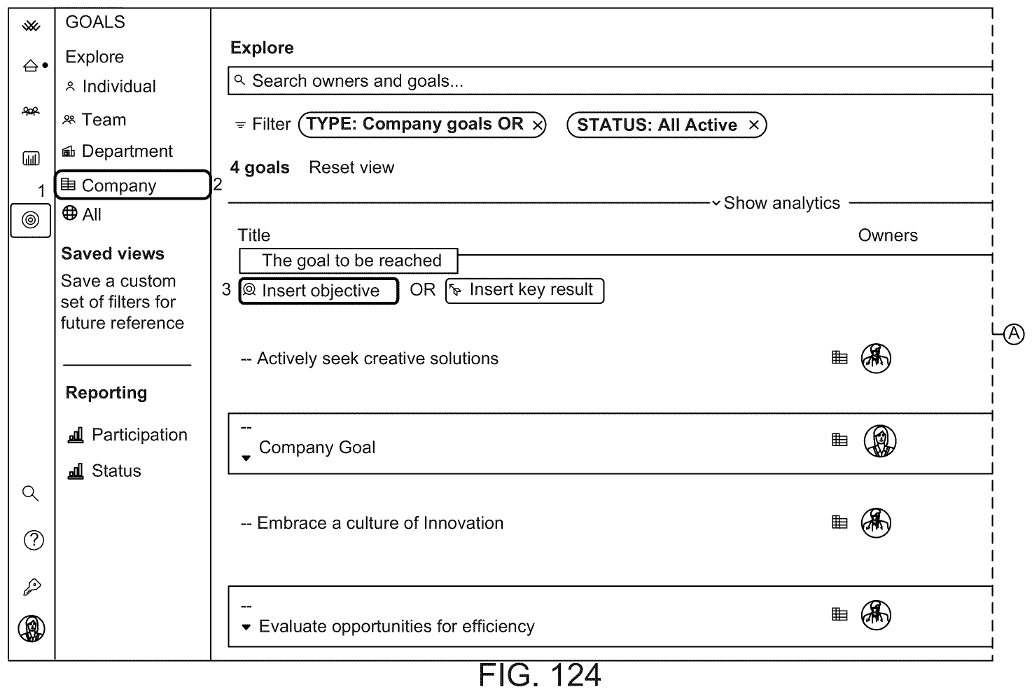

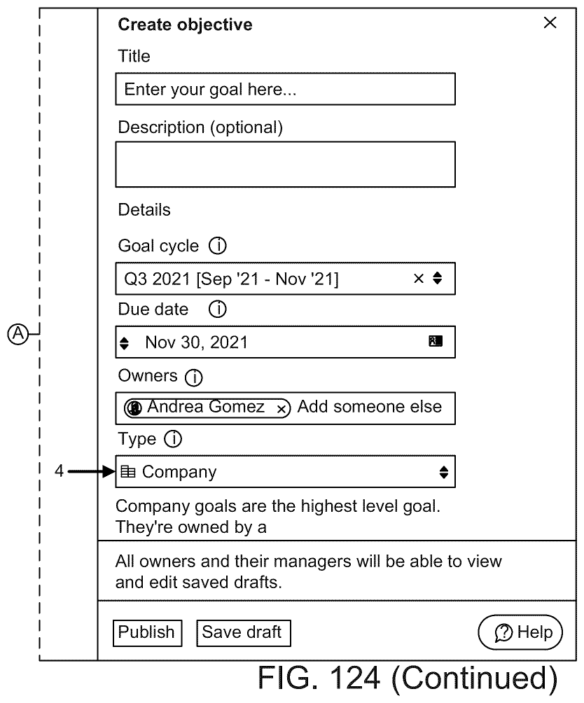

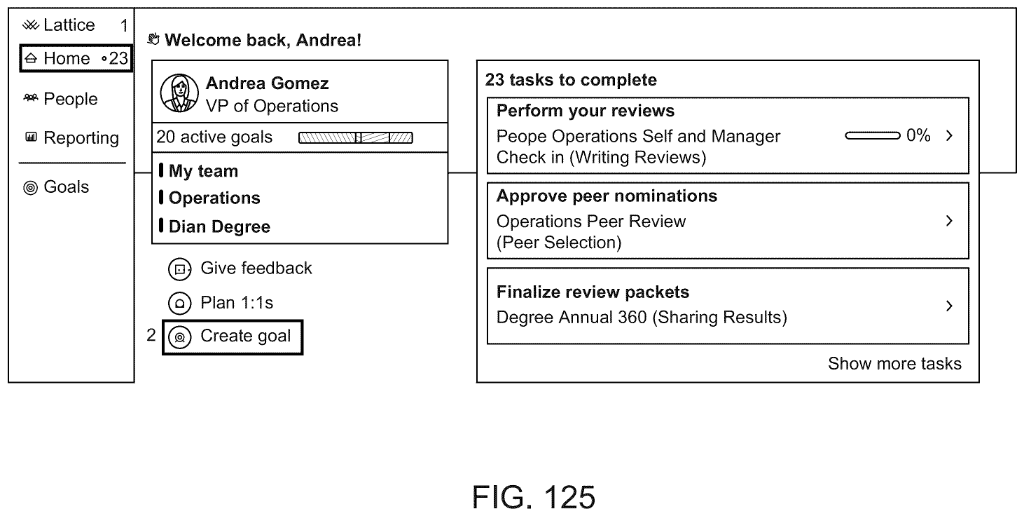

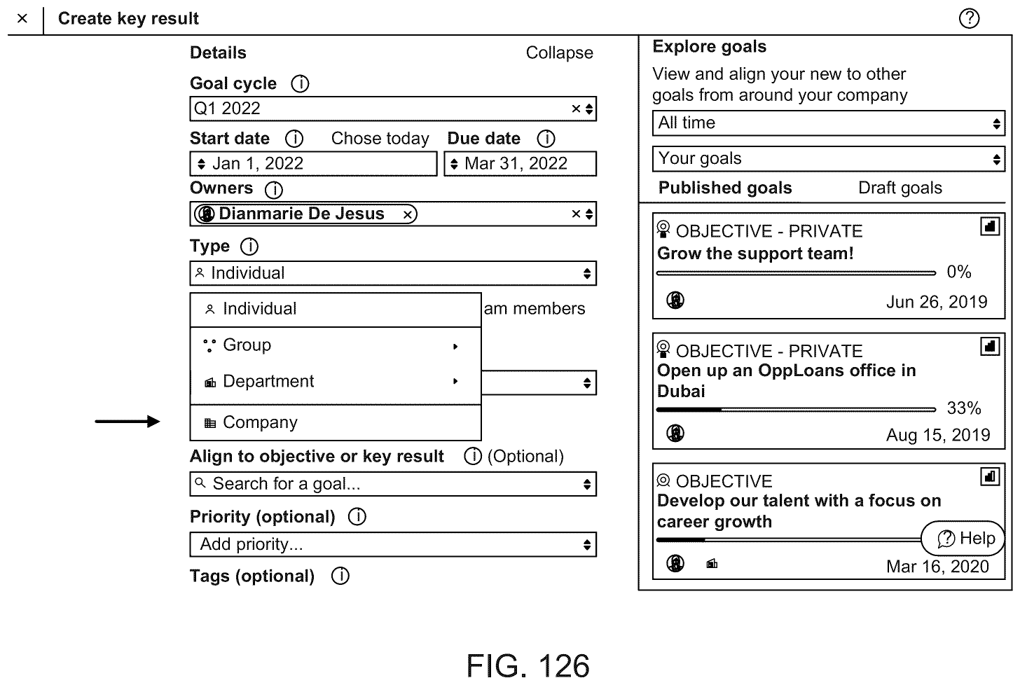

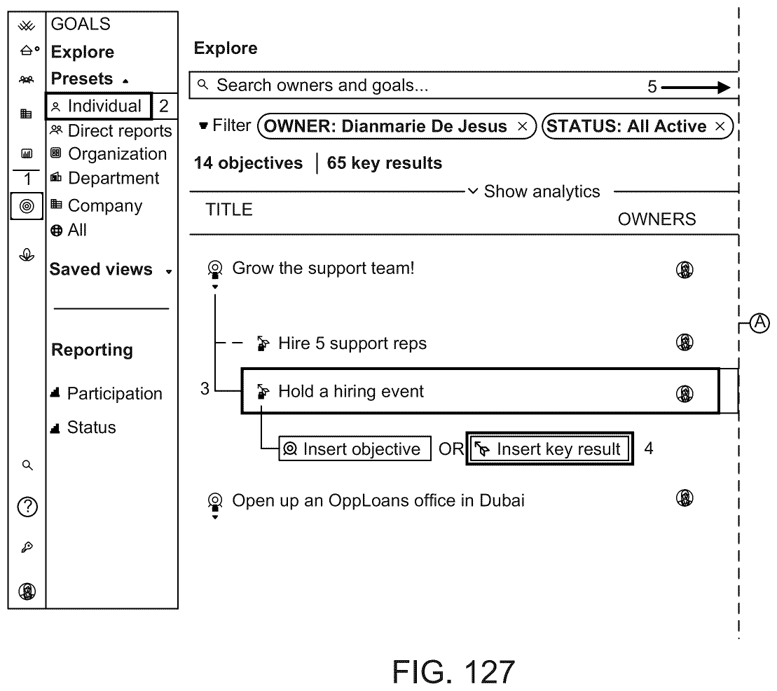

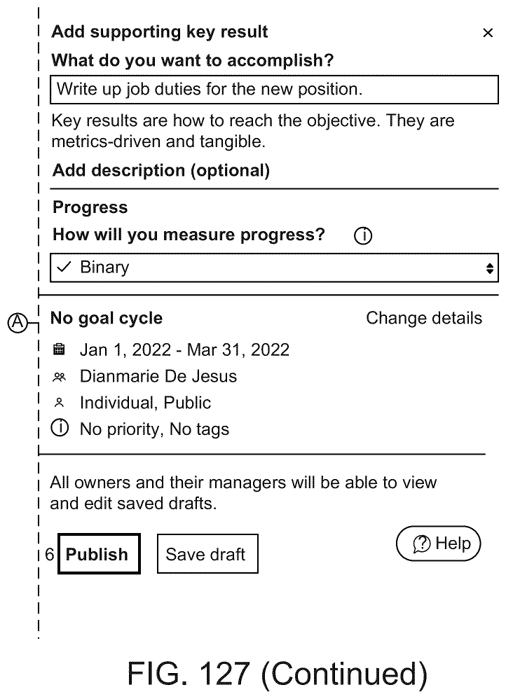

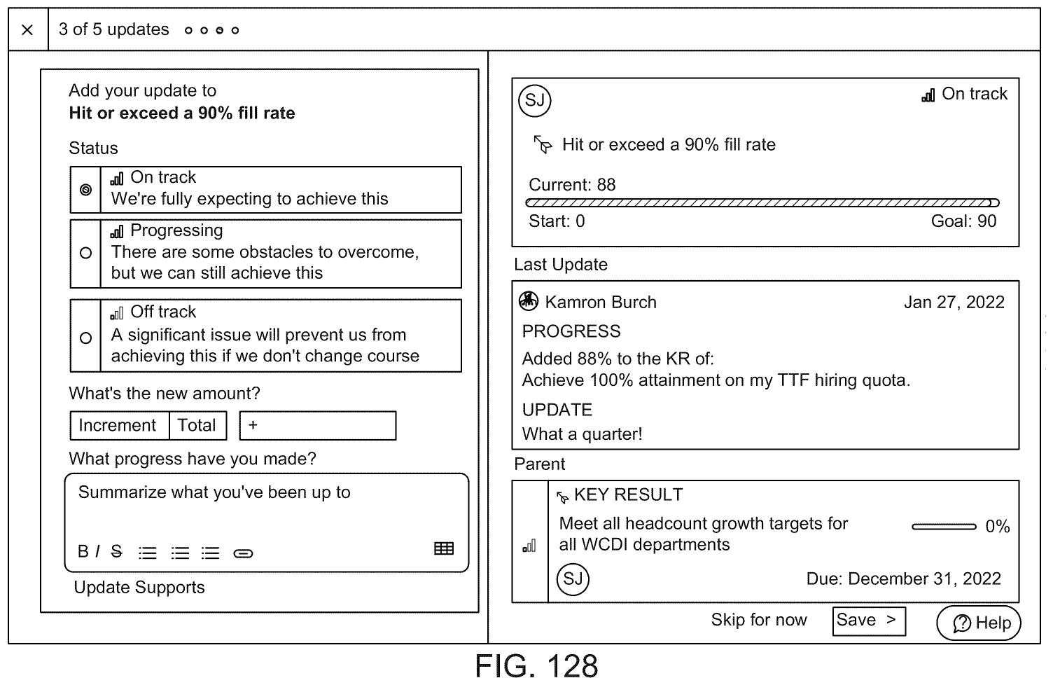

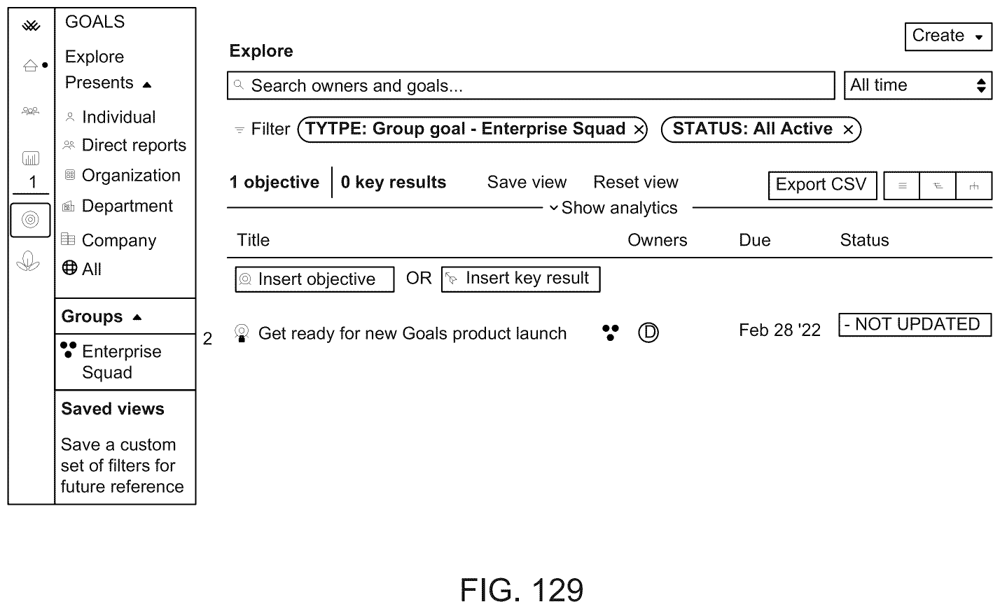

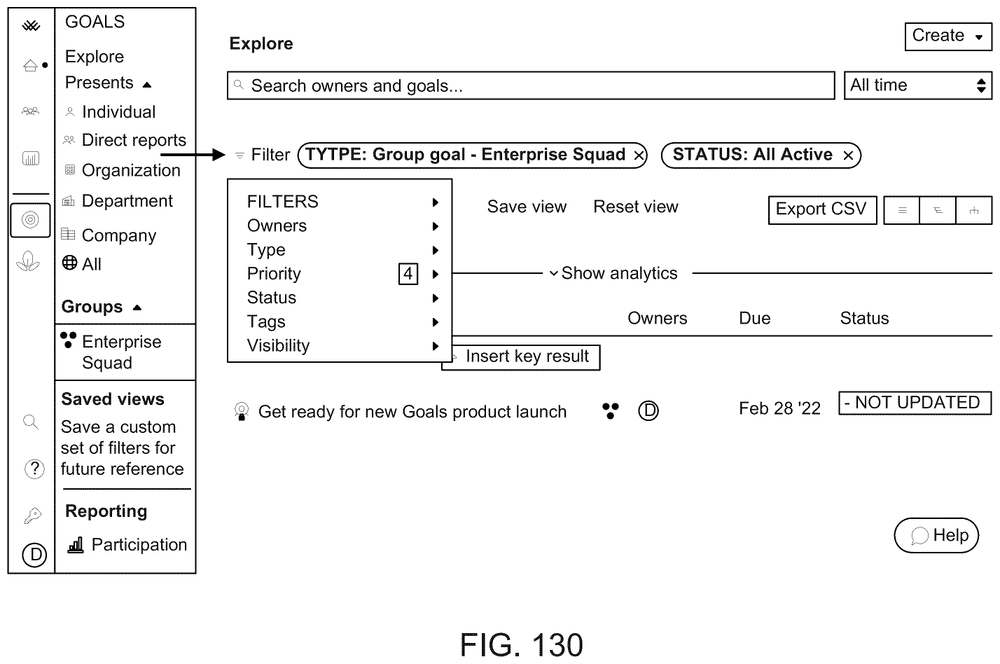

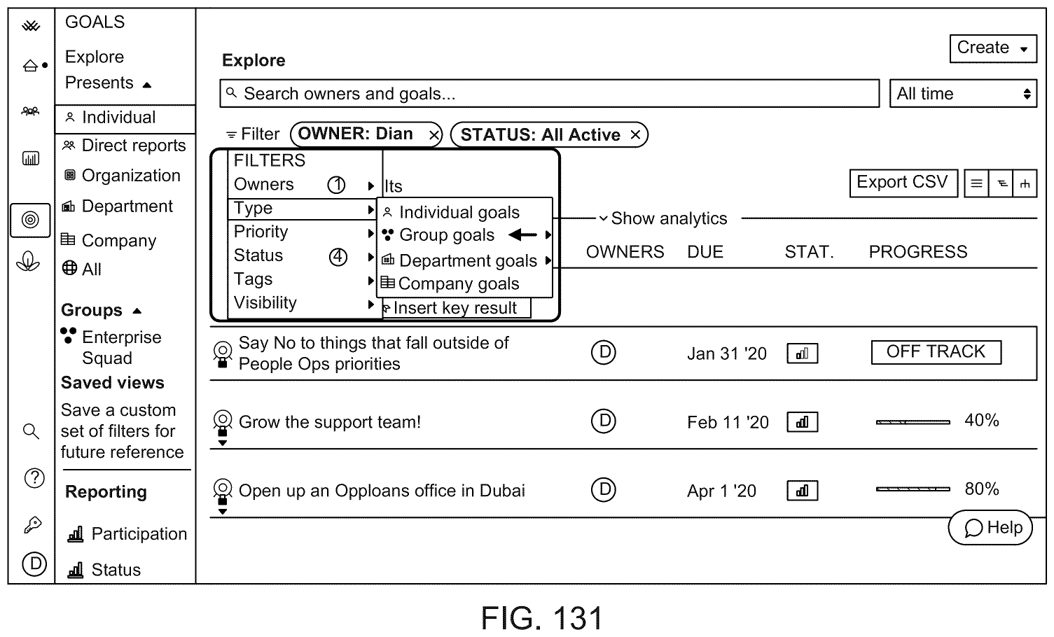

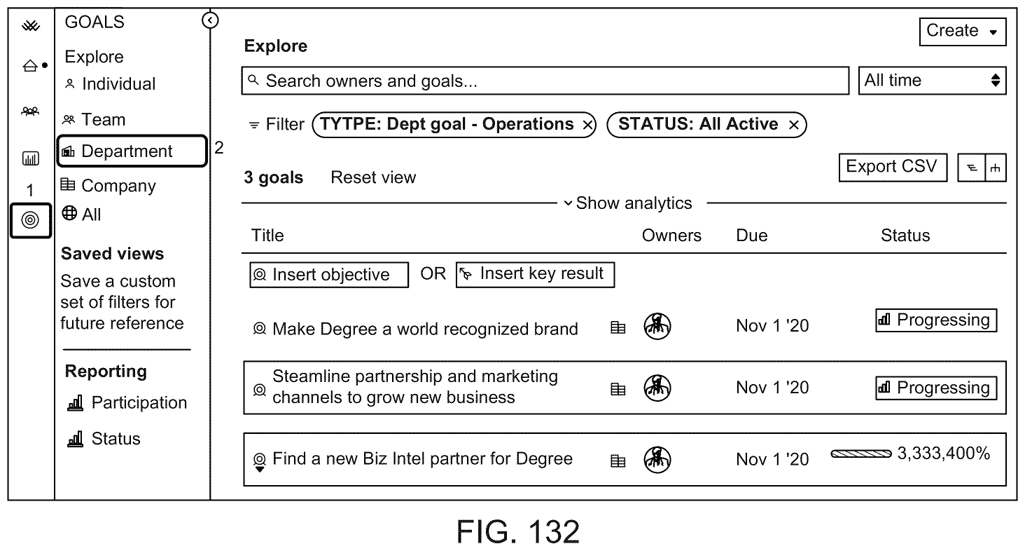

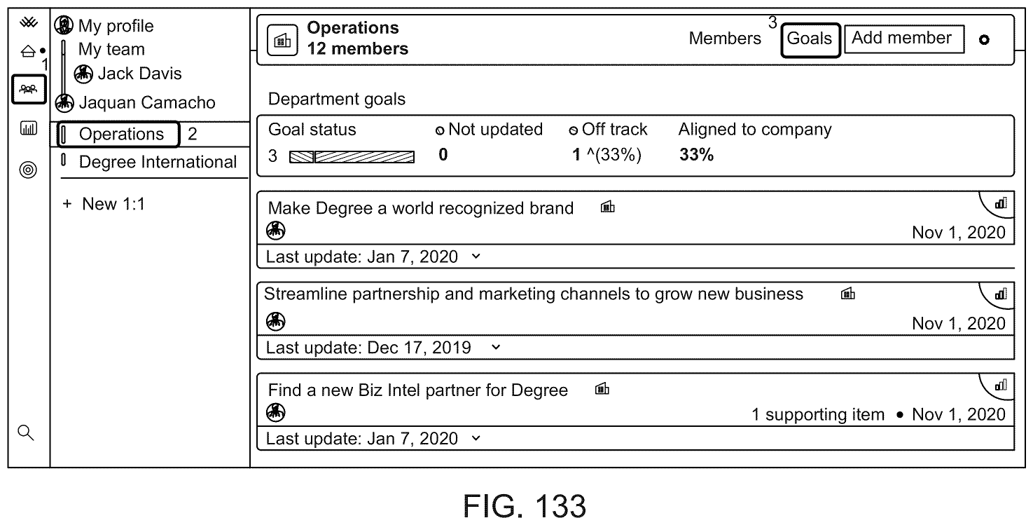

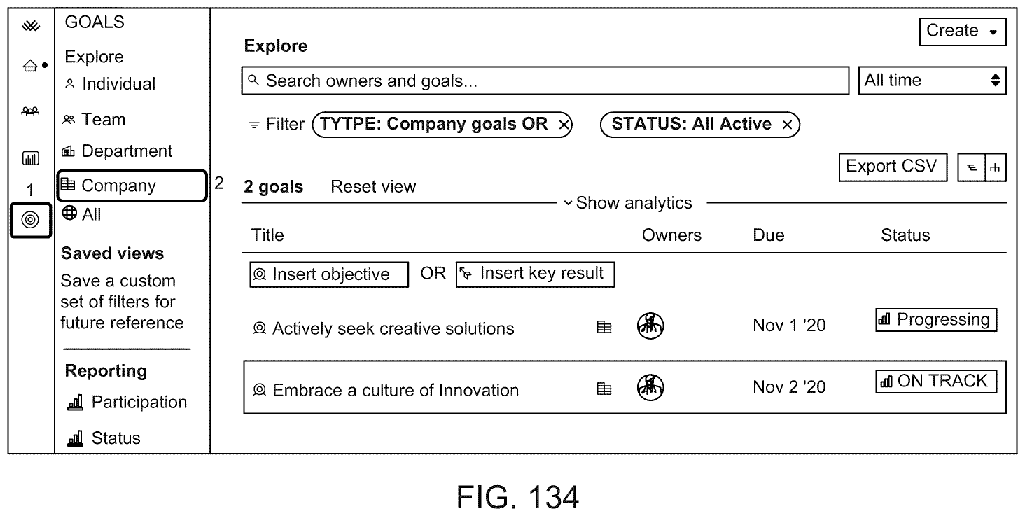

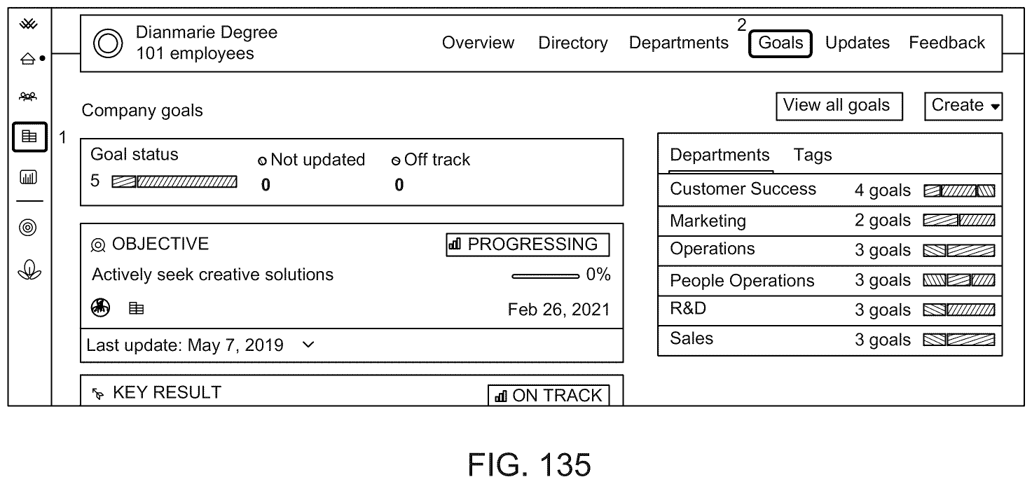

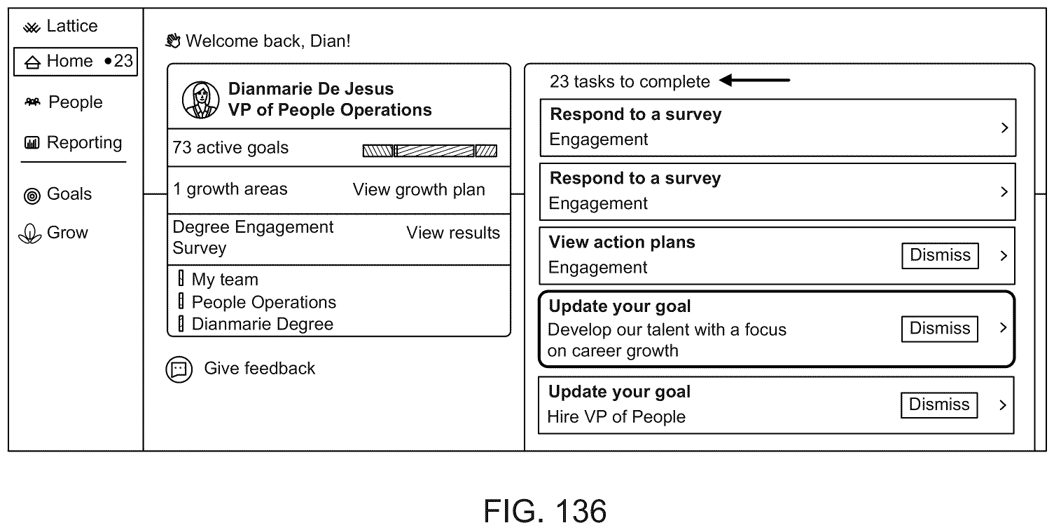

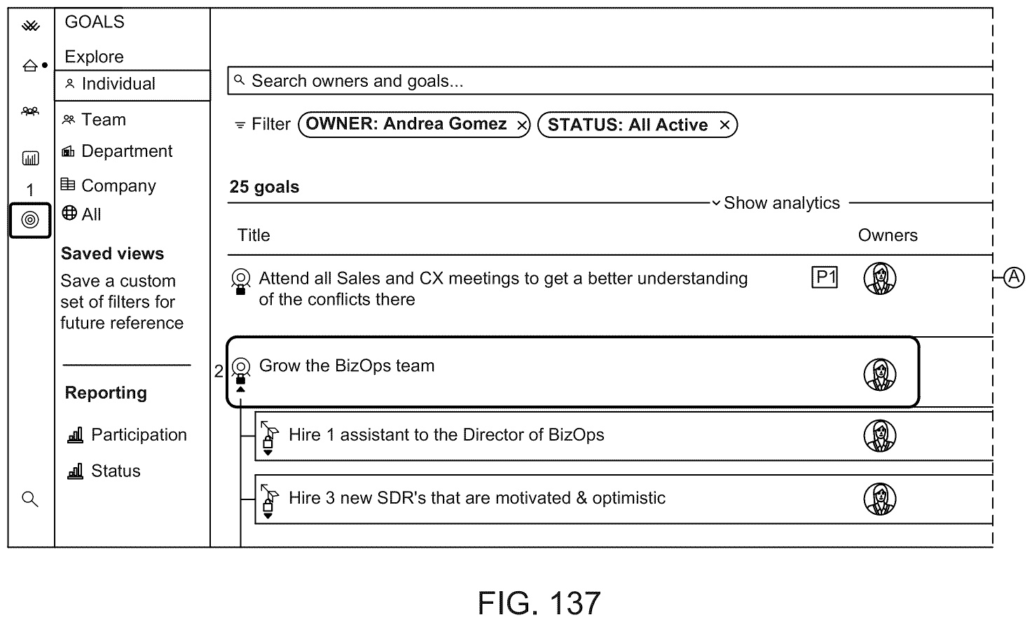

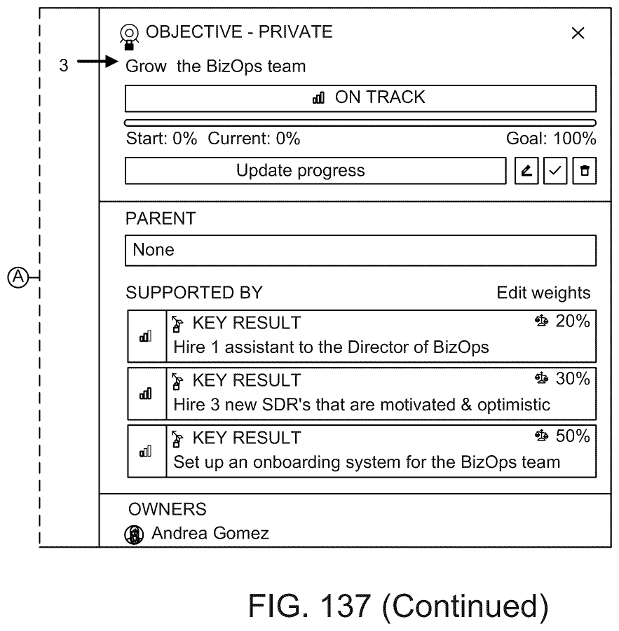

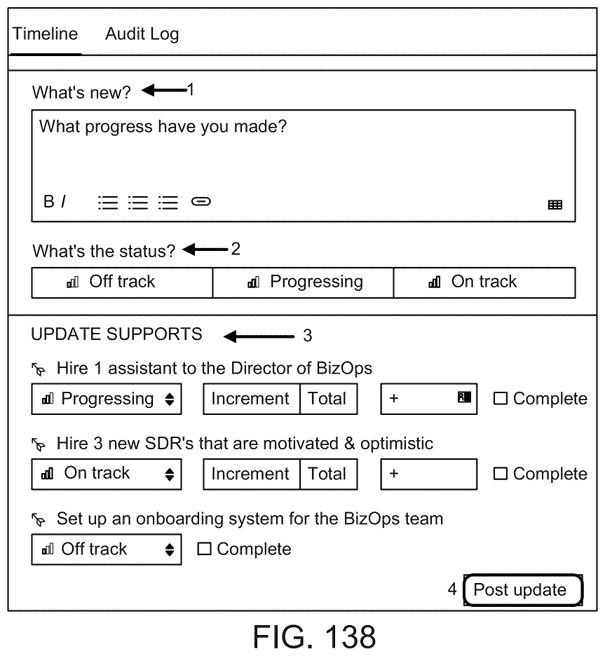

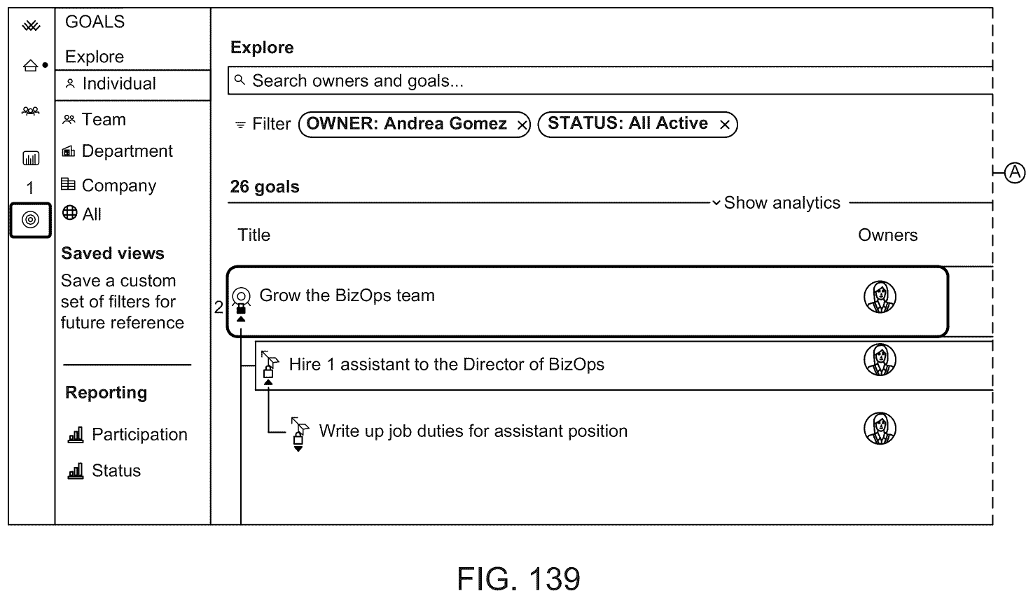

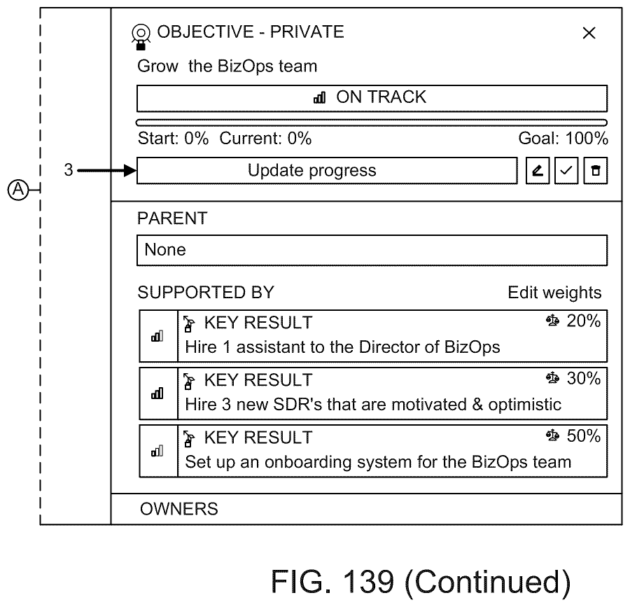

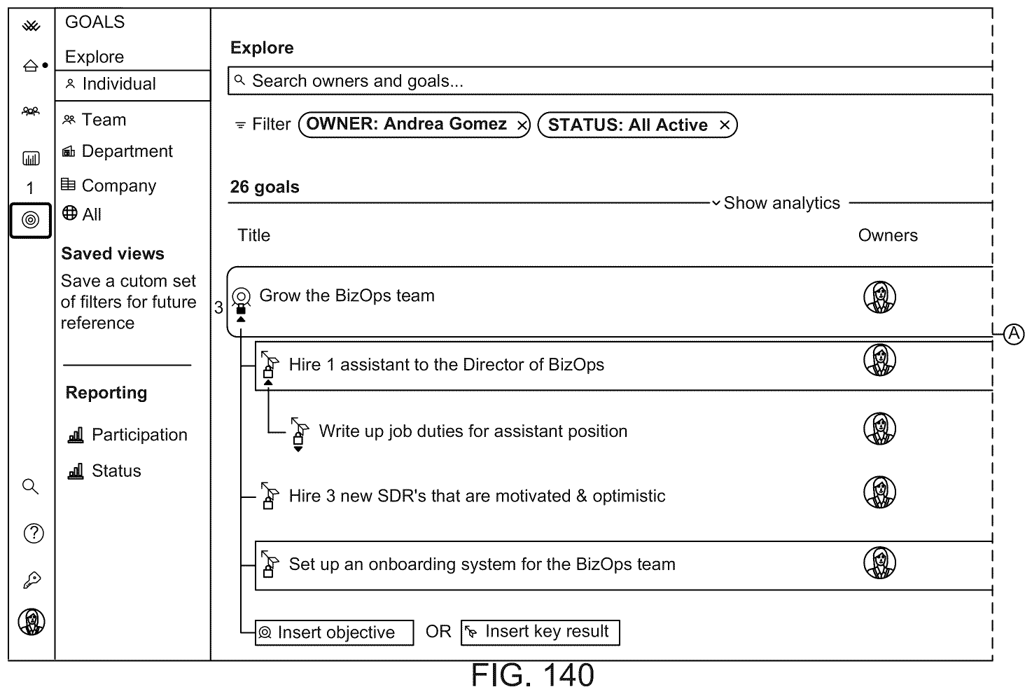

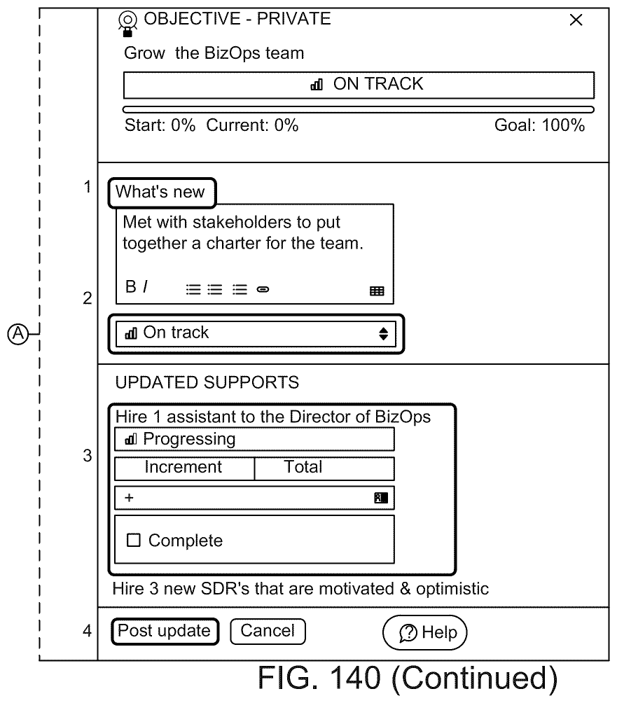

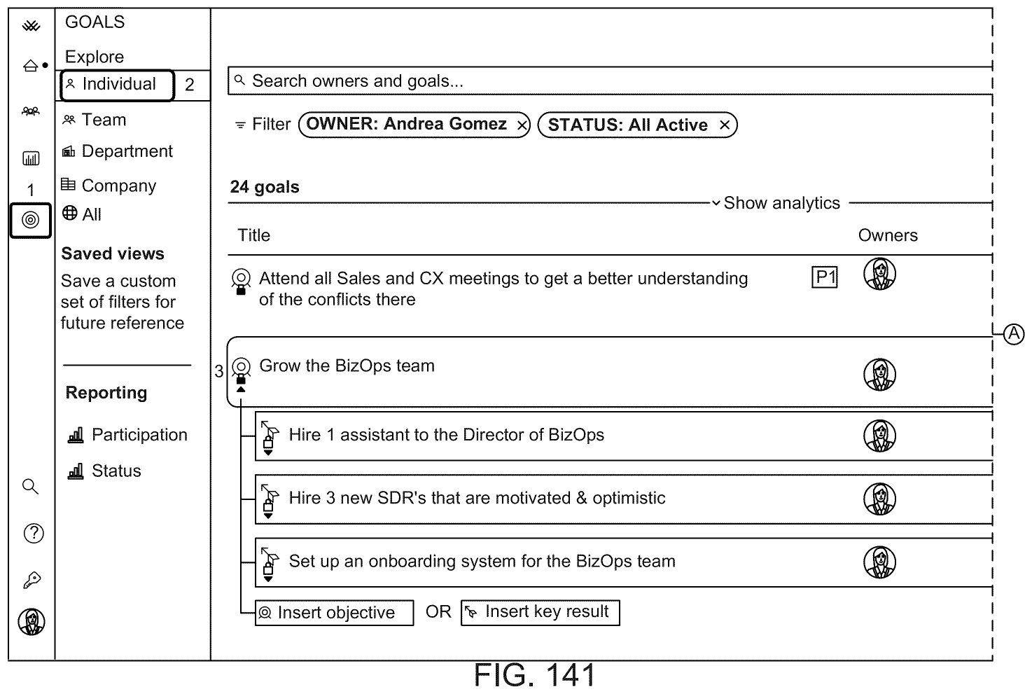

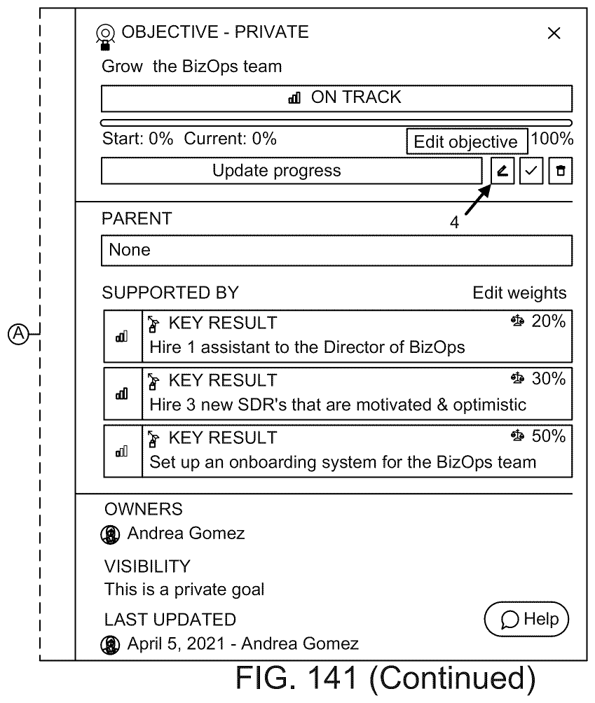

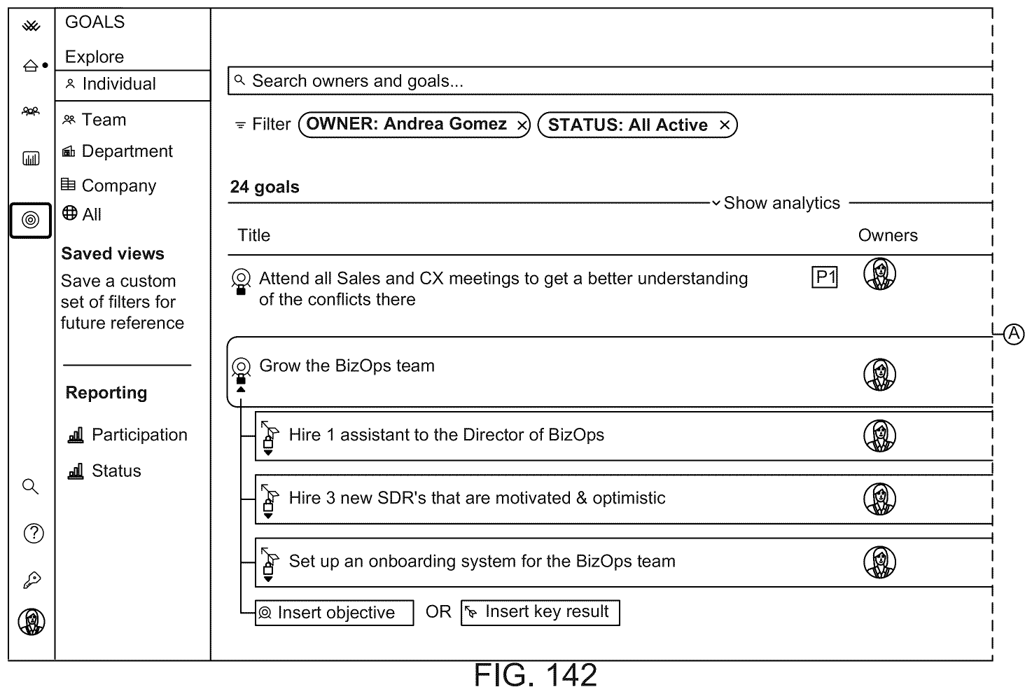

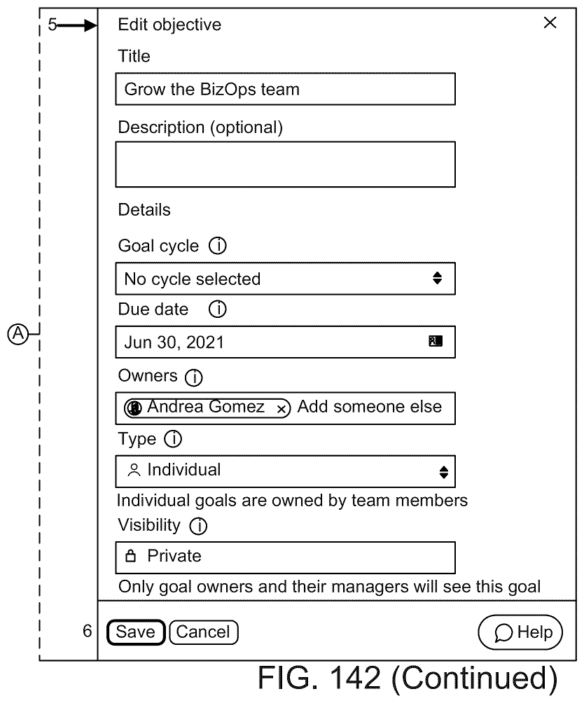

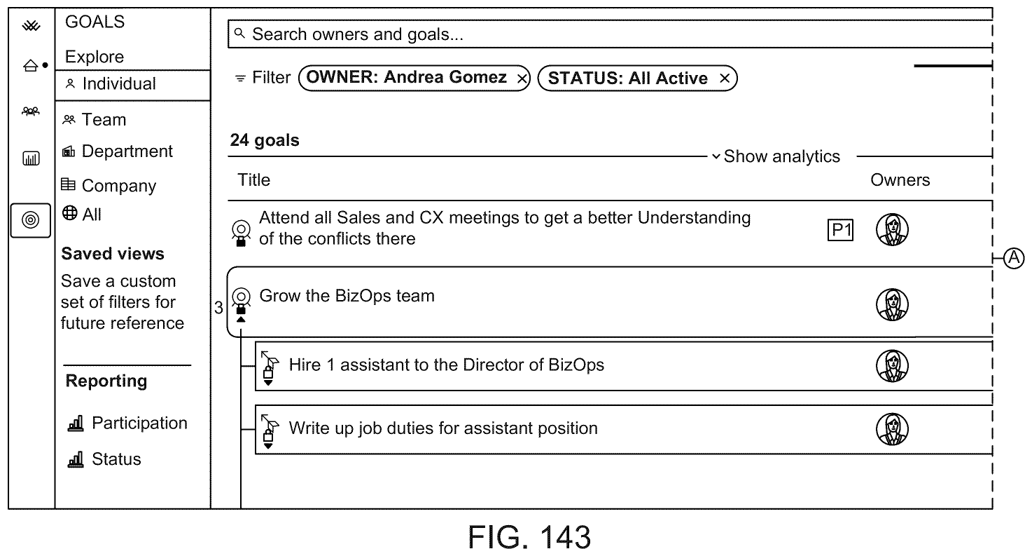

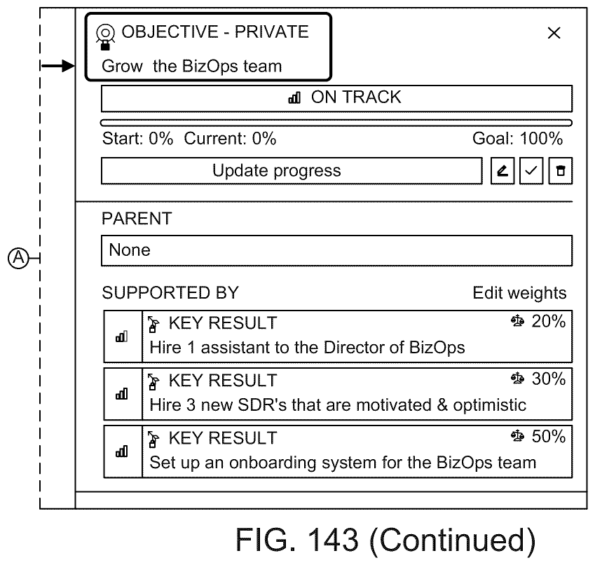

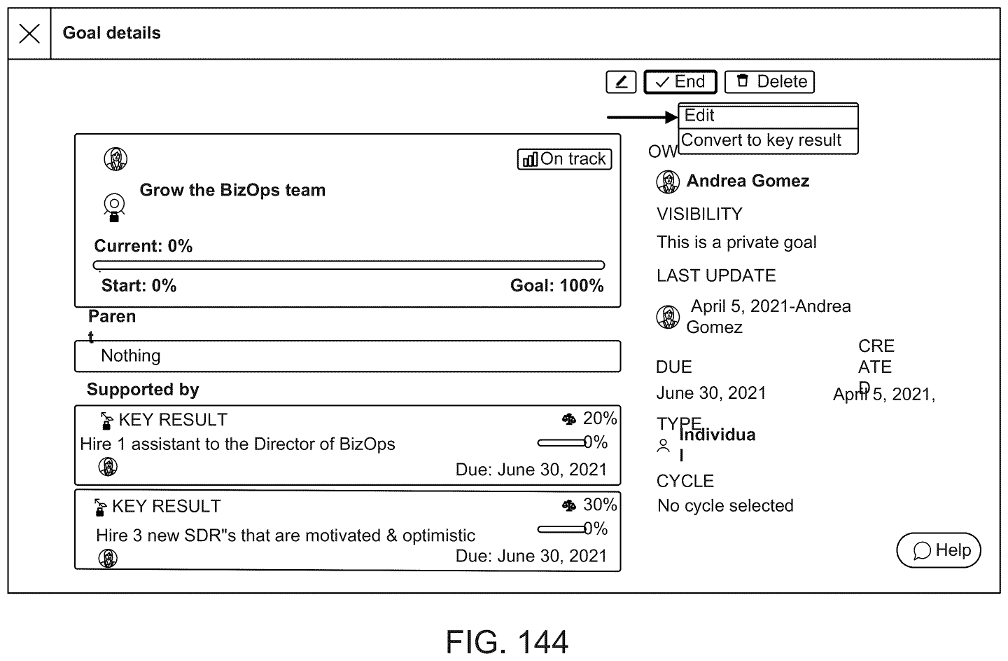

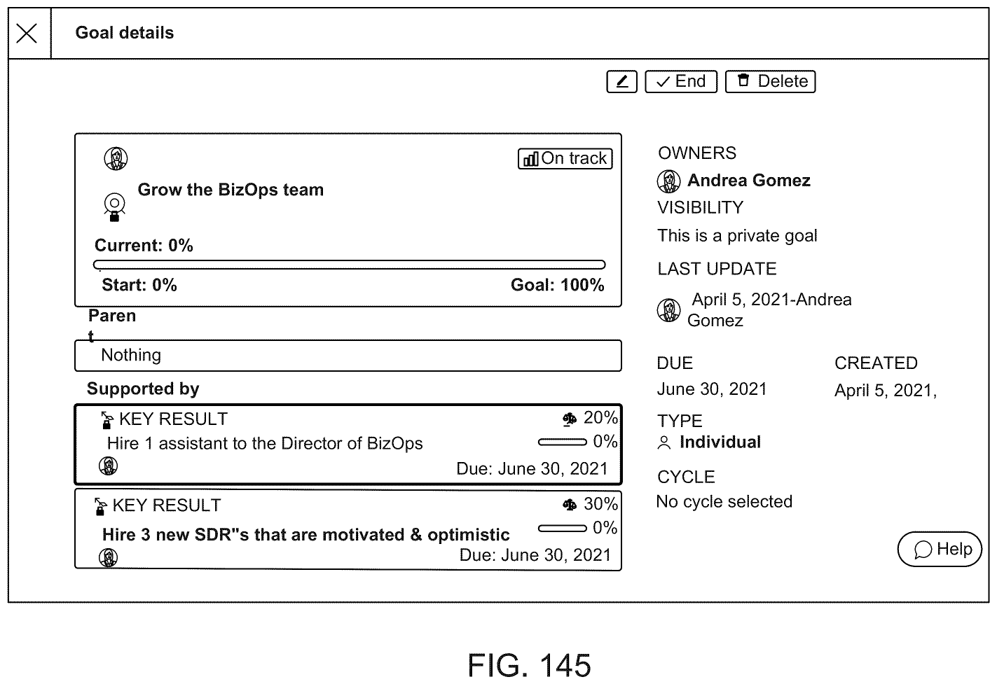

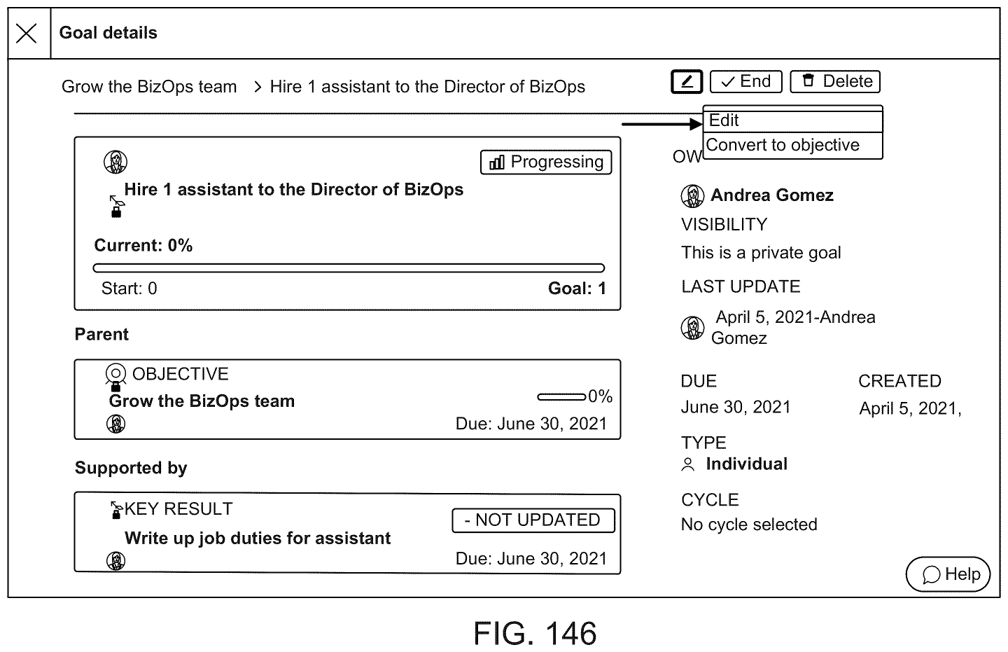

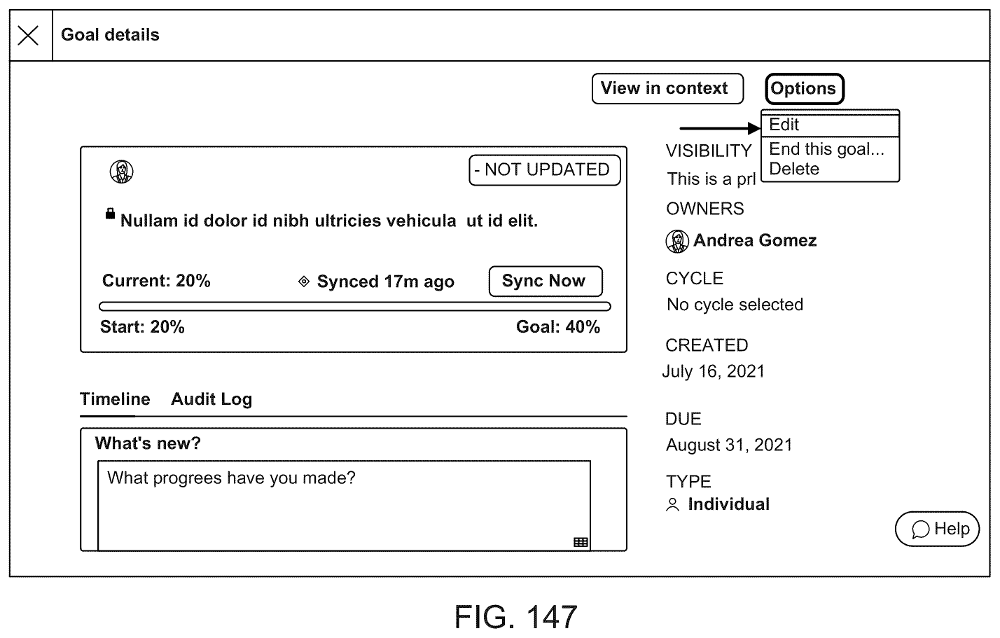

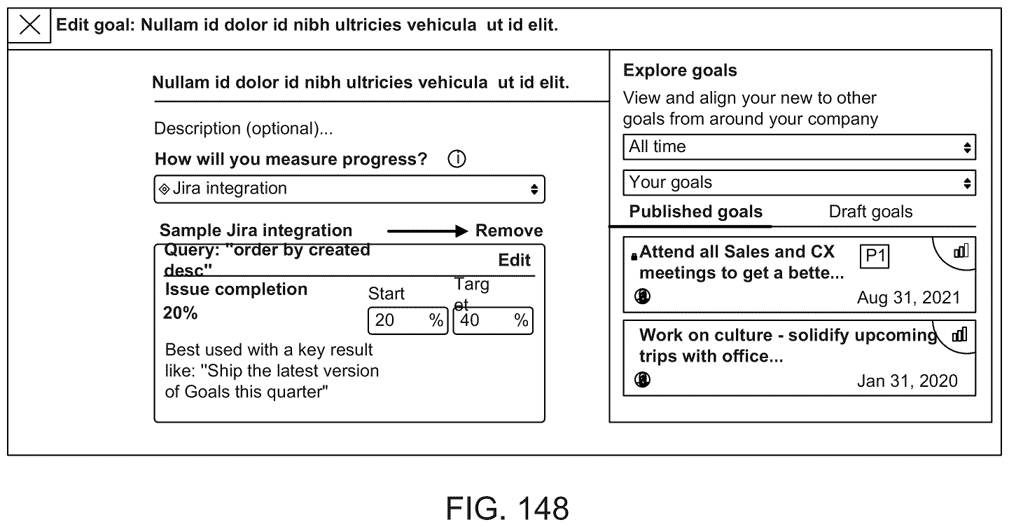

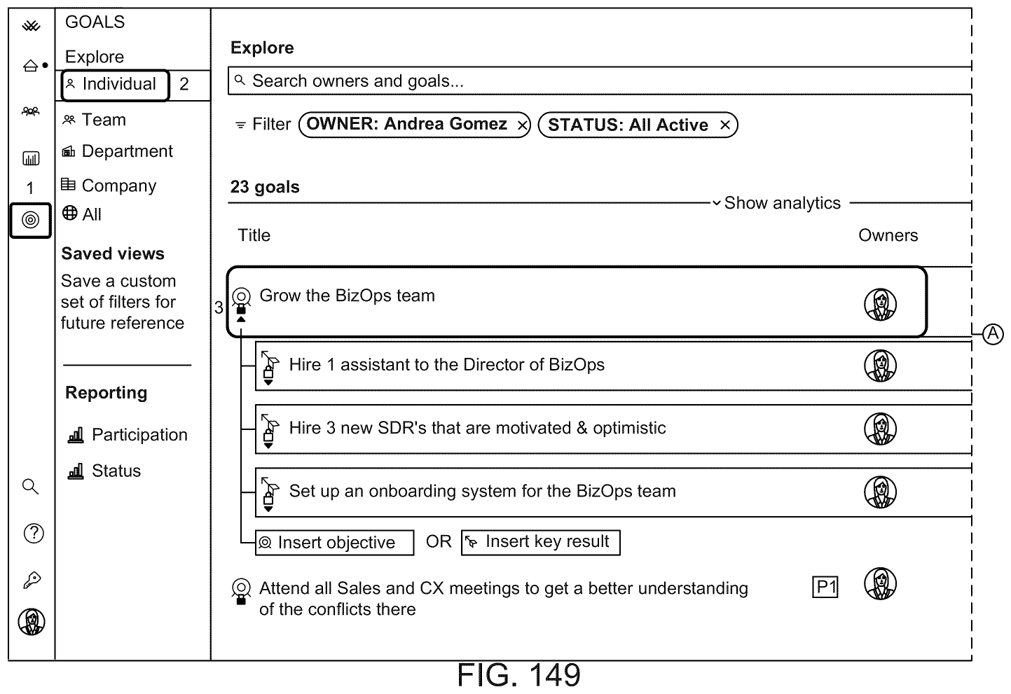

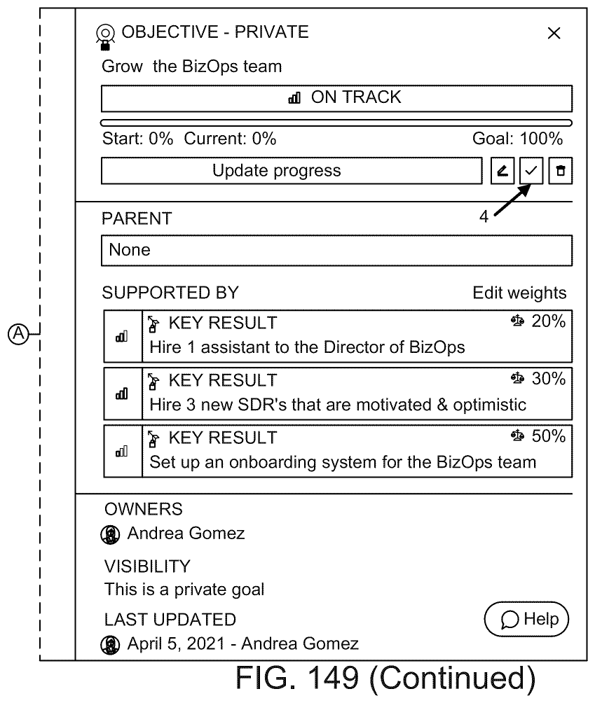

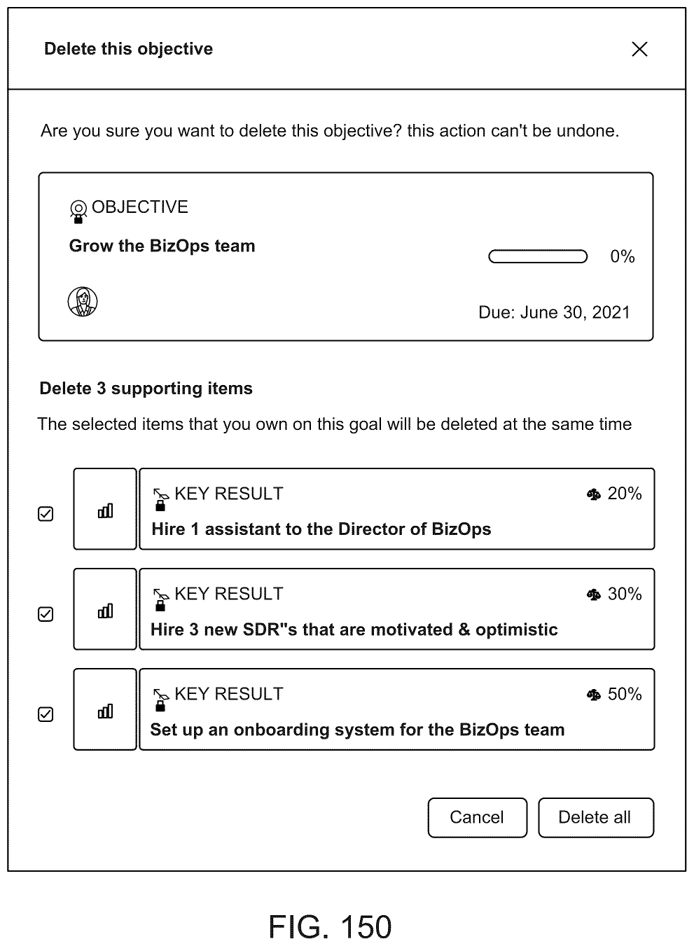

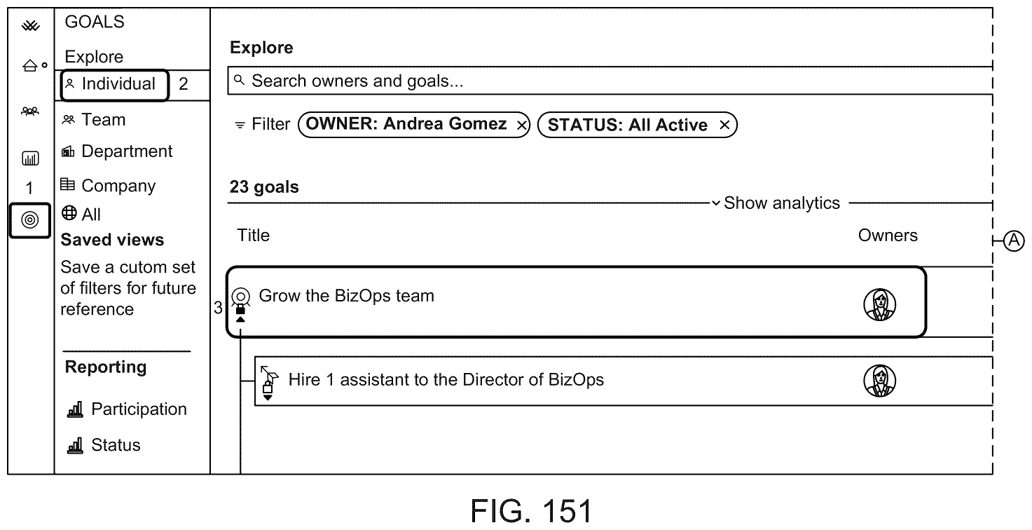

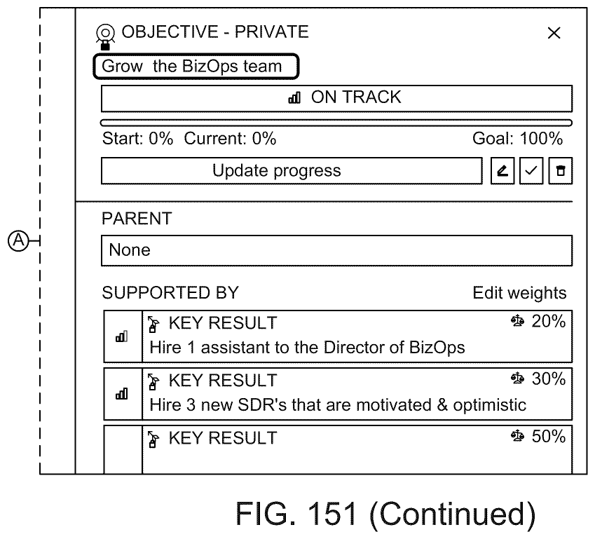

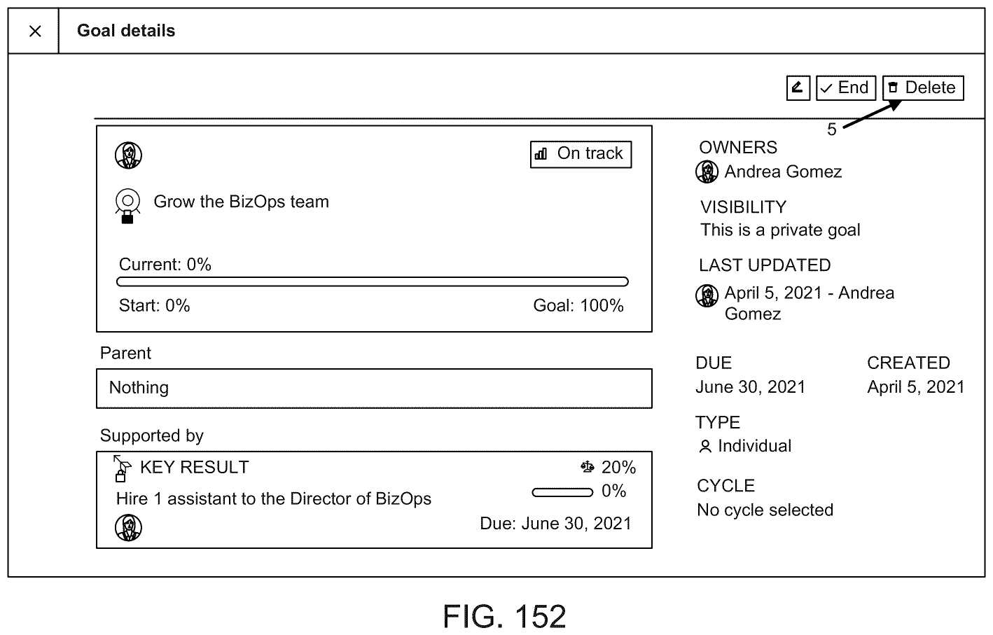

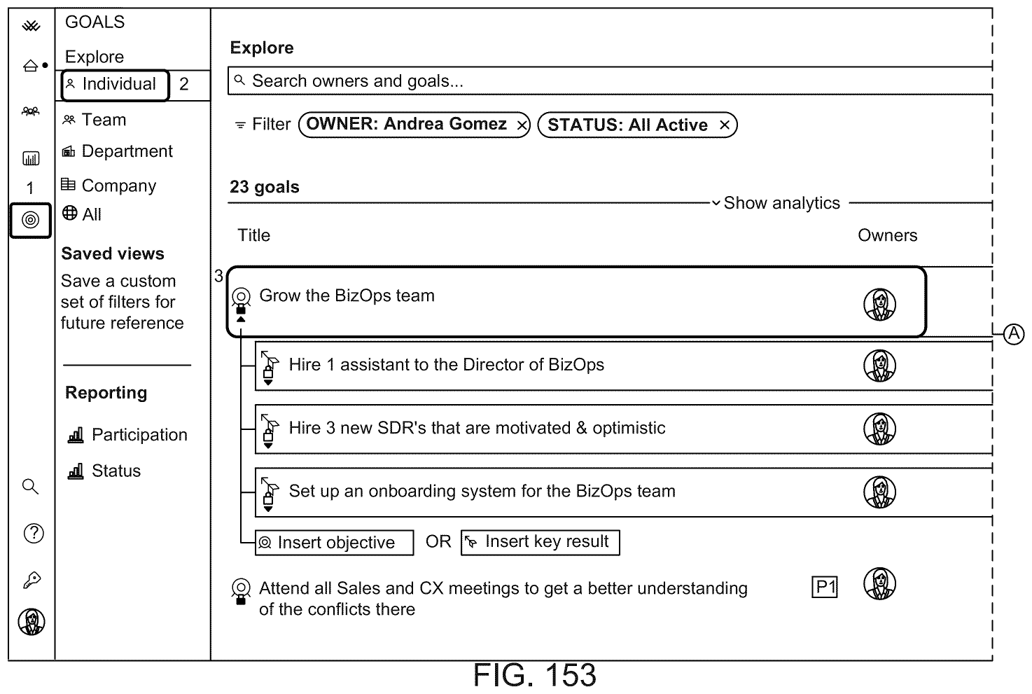

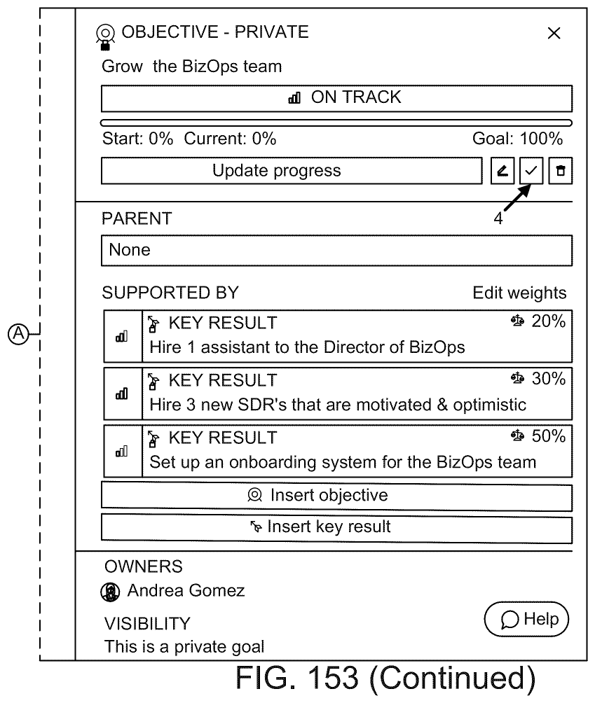

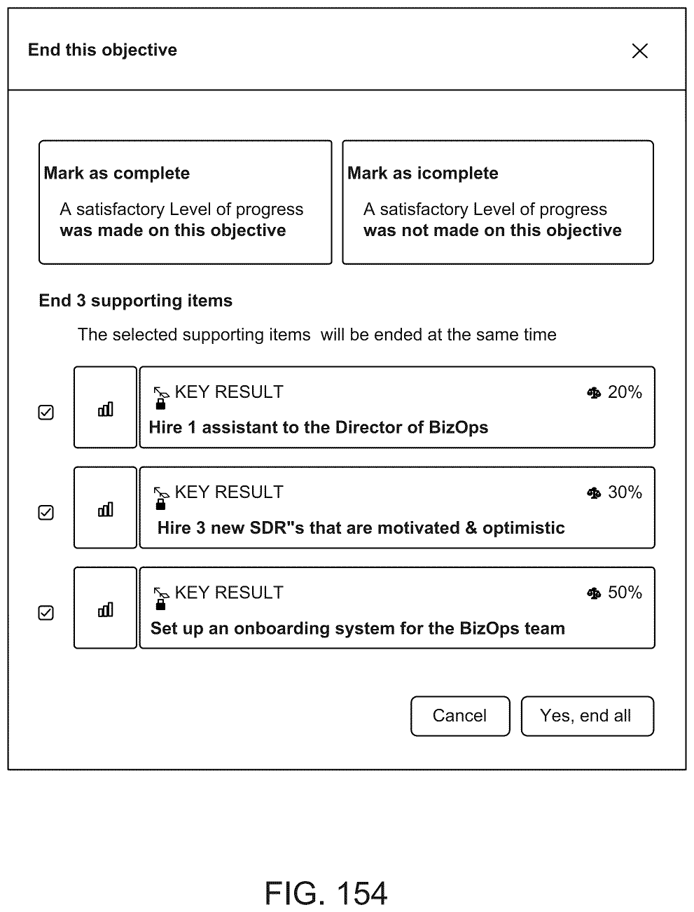

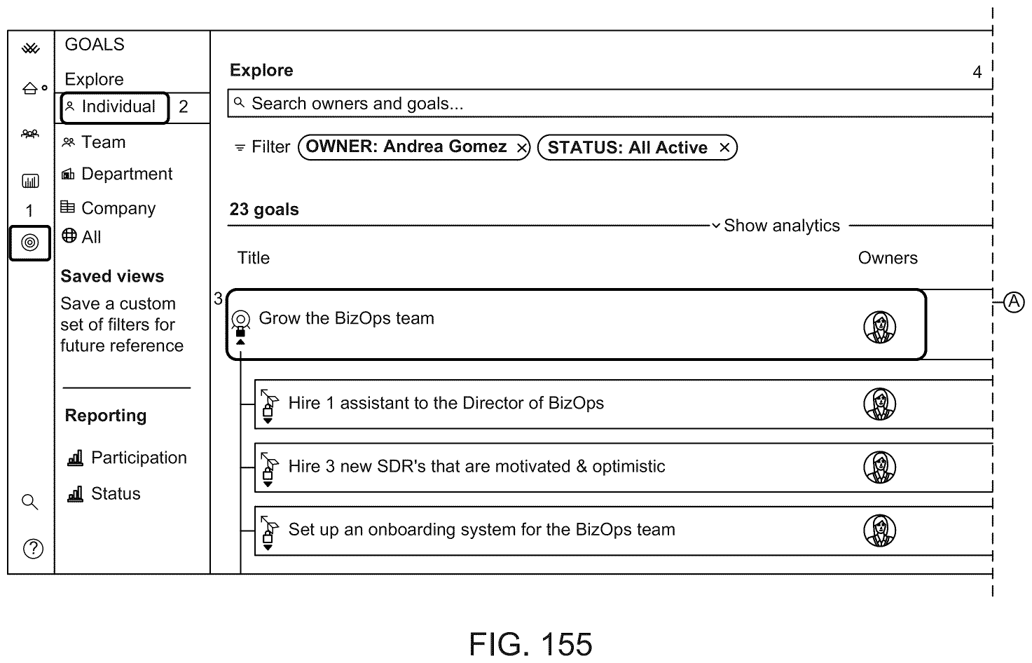

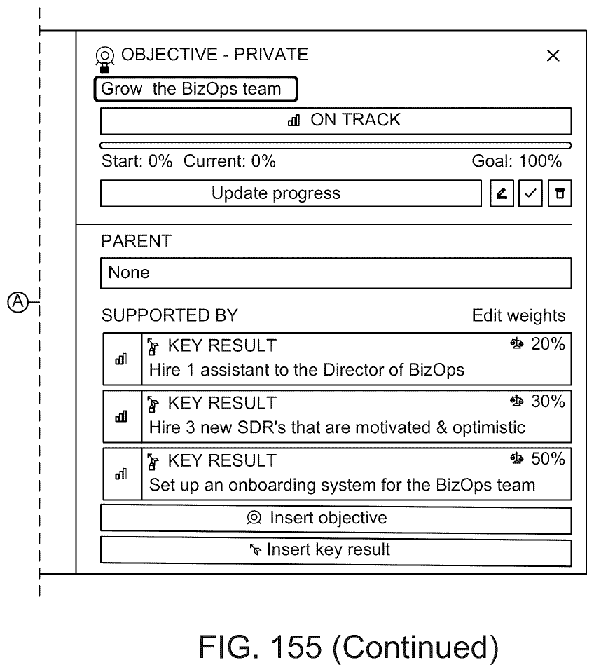

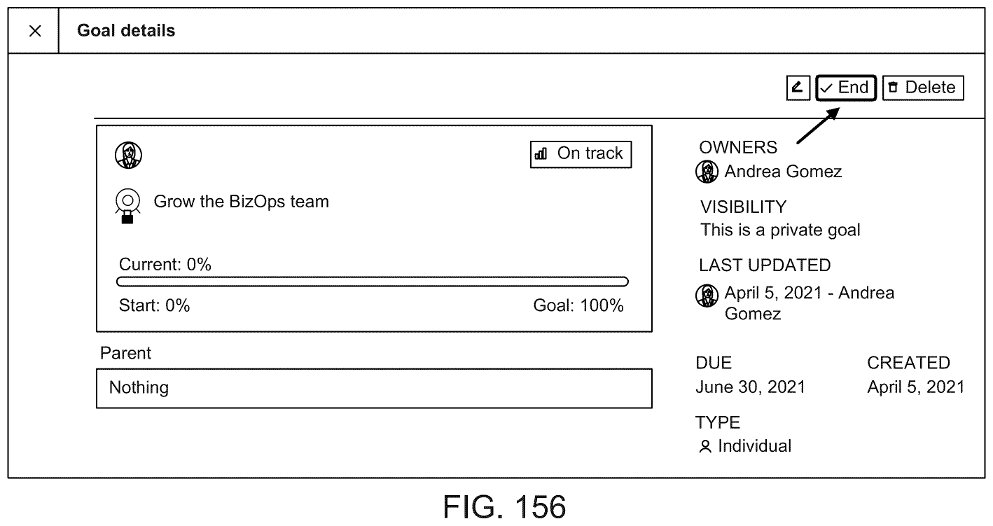

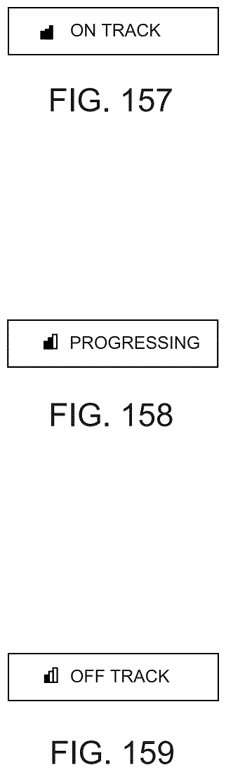

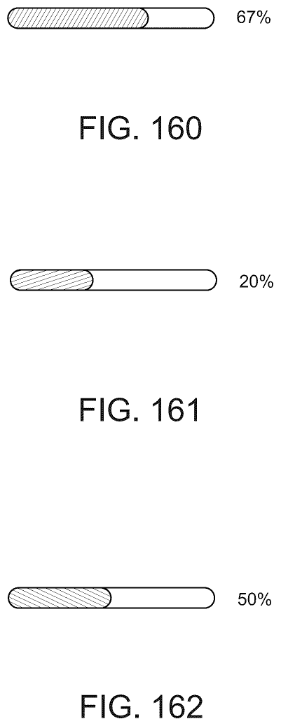

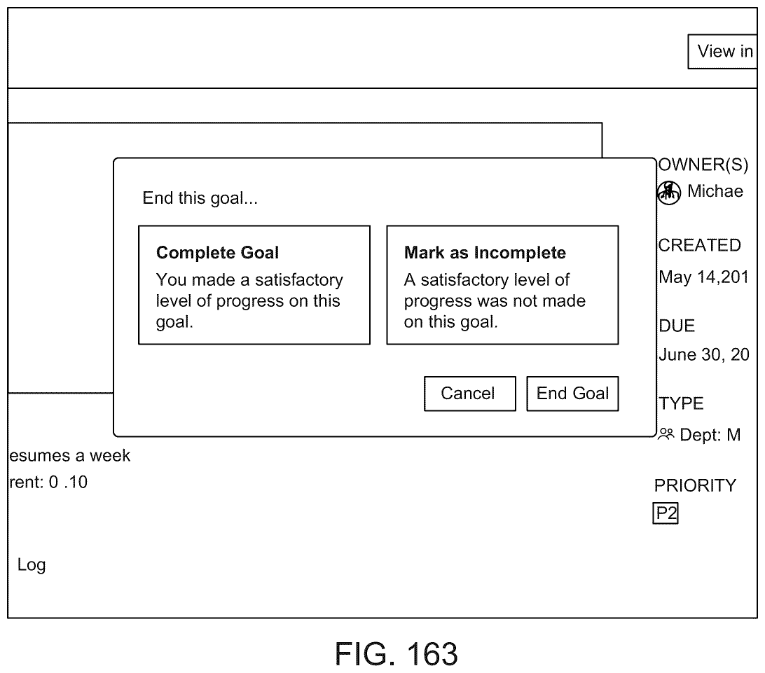

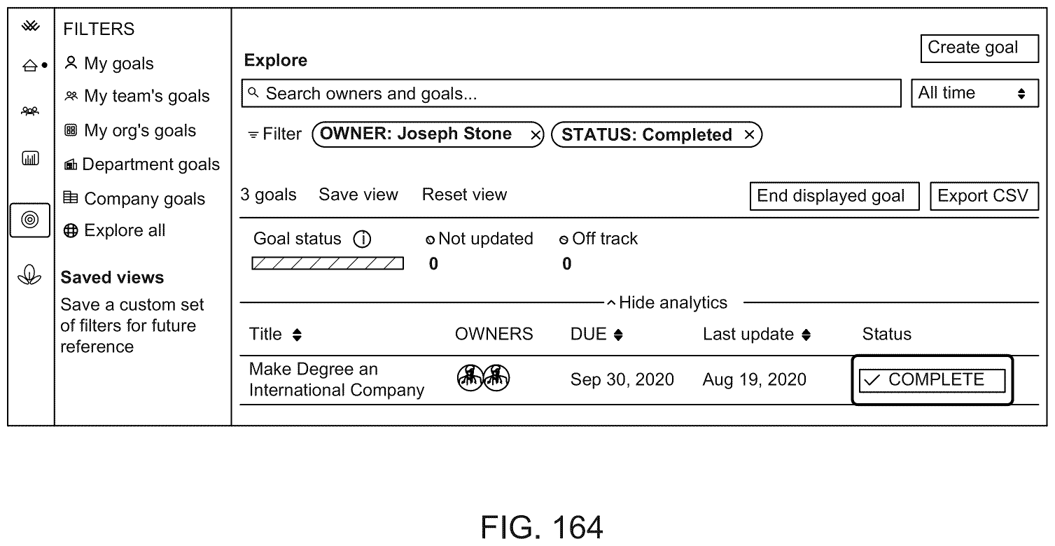

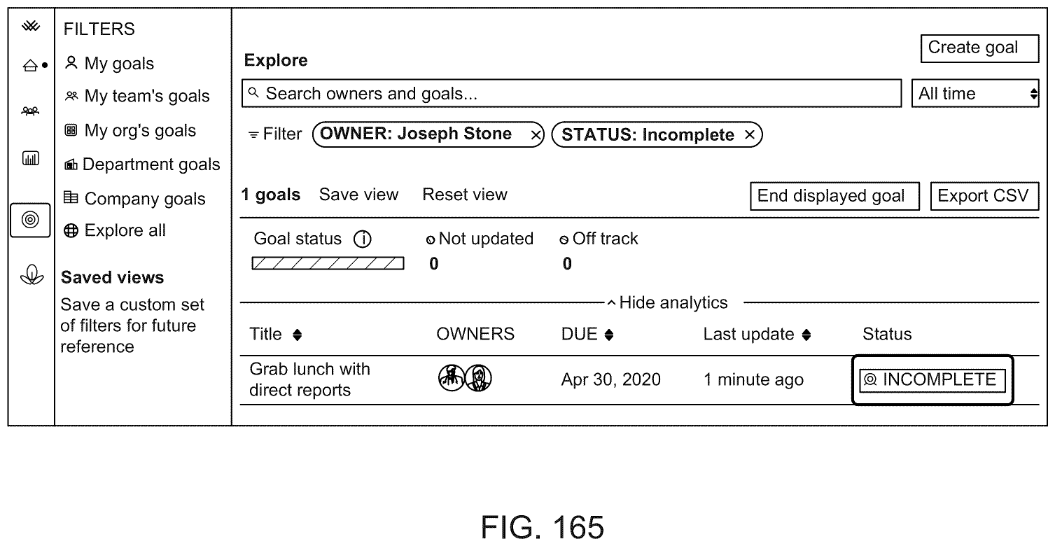

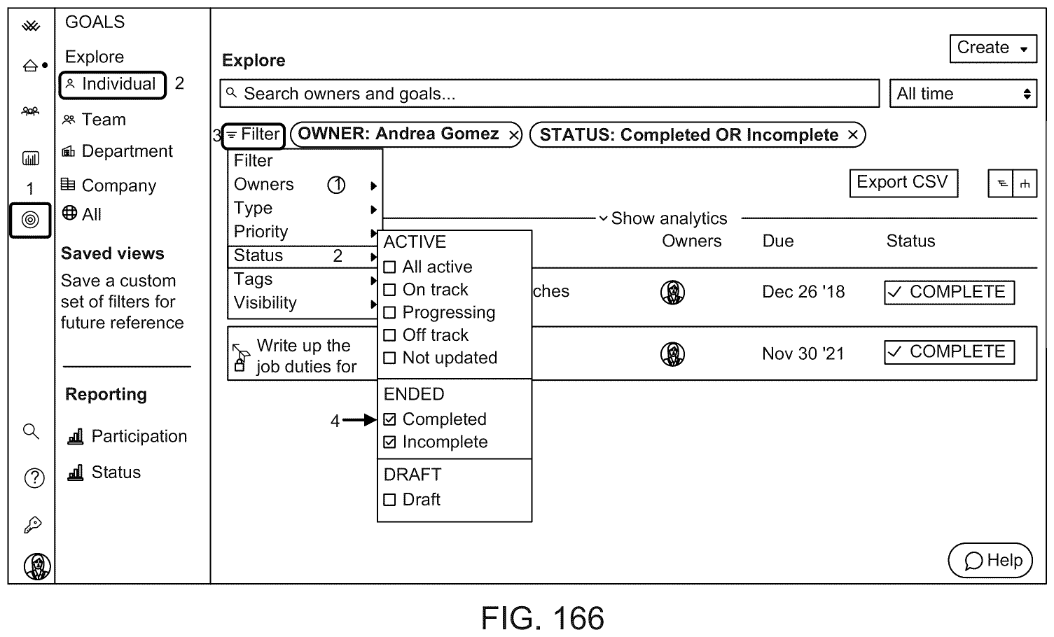

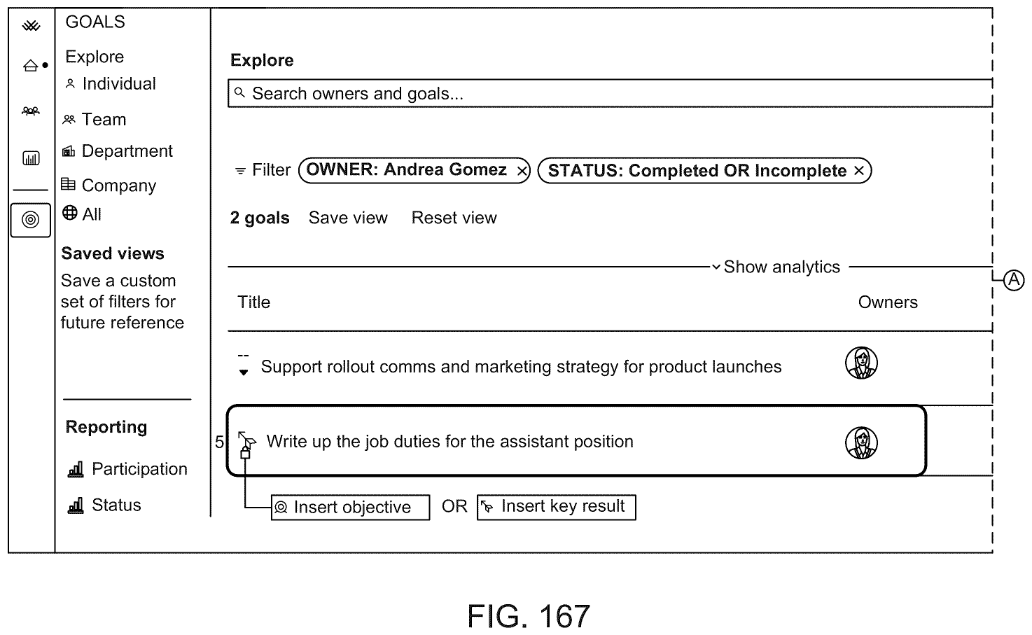

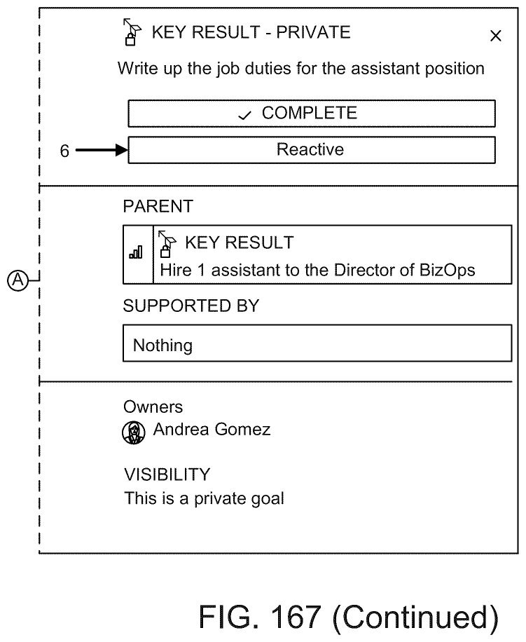

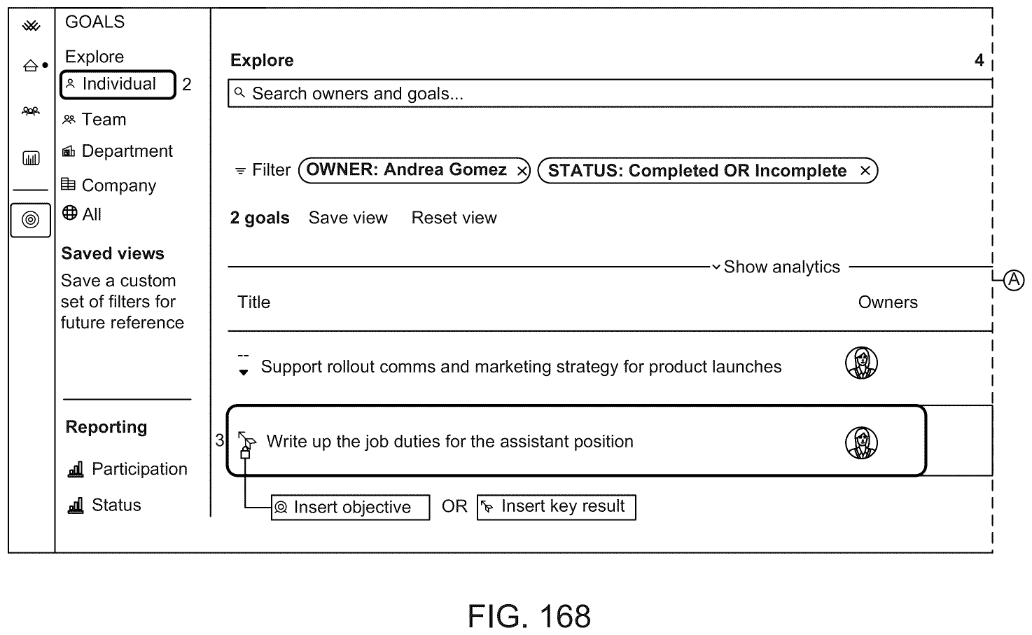

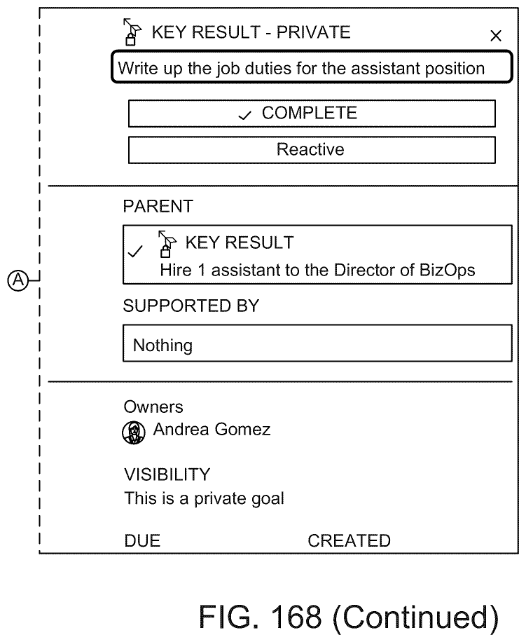

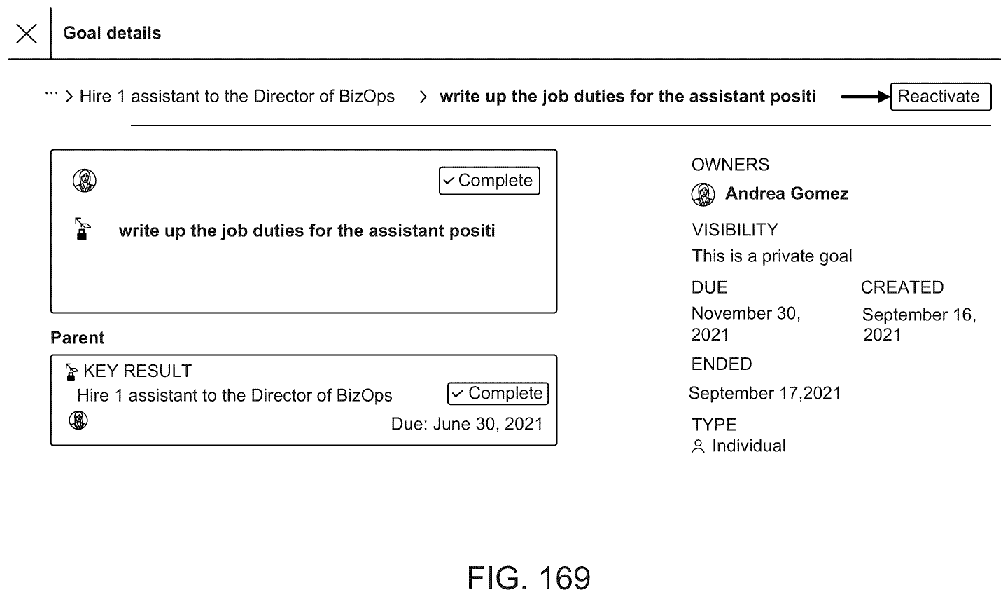

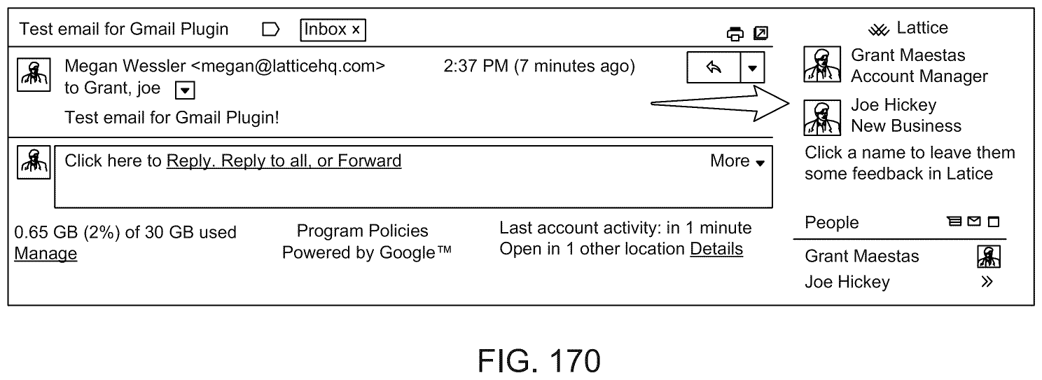

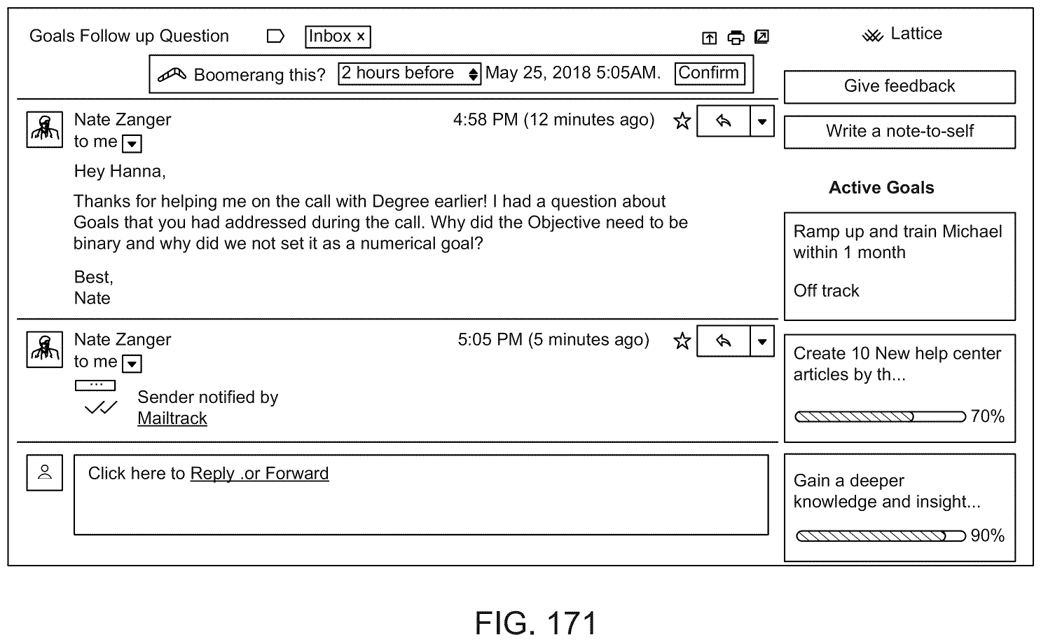

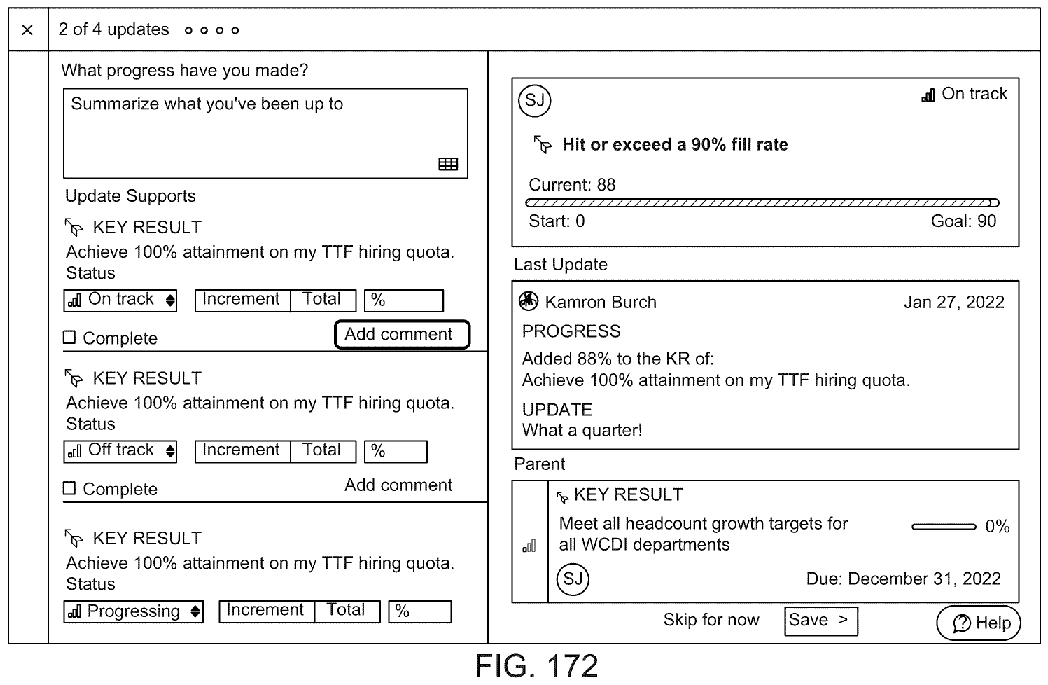

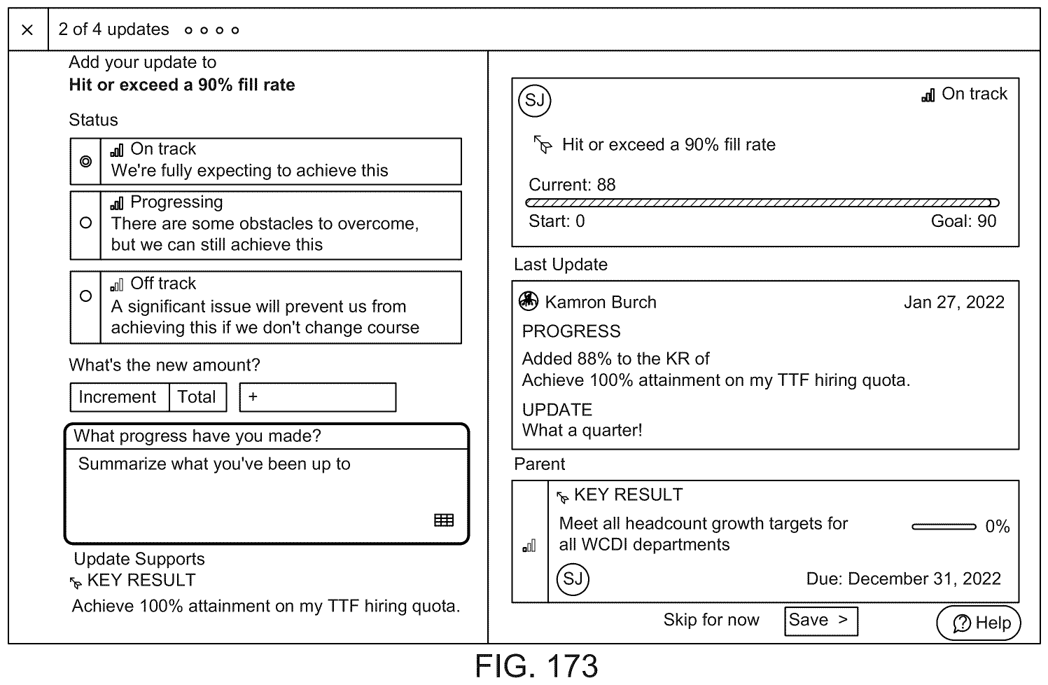

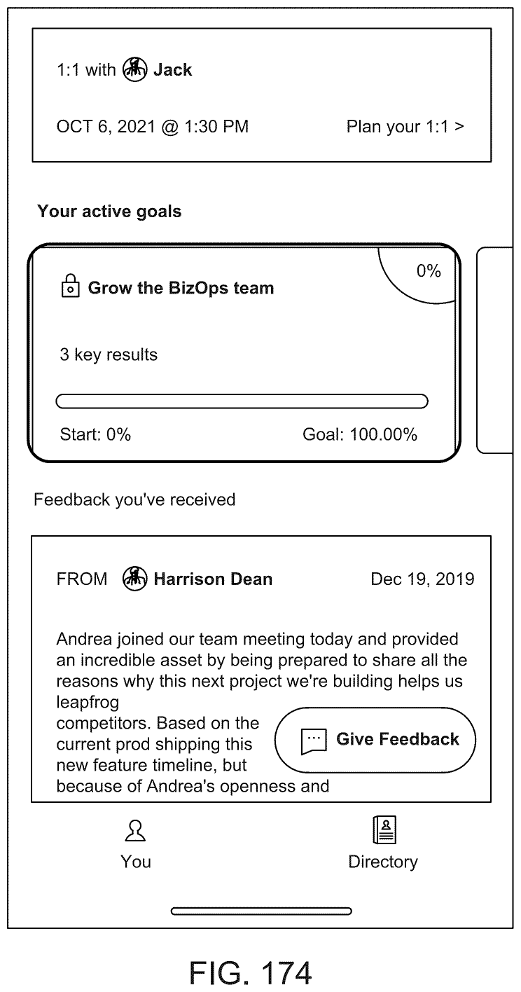

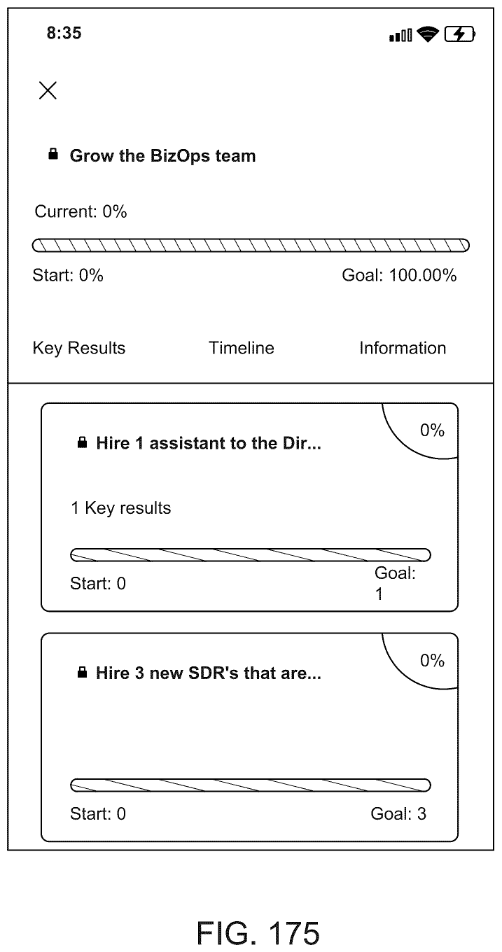

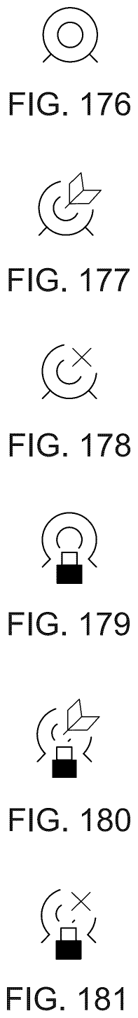

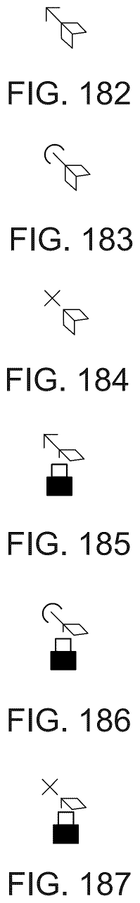

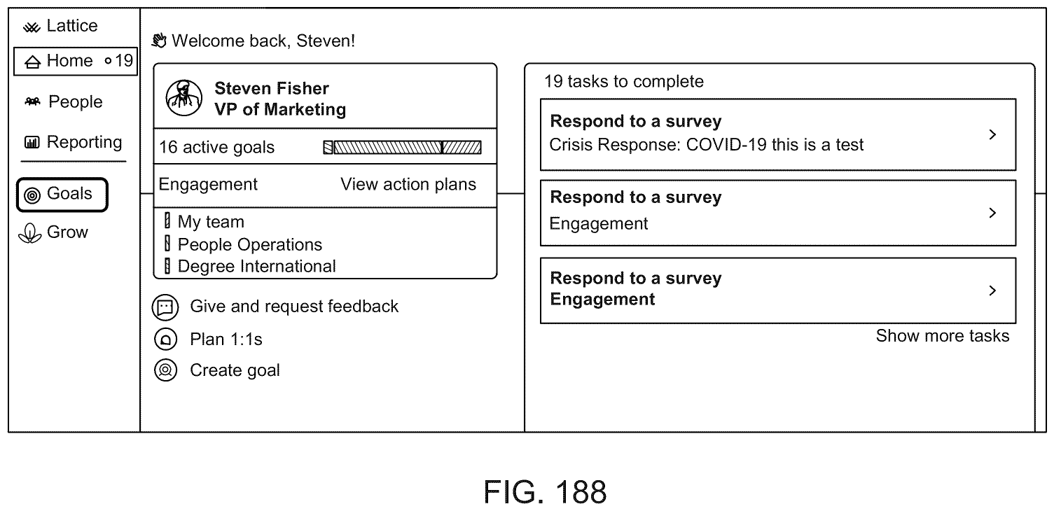

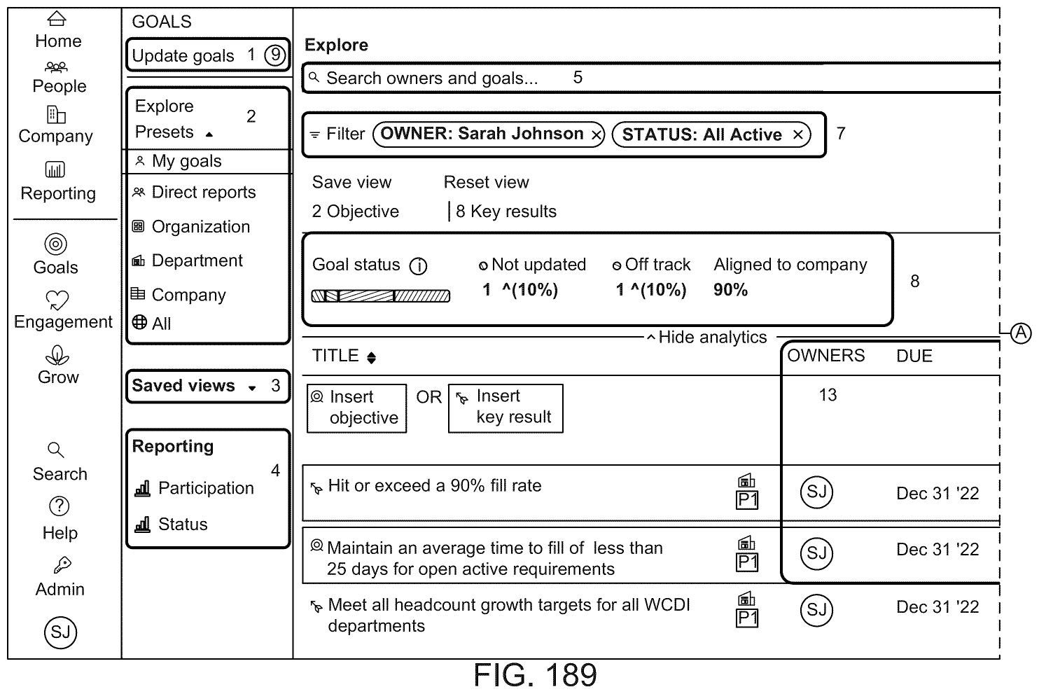

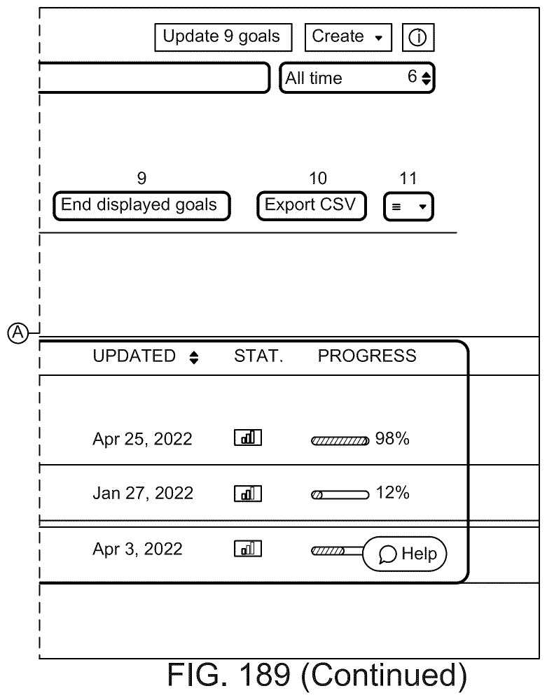

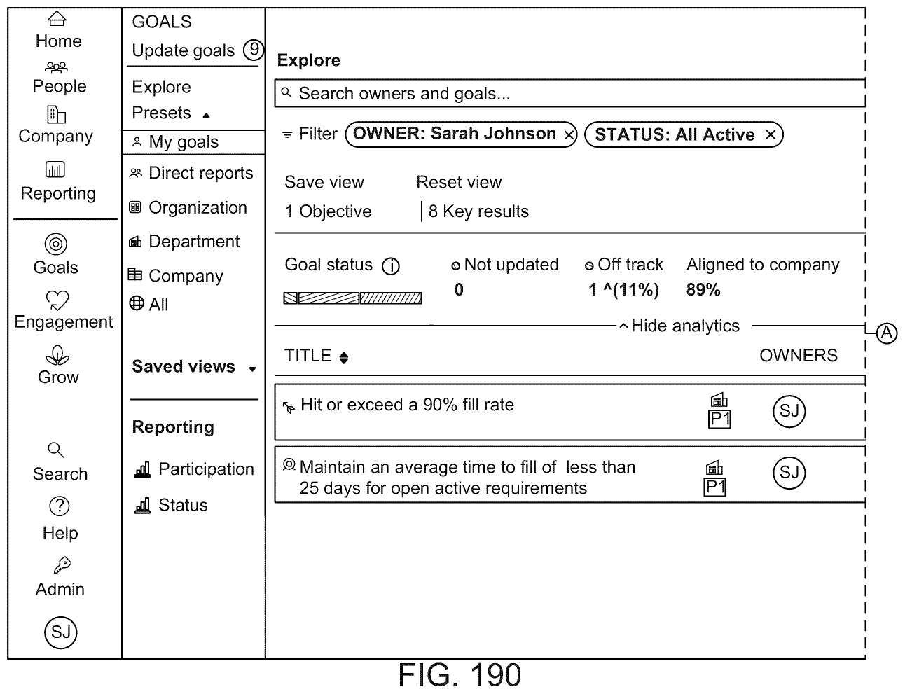

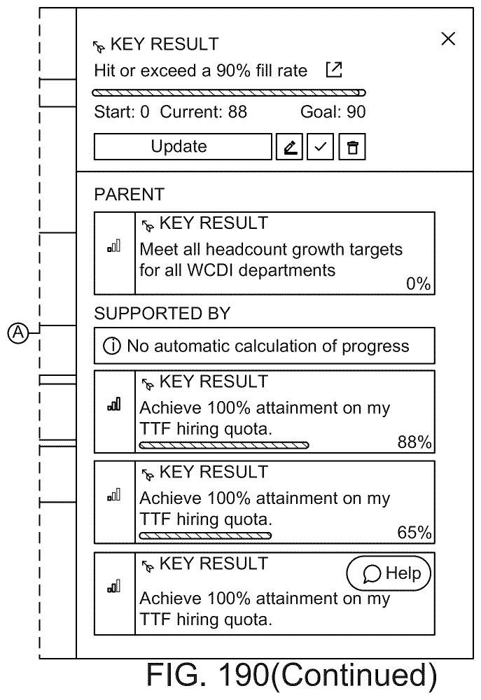

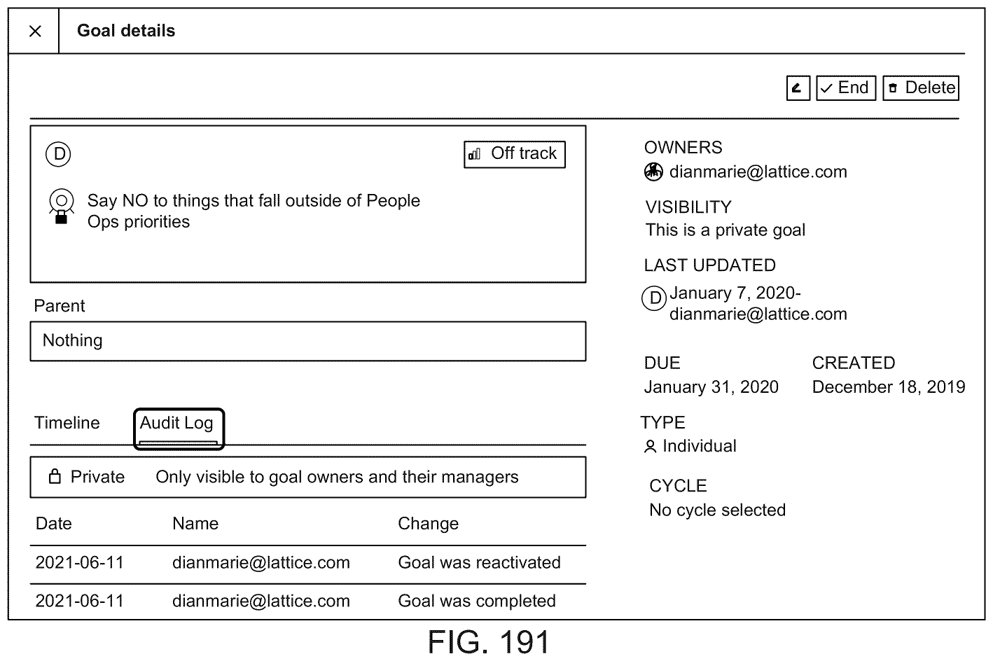

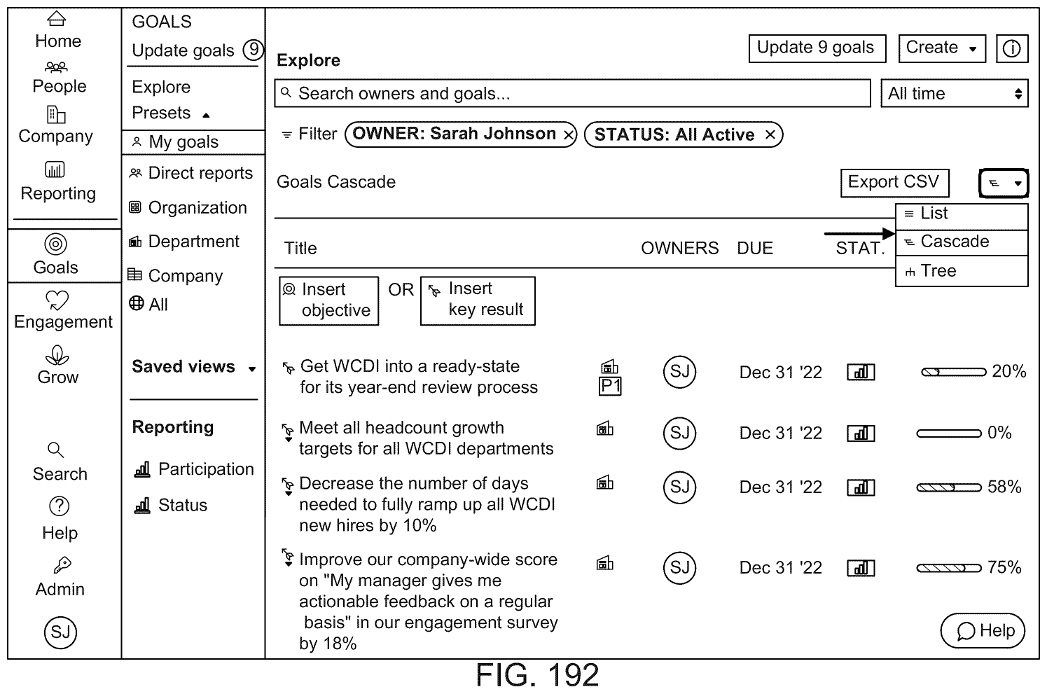

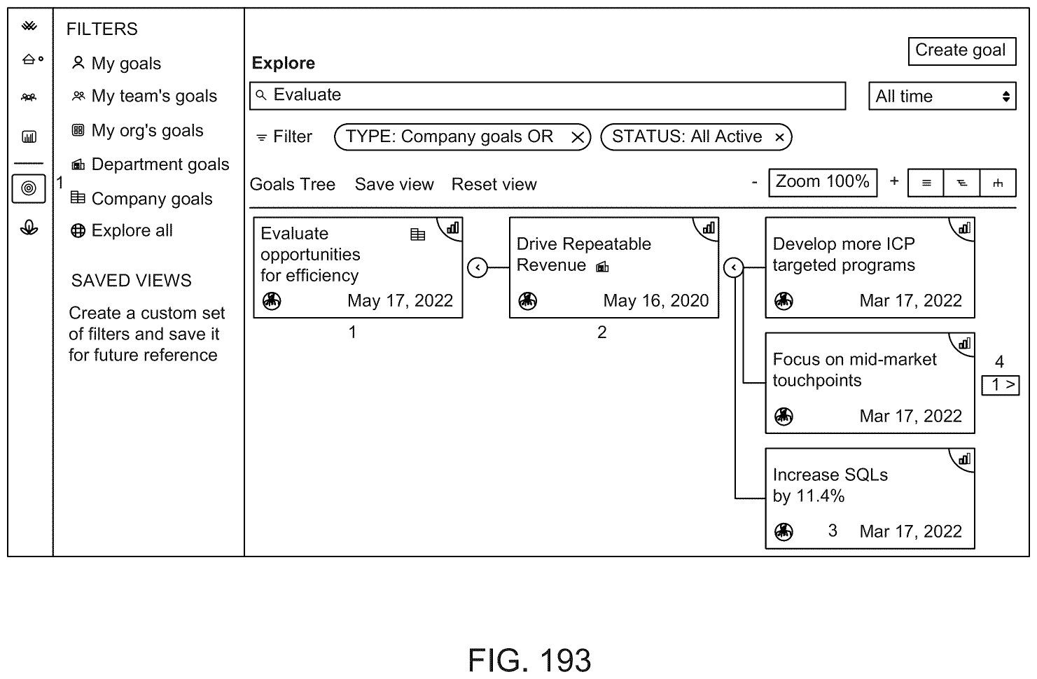

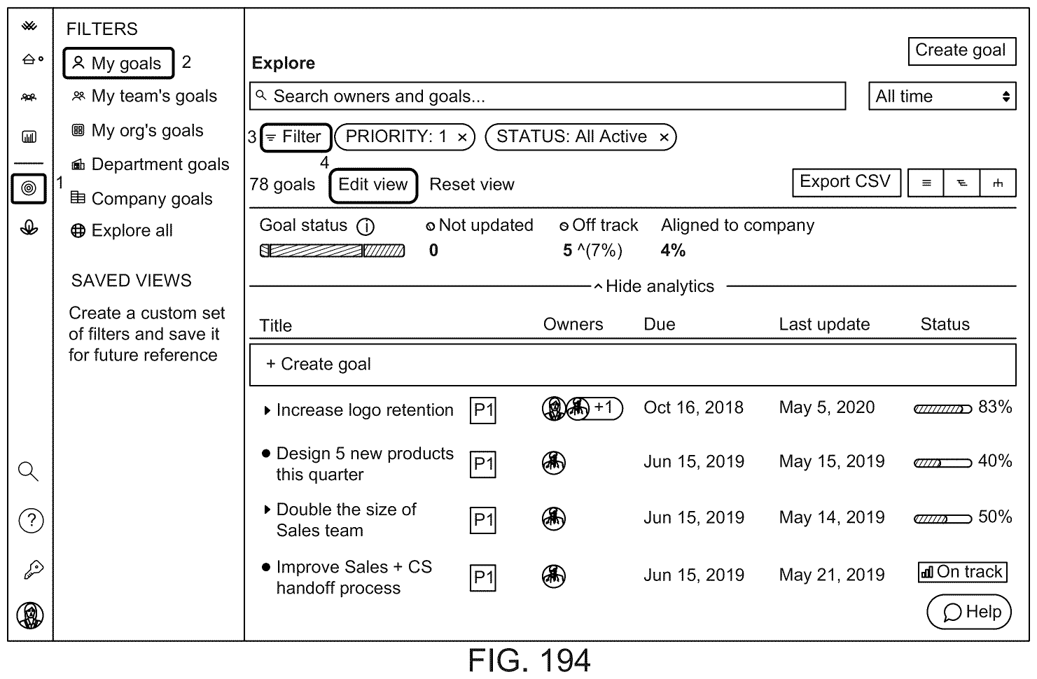

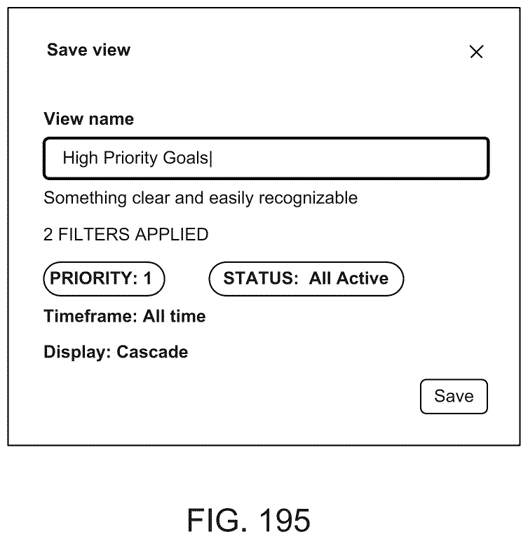

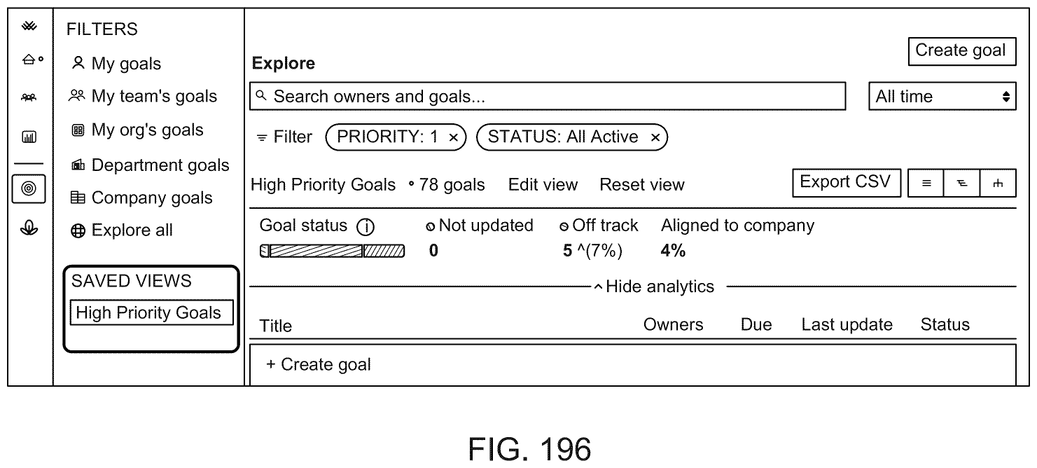

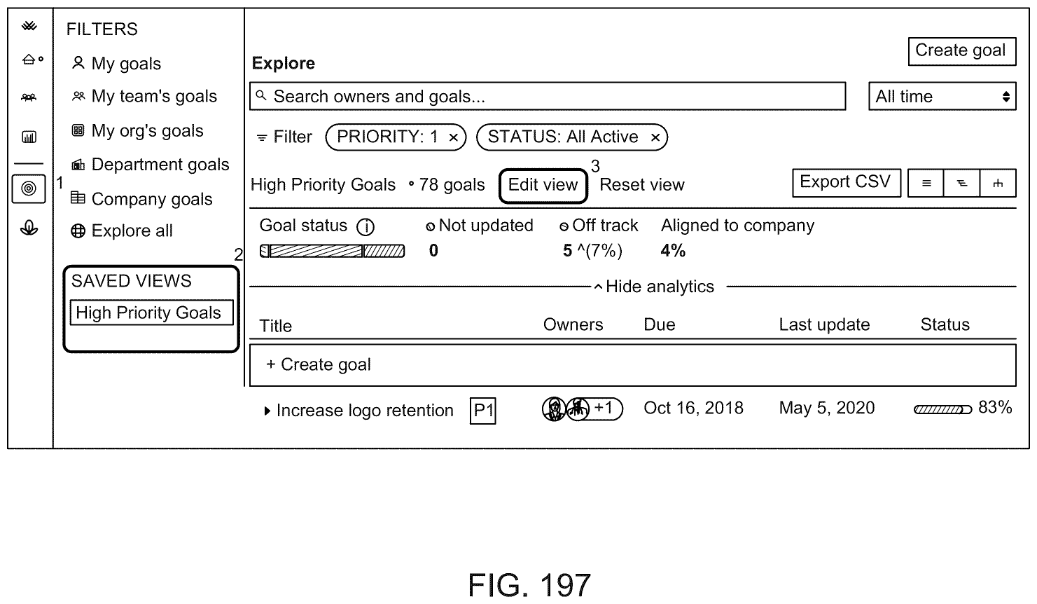

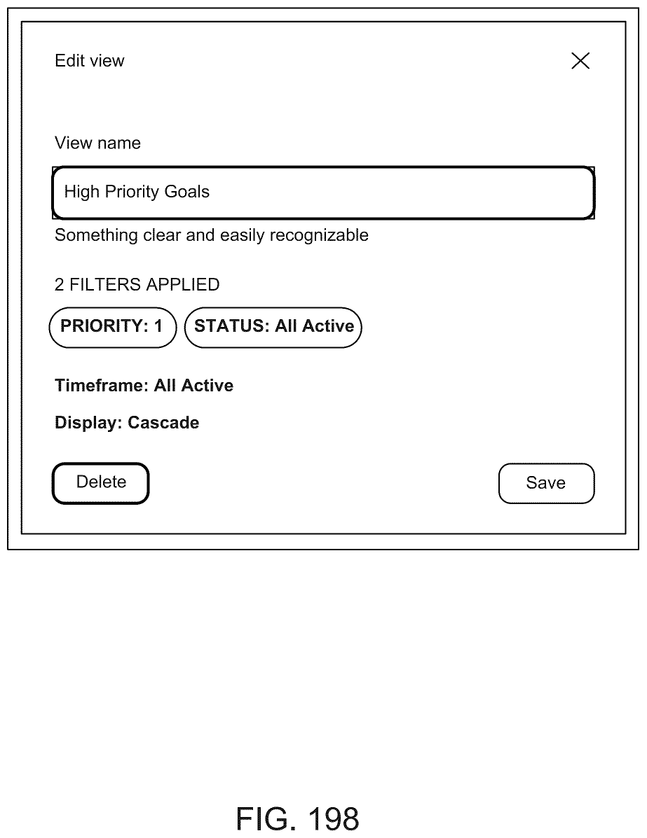

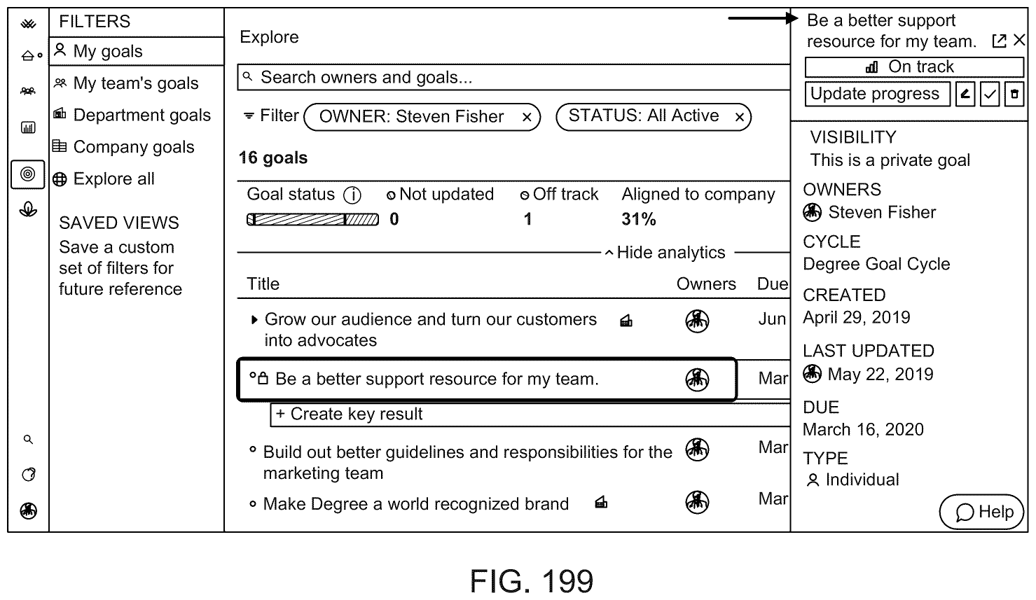

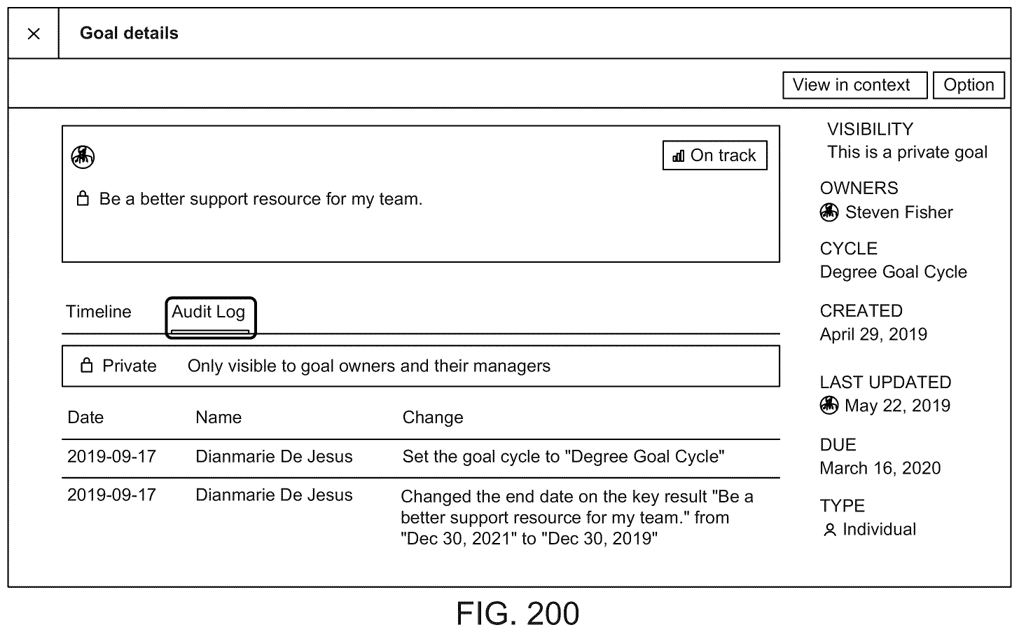

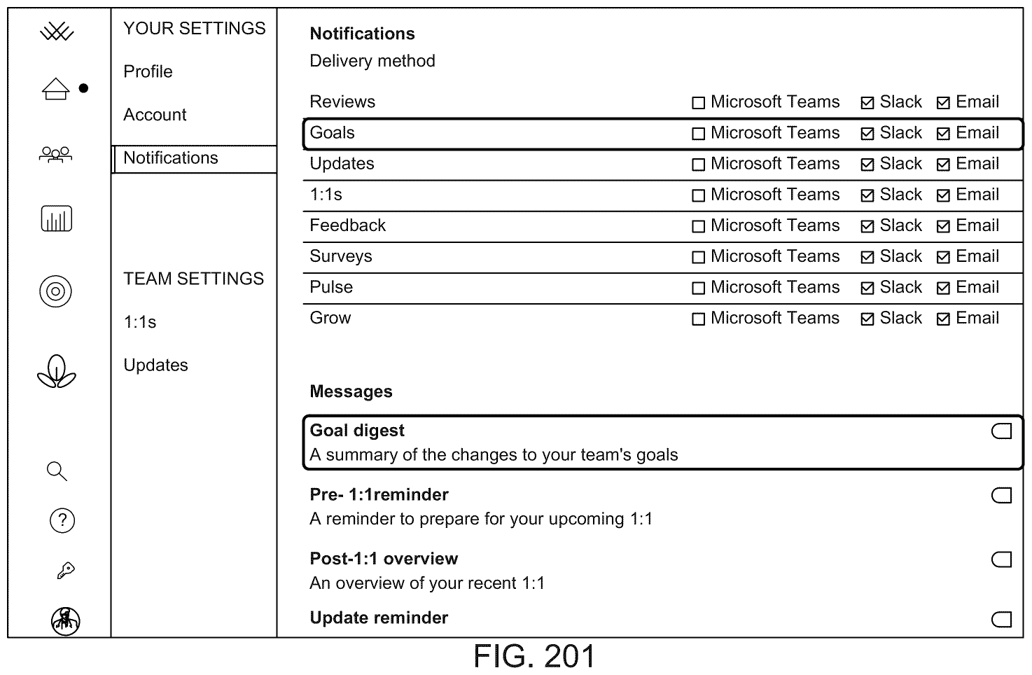

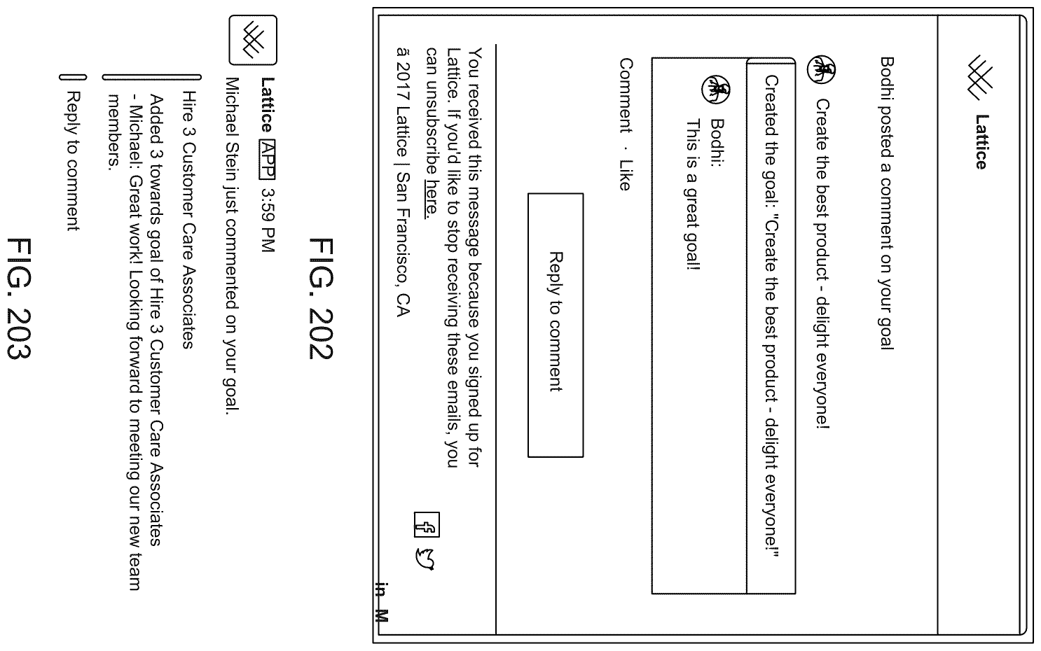

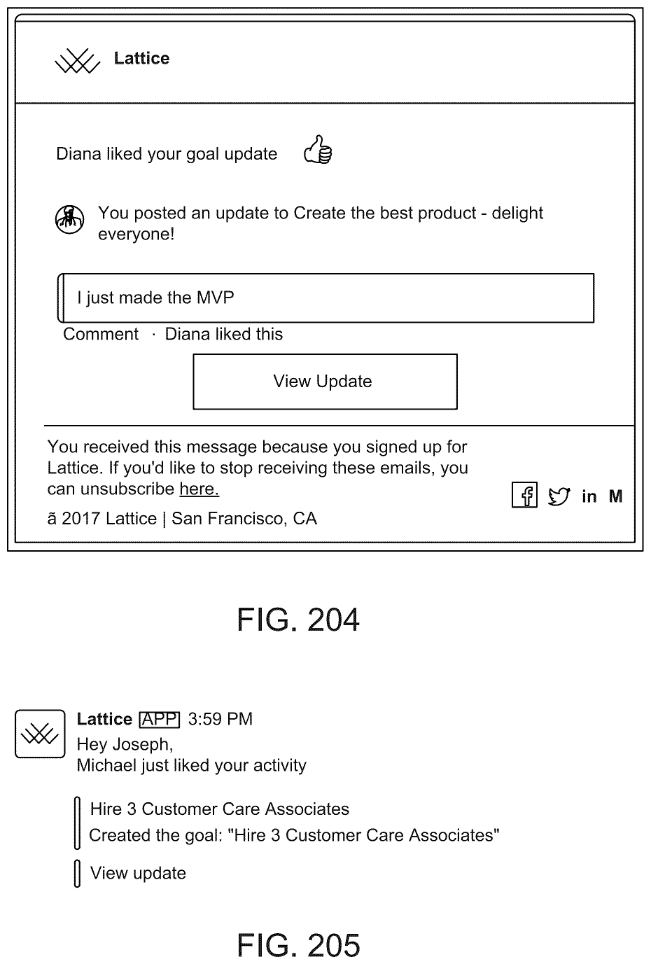

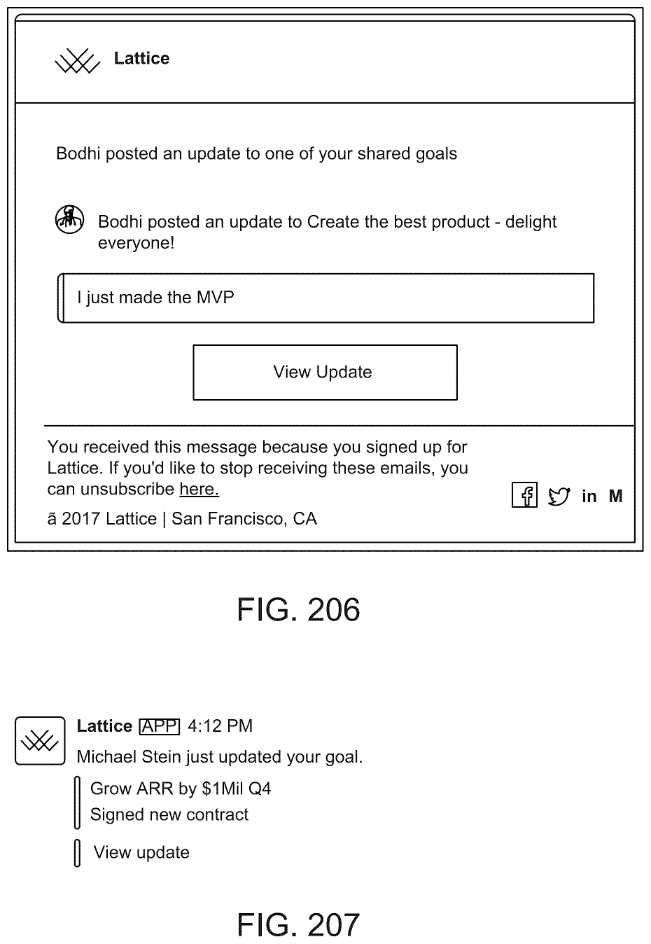

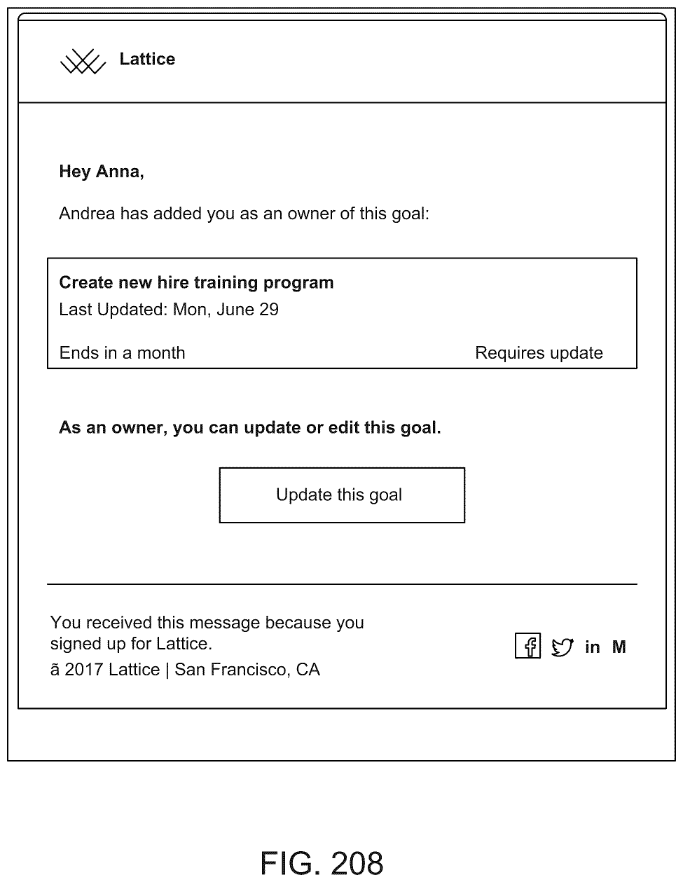

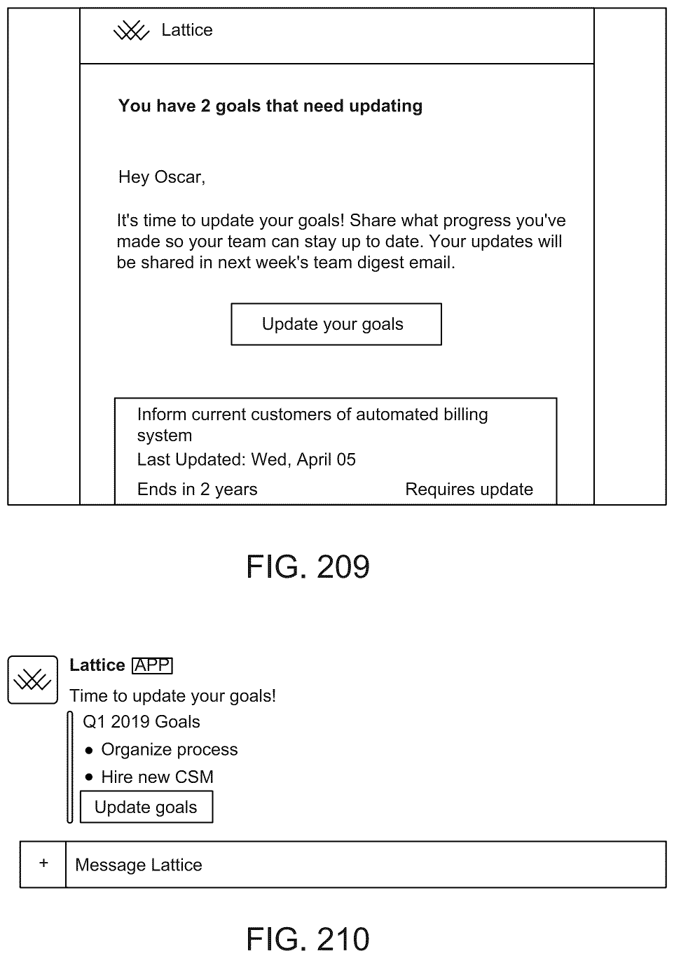

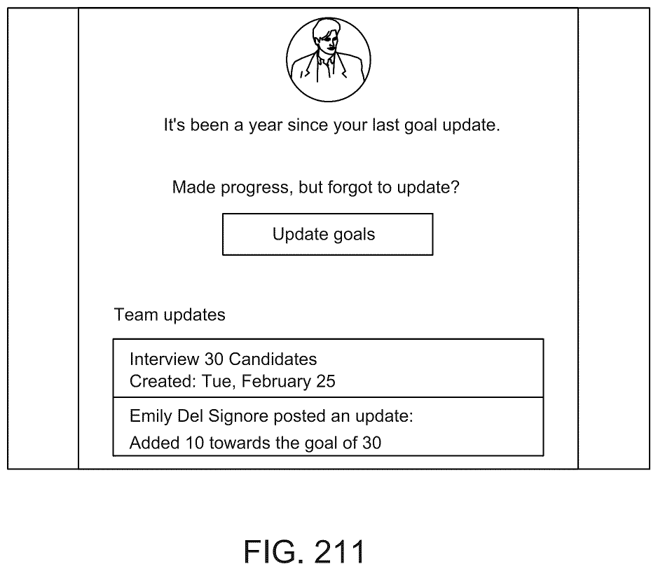

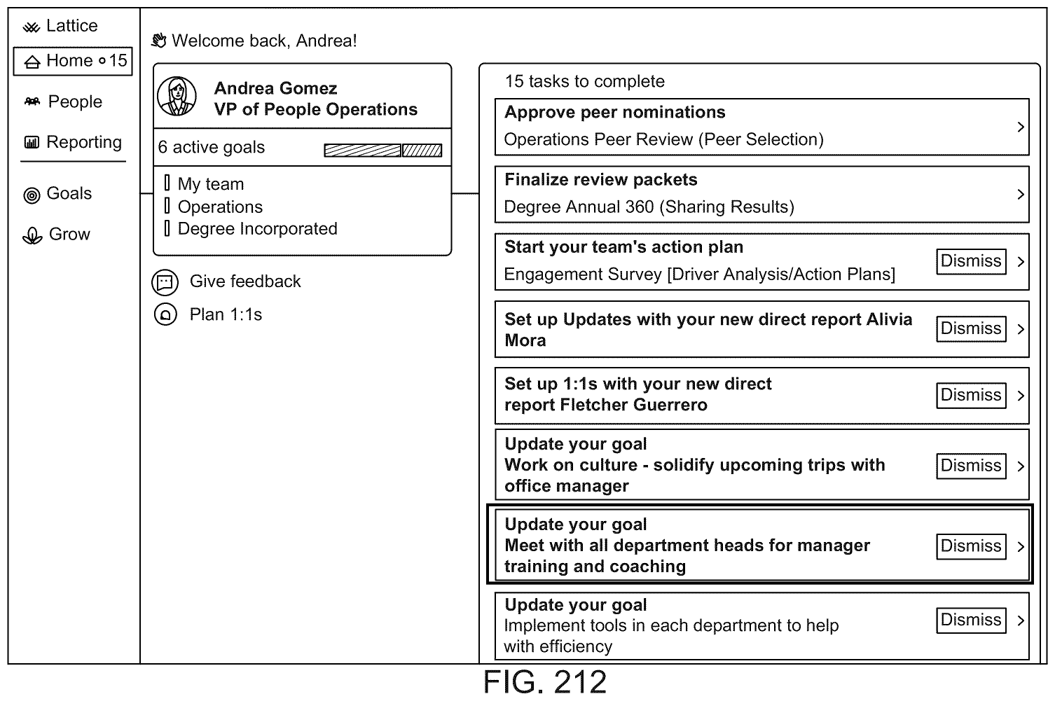

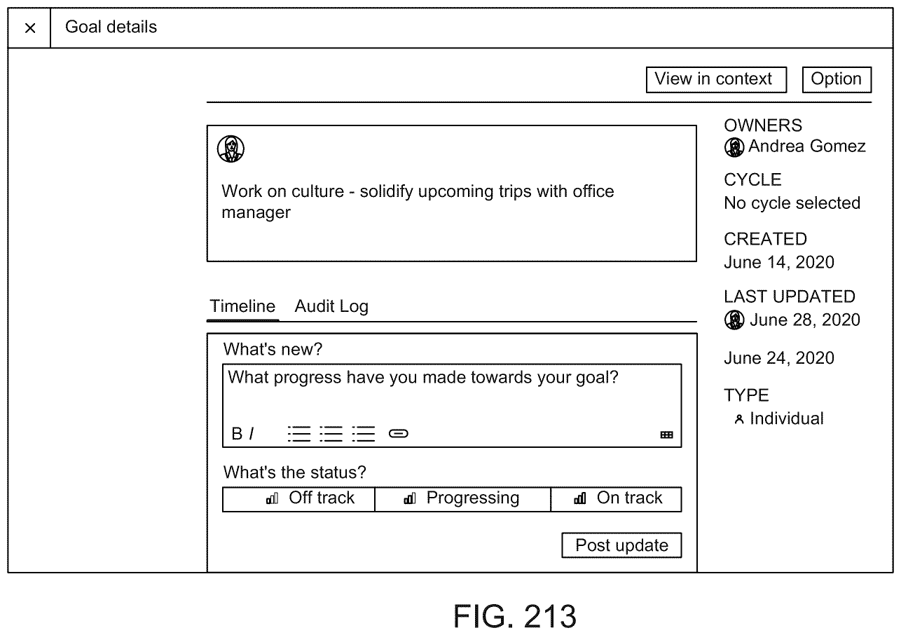

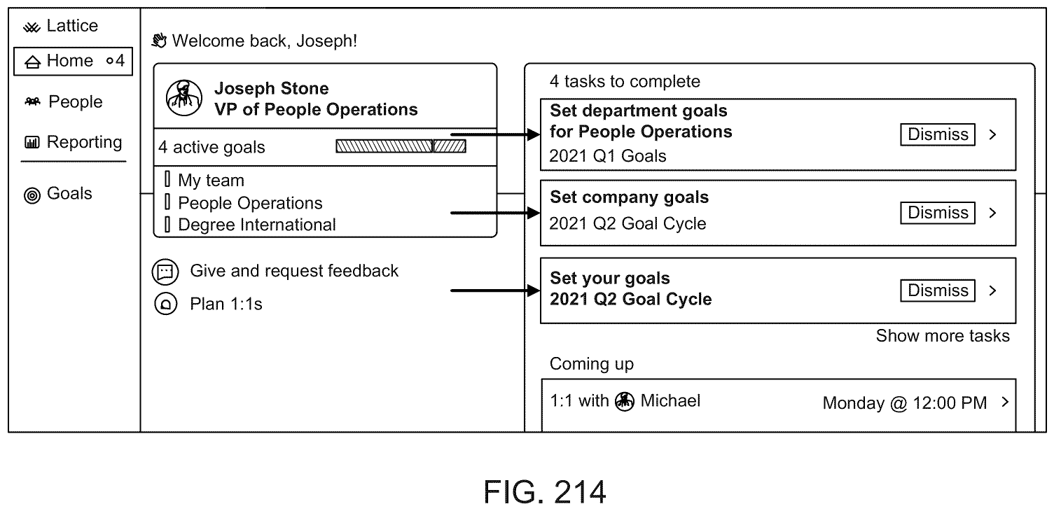

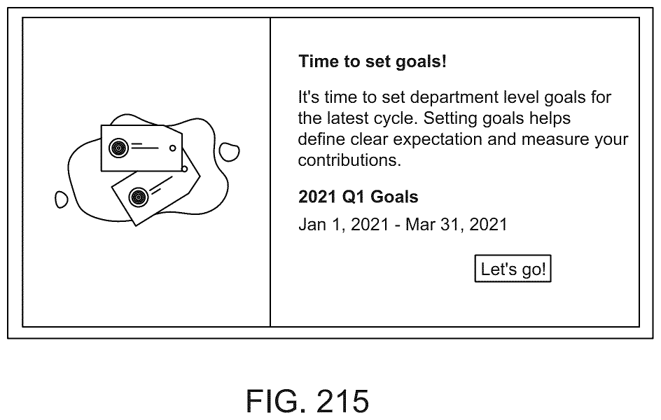

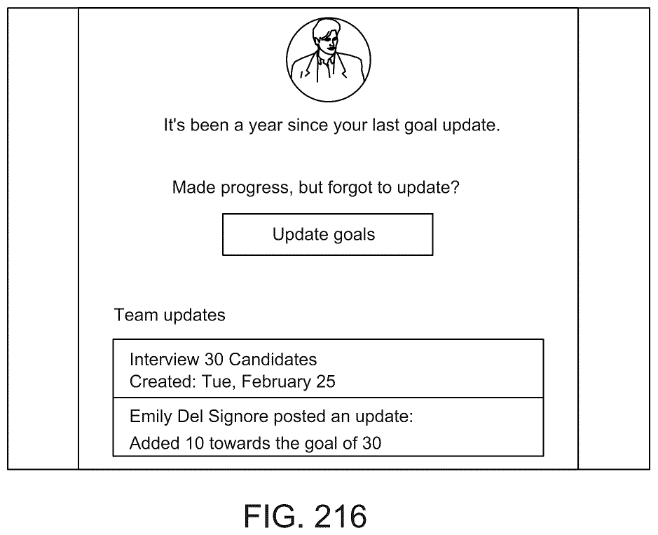

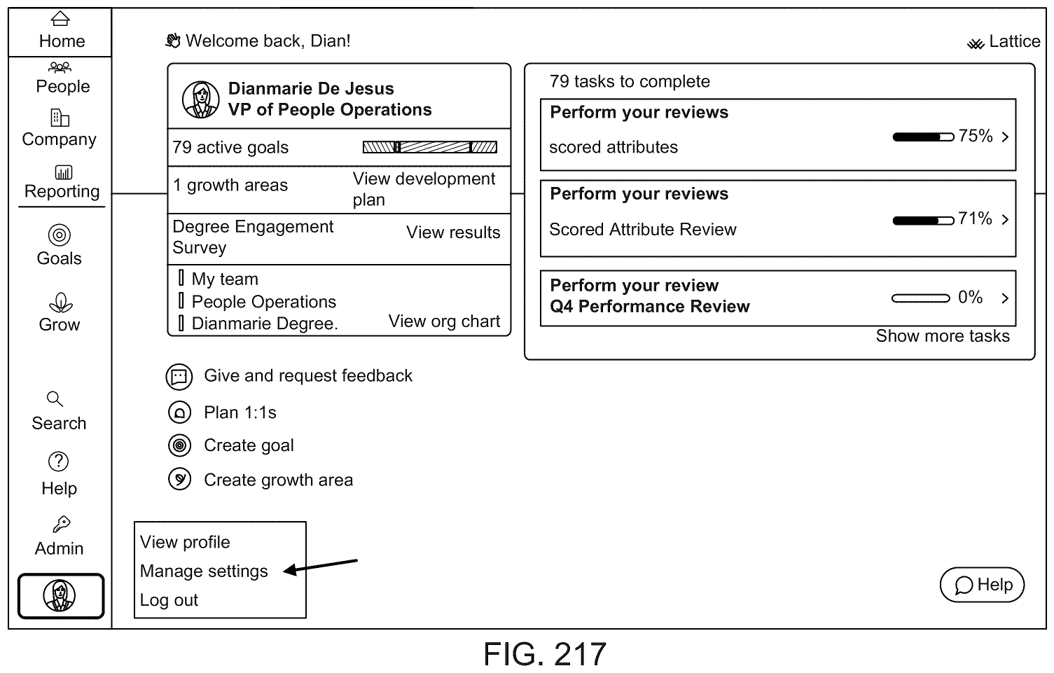

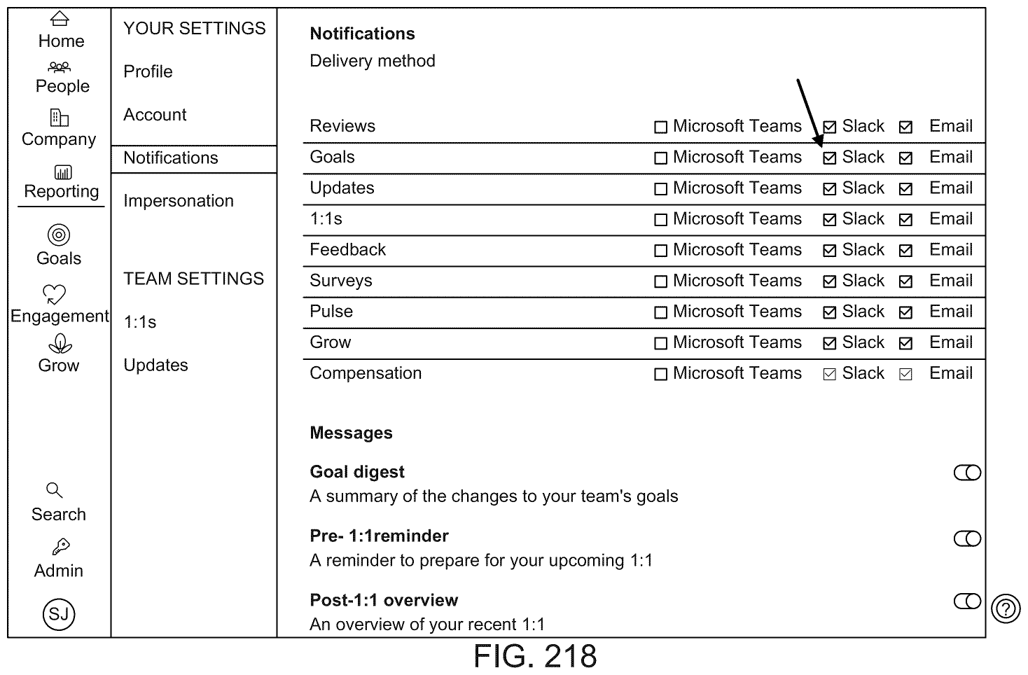

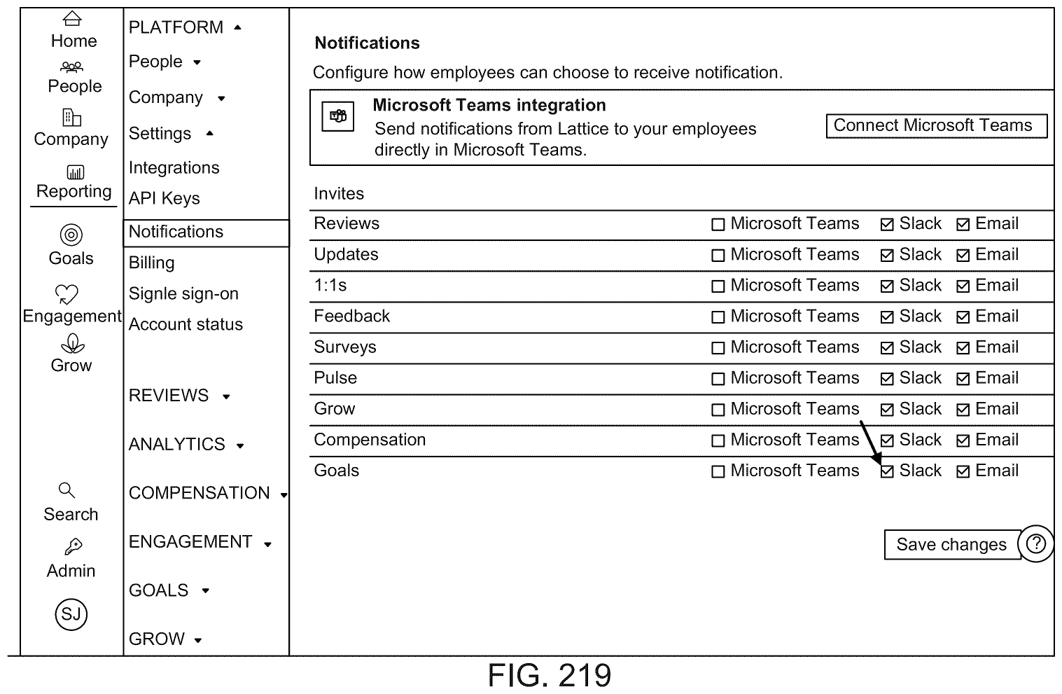

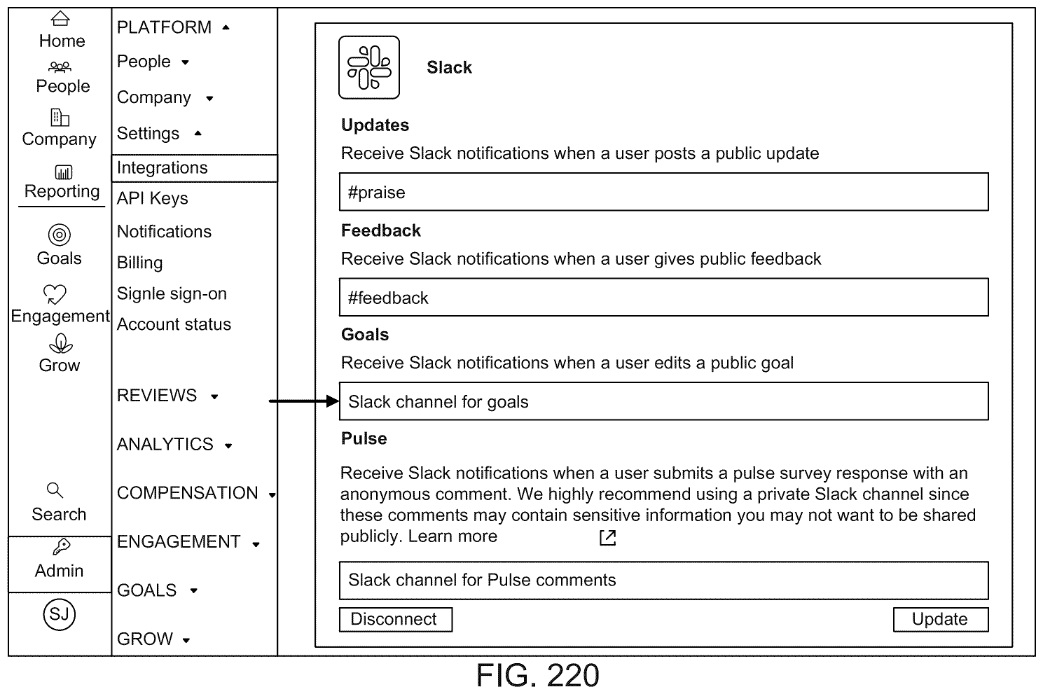

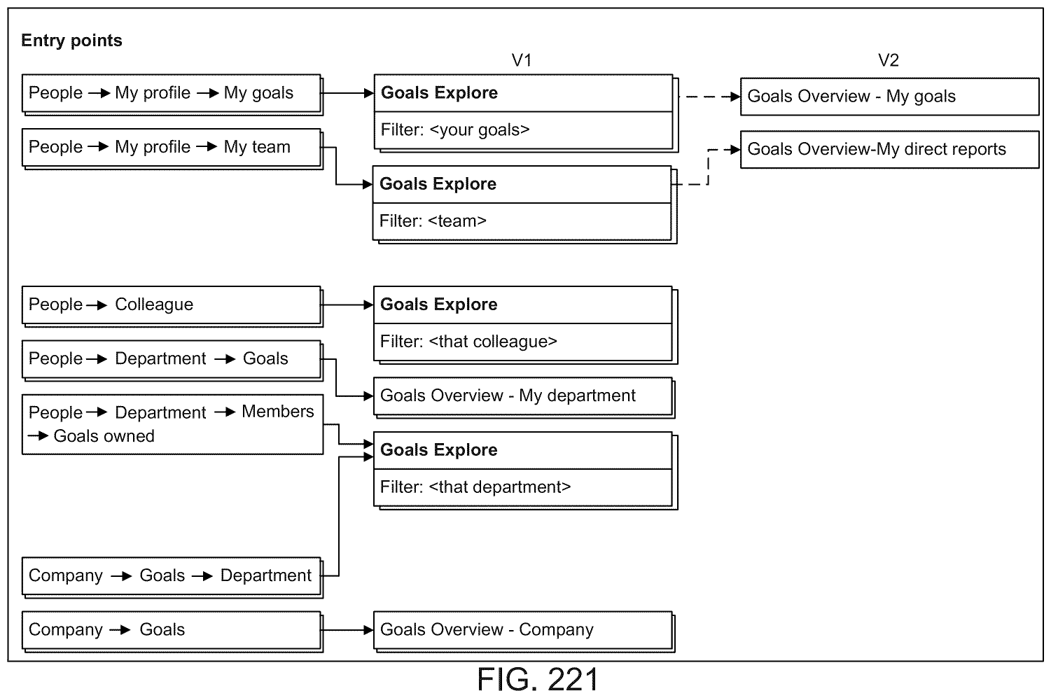

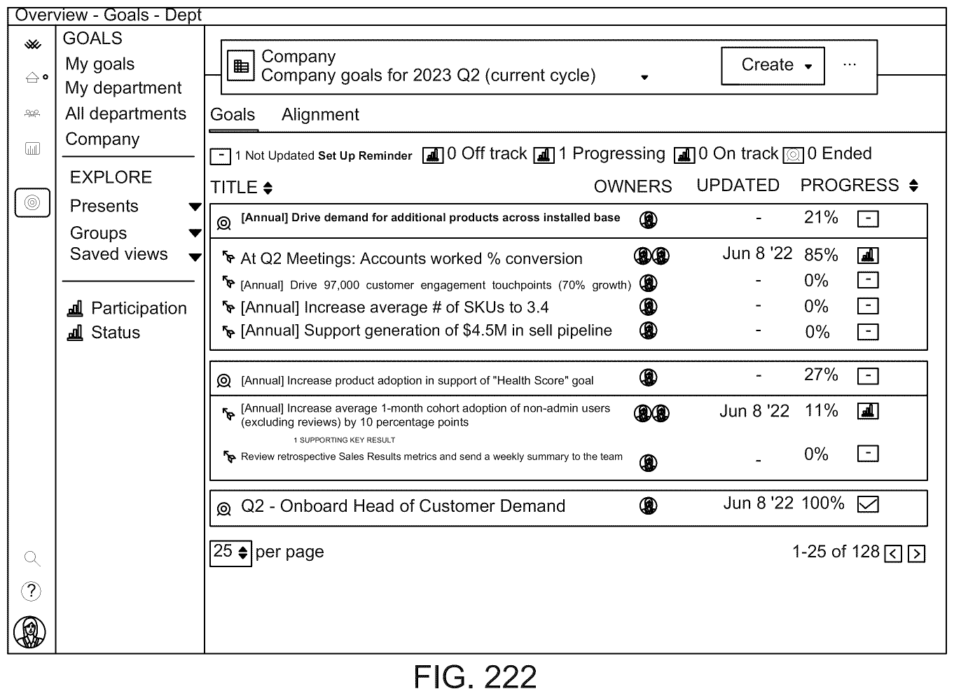

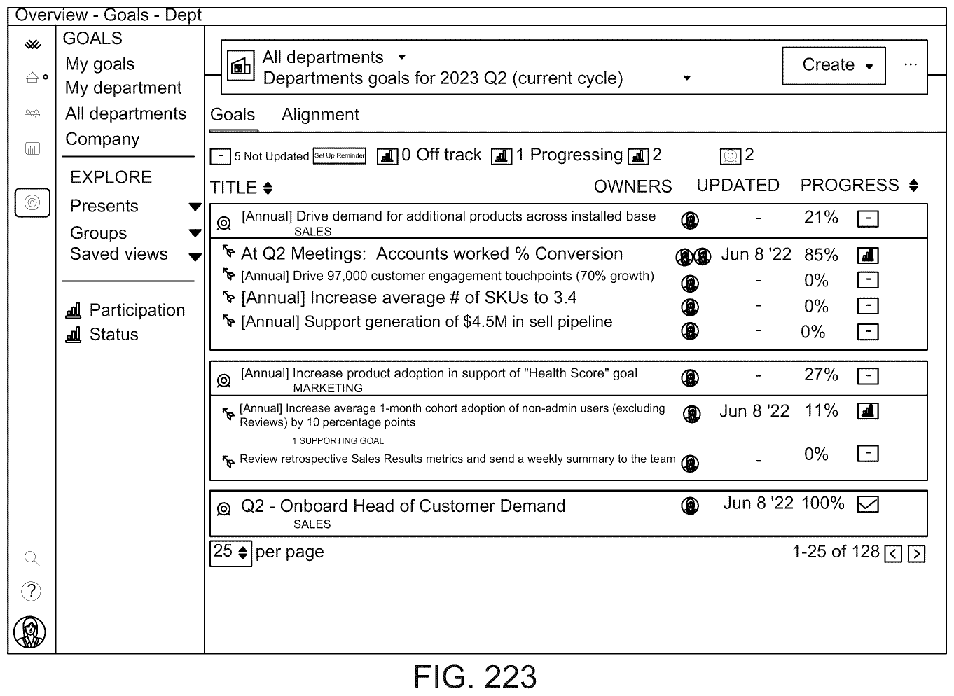

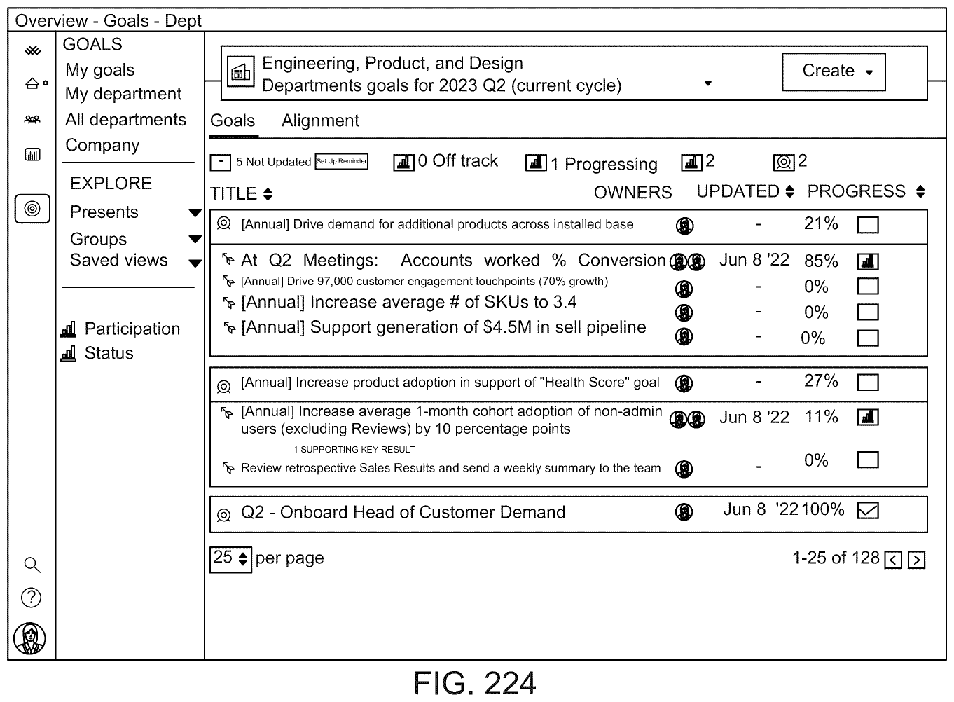

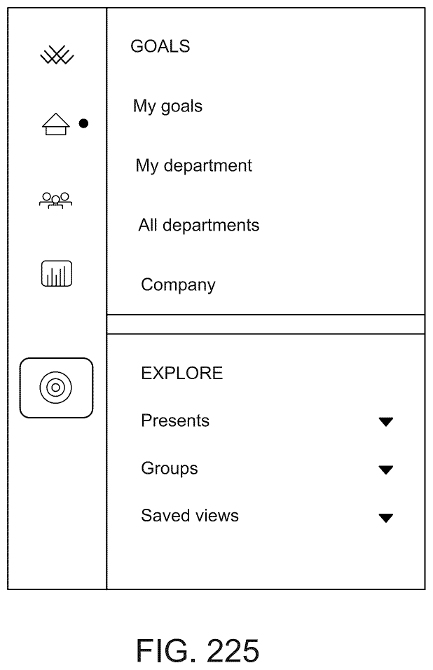

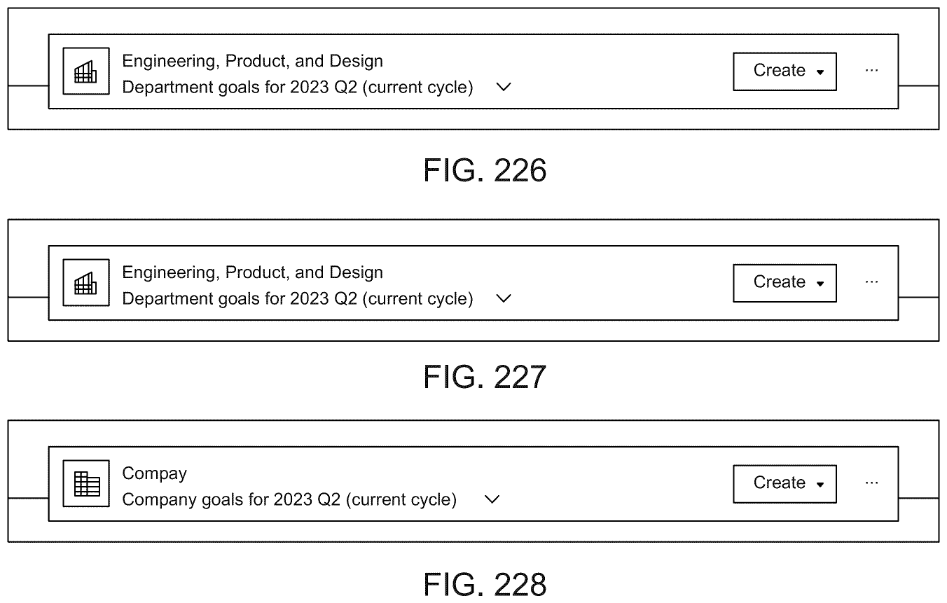

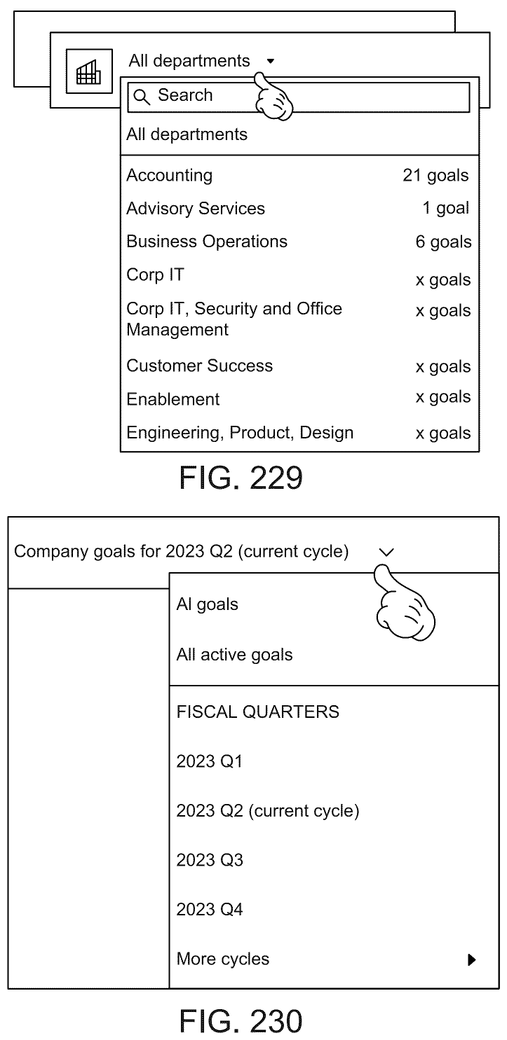

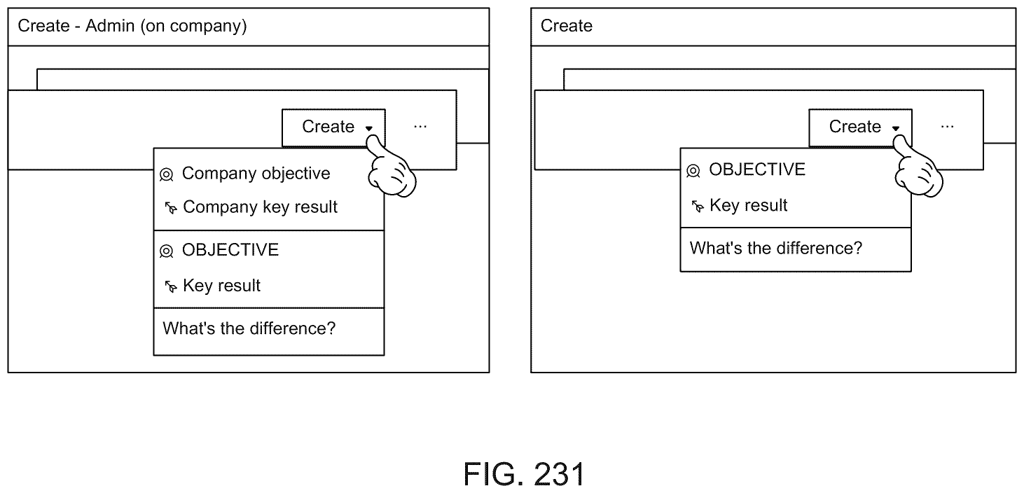

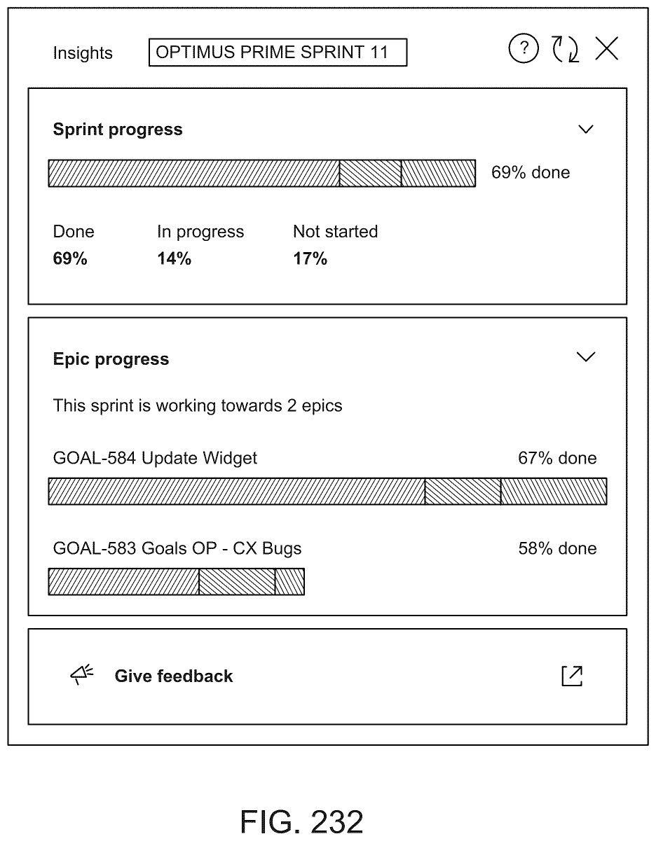

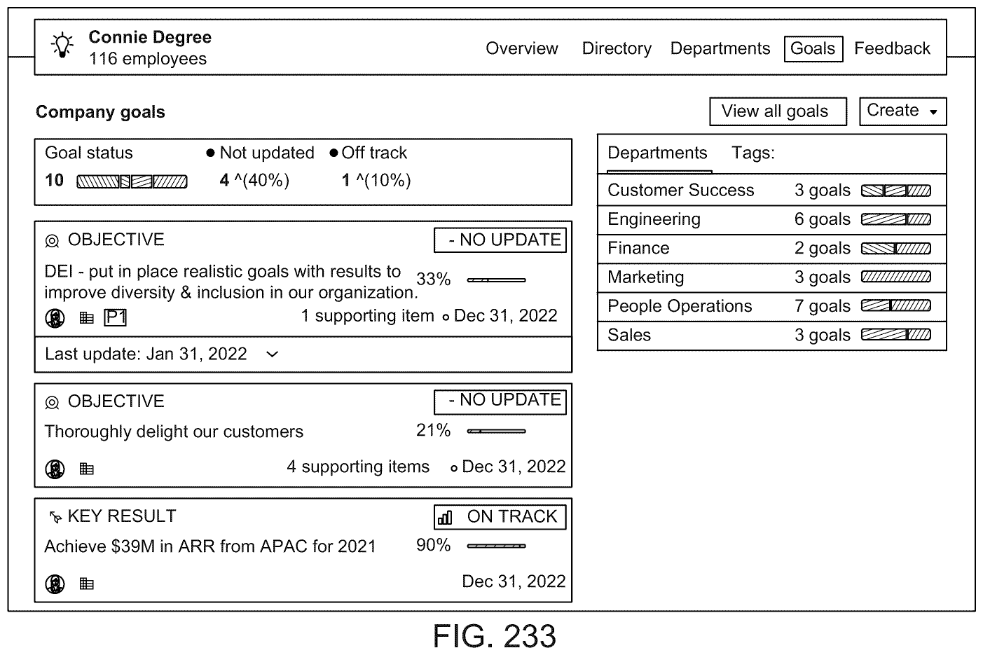

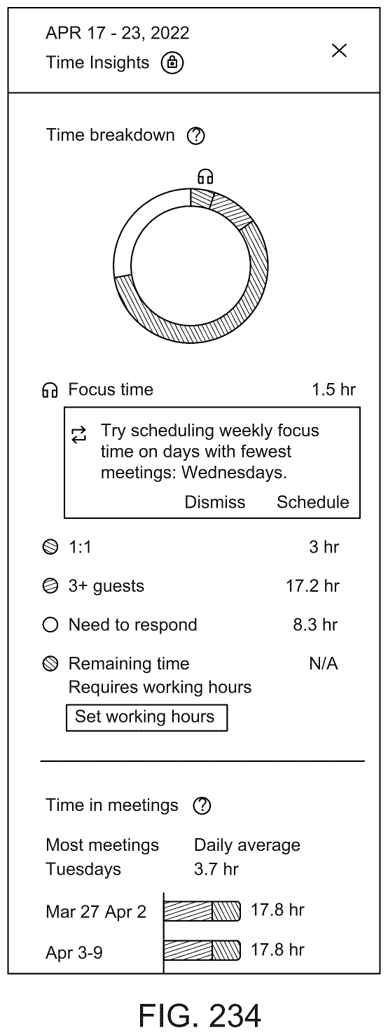

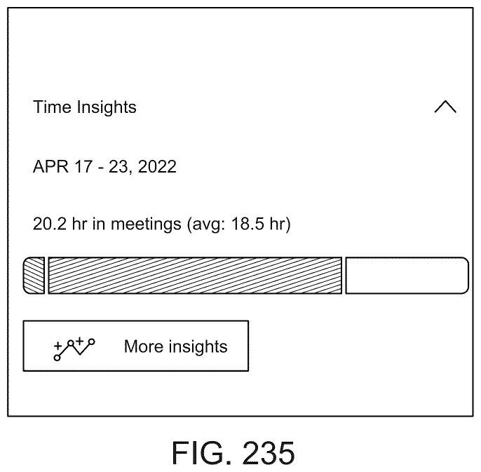

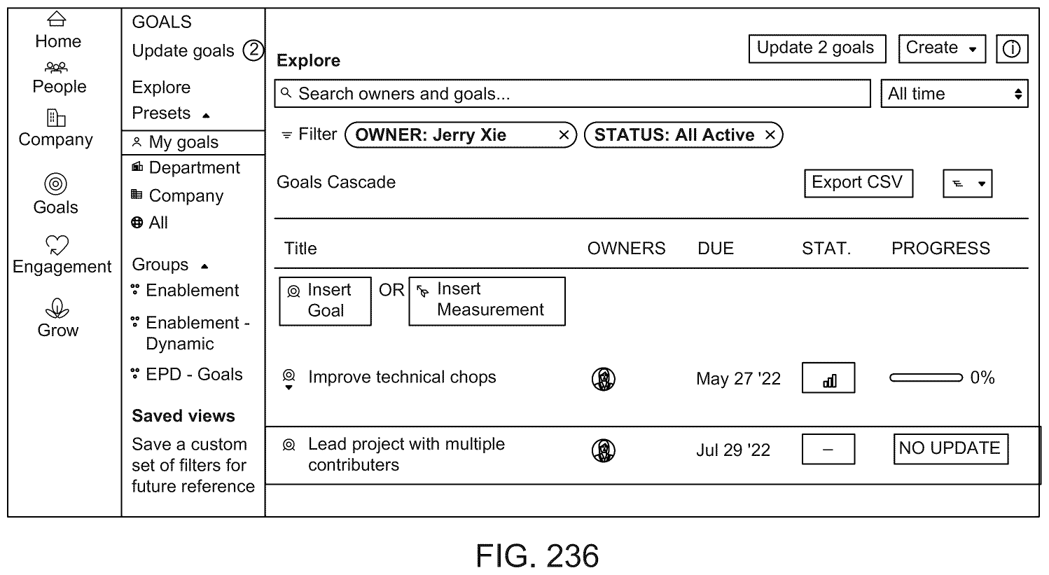

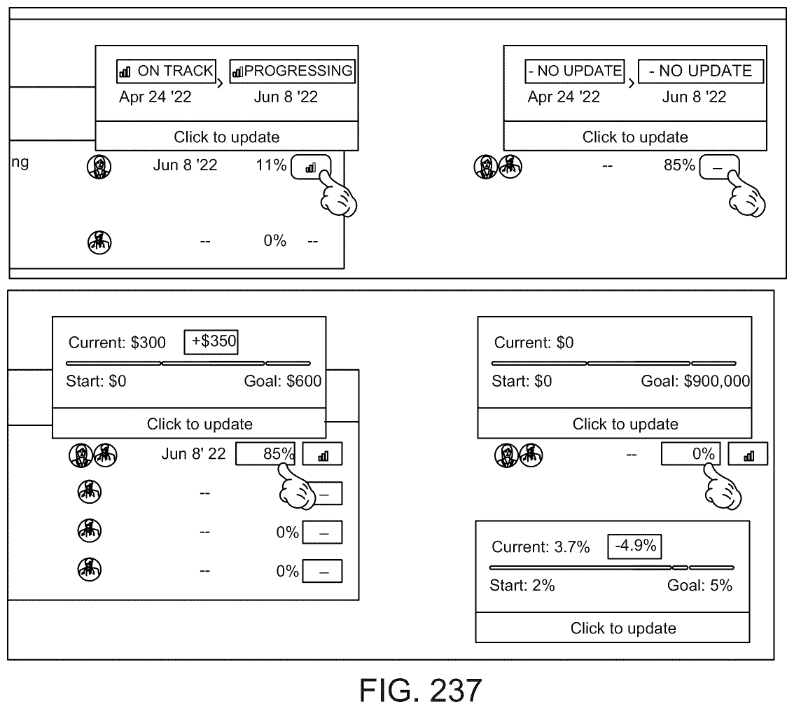

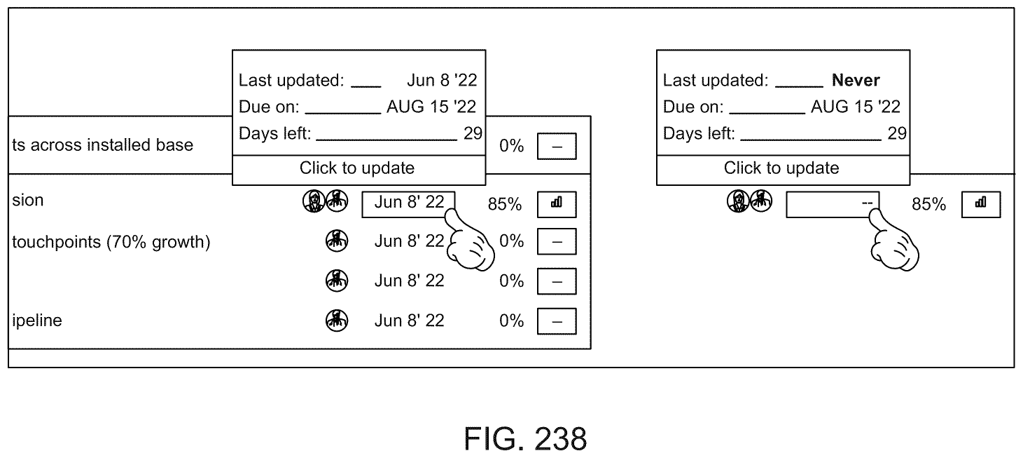

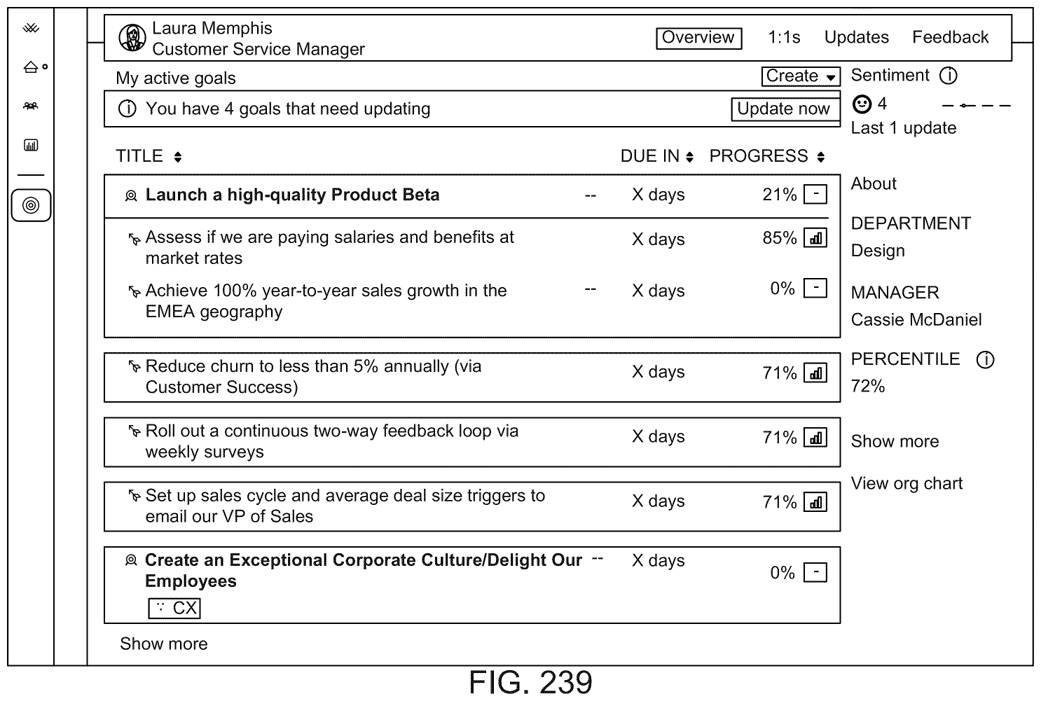

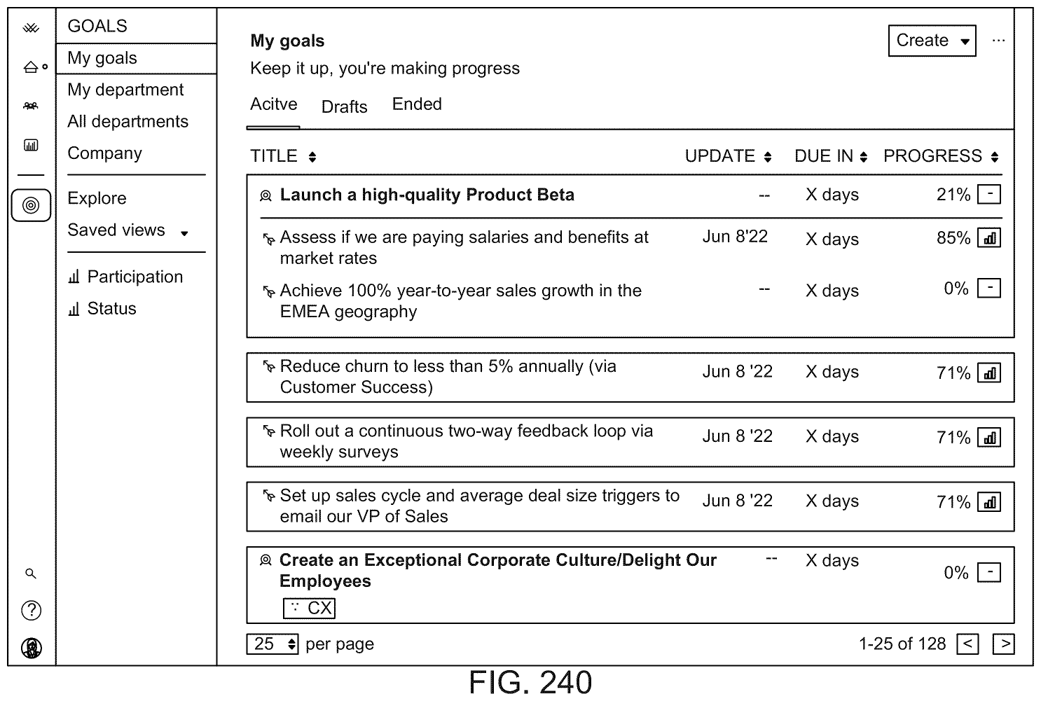

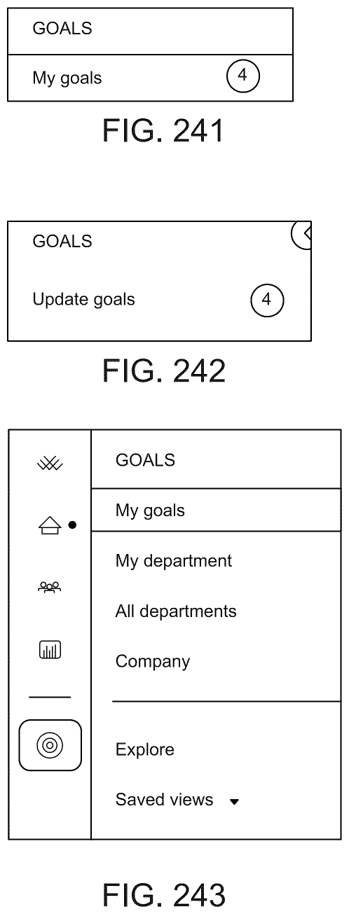

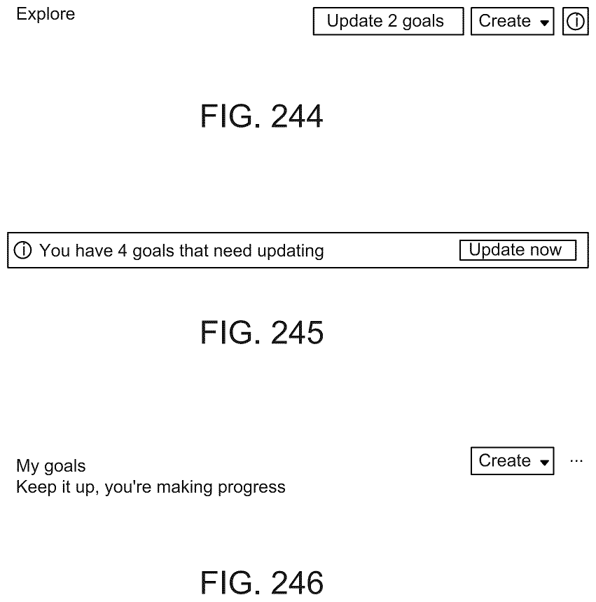

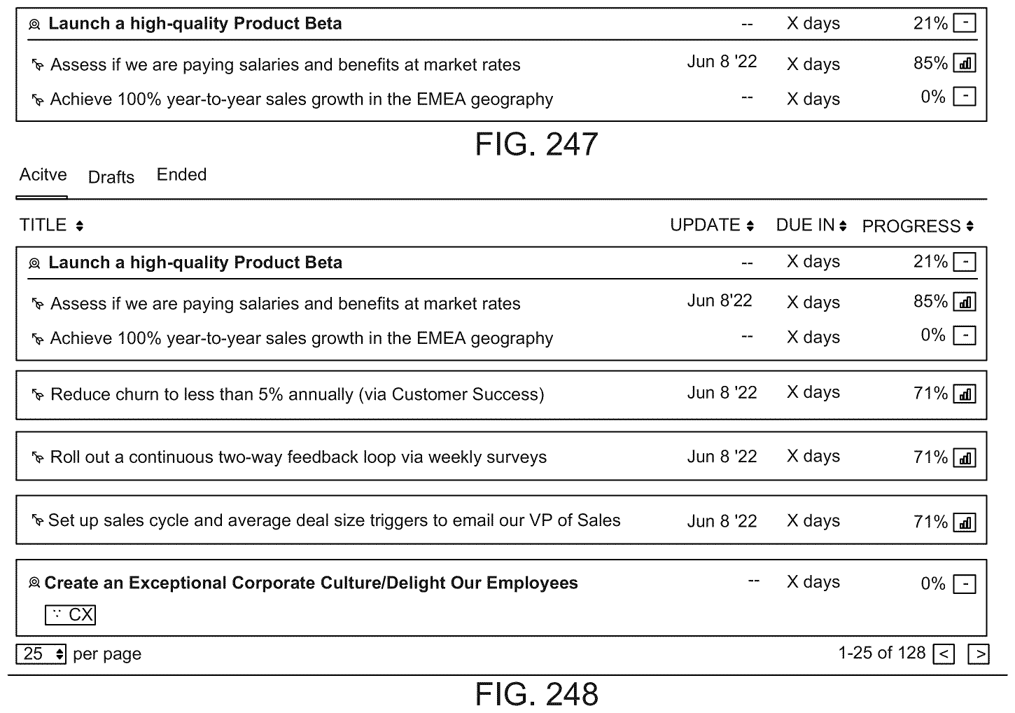

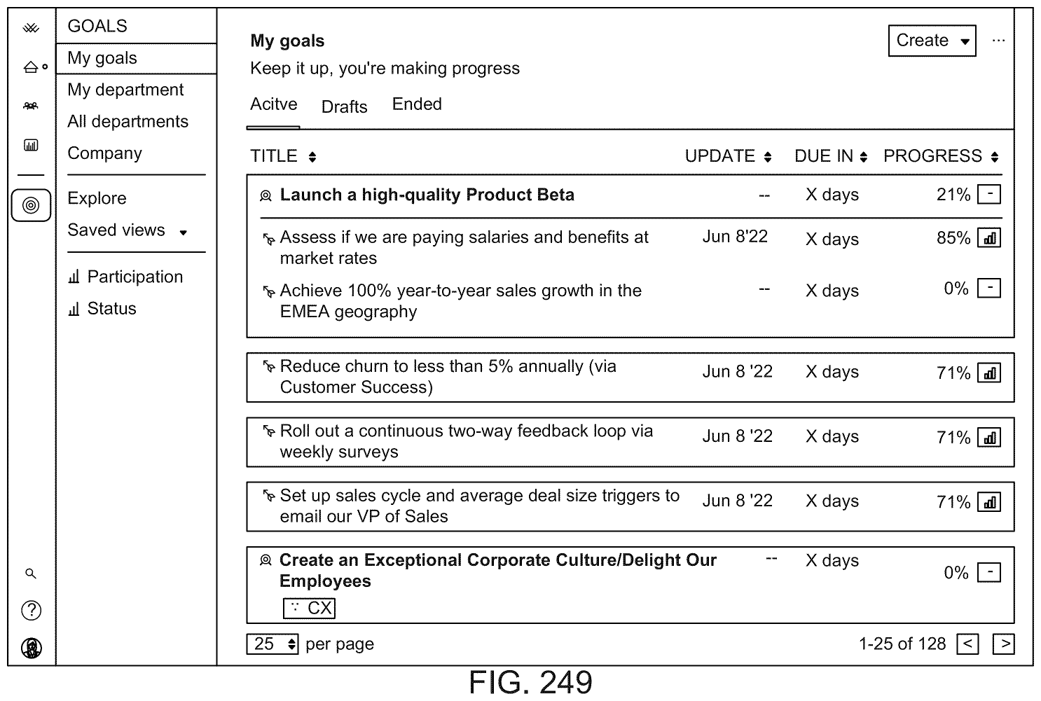

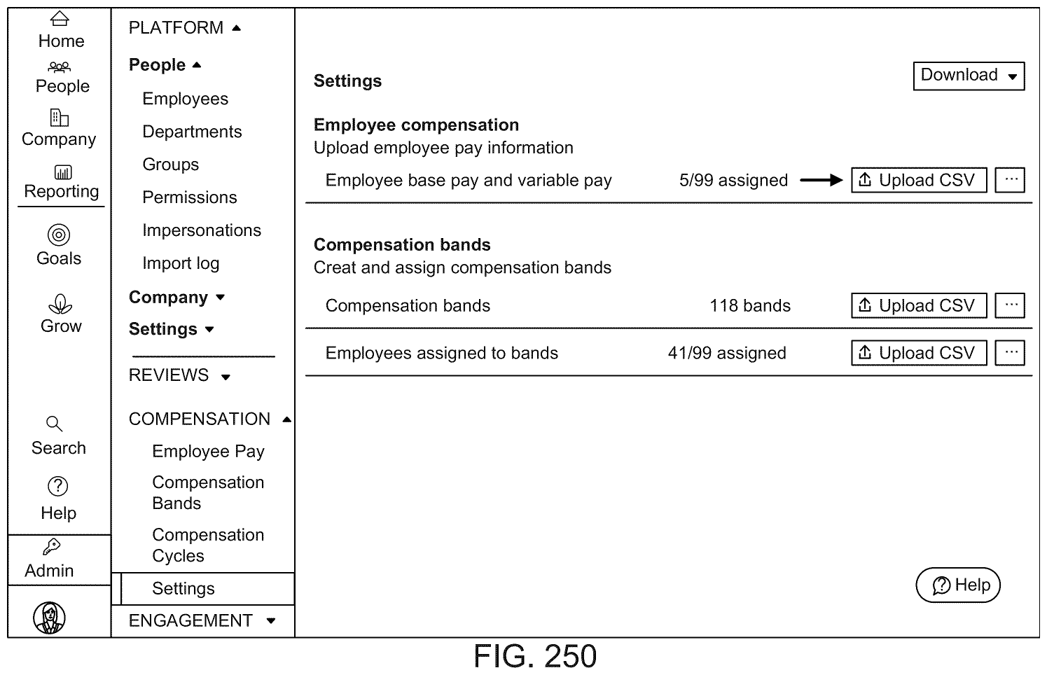

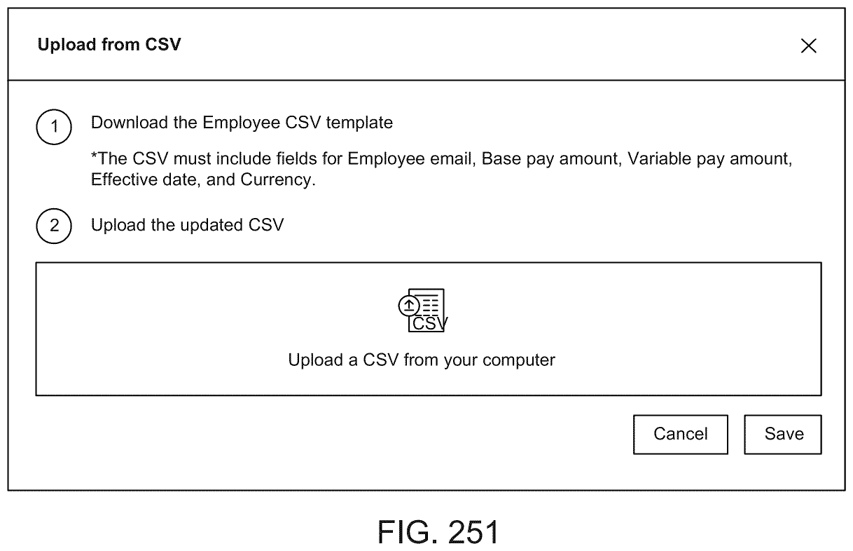

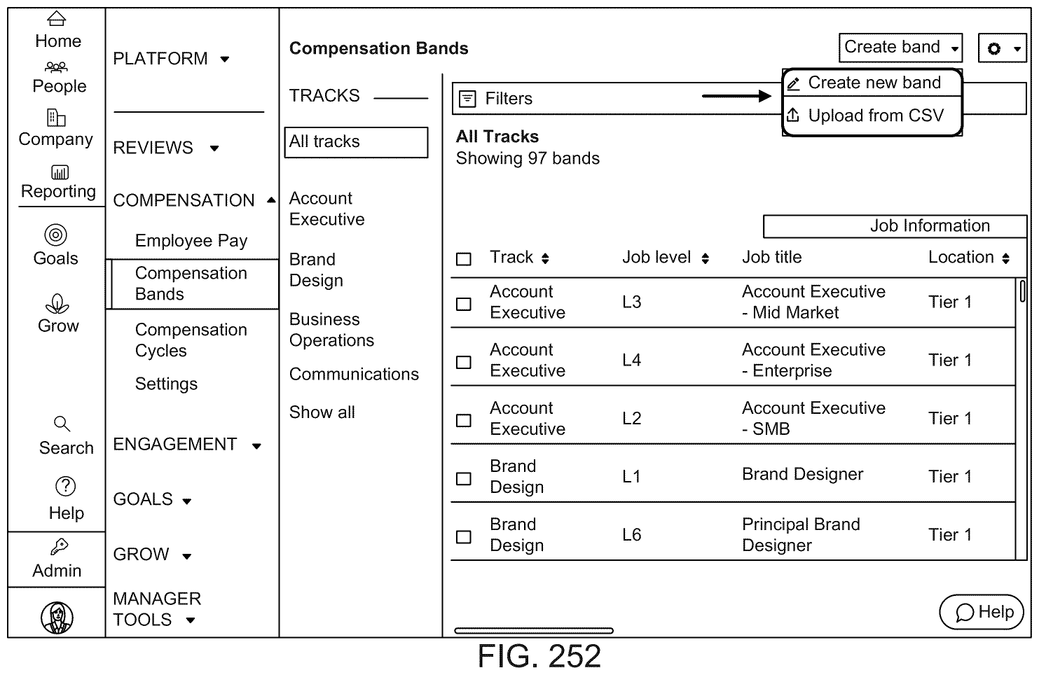

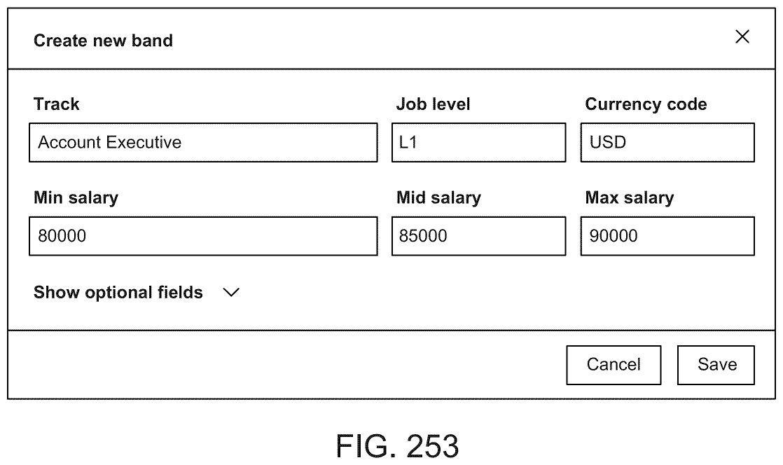

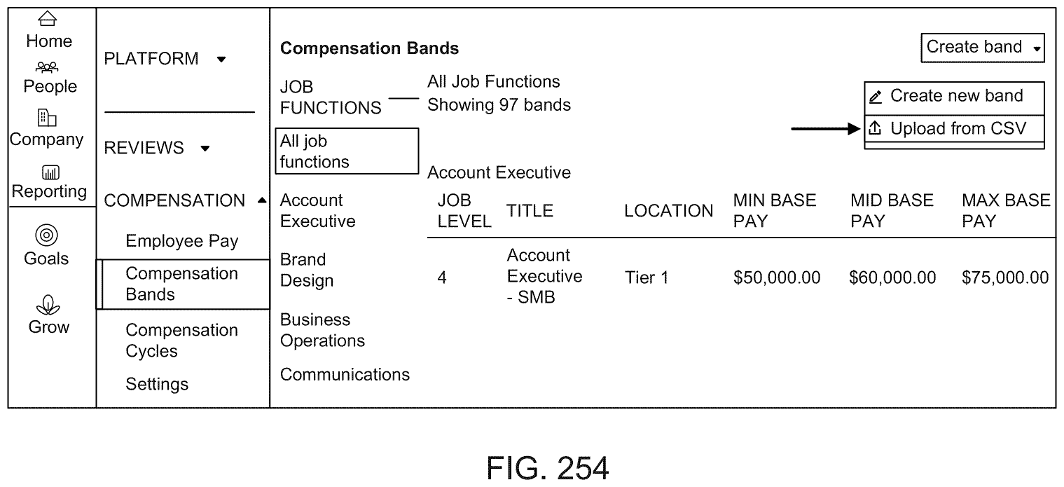

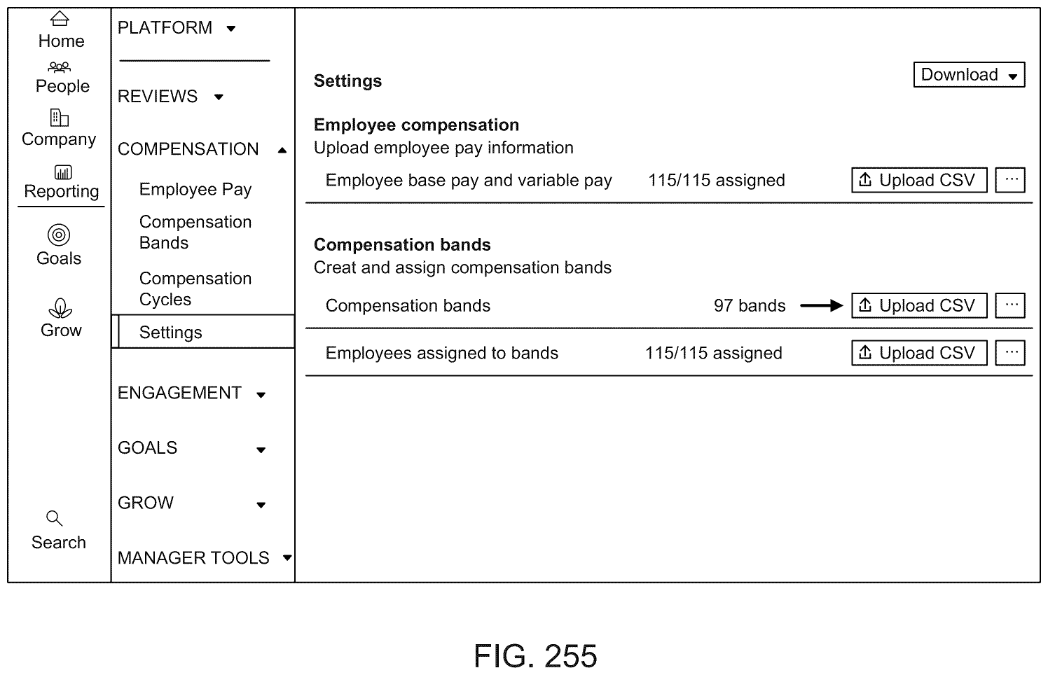

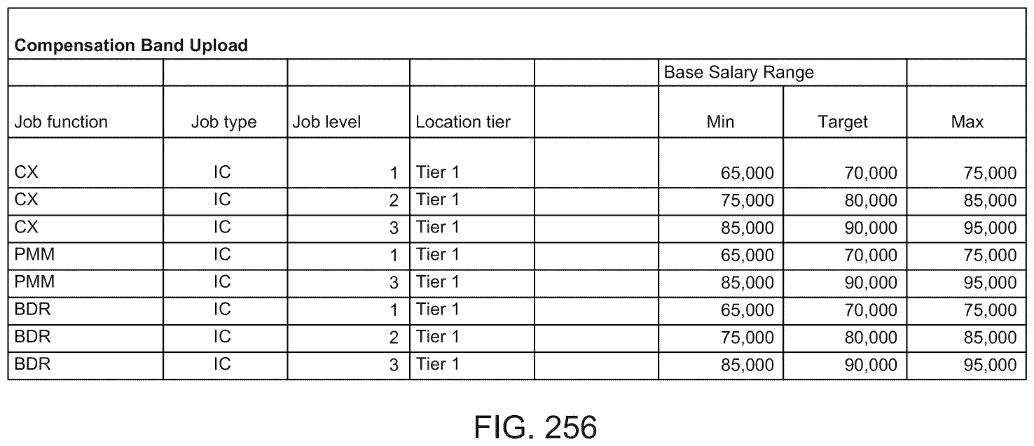

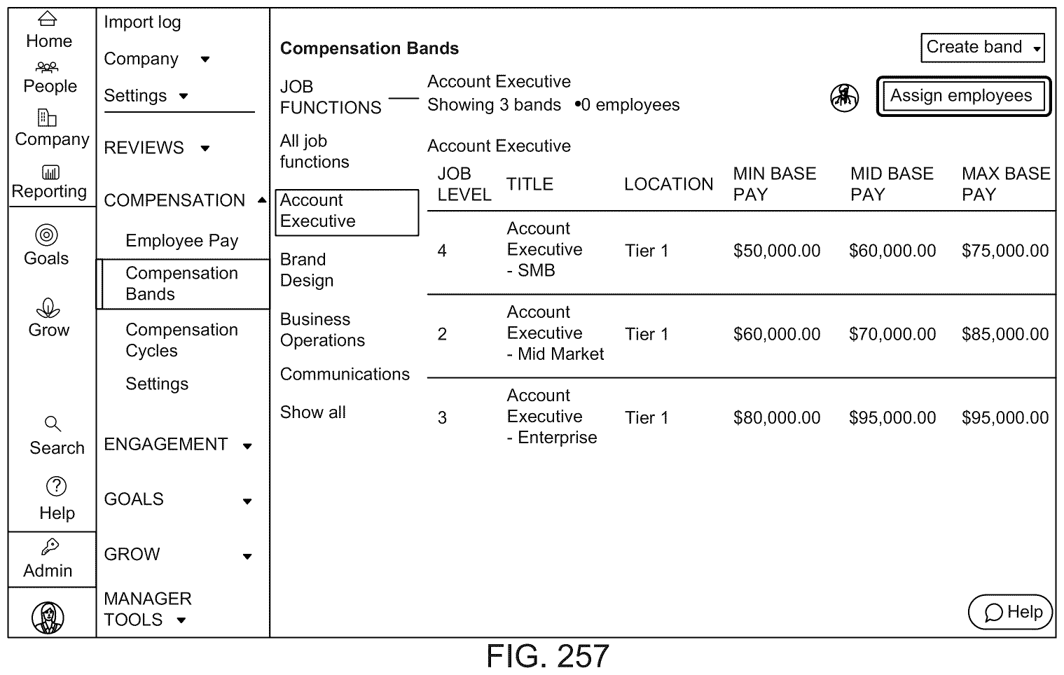

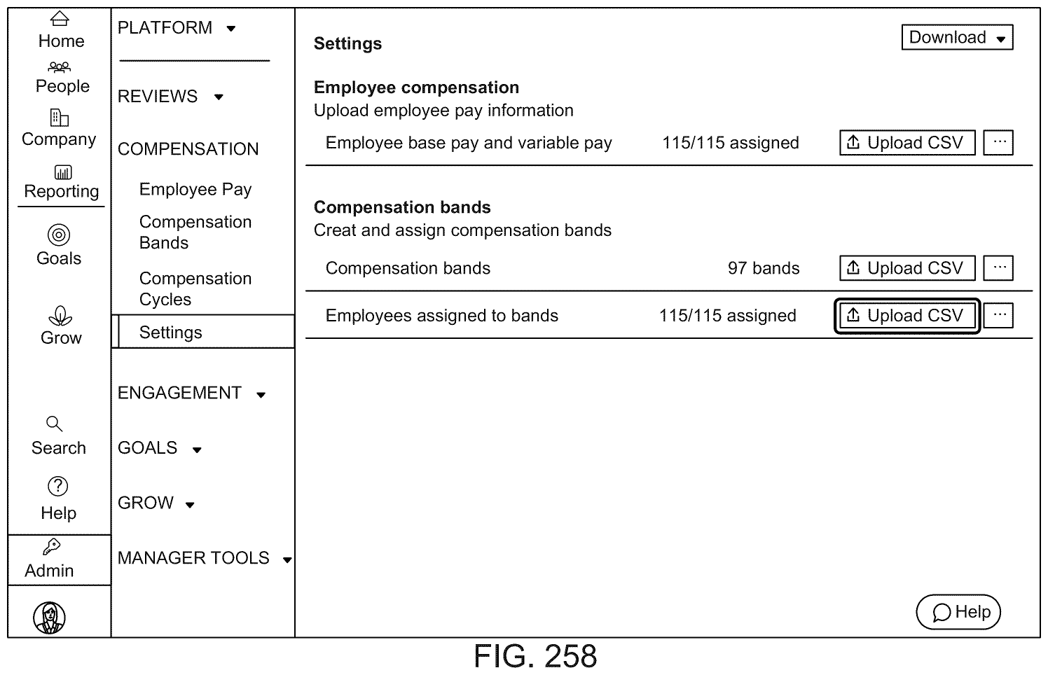

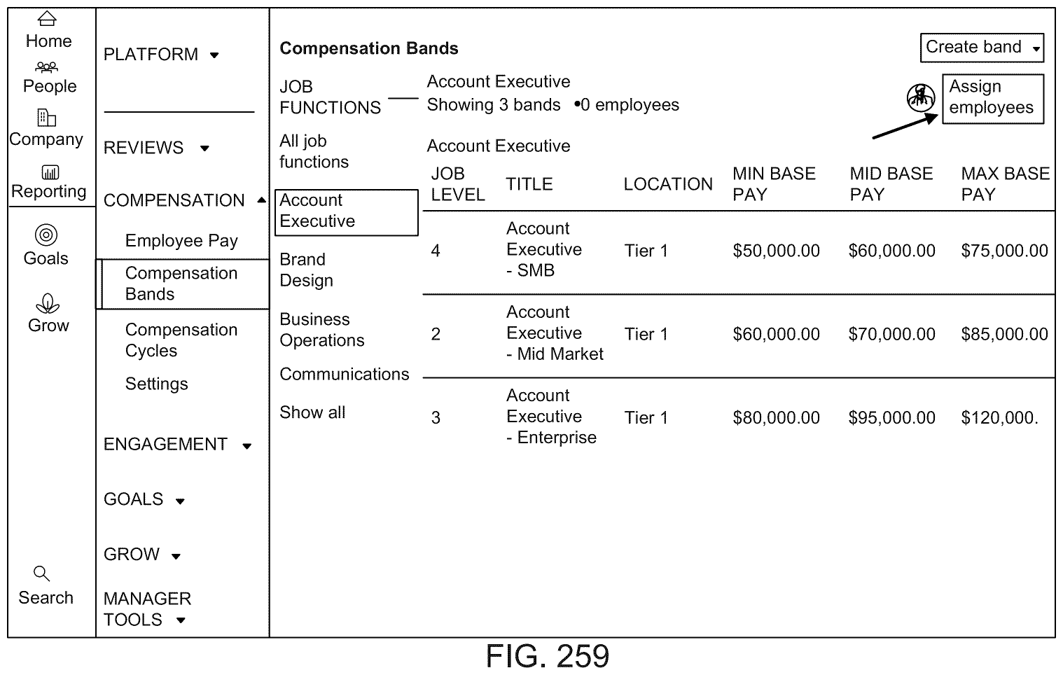

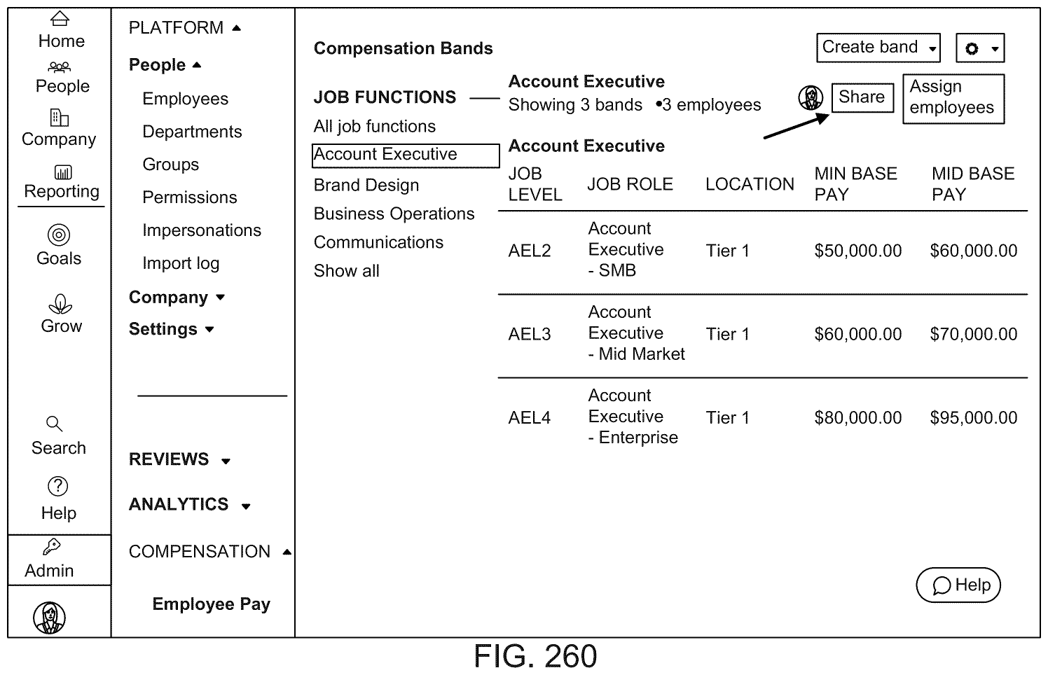

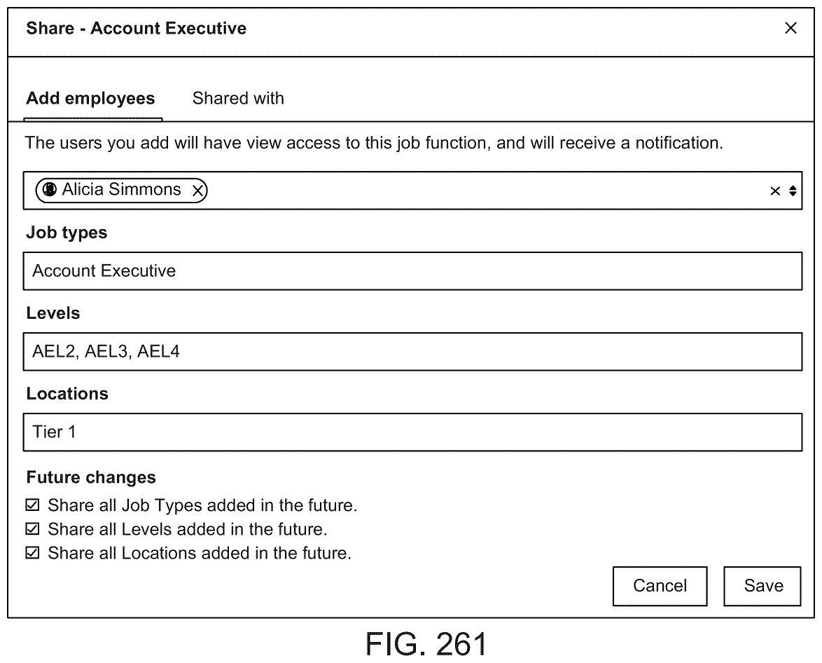

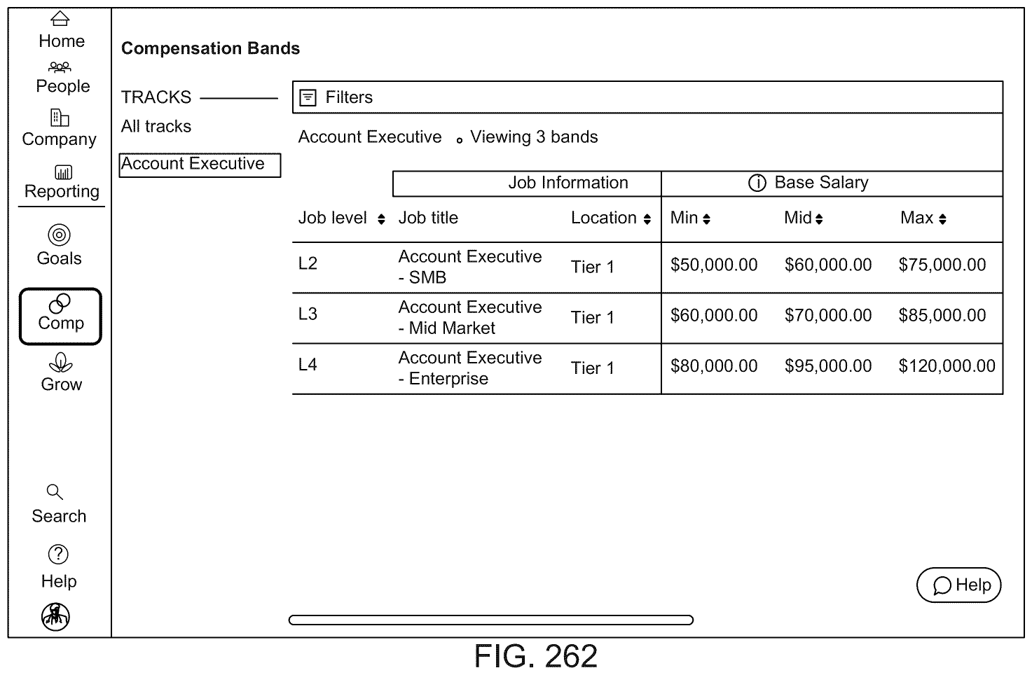

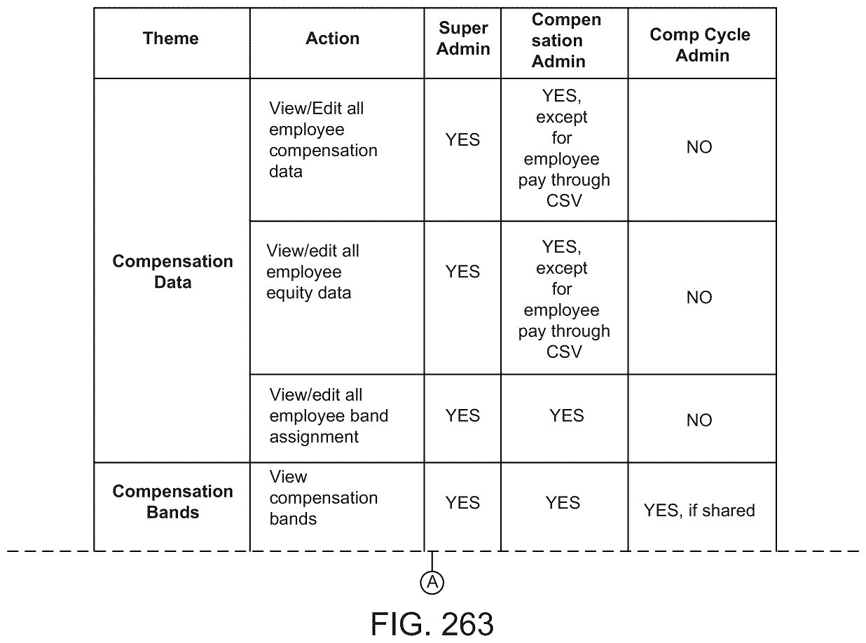

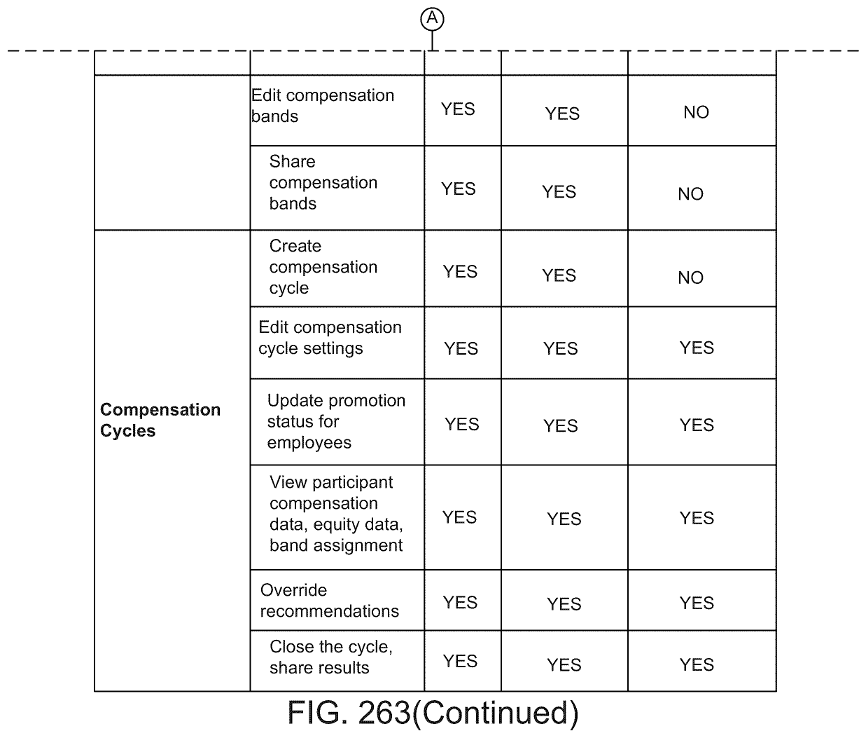

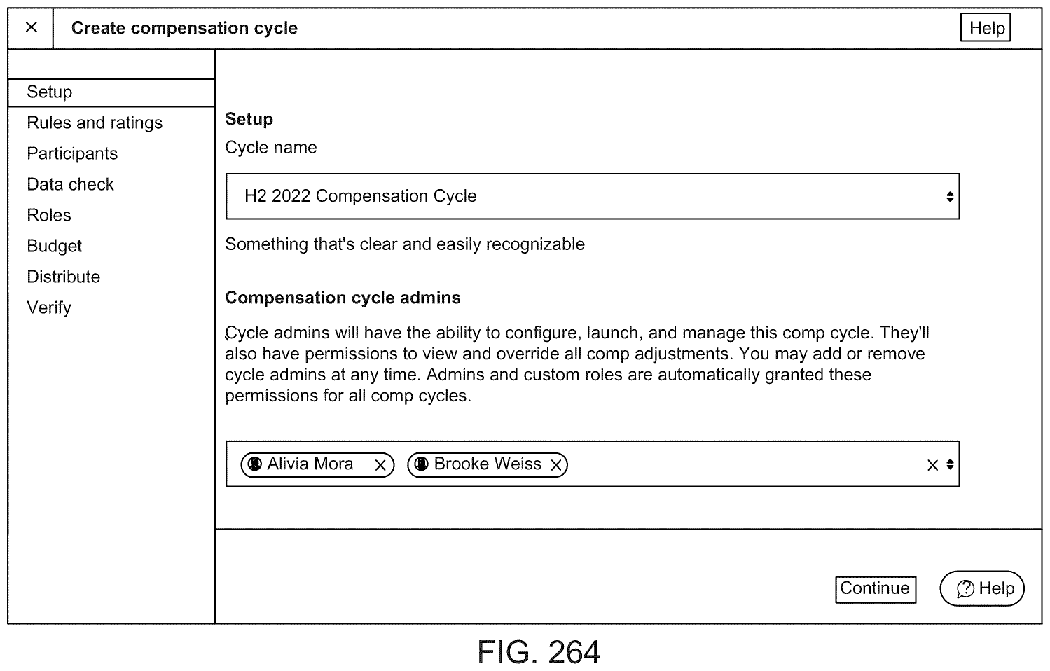

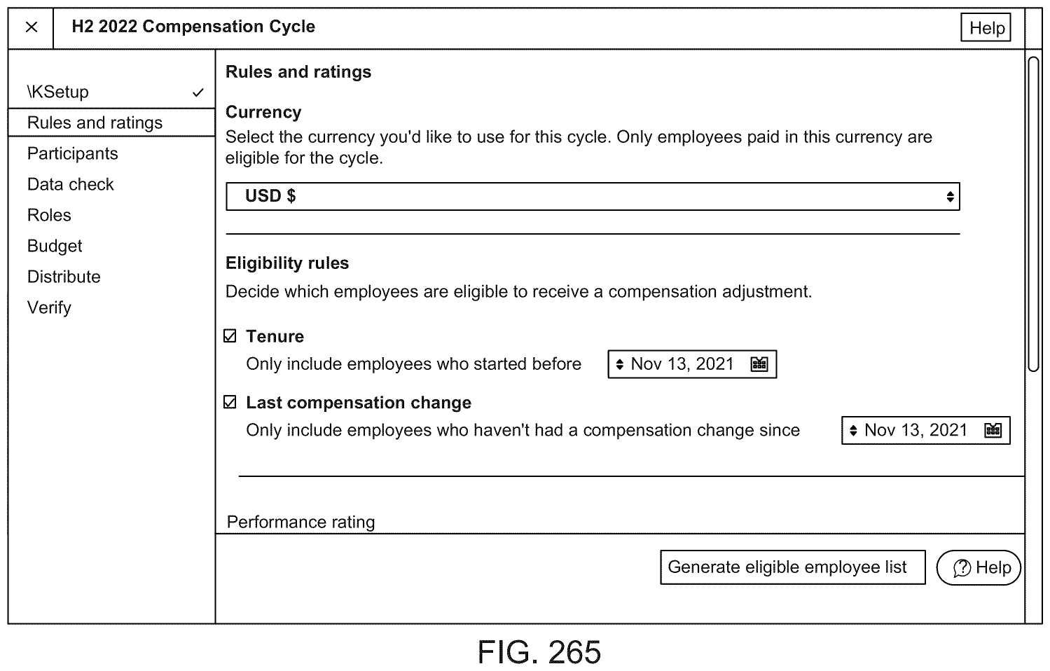

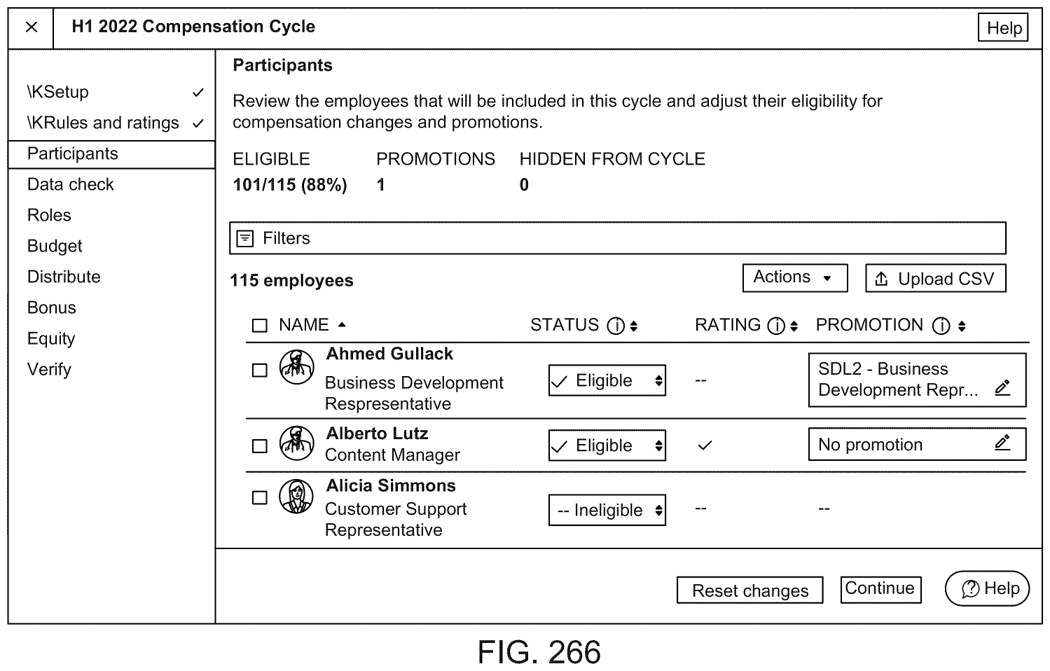

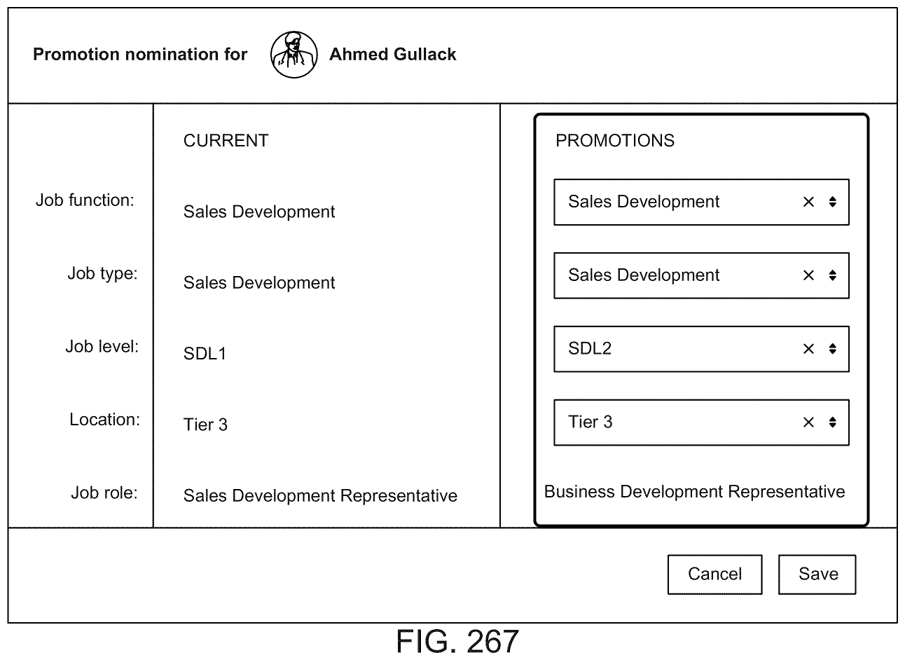

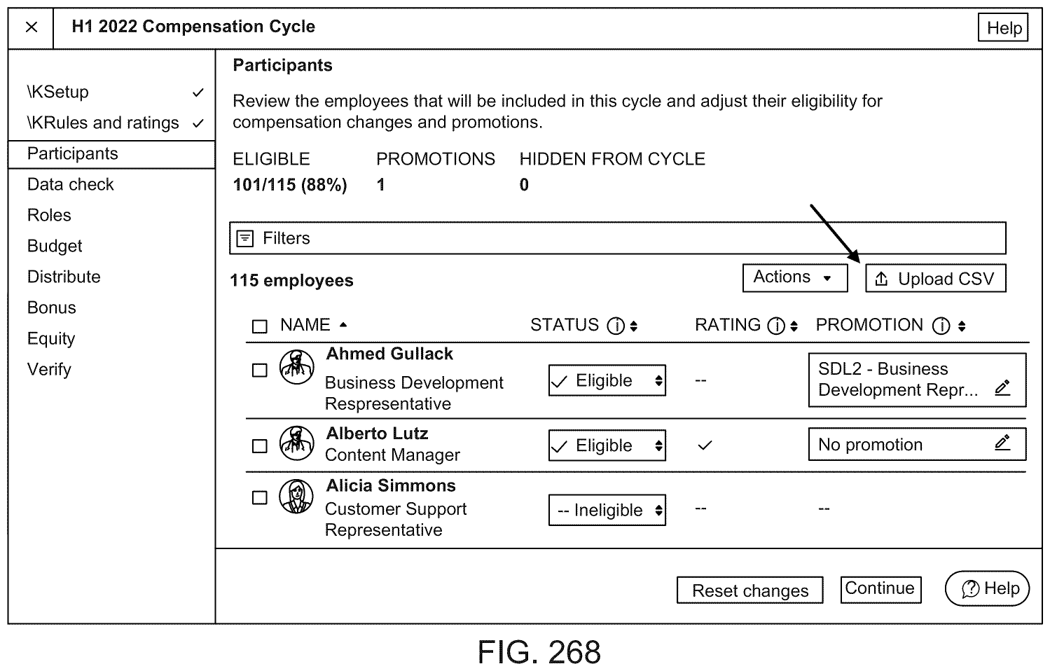

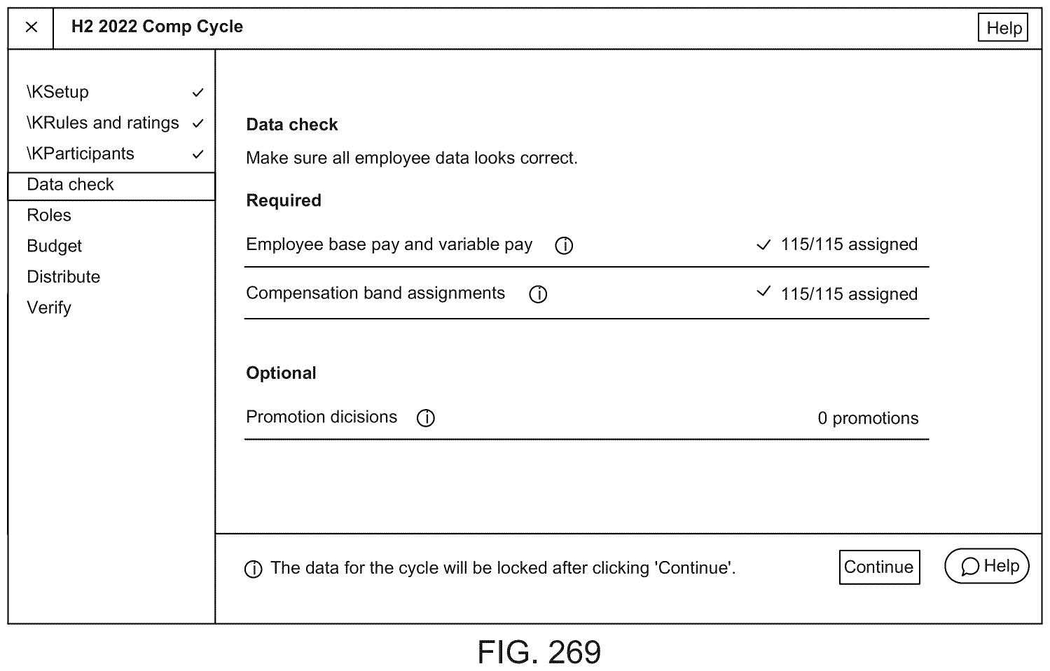

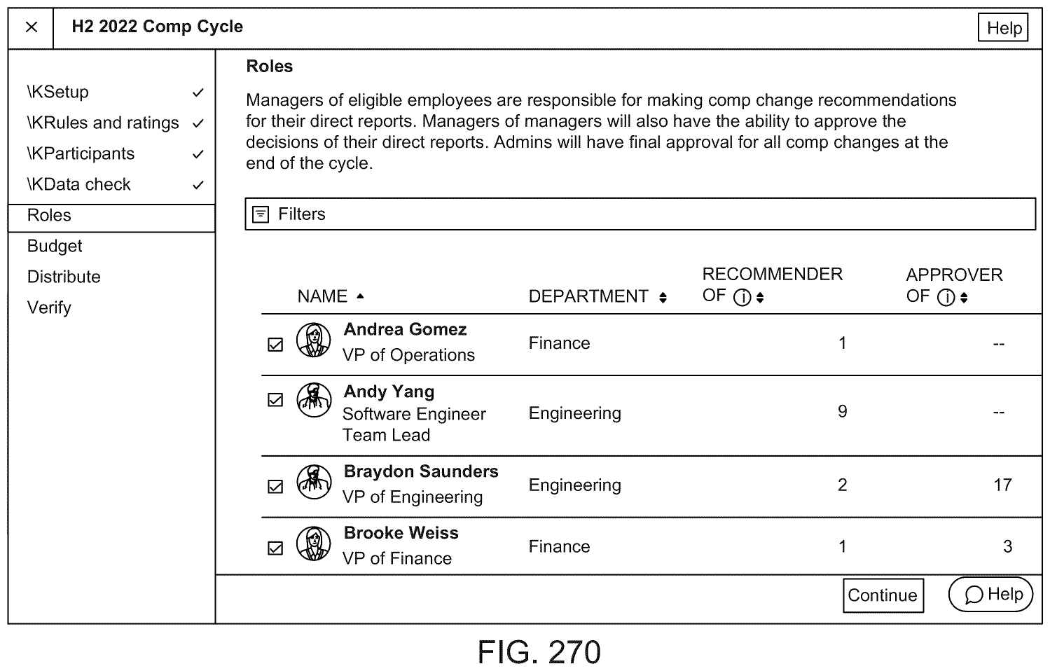

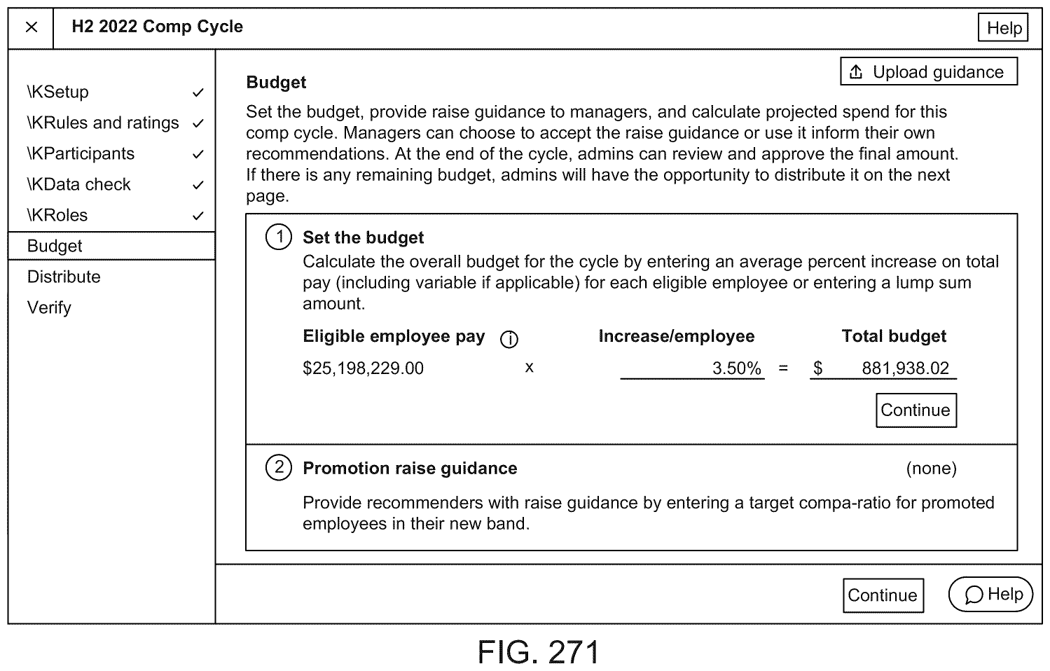

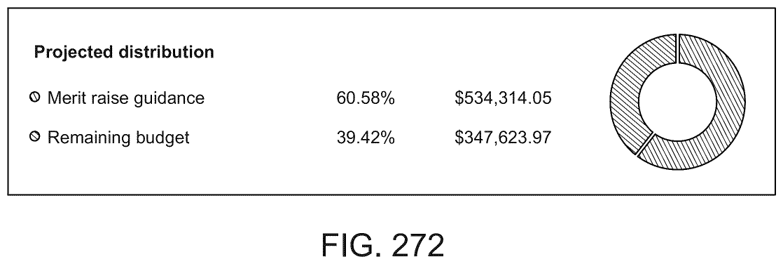

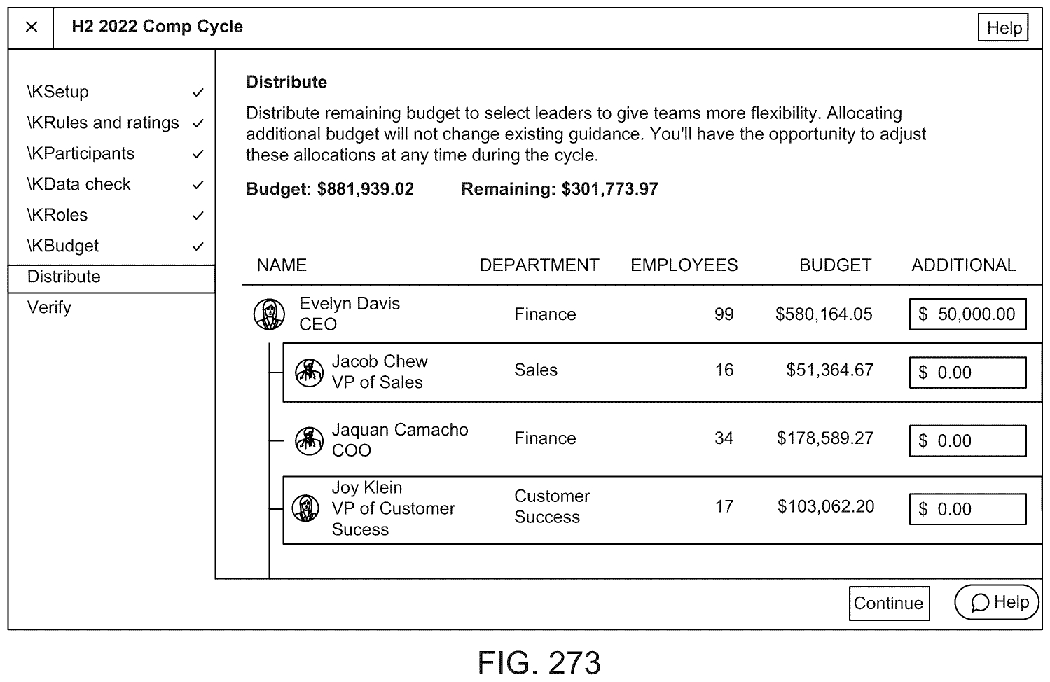

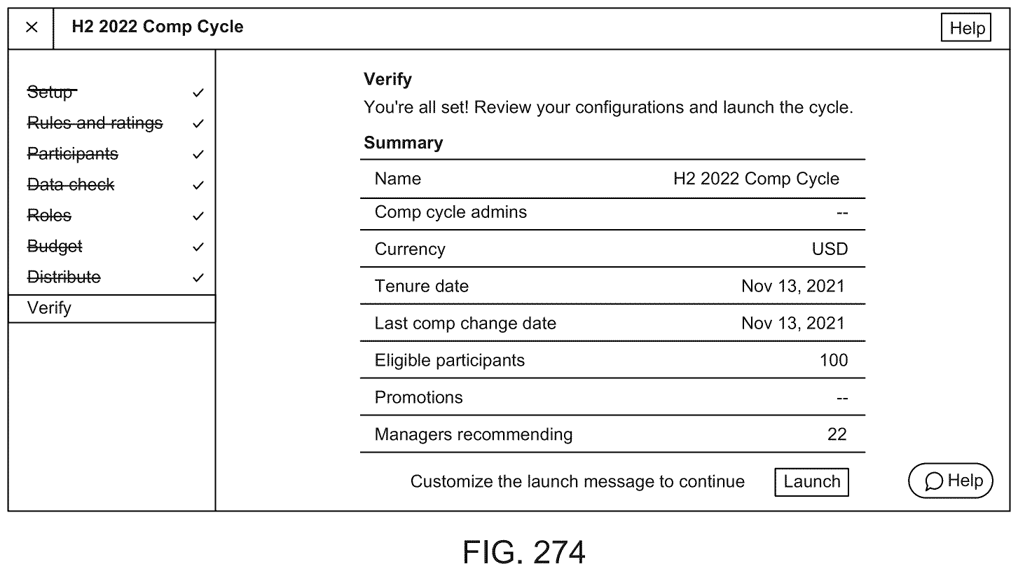

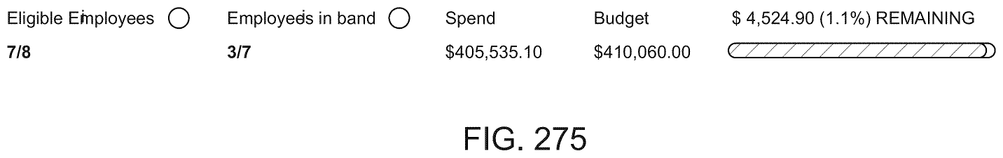

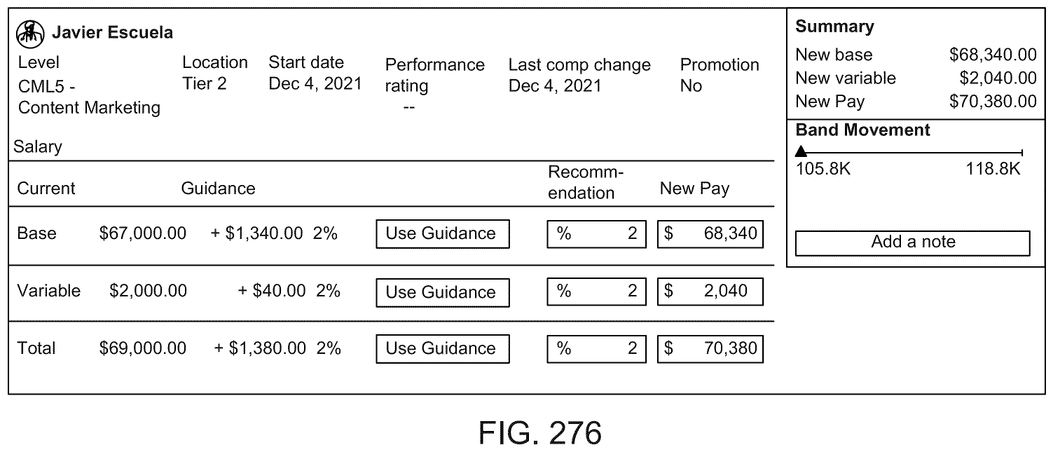

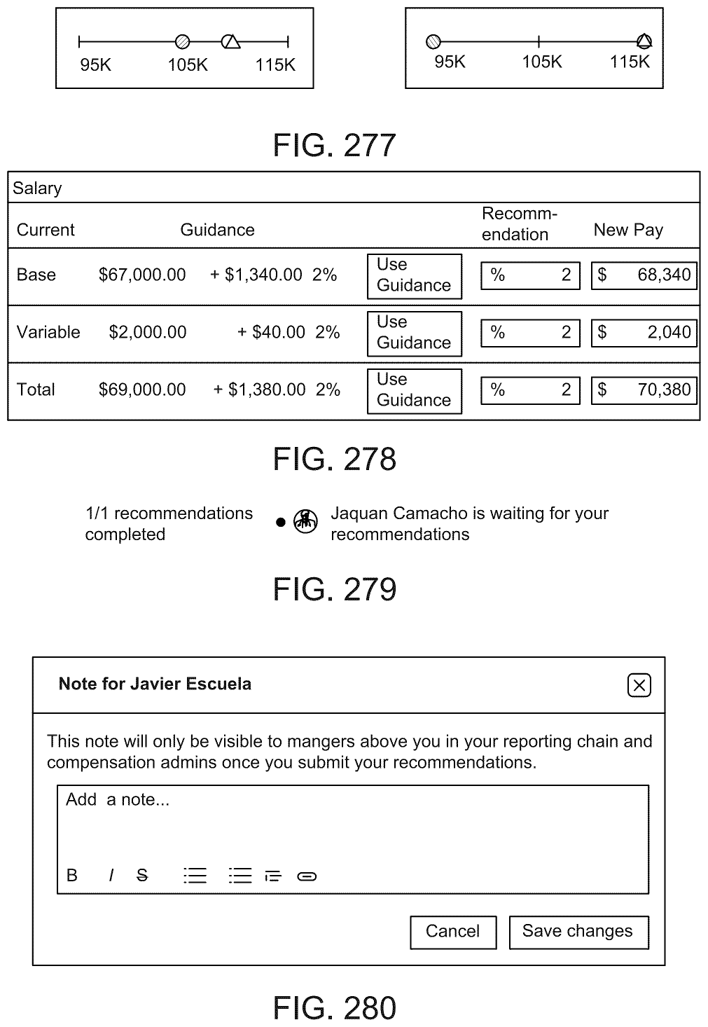

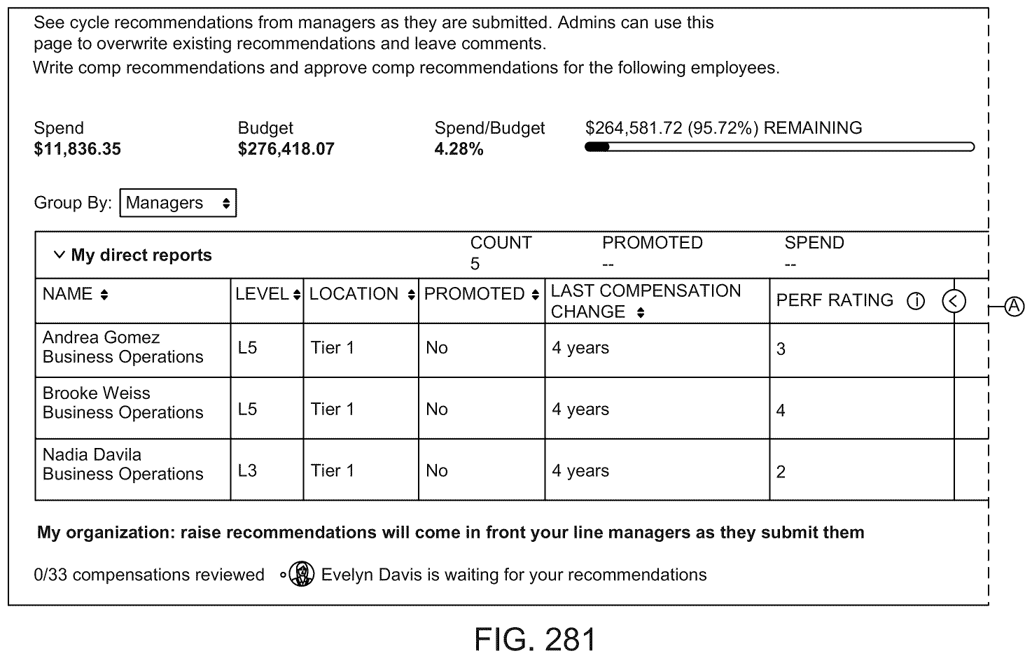

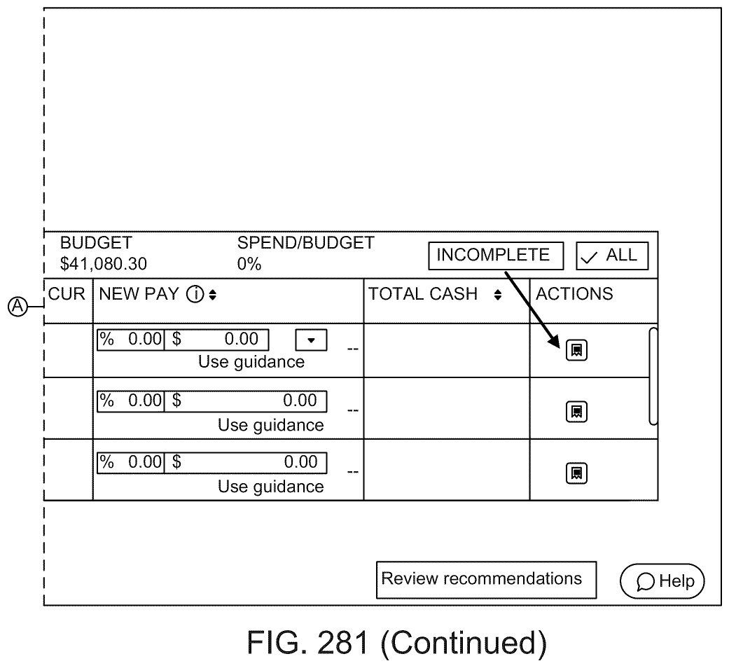

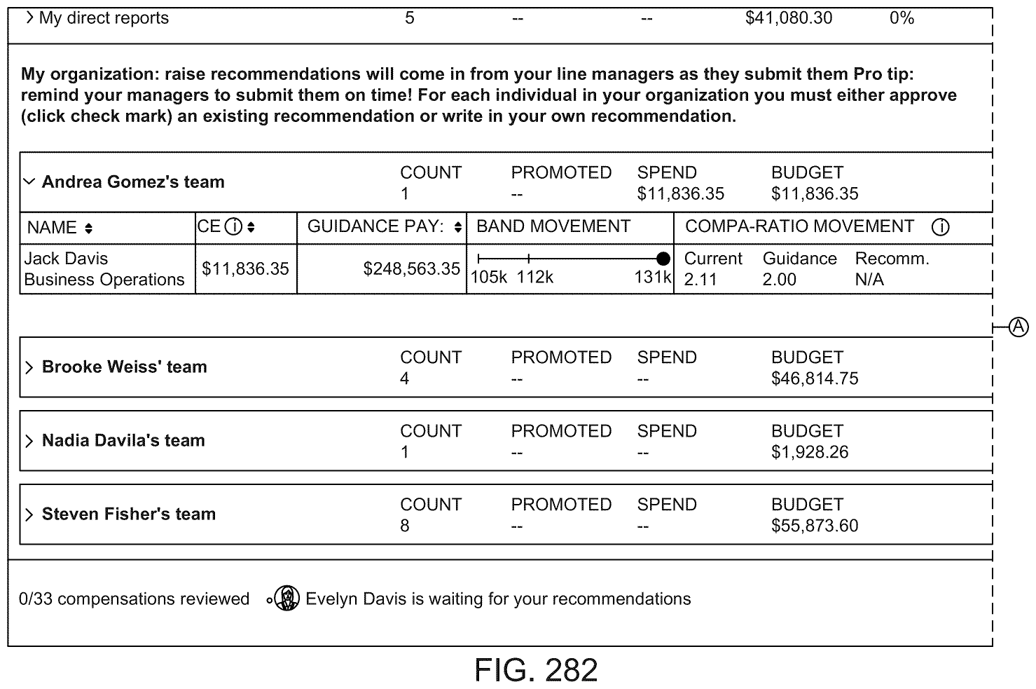

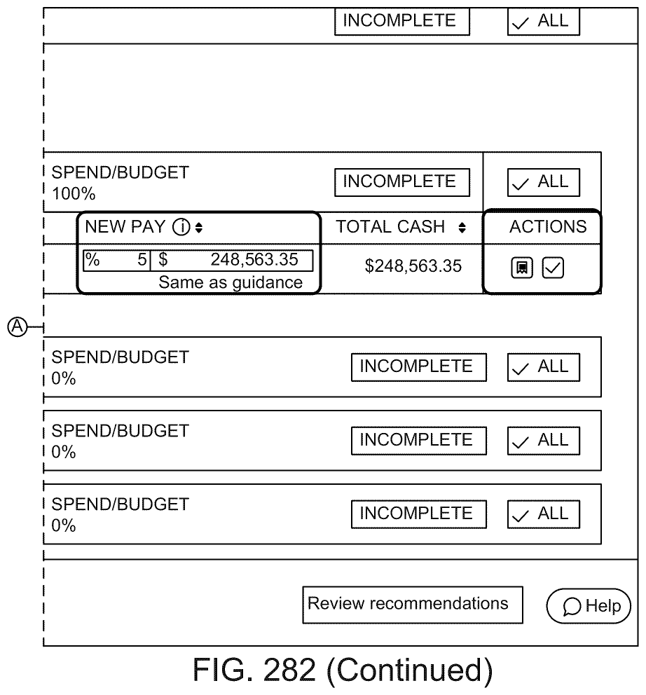

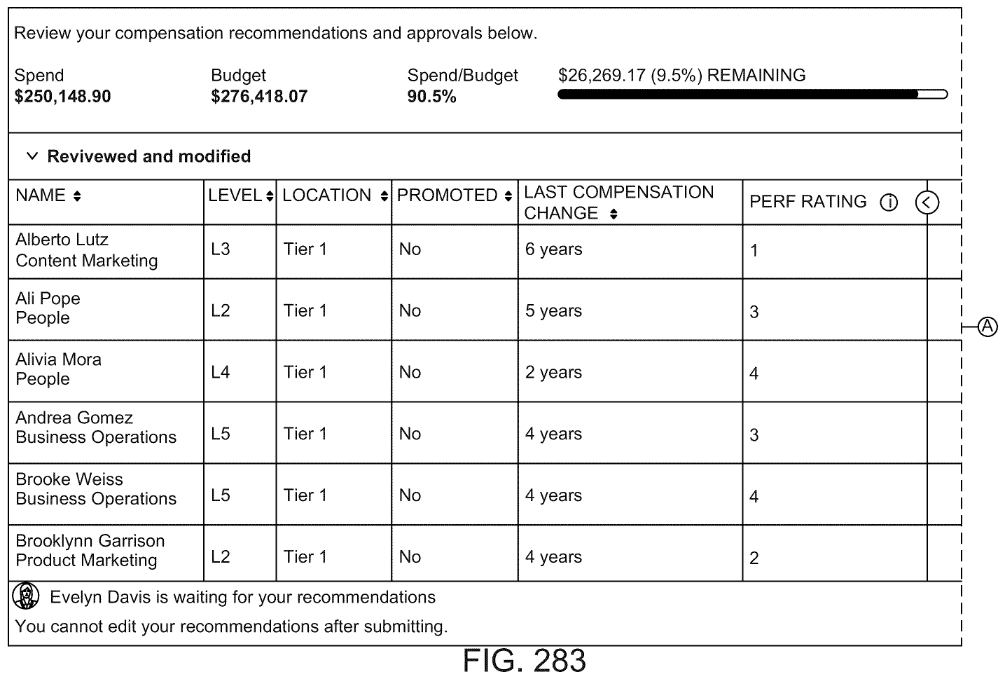

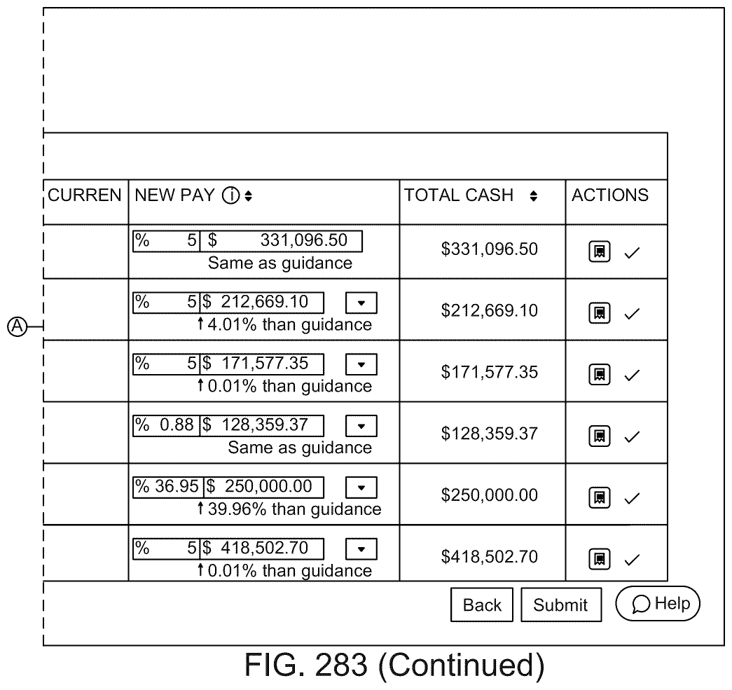

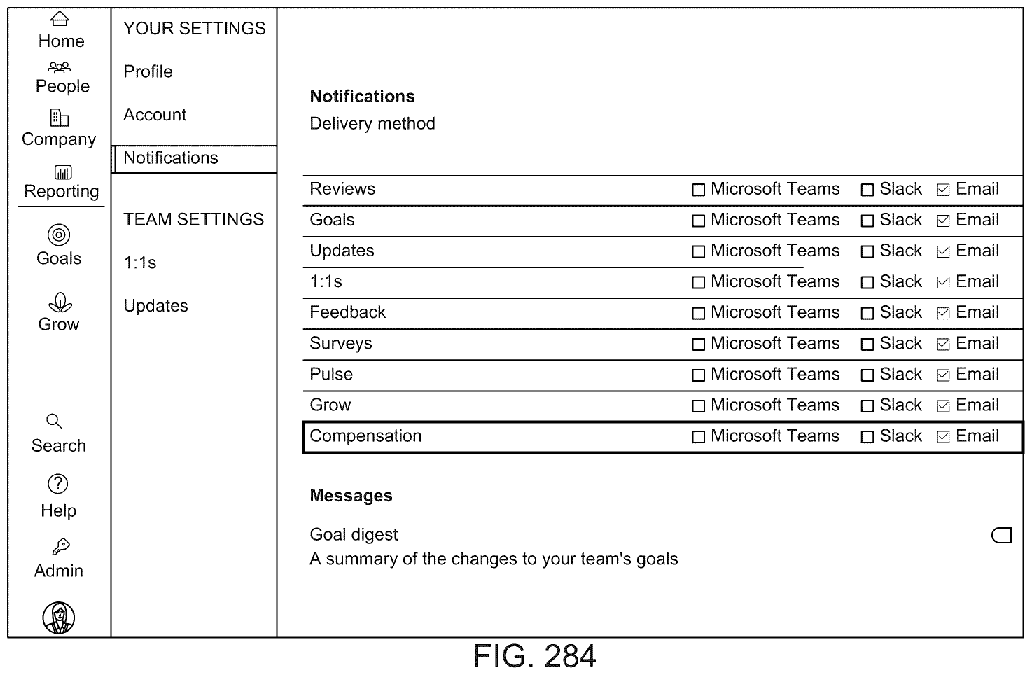

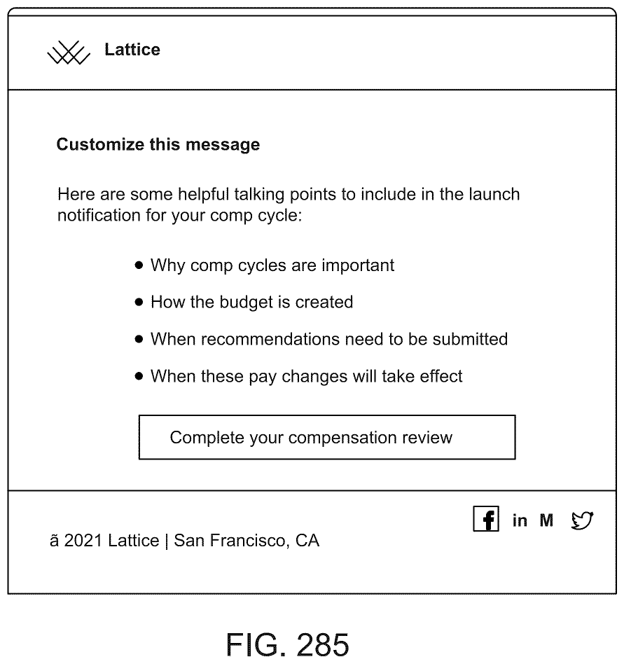

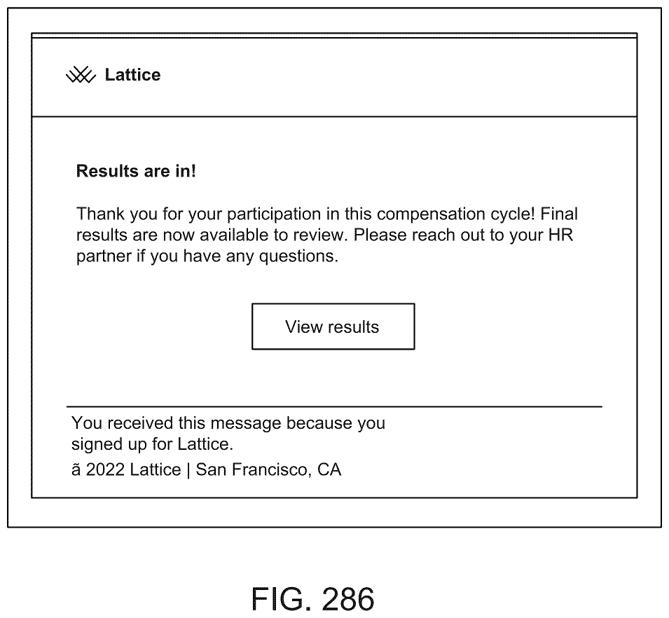

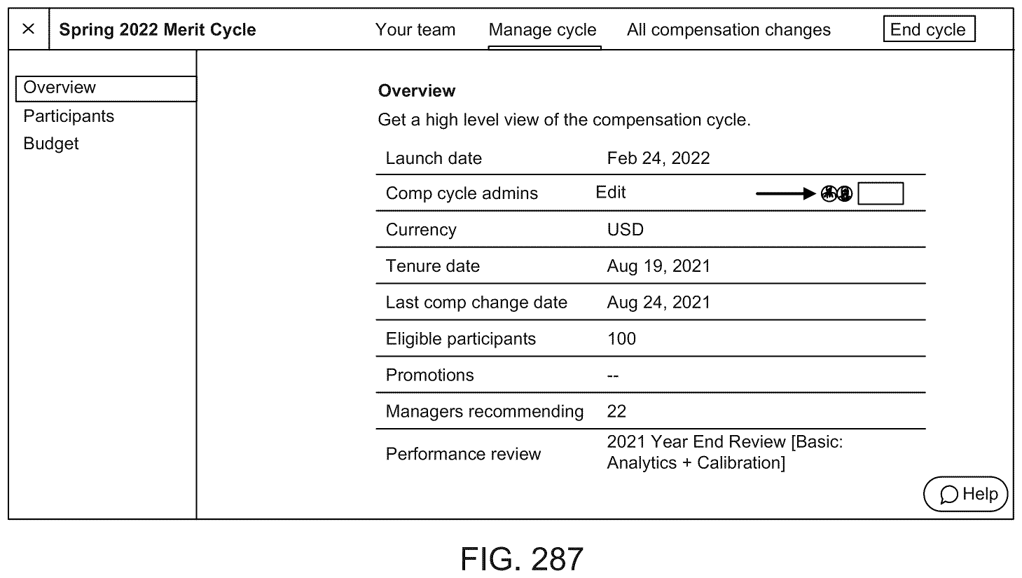

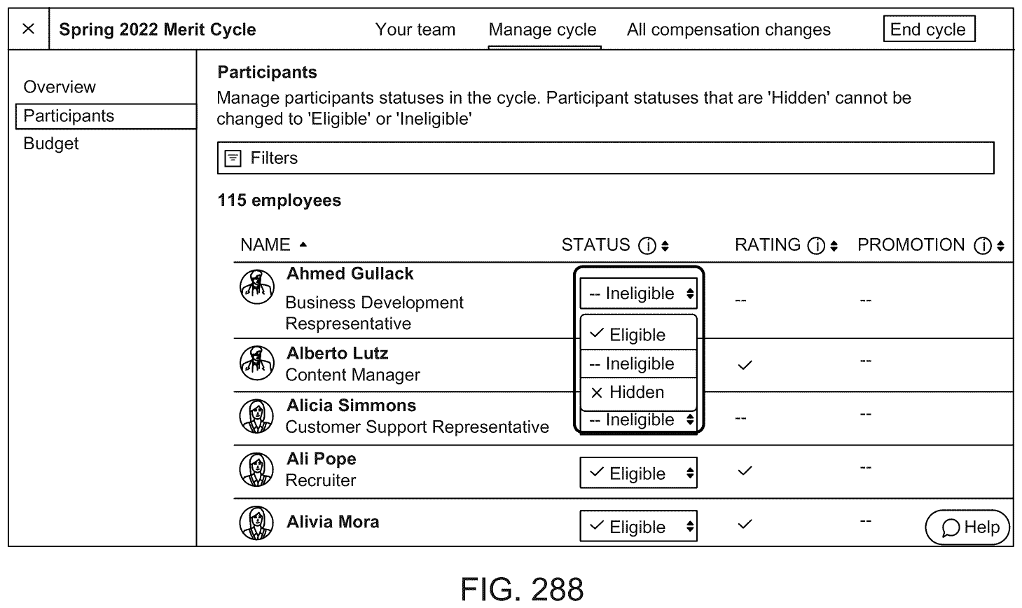

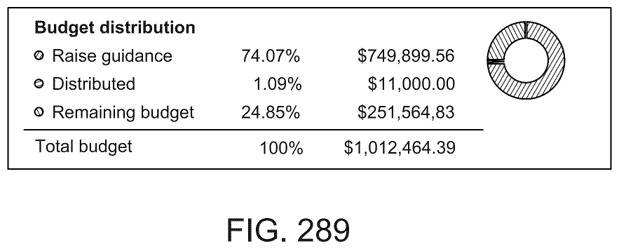

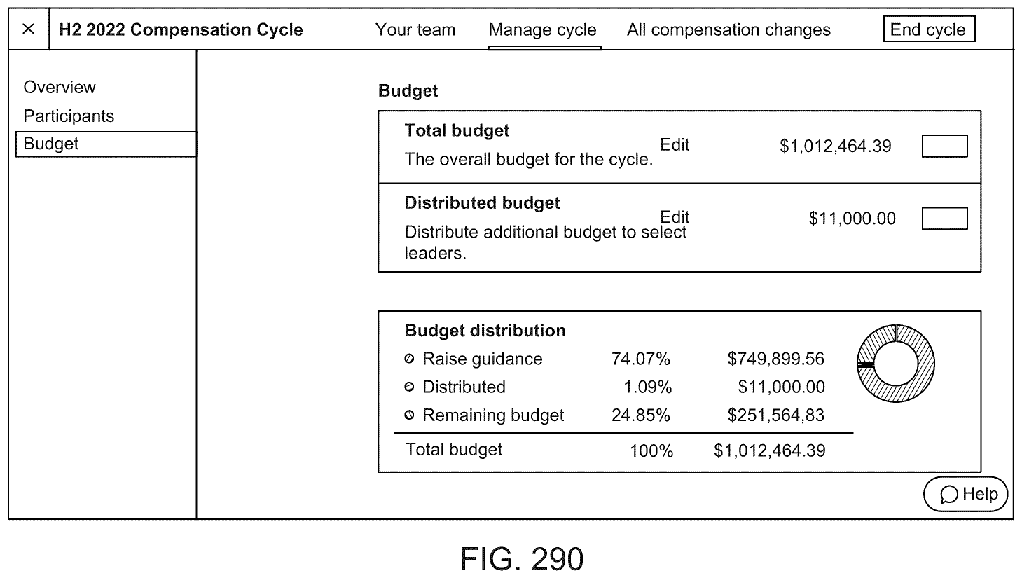

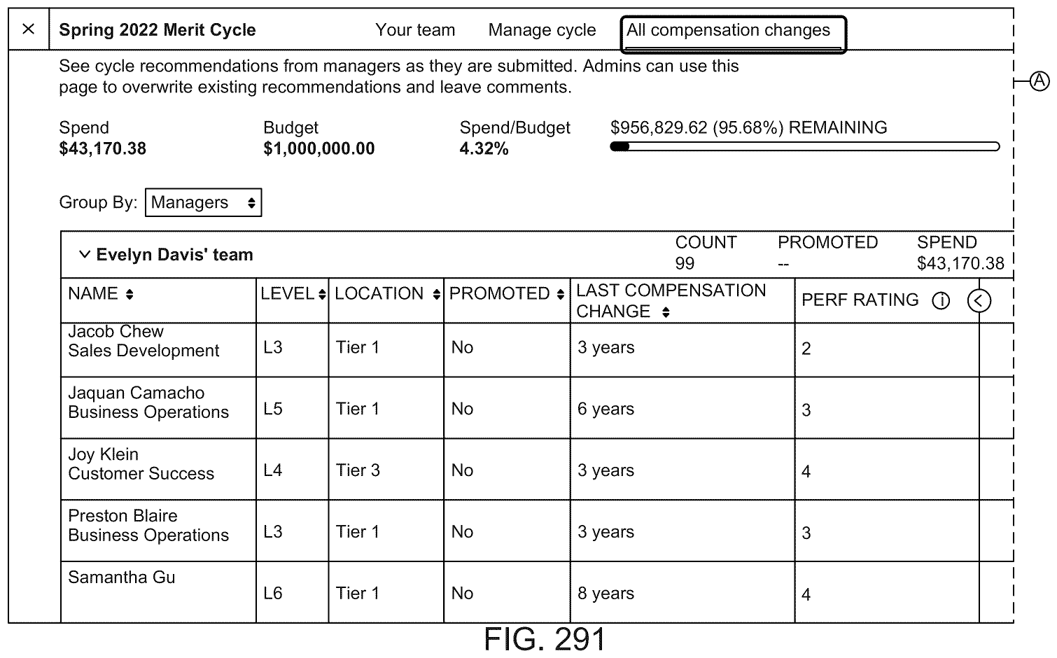

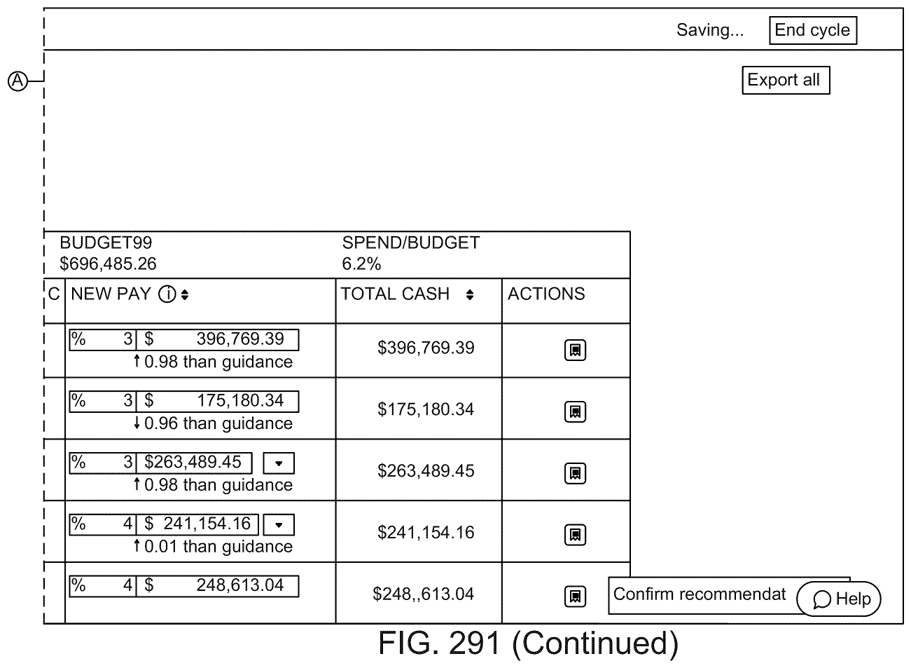

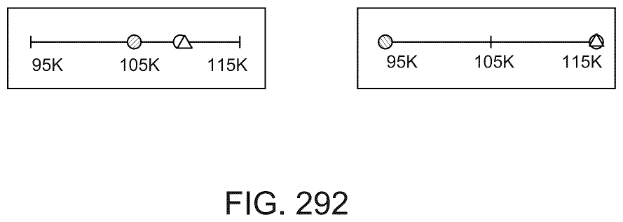

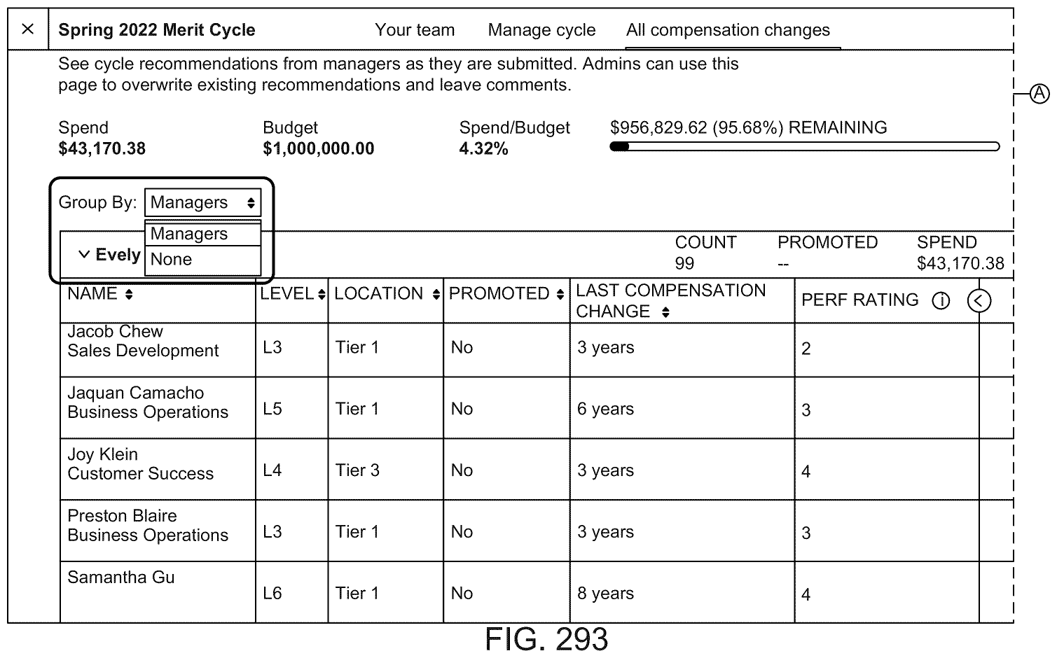

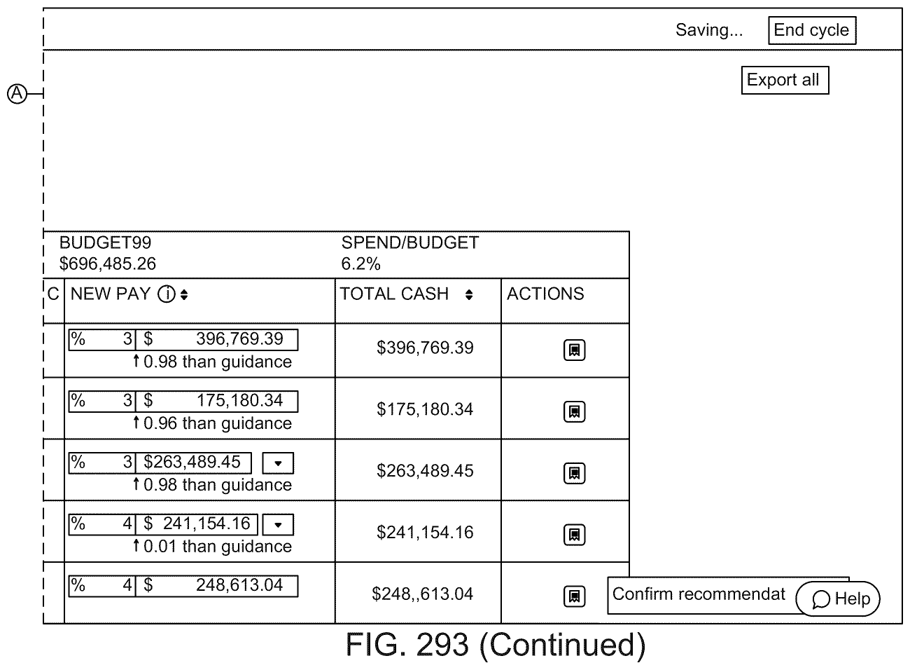

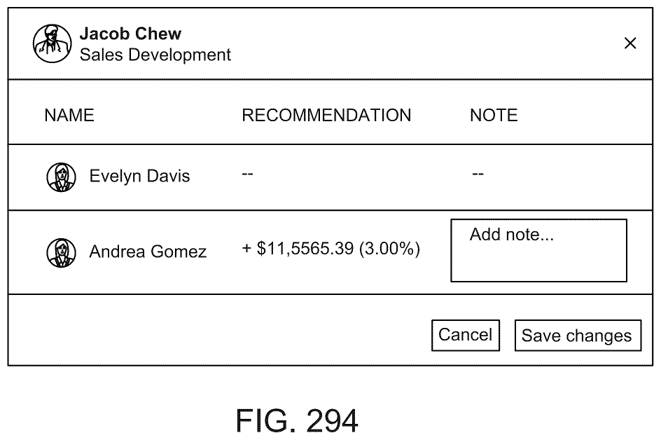

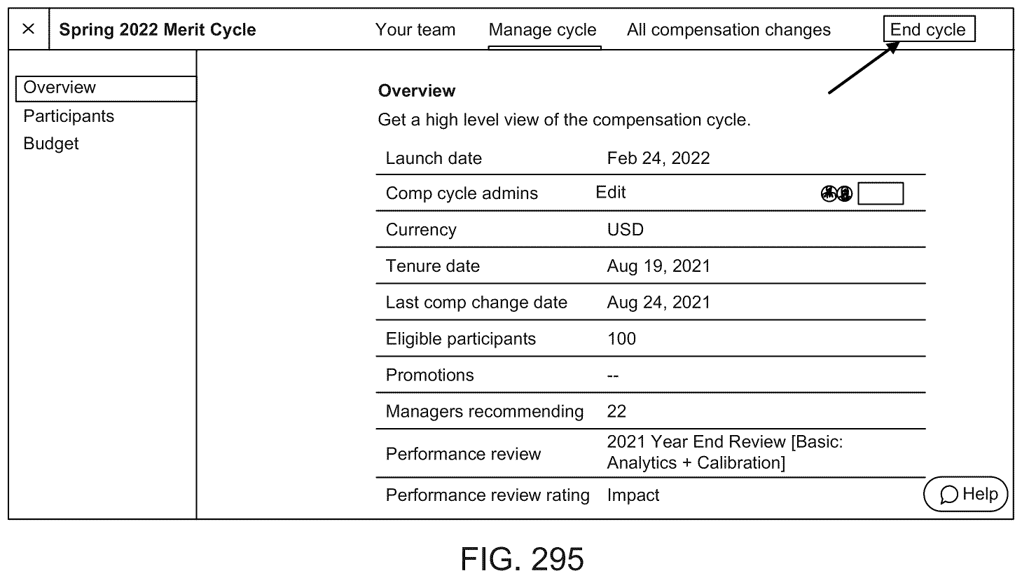

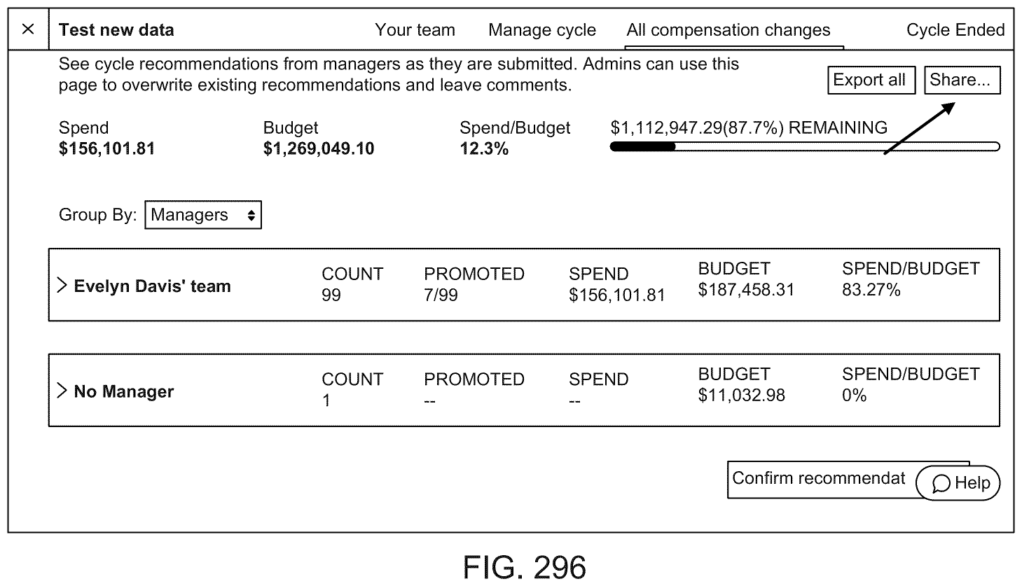

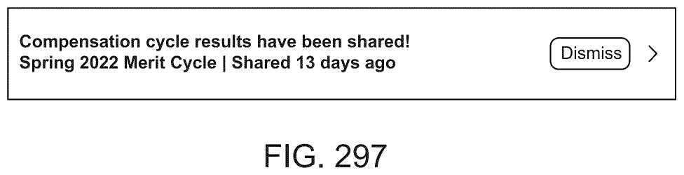

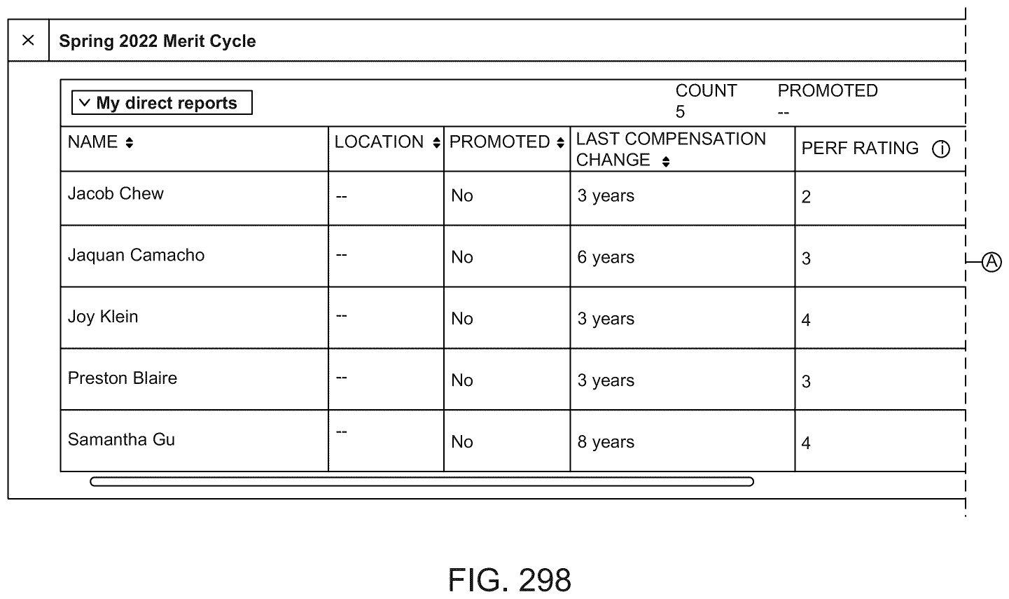

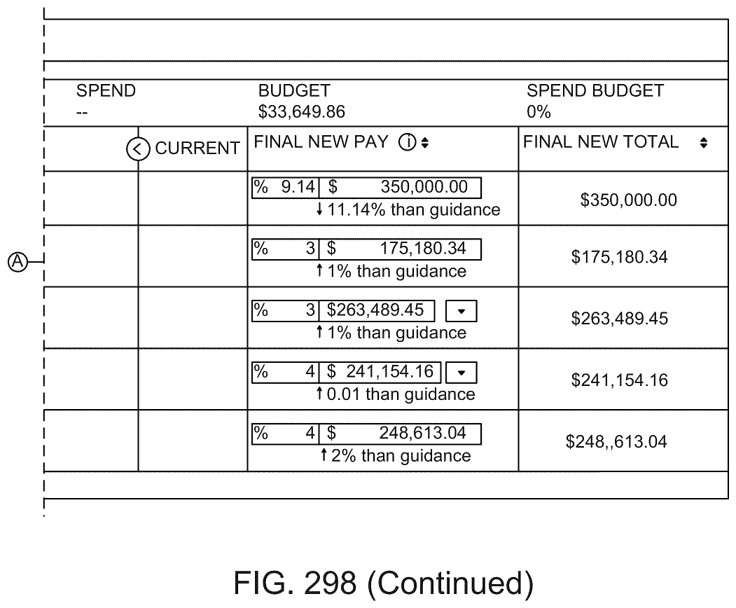

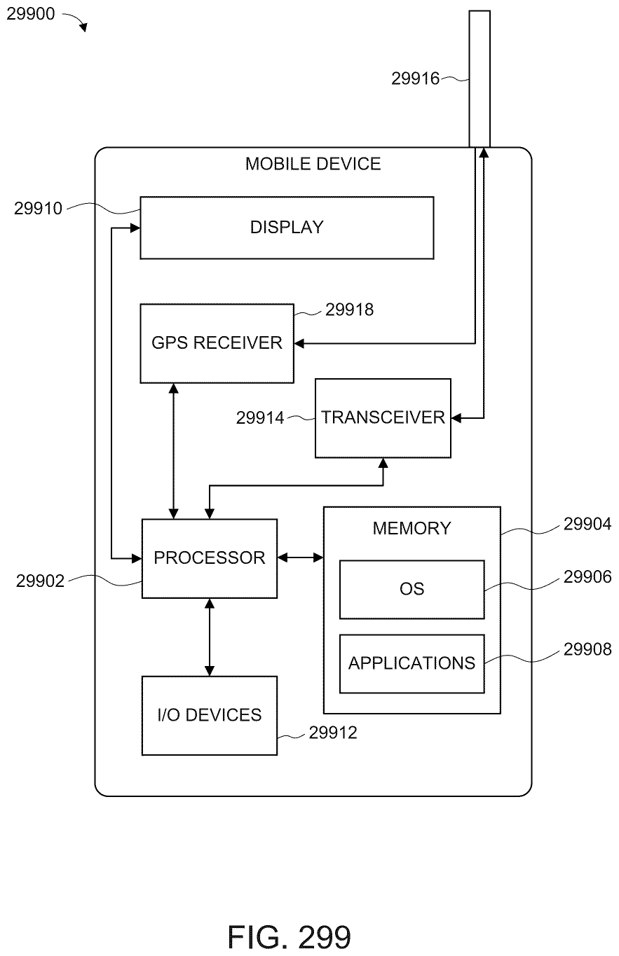

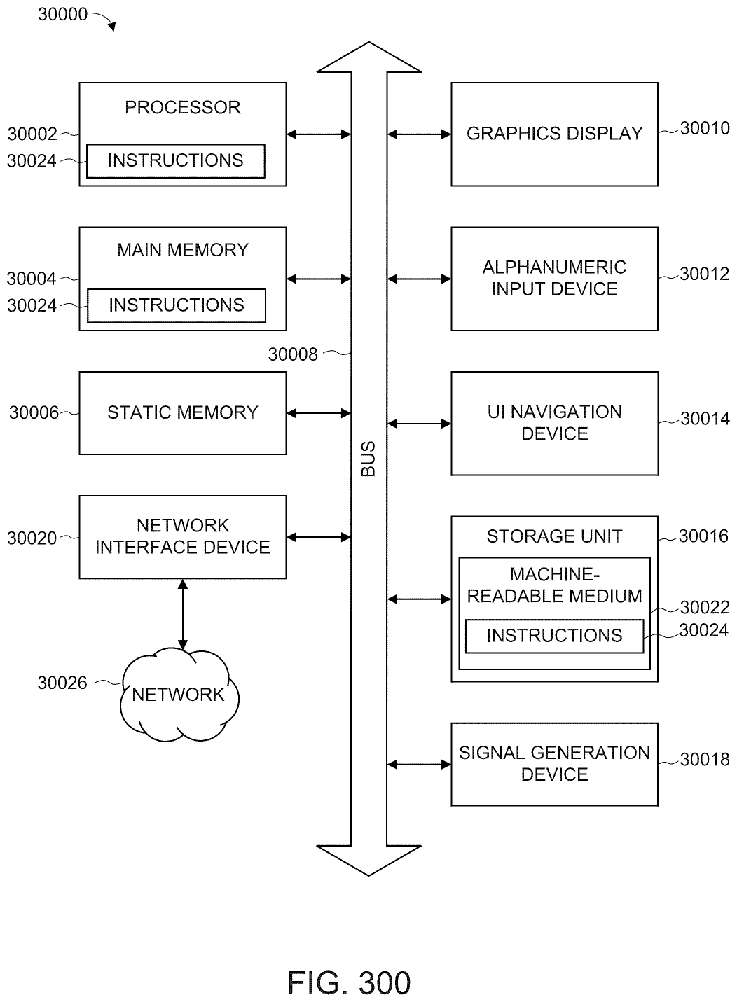

FIG. 120 is a schematic demonstrating how to navigate a user interface to apply custom weights from the goals page.

The system's Salesforce integration allows users to connect their system goals and have them automatically update progress when Salesforce is updated. Salesforce syncs with the system at the start of the hour; if there have been any updates, the goal's progress will be updated.

Connect Salesforce to a Goal

FIG. 121 is a schematic of a user interface displaying a create key result page with the option to select Salesforce Integration to measure progress.

FIG. 122 is a schematic of a user interface displaying a Salesforce connection preview page containing the option to search for a report.

FIG. 123 is a schematic of a user interface displaying a Salesforce connection page containing the option to select a measurement to track progress and set a start and target amount.

The following are steps to connect Salesforce to a goal:
1. From the Home page, select Create goal>Key result.
2. Under How will you measure progress?, select Salesforce Integration and Connect.
3. Confirm the correct connection, and search for a report to connect to.
4. A preview will appear-select the correct report and click Next.
5. Select a value. The values that appear will depend on the values defined within the Salesforce report.
6. Select the measurement to track progress ($, #,%) and set a Start and Target amount
7. Connect and continue to create the goal.

Company goals are a great way to motivate employees and give them context for a company's actions and priorities. Users can create company goals from at least two different locations within the system:
The Goals page
The Goal Creation page

To create a company-level goal, users will need to be either a super admin or be given special permission by the super admin. Company goals will be public to all users in the system; however, only goal owners will be notified when published.

Create a Company Goal from the Goals Page

FIG. 124 is a schematic demonstrating how to navigate a user interface to create a company goal from the goals page.

The following are steps to create a company goal from the goals page:
1. Navigate to the Goals page>Company.
2. Click Insert objective or Insert key result to open the quick action context panel.
3. Select Change details.
4. Add in the desired fields Within the Type field, confirm it is selected to Company.
5. Click Publish.

Create a Company Goal from the Goal Creation Page

FIG. 125 is a schematic demonstrating how to navigate a user interface to create a company goal from the goal creation page.

FIG. 126 is a schematic demonstrating how to navigate a user interface to designate a key result type.

The following are steps to create a company goal from the goal creation page:
1. Navigate to the Home page>Create goal.
2. Click Objective or Key result to open the creation page.
3. Select Change details.
4. Add in the desired fields—within the Type field, select Company.
5. Click Publish.

Adding a supporting objective or key result to an existing key result is only available for accounts with cascading goals enabled.

Note that there will be no automatic calculation of progress from the supporting key result to the existing key result. If users would like the new key result to automatically progress up, they should either convert the key result to an objective or manually update the progress of the existing key result.

Add a Key Result or Supporting Objective with Cascading Goals

FIG. 127 is a schematic demonstrating how to navigate a user interface to add a key result or objective with cascading goals.

The following are steps to add a key result or supporting objective with cascading goals:
1. Navigate to Goals>Individual.
2. Expand the objective and then click on the key result to add support to.
3. Click Insert objective or Insert key result to open the goal context panel.
4. Enter the desired fields and Publish.

Updating goals via the Goals Update Screen allows users to access all of the goals that need updating in one place instead of having to click into separate owned goals.

Employees will be able to update multiple goals based on the company's goal update reminder cadence. If users do not have a cadence set, or have opted out of notifications, the system allows the ability to update multiple goals every two weeks.

Goals are shown in order of time since the last update. Therefore, the goal that hasn't received an update in the most extended amount of time will be displayed first, and the goal that has received the most recent update will be shown last.

Navigate to the Goals Update Screen

Goal owners can access the Goals Update screen on the system homepage (dependent on update cadence timing), the Goals Explore page, and Slack/Teams and email notifications.

To navigate via the Goals Explore page directly within the system:
1. Navigate to the Goals page.
2. Within the Goals sidebar, select Update goals
OR
1. Navigate to the Goals page.
2. Select the Update_goals button within the Explore page.

Using the Goals Update Screen

The Goals Update screen includes a context view of the goal users are updating along with the last three status updates for that goal. If a user's goal is aligned to a parent or is being supported by another goal, clicking into these goals will open the Goal side panel for more details on that goal.

Goals are shown in cascading order starting with the parent objective or goal and moving downward through the supporting goals.

FIG. 128 is a schematic of a user interface displaying the goals update screen.

If users are not ready to provide an update to the goal, they can choose to skip the goal by selecting Skip for now. Skipping a goal will not remove it from the Goals Update screen. Instead, it will allow users to progress to the next goal that needs updating without adding progress.

To end the goal:
1. Select the Are you ready to end this goal? dropdown.
2. Choose one of the three options:
   Mark as complete: A satisfactory level of progress was made
   Mark as incomplete: A satisfactory level of progress was not made
   Keep this goal open for now
3. Select Save.

Updating a goal:
1. To update the goal.
   Select a goal status.
   Enter a new increment or total amount.
   Add a progress status update.
2. (Optional) For any supporting goals:
   Select a status.
   Enter a new increment or total amount.
   Mark as complete.
   Add a comment.
3. Select Save to move to the next goal.
4. Once users move through the goals, they will have the option to Update skipped goals, Explore goals, or Go home.

Group goals are a great way to keep track of what the assigned group is working towards to help meet the company's priorities. We recommend all employees view and understand their group goals to get context on the organization's actions.

Only admins can create and manage groups; however, all users can create group goals.

The Goals Page—Using the Groups Saved Filter

FIG. 129 is a schematic demonstrating how to navigate a user interface to access group goals from the goals page.

If users are a member of a group, the system will create a saved view where they can easily access the group goals.

Note: Admins will not have visibility into the Group saved view if they are not a member of the group. However, they can still filter by group using the filter option Type>Group goals.

To access group goals from the goals page, navigate to Goals>Groups>select the desired group.

The Goals Explore page will allow users to add and remove any additional filters to drill down on the group's goals.

FIG. 130 is a schematic of a user interface displaying the goals explore page with the option to add and remove filters

If users are not a member of a group but want to see a specific group's goals, they can do so by filtering by Type>Group goals>select a group.

FIG. 131 is a schematic of a user interface displaying the goals explore page with the option to filter by group goals.

Department goals are a great way to keep track of what the department is working towards to help meet the company's priorities.

To create a department-level goal, users will need to be either a super admin or be given special permission by the super admin.

View Department Goals

Users can view a department's goals from at least two places in the system:
The Goals page.
The Departments page.

FIG. 132 is a schematic demonstrating how to navigate a user interface to view a department's goals from the goals page.

To view a department's goals from the Goals page, navigate to Goals>Department.

FIG. 133 is a schematic demonstrating how to navigate a user interface to view a department's goals from the departments page.

To view a department's goals from the Departments page, navigate to People>Department>Goals.

Company goals are a great way to keep track of what the company is focusing on.

To create a company-level goal, users will need to be either a super admin or be given special permission by their super admin.

View Company Goals

Users can view the company's goals from at least two places in the system:
The Goals page.
The Company page.

FIG. 134 is a schematic demonstrating how to navigate a user interface to view the company's goals from the goals page.

To view the company's goals from the Goals page, navigate to Goals>Company.

FIG. 135 is a schematic demonstrating how to navigate a user interface to view the company's goals from the company page.

To view the company's goals from the Company page, navigate to Company>Goals

As users progress on the goals, they will want to make sure that they keep the goals up-to-date in the system. Keeping the goal progress updated allows users to stay focused and keep the manager up-to-date on where they were successful or need additional support.

Goal timeline updates can be edited for seven days after they're published. After seven days, they are no longer editable. Users can quickly update goals directly from the page.

Add Progress to a Goal from the Goal Details Page

FIG. 136 is a schematic of a user interface displaying a home page with a reminder to update a goal.

The following are steps to add progress to a goal from the goal details page:
1. Navigate to the goal that is to be updated.
   Users may have a task on the Home page reminding them that it is time to update their goals.
   Users may have received an email to remind them that it is time to update their goals.
   Users may enter the profile by clicking on the goal name within the Goals page context panel.
2. Within the Goal details page, under the Timeline section, add progress toward the goal by including an update in the What's new? field and select a status.
3. (optional). Update the key results.
4. Click Post Update.

FIG. 137 is a schematic demonstrating how to navigate a user interface to add progress to a goal from the goals page context panel.

If the company has goals aligned with different owners for objectives and key results, users may find child results that align with their goal included under key results. As a goal owner of the parent goal, a user will have the option to add progress to these supporting goals regardless of ownership.

Please note: If users want to add a What's new? summary to a key result or child goal, they can add progress directly from the key result or child goal by clicking into it from the Supported by list.

FIG. 138 is a schematic demonstrating how to navigate a user interface to add progress to a goal within the goal details page by adding an update in the “Whats New?” field and selecting a status.

Add Progress to a Goal from the Goal Page's Context Panel

FIG. 139 is a schematic demonstrating how to navigate a user interface to add progress to a goal within the goal explore context panel.

When inside the Goal Details page, users may find that they want to update or add more context to one child goal or key result. Users can do this by entering the Key Result Profile page.

The following are steps to add progress to a goal from the goal page's context panel:
1. Navigate to Goals>click on goal>Update progress.
2. (required): Add progress toward the goal by including an update in the What's new? field and select a status.
3. (optional): Update the key results.
4. Click Post update.

If the company has goals aligned with different owners for objectives and key results, users may find child results that align with the goal included under key results. As a goal owner of the parent goal, users will have the option to add progress to these supporting goals regardless of ownership.

Please note: If users want to add a What's new? summary to a key result or child goal, they can add progress directly from the key result or child goal by clicking into it from the goals list.

FIG. 140 is a schematic demonstrating how to navigate a user interface to add progress to a goal within the goal explore context panel by adding an update in the “Whats New?” field and selecting a status.

Add Progress from the Goals Update Widget

Updating goals via the Update widget allows users to access all of their goals that need updating in one place instead of having to click into separate owned goals.

The following are steps to add progress to a goal from the goals update widget:
1. Navigate to the Goal page.
2. Within the Goals sidebar, select Update goals. OR Select the Update goals button within the Explore page.
3. To update the goal.
   Select a goal status
   Enter a new increment or total amount
   Add a progress status
4. (Optional): For any supporting goals:
   Select a status
   Enter a new increment or total amount
   Mark as complete
   Add a comment

Once users have created a goal, users may want to edit the details of the goal set during the creation.

Edit an Objective or Key Result from the Goals Explore Context Panel

FIG. 141 is a schematic demonstrating how to navigate a user interface to edit an objective or key result from the goals page context panel.

FIG. 142 is a schematic demonstrating how to navigate a user interface to make changes to goal fields from the goal explore context panel.

The following are steps to edit an objective or key result from the goal explore page context panel:
1. Navigate to Goals>Individual.
2. Click on the desired objective or key result to open the goal context panel.
3. Next to Update progress, click on the Edit goal icon>Edit.
4. Make the desired changes to the goal fields and Save.

Edit an Objective from the Goal Details Page

FIG. 143 is a schematic demonstrating how to navigate a user interface to edit an objective from the goals page context panel.

The following are steps to edit an objective from the goal details page:
1. Navigate to the goal to update.
   Users may have a task on the homepage reminding them that it is time to update their goals
   Users may have received an email to remind them that it is time to update their goals.
   Users may enter the profile by clicking on the goal name with the Goals page context panel.
2. At the top right corner, click Options>Edit to be taken to the Goal creation page.
3. Make the desired changes to the goal fields and Save.

FIG. 144 is a schematic demonstrating how to navigate a user interface to edit an objective from the goal creation page.

Edit a Supporting Objective or Key Result from the Goal Details Page

FIG. 145 is a schematic of a user interface displaying the goal details page containing support goals.

The following are steps to edit a supporting objective or key result from the goal details page:
1. Navigate to the parent Goals Details page.
2. Under the Supported by list, click on the desired support goal to edit to enter the Goals Details page.
3. At the top right corner, click Options>Edit to be taken to the Goal Creation page.
4. Make the desired changes to the goal fields and Save.

FIG. 146 is a schematic demonstrating how to navigate a user interface to be taken to the goal creation page from the goal details page.

The system's Salesforce integration allows users to connect their system goals and have them automatically update progress when Salesforce is updated. Users may want to disconnect the Salesforce connection if they find the query is no longer relevant or if they want to manually update the goal in the system.

Disconnecting Salesforce from a goal will stop all automatic updates and progress. Once disconnected, the goal will need to be updated manually from this point forward.

Disconnect Salesforce

FIG. 147 is a schematic demonstrating how to navigate a user interface to be taken to the goal editor from the goal details page.

FIG. 148 is a schematic of a user interface displaying the goal editor with a remove button for disconnecting Salesforce.

The following are steps to disconnect Salesforce:
1. From the Goal page, navigate and click on the desired goal.
2. Click on the goal title within the context panel to open the Goal details page.
3. Select Options>Edit to be taken to the goal editor.
4. Under How will you measure progress?, select Remove.
5. A confirmation popup will appear—Select Disconnect.

After users create a goal, they may find that it is no longer relevant and choose to permanently delete it.

Delete a Goal from the Goals Explore Page

FIG. 149 is a schematic demonstrating how to navigate a user interface to delete a goal from the goal explore page.

FIG. 150 is a schematic of a user interface displaying a confirmation popup modal for deleting a goal.
1. Navigate to Goals>Individual.
2. Click on the objective or key result to open the goal context panel.
3. Click on the trash icon to delete the goal.
4. A confirmation popup modal will appear. If a user's goals include key results or supporting objectives, the user has the option to delete them or uncheck them to keep them.
5. Confirm by clicking Delete all.

Delete a Goal from the Goals Details Page

FIG. 151 is a schematic demonstrating how to navigate a user interface to be taken to the goal details page from the goal explore context panel.

FIG. 152 is a schematic demonstrating how to delete a goal from the goal details page.

The following are steps to delete a goal from the goals details page:
1. Navigate to the goal that users want to update.
   Users may have a task on the homepage reminding them that it is time to update their goals
   Users may have received an email to remind users that it is time to update their goals.
   Users may enter the profile by clicking on the goal name within the Goals page context panel.
2. Once users have entered the Goal Details, click Delete.
3. A confirmation popup modal will appear. If their goal includes key results or supporting objectives, users have the option to delete them or uncheck them to keep them.
4. Confirm by clicking Delete all.

Once users have stopped working on an objective or key result in the system, they have the option to end the goal as complete or incomplete.

Users might want to mark a goal as complete if they have finished progress on the goal or they have made significant progress on the goal. Users might mark a goal as incomplete if they made little to no progress on the goal.
If users have the Slack integration and have marked their goal as incomplete, no one will be notified of that change.
Marking a public goal as complete will notify everyone via Slack when updated.
Once they have ended the goal, the goal's progress will be preserved as-is.
Goal owners will not be emailed that the goal has been ended.

End a Goal from the Goal Explore Context Panel

FIG. 153 is a schematic demonstrating how to navigate a user interface to end a goal from the goal explore context panel.

FIG. 154 is a schematic of a user interface displaying a confirmation popup modal for ending a goal.
1. Navigate to Goal>Individual.
2. To open the goal context panel, click on the objective or key result to end.
3. Click on the checkmark icon to end the goal.
4. A popup will appear—mark the goal as Complete or Incomplete.
5. Confirm by clicking Yes, end all.

If the company has cascading goals turned on (parent/child goals) users will also be able to end child objectives or key results of the parent goal at the same time. Please note: this will not end other child goals down the cascade.

End a Goal from the Goals Details Page

FIG. 155 is a schematic demonstrating how to navigate a user interface to be taken to the goal details page from the goal explore context panel.

FIG. 156 is a schematic demonstrating how to end a goal from the goal details page.

The following are steps to end a goal from the goal details page:
1. Navigate to the objective or key result to end.
   Users may have a task on the homepage reminding them that it is time to update their goals.
   Users may have received an email to remind them that it is time to update their goals.
   Users may enter the profile by clicking on the goal name within the Goals page's context panel.
2. At the top right corner, click End.
3. A popup will appear—mark the goal as Complete or Incomplete.
4. Confirm by clicking Yes, end all.

If the company has cascading goals turned on (parent/child goals) users will also be able to end child goals (key results) of the parent goal at the same time. Please note: this will not end other child goals down the cascade.

Goal progress can easily track goals' statuses by understanding each goal's progress bars and statuses.

When users will see Progress Bars vs. Statuses:
For all quantitative (#, $, and %) goals, users will always see a progress bar with % to completion.
For all binary goals with no key results, users will see a written status. This written status will correspond to what was selected by the employee in their last goal update (Off Track, Progressing, or On Track)
For binary goals with at least one key result (OKR format), users will see a progress bar with % to completion. Unless users have set custom goal weighting, each key result will be treated as an equal % towards the goal. For example, if users have a binary goal with three key results, completing one key result will mark the goal 33% completed.

Understanding Goal Progress Bars and Statuses

Active Goal Statuses: When employees update their goals, they are prompted to pick a status to reflect how they believe they are performing on their goal. The statuses are as follows:

On Track typically means that the employee feels good about where the goal is and believes they will be able to accomplish the goal.

FIG. 157 is a schematic of an “on track” status for a goal.

Progressing means that the goal is moving forward, but the employee is not 100% confident they will be able to accomplish everything in the goal. They may, however, be able to get the goal back on track.

FIG. 158 is a schematic of a “progressing” status for a goal.

Off Track typically means the employee is not feeling good about their progress on the goal, and they will most likely not be able to accomplish the entire goal.

FIG. 159 is a schematic of an “off track” status for a goal.

Goal Progress Bars: In the progress bar, the color of the highlighted progress corresponds to the employee's status in their last goal update.
Green=On Track

FIG. 160 is a schematic of an “on track” goal progress bar.
Yellow=Progressing

FIG. 161 is a schematic of a “progressing” goal progress bar.
Red=Off Track

FIG. 162 is a schematic of an “off track” goal progress bar.

Ended Goal Statuses: When an employee is finished working on a goal, they will have two options for marking the goal ended: Complete or Incomplete.

FIG. 163 is a schematic of a user interface displaying a popup page displaying options to end a goal as complete or incomplete.

FIG. 164 is a schematic of a user interface displaying a goal explore page with a goal marked as complete.

An employee might want to mark a goal as complete if they've finished progress on the goal or have made significant progress. FIG. 163 is a schematic depicting how the completed goal will look on the Goal homepage when filtered by complete.

FIG. 165 is a schematic of a user interface displaying a goal explore page with a goal marked as incomplete.

An employee might mark a goal as incomplete if they made little to no progress on their goal. FIG. 165 is a schematic depicting how the incomplete goal will look on the Goal page when filtered by incomplete.

Once users have ended a goal, they may want to reactivate the goal to update the goal progress or edit the goal.

Reactivating a parent objective or goal will not reactivate child goals or key results. Reactivating a key result or child objective linked to a completed parent objective will not update the parent objective's progress—the parent objective will need to be reopened individually.

Reactivate a Goal from the Goal Explore Context Panel

FIG. 166 is a schematic demonstrating how to navigate a user interface to filter the goal explore list by status.

FIG. 167 is a schematic demonstrating how to navigate a user interface to reactivate a goal from the goal explore context panel.

The following are steps to reactivate a goal from the goal explore context panel:
1. Navigate to Goals>Individual.
2. Filter the Explore list by Status>Complete and Incomplete.
3. To open the goal context panel, select the objective or key result to reopen and click Reactivate.

Reactivate a Goal from the Goals Details Page

FIG. 168 is a schematic demonstrating how to navigate a user interface to be taken to the goal details page from the goal explore context panel.

FIG. 169 is a schematic demonstrating how to navigate a user interface to reactivate a goal from the goal details page.

The following are steps to reactivate a goal from the goals details page:
1. Navigate to the objective or key result that users want to reactivate.
   Users may have a task on their homepage reminding them that it is time to update their goals.
   Users may have received an email to remind them that it is time to update their goals.
   Users may enter the profile by clicking on the goal name within the Goals page's context panel.
2. Once on the Goal Details page, click Reactivate.

The system's Gmail plugin makes it easy to view a colleagues' goals directly in an email thread.
Users must be signed into the system to view goals.
The inbox participant must be an active system user for users to view their goals.
Users can minimize the extension by clicking on the system icon.

Plugin Installation Steps

FIG. 170 is a schematic of a Gmail inbox with the system plugin.

The following are steps to install the system plugin:
1. Log in to the system.
2. Download the system's Chrome extension for Gmail.
3. Click into any email thread which includes an active system user(s).
4. On the right side of the Gmail inbox, users will see the system plugin by clicking on the system logo.

Viewing Employee Goals Via the Gmail Plugin

Once the plugin is installed, participating team members' public goals will appear in the Gmail plugin.

FIG. 171 is a schematic of a Gmail inbox displaying employing goals via the system plugin.

The following are steps to view employee goals via the Gmail plugin:
1. To view their goals, click the name of the participating team member. If the team member does not have public goals in the system, nothing will appear.
2. Click on each goal to be taken to the system's Goals Details page.

FIG. 172 is a schematic of a user interface displaying a goals update screen with the option to add a goals comment to a supporting goal.

A goals comment allows for a goal owner to leave a note with more information—separate from their status update—on another supporting goal/key result when updating without requiring to update that supporting goal. Goal comments are only available within the Goals Update screen.

FIG. 173 is a schematic of a user interface displaying a goals update screen with the option to add a goal status update.

A goals status update only applies to the key result/goal the user is updating.

Navigating to Goals in Mobile

FIG. 174 is a schematic of a mobile device user interface displaying an employee's active goals.

Your goals can be found on the You page under Your active goals.

Side-scroll to view all of the active goals a user owns. To view the progress and details for an individual goal, click on the goal to be taken to its Details page.

If users want to see their colleagues' public goals, they can do that by going into the Directory page>All employees>clicking into their profile>Their active goals.

View Goal Details

FIG. 175 is a schematic of a mobile device user interface displaying an individual goal profile page.

Clicking into an individual goal profile allows users to toggle between the:
Key results of the goal
Timeline of the goal (the progress that has been made since the goal was created)
General information about the goal (when it was created and when it ends).

With the system's goal iconography, users can quickly identify their objective and key result types without having to click into the goal itself. To best understand what each icon means, take a look at the labels below.

FIG. 176 is a schematic of an icon representing a public objective.

FIG. 177 is a schematic of an icon representing a completed public objective.

FIG. 178 is a schematic of an icon representing an incomplete public objective.

FIG. 179 is a schematic of an icon representing a private objective.

FIG. 180 is a schematic of an icon representing a completed private objective.

FIG. 181 is a schematic of an icon representing an incomplete private objective.

FIG. 182 is a schematic of an icon representing a public key result.

FIG. 183 is a schematic of an icon representing a completed public key result.

FIG. 184 is a schematic of an icon representing an incomplete public key result.

FIG. 185 is a schematic of an icon representing a private key result.

FIG. 186 is a schematic of an icon representing a completed private key result.

FIG. 187 is a schematic of an icon representing an incomplete private key result.

The Goals page is an interactive space called Goals Explore, where employees can view, edit, and update their personal goals and see any public goals and their progress. The Explore page offers several visualizations that depict the structure between individual goals and key results and the relationship between cascading goals (if enabled).

FIG. 188 is a schematic demonstrating how to navigate a user interface to enter the goals page from the discovery navigation bar.

To enter the Goals page, select Goals on the discovery navigation.

The Goals Explore Page

FIG. 189 is a schematic of a user interface displaying the explore page and its main features.

There are thirteen main features to the Explore page.

These features allow users to:
1. Update multiple goals
2. View Explore default views
3. View custom saved views
4. View goal reporting for their team (managers only)
5. Search for a specific goal by owner or keyword
6. View goals within a certain time frame, by start date, and by due date
7. Filter goals by the owner, type, priority, status, tags, and visibility
8. View goal analytics in the List View (not available for Cascade view)
9. End displayed goals (admins only)
10. Export their goals to a file (e.g., a csv file)
11. Visualize goals in a cascade or trees view (if cascading goals is enabled)
12. Create an objective or key result
13. View goal owners, due date, and status

Preset saved views: The Goals Explore page includes six default saved views to make it easier to view the goals users need.
Individual: Goals where users are the goal owner
Direct reports: Individual, department, or company goals where a user's direct reports are goal owners
Organization: Individual, department, or company goals where a user's direct and indirect reports are goal owners
Department: Department-level goals that are assigned to a user's department
Company: Company-level goals that are publicly visible to all employees in their company
All: All goals that users have visibility into. Users will not have visibility into the private goals for employees that are not in their organization.

A note on analytics:
Draft goals are not included in the analytics, even if a user has applied a filter for draft goals.
The count of goals represents unique goals, regardless of how many owners.
Archived users' goals will count only IF they are co-owned by an active employee or part of a cascade of active goals.
When applying department or company filters, note that the system will only count department or company objectives or key results. Supporting goals that are not a department or company objective or key result will not be counted towards the total.
Goals are ordered by active state>priority>due date>a to z. View an Individual Goal from the Goals Explore Page

FIG. 190 is a schematic of a user interface displaying an individual goal in the goal explore context panel.

A context panel will emerge to the right with additional details when users click on an individual goal within the Goal Explore page.

This context panel includes:
Quick actions
Child objectives or key results
Alignment
Owners
Due date
Type
Tags
Priority
Comment and like on last update

If users click on the goal's title, they will be redirected to the Goals Details page. From there, users can view a goal's progress timeline, check if it's on track, and see any notes that the goal owner has posted within the Audit Log. You can also edit, complete, or delete a goal from this page.

FIG. 191 is a schematic of a user interface displaying a goals detail page containing an audit log.

Cascading Goals

If users have cascading goals enabled, they will be able to view their objectives and key results in a cascade and tree view.

Cascading goals allows for direct alignment where the progress of the child goal will impact the parent's progress.

FIG. 192 is a schematic demonstrating how to navigate a user interface to enter cascade view in the goal explore page.

When users enter the Cascade view, they will initially only see parent objectives and key results. Expanding the goal will display any aligned child goals. You can also use the search bar and filter to find a goal of any level without manually clicking through each layer.

Note: Goal list analytics is not available in cascade view. Switch to list view to view goal list analytics.

In FIG. 192, the rows can be expanded to show the structure between:
1. Company goals
2. Department goals
3. Individual goals
4. Key results for individual goals

You can continue to expand each goal until users reach the key results for individual contributors' goals. Users can have a vast network of interconnected goals based on their company's needs.

FIG. 193 is a schematic demonstrating how to navigate a user interface to expand a goal's structure when tree view is enabled in the goal explore page.

When entering tree view initially, users will only see parent goals (1). By clicking the grey bubble, they will expand the goal structure to see a second layer (2). Users can continue to expand these layers to display individual goals (3) and their key results (4).

Within the Goals page, users can filter their data by different attributes to view the goals they want within their org. From here, users can save the view so they can quickly come back and reference the filtered set of goals.

Create a Saved View

FIG. 194 is a schematic demonstrating how to navigate a user interface to create a saved view in the goal explore page.

FIG. 195 is a schematic of a user interface displaying a popup modal with the option to name a saved view.

The following are steps to create a saved view:
1. Navigate to the Goals homepage by clicking on the target icon within the discovery navigation.
2. Enter the desired filter starting point from the Filters list.
3. Add or remove the desired filters using the Filters dropdown menu.
4. Select Save view.
5. A popup modal will appear—give the view a name.
6. Click Save.

FIG. 196 is a schematic demonstrating how to navigate a user interface to access saved views in the goal explore page.

Once they have created their view, users can access it under the Saved Views section of the Goals page.

Once users have created a saved view from their Goals Homepage, they may find that the view is no longer relevant the way it exists currently. The system allows users to edit or delete saved views so they can keep the filters that are the most pertinent to them.

Edit a View

FIG. 197 is a schematic demonstrating how to navigate a user interface to edit a saved view from the goal explore page.

FIG. 198 is a schematic of a user interface displaying a popup modal with the option to rename or delete a saved view.

The following are steps to edit a view:
1. Navigate to the Goals homepage by clicking on the target icon within the discovery navigation.
2. Under the Saved Views section, select the view to edit.
3. Select Edit view.
4. A popup modal will appear—rename the view and save.
5. To delete the view instead, select Delete.

The goal audit log with the Goal Details page allows goal owners, managers, and admins to keep track of the changes made to a goal.

The following users can see Audit Logs:
Goal owners.
Managers of goal owners.
Admins.

Navigate to the Audit Log

FIG. 199 is a schematic demonstrating how to navigate a user interface to view a goals detail page from the goal explore context panel.
1. Navigate to the desired goal's Details page to end.
   Users may have a task on their homepage reminding them that it is time to update their goals.
   Users may have received an email to remind them that it is time to update their goals.
   Users may enter the profile by clicking on the goal name within the Goals page's context panel.
2. Below the objective and key results, click on Audit Log.

FIG. 200 is a schematic of a user interface displaying a goals detail page containing an audit log.

The following is tracked in the audit log:
Goal titles.
Visibility settings (public/private).
Key results.
Start and end value changes.
Type (individual/department/company).
Goal owner(s).
Goal tag(s).
End date.
Priority.
Description.
Conversion to an objective or key result (if goal differentiation is enabled).

Once users have navigated to the Notification Center, there are at least several options for how notifications can be sent when it comes to the Goals tool—through Slack, MS teams, and/or through email.

Goal notifications are sent as follows:
When someone comments on a goal.
When someone likes an update made to a goal.
When a goal co-owner posts an update to a goal.
When someone is added as a goal owner.
A reminder to update a goal.
A goal digest of goal updates or newly created goals.

Please note: Employees will not be notified if they are removed as an owner of a goal.

Set Lip Notifications

FIG. 201 is a schematic of a user interface displaying a notification center.

To send notifications to Microsoft Teams, Slack, or email, navigate to the Notification center>Check on the desired boxes to the right of Goals>Click Save changes.

Notifications

FIG. 202 is a schematic of an email notification stating that a comment was posted on a goal.

FIG. 203 is a schematic of a Slack notification stating that a comment was posted on a goal.

FIG. 204 is a schematic of an email notification stating that someone liked an update made to a goal.

FIG. 205 is a schematic of a Slack notification stating that someone liked an update made to a goal.

FIG. 206 is a schematic of an email notification stating that a goal co-owner posted an update on a goal.

FIG. 207 is a schematic of a Slack notification stating that a goal co-owner posted an update on a goal.

FIG. 208 is a schematic of an email notification stating that an employee has been added as an owner of a goal.

FIG. 209 is a schematic of an email notification stating that an employee needs to update goals.

FIG. 210 is a schematic of a Slack notification stating that an employee needs to update goals.

FIG. 211 is a schematic of a goal digest email.

Notifications will be sent to employees who own goals when:
1. There is a comment posted on one of their goals.
2. Someone likes an update made to a goal.
3. A goal co-owner posts an update on a goal that another individual also owns.
4. An employee is added as an owner of a goal.
5. Employees need to update a goal.
6. Goal Digest.

Goal update reminders are set to be sent out on Thursdays around 10:00 A.M. in the user's local time zone.

The weeks that the reminders are sent are based on an ISO calculator that calculates cadence every week, two weeks, month, or quarter beginning on the calendar year's first week. For example, if users select monthly notifications, they would be sent on weeks 4, 8, 12, etc.

Goal digest is a list of goal updates or newly created goals for a manager's team. For individual contributors, updates include when a company goal has been updated. Managers will receive the digest email when their direct reports have made an update to their goal.

No private goals are included in either the company or team digests.

Notification Cadences

Goal update reminders are set to be sent out on Thursdays around 10:00 A.M. in a user's local time zone. In a user's goal settings, there may be up to five options to set reminder cadence to:
1. Once a week.
2. Once every two weeks.
3. Once a month.
4. Twice a quarter.
5. Never.

Here is a breakdown of when users can expect to receive an email notification reminder, based on their cadence setting:
Weekly reminders are sent out every Thursday.
Bi-weekly reminders are sent out every two weeks, starting on the first week of the month, third week, etc.
Monthly reminders are sent out on the third week of the month, and then every fourth week. Please note, it doesn't matter when users start sending reminders, but they will send every four weeks starting on the third week of the year once users have enabled monthly reminders.
Twice a quarter reminders are sent out the week before the middle and end of each quarter. So the reminder would get sent out on week five and week eleven of the first quarter and repeats on a six-week cadence.

The goal digest is sent out on Monday the week after the goal update reminder is sent out. Both company and team digests are sent out in the same email. You will only receive the digest if there are updates that need to be communicated.
Weekly digests are sent every week following the update reminder notification.
Bi-weekly digests are sent out every two weeks, starting on the second week, fourth week, and so on.
Monthly digests are sent out on the fourth week, eighth week, and so on.
Twice a quarter digests are sent out on the sixth week, twelfth week, etc.

Tasks are created for goals within the system in at least two instances:
1. When it's time to update a goal.
2. When it's time to set goals for a goal cycle.

Update Reminder

FIG. 212 is a schematic of a user interface displaying a home page containing a list of tasks to complete.

Tasks are created to remind users to update a goal and are sent out at a cadence of the admin's choosing:
Once a week.
Once every two weeks.
Once a month.
Twice a quarter.

The task will be named Update the goal. Goal tasks can be dismissed without completing the action they're associated with.

Goal update reminders are set to be sent out on Thursdays around 10:00 A.M. in a user's local time zone.

FIG. 213 is a schematic of a user interface displaying a goal details page.

Clicking on the task will take users directly to the Goal Details page to update the goal progress.

Tasks for Goal Cycles

FIG. 214 is a schematic of a user interface displaying a home page containing a list of tasks to complete for a goal cycle.

Whether or not users will need to create a goal for a goal cycle depends on which types of goals the admin chooses to include in that cycle.
Set company goals: Users may need to create a company goal for a goal cycle.
Set department goals for [the department's name]: User may need to create a department-level goal for a goal cycle.
Set the goals: User may need to create an individual goal for a goal cycle.

Clicking on the task will take users into a blank goal profile and remind users which kind of goal they are setting for that cycle.

FIG. 215 is a schematic of a user interface displaying a create new goals page.

FIG. 216 is a schematic of a goal digest email.

The goal digest is a list of goal updates or newly created goals for a manager's team. For individual contributors, those updates include when a company goal has been updated. Managers will receive the digest email when their direct reports have made an update to their goal.

Enable or Disable the Goal Digest

FIG. 217 is a schematic demonstrating how to navigate a user interface to enable or disable goal digest from the discovery navigation bar.

The following are steps to toggle goal digest off/on.
1. Within the discovery navigation bar, enter profile icon>Manage settings.
2. Navigate to the Notifications page.
3. Under Messages, toggle off/on Goal digest.

The system's Slack integration includes two types of Goals notifications—individual and feed notifications. The individual notifications include activities that directly impact the user's assigned goals whereas feed notifications include public activities for all goals within a Slack channel.

Dsable Individual Notifications

FIG. 218 is a schematic demonstrating how to navigate a user interface to disable the Goals Slack notifications for the individual.

The following steps will disable the Goals Slack notifications for the individual.
1. Within the navigation bar, navigate to the profile icon>Manage settings>Notifications.
2. Under the Delivery method>Goals, uncheck the checkbox for Slack.
3. Select Save.

Only the system's admins or individuals with IT admin permissions can enable or disable Goals Slack individual notifications for all users.

Disable Individual Goals Slack Notifications for the Company

FIG. 219 is a schematic demonstrating how to navigate a user interface to disable individual Goals Slack notifications for the company.

The following steps will disable individual Goals Slack notifications for the company:
1. Navigate to Admin>Platform>Settings>Notifications.
2. Next to Goals, uncheck the checkbox for Slack.
3. Select Save changes.

Only the system's admins or individuals with IT admin permissions can enable or disable Goals Slack feed notifications.

Disable Goals Feed Slack Notifications

FIG. 220 is a schematic demonstrating how to navigate a user interface to disable goals feed Slack notifications.

The following steps will disable the goals feed Slack notifications:
1. Navigate to Admin>Platform>Settings>Integrations.
2. Under Communication Integrations, navigate to Slack.
3. Within the Goals field, remove the Slack channel name.
4. Select Update.

In example embodiments, various user interfaces (also referred to herein as “surfaces”) may surface the information people need to get a snapshot understanding of where the company is at and how goals are progressing without needing to dig for it. Such an overview may be digestible, actionable, and easy to use.

Based on the user type, the system may surface the most relevant information for the user. In addition, the system may make sure to respect and adhere to the goal type in these overview surfaces.

In example embodiments, a goals overview may focus on admins (super admins, goal admins, and goal cycle admins), executives (MoMs), and department heads with higher level overviews. In example embodiments, the goals overview may additionally focus on individual and team experiences.

A surface may be created for an overview of Goals with multiple views that summarizes goal information based on goal type (company or department).

Users may have the option to customize the layout of information based on personal preference, with fields such as goal progress, goal status, owners, time frame. Users can see the relevant goals and how they connect to other goals in the organization through the tree view. Users can see the most recent status update. Users can see analytics components for each view and be quickly informed on the state of the goals.

Permissions

FIG. 221 is a flow chart displaying permissions for various entities.

Users should see all public goals and private goals based on their existing permissions. Admins/department heads may be enabled to more easily get actionable insight into their business for a better user experience.

Each page may have one or more KPIs displayed to the user that summarize the data. A Company page, an All Departments page, and a My Department page may be generated. Each page may have a Goals tab and an Alignment tab.

The Goals tab displays a list of objectives combined with the goal's key results, as well as standalone key results. The Alignment tab displays goals in a tree view, expandable in both directions.

FIG. 222 is a schematic of a user interface displaying a company page.

The company page is an overview page for company-type goals with four main columns: title, owners, updated, progress (%). It may replace an existing company filter preset.

FIG. 223 is a schematic of a user interface displaying an all departments page.

The all departments page is an overview page for summary of all departments with the option to filter to a single department. It is the equivalent of selecting all departments in the explorer filter.

FIG. 224 is a schematic of a user interface displaying a my department page.

The my department page is an overview page for the user's department (not the department a user might be the head of) with similar data as the Company page and the All Departments page. It may replace a department filter preset.

### Components

FIG. 225 is a schematic of a user interface displaying the navigation component of a goals overview page.

Each nav item will be protected by the feature flag+permission level. When the system adds the new pages, the system may hide the old equivalent filter presets.

Because the headers differ slightly for all pages, the system may make one header component per page rather than one general one.

FIG. 226 is a schematic of a user interface displaying a header component of a my department page.

FIG. 227 is a schematic of a user interface displaying a header component of an all departments page.

When a department is selected, the current URL should update to include the departmentEntityId as part of the query params. When the page is reloaded, the department should automatically be set as the initial filter.

FIG. 228 is a schematic of a user interface displaying a header component of a company page.

FIG. 229 is a schematic of a user interface displaying a drop-down component of an all departments page.

This dropdown selects a single as opposed to the multi-department filter we currently see on the explorer page.

FIG. 230 is a schematic of a user interface displaying a drop-down component of a company page.

The drop-down component is a single, simple filter for time range, defaulting to
1. Active goals
2. Current goal cycle (if it exists), else
3. Current fiscal quarter, else
4. All goals. This should control analytics and the goals shown on the entire page

FIG. 231 is a schematic of a user interface displaying drop-down components for creating a goal.

### Example User Interfaces for Presenting Real-Time Insights

FIG. 232 is a schematic of a user interface displaying insights on the progress of goals.

FIG. 233 is a schematic of a user interface displaying insights on a company's goals.

FIG. 234 is a schematic of a user interface displaying time insights.

FIG. 235 is a schematic of a user interface displaying time insights.

Example “AI Goals” User Interfaces

FIG. 236 is a schematic of a user interface displaying an explore goals page.

FIG. 237 is a schematic of a user interface displaying progress for various goals.

FIG. 238 is a schematic of a user interface displaying information for various goals.

FIG. 239 is a schematic of a user interface displaying an employee's goals page.

FIG. 240 is a schematic of a user interface displaying a list of an employee's goals.

FIG. 241 is a schematic of a portion of a user interface indicating unread notifications for my goals.

FIG. 242 is a schematic of a portion of a user interface displaying unread notifications for goals which need to be updated.

FIG. 243 is a schematic of a portion of a user interface displaying the discovery navigation bar.

FIG. 244 is a schematic of a portion of a user interface displaying a goal explore page header.

FIG. 245 is a schematic of a portion of a user interface displaying an update goals notification.

FIG. 246 is a schematic of a portion of a user interface displaying a my goals page header.

FIG. 247 is a schematic of a portion of the user interface displaying a matrix of a goal and supporting key results.

FIG. 248 is a schematic of a user interface displaying a list of goals and supporting key results.

FIG. 249 is a schematic of a user interface displaying a my goals page.

### Compensation

The Employee Pay page is where super admins and compensation admins can see an overview of all of their company's employees' compensation and demographic information and upload employee pay data.

Admins can filter data as well as export the table into a CSV.

Navigate to the Employee Page
from Admin>Compensation>Employee Pay.

The Employee Pay Table contains the following information:
1. Employee info data is pre-populated in the employee pay table. Employee info in the employee pay table includes:
   Employee title.
   Manager.
   Department.
2. Compensation band data can be populated. Compensation bands in the employee pay table include:
   Job level.
   Job role.
   Location tier
   Total OTE Min/Mid/Max.
   Comp band placement.
   Compa-ratio.
3. Compensation data is populated either through an HRIS sync or through manual CSV upload. If data was populated via CSV, admins are able to manually edit individual pay information within the table. Compensation in the employee pay table includes:
Pay type.
Currency.
Hourly pay.
Base pay.
Variable pay.
On-target earnings
Ratio (Variable %).
Pay effective date.

The Compensation Settings page is where super admins and compensation admins are able to bulk upload key compensation information for their employees.

Navigate to Compensation Settings from Admin>Compensation>Settings.

All data on this page is required to run a compensation cycle.

Compensation data includes:
Employee base pay and variable pay.
Compensation bands.
Compensation band assignments.

The Compensation Bands page is where super admins can manage the compensation bands for their organization.

Navigate to the Compensation Bands page from Admin>Compensation>Compensation Bands.

The Compensation Bands page allows admins to:
Create compensation bands.
View all compensation bands.
Edit compensation bands.
Delete compensation bands.
Share compensation bands.
Assign compensation bands.

Before admins can create a compensation cycle, they must upload employee pay data (base pay, variable pay if applicable, pay effective date, and pay currency), create compensation bands, and assign each employee to a compensation band.

Ensure that email addresses are correct and match existing emails of active employees in the system. If an email is uploaded that is not currently in the system, a new user will be created.

Only the system's super admins will be able to upload compensation data. Comp admins will have visibility to the modal but will be unable to upload.

Employee Base Pay and Variable Pay

FIG. 250 is a schematic of a user interface displaying the compensation settings page.

The following are steps to upload pay data:
1. Navigate to Admin>Compensation>Settings
2. Under Employee compensation, next to Employee base pay and variable pay, select Upload CSV.
OR
1. Navigate to Admin>Compensation>Employee Pay.
2. Select Upload pay data.
3. Download the Employee CSV template and input the necessary data.
4. Upload the CSV.
5. Select Save.

The following fields are required in the Employee CSV Template:
Email.
Base pay amount.
Variable pay amount.
Pay effective date
Currency.

FIG. 251 is a schematic of a user interface displaying a page for uploading an employee's CSV.

Job architecture is the framework for understanding roles and their hierarchy within a company. In the system, job architecture is a combination of user attributes that determine an employee's compensation band in our Compensation tool.

Job architecture is available as three default user attributes in the system:
Job function.
Job type.
Job level.

Align Job Architecture with Compensation Bands

The following are steps to align job architecture with a compensation band:
1. Create each compensation band with an assigned job function, job type, and job level manually or via CSV upload.
2. Assign employees to each compensation band via CSV upload.

Note: The CSV upload will contain all job architecture attributes. Uploading the CSV with the associated job architecture values will match the employees to the corresponding compensation band.

Before admins can create a compensation cycle, compensation bands must be created in the system.

Create a Compensation Band

FIG. 252 is a schematic demonstrating how to navigate a user interface to create a new compensation band.

The following are steps to create a new compensation band:
1. Navigate to Admin>Compensation>Compensation Bands.
2. Select Create band Create new band.
3. Add the following required fields:
   Track
   Job level
   Job function
   Job type
   Currency code
   Min base pay (salary)
   Mid base pay (salary)
   Max base pay (salary)
4. (optional). Select Show optional fields to view and input any additional values, including OTE, equity, and bonus.
5. Select Save to apply the compensation band to the track.
6. Select Save.

FIG. 253 is a schematic of a user interface displaying required fields for the creation of a new compensation band.

Note: To bulk upload compensation bands, select Upload from CSV, download the template, and reupload.

Before admins can create a compensation cycle, admins must create and assign employees to compensation bands in the system.

Buk Upload Compensation Bands

There are two locations in the system that allow admins to bulk upload compensation bands:
Compensation Bands page.
Compensation Settings page.

FIG. 254 is a schematic demonstrating how to navigate a user interface to bulk upload compensation bands from the compensation bands page.

The following are steps to bulk upload compensation bands from the compensation bands page:
1. Admin>Compensation>Compensation Bands.
2. Select Create band >Upload from CSV.

FIG. 255 is a schematic demonstrating how to navigate a user interface to bulk upload compensation bands from the compensation settings page.

The following are steps to bulk upload compensation bands from the compensation settings page:
1. Navigate to Admin Compensation>Settings.
2. Under Compensation bands, select Upload CSV.
3. (for both locations) Download the Compensation bands CSV template and input the necessary data.
4. (for both locations) Upload the CSV.
5. (for both locations) Select Save.

The following fields are required for the compensation bands CSV template:
Job level
Job function
Job type
Currency
Min base pay (salary)
Mid base pay (salary)
Max base pay (salary)

Note: Base salary ranges need to be broken out for each job function.

FIG. 256 is a matrix containing an example compensation band CSV.

FIG. 257 is a schematic of a user interface displaying a compensation bands page with the option to assign employees to the bands.

Once compensation bands have been created, admins can assign employees to the bands. Employees must be assigned to a compensation band in order to be included in a compensation cycle

The following are steps to assign employees to compensation bands:
1. Navigate to Admin Compensation>Compensation Bands.
2. Under Job Functions, select the desired job function that contains the compensation band to be updated.
3. Select Assign employees.
4. Select+Add employees to open the employee modal.
5. Use filters or the search bar to find employees to assign to the compensation band. Check the desired employees and select Add employees.
6. Select Level and location from the drop-down for the newly added employees.
7. Select Save changes.

FIG. 258 is a schematic of a user interface displaying a compensation settings page with the option to upload a CSV for employees assigned to bands.

Once compensation bands have been created, an admin can follow the following steps to assign employees to the bands by uploading a CSV.
1. Navigate to Admin>Compensation>Settings.
2. Under Compensation bands, select Upload CSV next to Employees assigned to bands.
3. Download the prefilled Employee Compensation bands CSV template and input the necessary data.
4. (optional). Download the prefilled Compensation Bands Reference CSV as a reference guide as employees are assigned to the employee compensation bands CSV template.
5. Upload the CSV.
6. Select Save

The following fields are required in an employee compensation bands CSV template:
Name
Employee email
Job type
Job level
Location tier

Once an employee has been assigned to a compensation band, admins can remove that employee from the band at any point in time.

Note: Removing an employee from a compensation band will also remove them from any band information that has been shared.

Remove an Employee from a Compensation Band

FIG. 259 is a schematic demonstrating how to navigate a user interface to remove an employee from a compensation band from within the compensation bands page.

The following are steps to remove an employee from a compensation band from within the compensation bands page:
1. Navigate to Admin>Compensation>Compensation Bands.
2. Under Job functions, select the desired job function that contains the compensation band to be updated.
3. Select Assign employees.
4. Find the desired employee and select the ellipsis>Remove.
5. Select Confirm.

Once compensation bands have been created and assigned, admins can share the compensation bands with the employee's manager.

Share Compensation Bands with a Manager

FIG. 260 is a schematic demonstrating how to navigate a user interface to share compensation bands with a manager from the compensation bands page.

The following are steps to share compensation bands with a manager from the compensation bands page:
1. Navigate to Admin>Compensation>Compensation Bands.
2. Under Job functions, select the desired job function.
3. Select Share to open the Share modal
4. Under Add employees, search and select the employees that should have view access to the job function.
5. Select or deselect the Job types, Levels, and Locations that should be visible to the employee.
6. Under Future changes, select or deselect whether to share additional job types, levels, or locations that may be added to the track in the future.

FIG. 261 is a schematic of a user interface displaying a share modal to indicate which employee's compensation bands should be shared with a manager.

Once shared, compensation bands can be viewed by managers.

View Compensation Bands for a Team

FIG. 262 is a schematic of a user interface displaying compensation bands for a team.

The following are steps to view a compensation band for a team:
1. Navigate to Compensation within the Discovery navigation.
2. Under Tracks, select the desired track.

Compensation bands contain the following:
Job level
Job title.
Location.
Min base salary.
Mid base salary.
Max base salary.
Additional custom columns.

A glossary of terms for Compensation:
Variable pay: Payment made to an employee for their additional (“above and beyond”) contributions to the company. Very common pay practice seen in sales. A lot of times the variable is tied to hitting “key results” or “goals”.
Base pay: The base rate of pay for a job or activity. This does not include additional payments such as bonus, overtime, variable, etc.
Comp band: Range of compensation given for a certain role.
Compa-Ratio: A calculation expresses current pay as a percentage to the midpoint of a set comp band. For example, if the midpoint of a comp band is $100,000 and an employee is being paid $105,000, their compa-ratio is calculated as such: $105,000/$100,000=1.05
Compensation cycle: The process of reviewing and updating employee compensation.
Participant: An employee who is in the comp cycle as eligible or ineligible for a change in compensation
Ineligible: A status on an employee that indicates an individual who will not be able to receive any compensation changes. This is determined through preset rules by the admin (tenure, time since last compensation change) or manually.
Recommender: A manager who is only responsible for compensation recommendations for their direct reports
Approver: Any manager who is responsible for approving recommendations from managers below them, as well as recommending for their own direct reports
Raise guidance: The preferred raise amount for each employee. This is typically calculated before launching the cycle, and given to managers as a reference.
Promotion guidance: The preferred raise amount for an employee entering a new level/comp band based on a promotion. This is typically calculated before launching the cycle, and given to managers as a reference.
Overall budget: The total budget allocated for a compensation cycle.
Manager's budget: The amount a manager is allocated to use for comp adjustments across all their eligible direct reports. This is based on sum of guidance and any additional distributions.
Pay effective date: The date of the employee's last pay change (start date or date of last merit increase)

Files to Upload

The following files will need to be uploaded before creating a compensation cycle. All are required with the exception of promotions.

Employee pay data: Pay data includes base pay, variable pay, currency, and pay effective date. Employee pay data is required before creating a compensation cycle.

Compensation bands: Compensation bands refer to the minimum and maximum amounts a company is willing to compensate someone within a job level. Compensation bands are required before creating a compensation cycle.

The following fields are required for a compensation band:
Track.
Job level.
Job function.
Job type.
Currency code.
Min base pay (salary).
Mid base pay (salary).
Max base pay (salary).

Compensation band assignments: Employees must be assigned to a compensation band in order to be included in the compensation cycle.

When bulk assigning compensation bands, the following fields are required:
Name.
Employee email.
Job type.
Job level.
Location tier.

Promotions: Promotion indicates which individuals are going to be promoted via this cycle. Promotion is set during the compensation cycle set up via a CSV.

Compensation Cycle Information

The compensation cycle will require the following information.

Currency: Determine the currency to use for the compensation cycle. Compensation cycles can only use one currency type.

Eligibility rules: Decide which employees are eligible to receive a compensation adjustment based on:
Tenure (start date).
Last compensation change.

Performance data to be used: Determine whether to bring in a performance rating question from a review cycle. This information can be used to help calculate raise guidance and be provided to managers and admins for context.

Budget and distribution: Determine the overall budget based on an average (%) increase on total pay or a lump sum amount.

Guidance rules for salary increases: Determine whether to provide recommenders with a raise guidance for each eligible employee based on a target percent increase on total pay. You can set a certain percentage based on the linked performance review or for all employees.

There are several types of admin roles with varying levels of access to compensation data and functionality:
Super Admin: This is an overall system admin who has access to all data and functionality in Compensation, as well as every other product in the system. Ideally, there should only be one of these at any given time.
Compensation Admin: This is a custom role that can be created by a Super Admin by going to Admin>People>Permissions>Custom Role and creating the role and checking Global Permissions for Compensation. This admin will be able to access all compensation data and functionality, but will not be able to access any other system product admin functions
Compensation Cycle Admin: This is a role on a particular compensation cycle, and can be added by a super or compensation admin during any part of the cycle. This role has access to all compensation data for participants of that cycle, as well as access to that cycle's admin settings. This role will not have access to the broader compensation data or functionality outside of the specific cycle.

FIG. 263 is a table displaying the admin roles and their levels of access to compensation data and functionality.

For specific functionality, please see the table in FIG. 262.

Compensation cycles allow admins to set up, launch, and track the compensation review workflow directly in the system. For an overview of the process, see the following video:

Before admins can create a compensation cycle, admins may be prompted to:
Upload employee pay data (base pay, variable pay if applicable, pay effective date, and pay currency).
Create compensation bands.
Assign each employee to a compensation band.

Create a Compensation Cycle

The following are steps to create a new compensation cycle:
1. Navigate to Admin>Compensation>Compensation Cycles.
2. Select Create new cycle.

Compensation cycles require completion of the following steps:
1. Setup
2. Rules and ratings
3. Participants
4. Data check
5. Roles
6. Budget
7. Distribute
8. Verify

The Setup page of a compensation cycle setup allows admins to name the cycle and set compensation cycle admins.

Setup Page

FIG. 264 is a schematic of a user interface displaying a setup page for creating a compensation cycle.

The following are steps in the setup page of a compensation cycle:
1. Give the cycle a name. The title of a compensation cycle should be clear and descriptive. This name will appear for managers and managers of managers who will participate in the cycle.
2. (Optional) Search and select compensation cycle admins who will be able to configure, launch, and run the compensation cycle they have been added to.

The Rules and Ratings page of a compensation cycle setup allows admins to define eligibility requirements for the compensation cycle.

Rules and Ratings Page

FIG. 265 is a schematic of a user interface displaying a rules and ratings page for creating a compensation cycle.

The following must be input in the rules and ratings page for employees to be eligible to receive a compensation adjustment:
1. Currency: Select the single currency to use for the cycle. Only employees with this currency will be able to participate in the compensation cycle
2. Eligibility rules: Define which employees are eligible to receive a compensation adjustment based on Tenure and the Last compensation change date.
3. Performance rating: Select whether to bring in a review with performance ratings. This information can be used to help calculate raise guidance and be provided to managers and admins for context.
   If users select Select a review and a performance rating, they can choose a Review cycle and a Performance rating question that best describes overall performance for additional context.

The Participants page of a compensation cycle setup allows admins to determine who will be included in the cycle, who will be promoted in the cycle, and confirm performance ratings.

Participants Page

FIG. 266 is a schematic of a user interface displaying a participants page for creating a compensation cycle.

Status: Participants initially represent all employees. In the table, each participant will have a specific status based on the eligibility rules:
1. Eligible: Employees that can receive a comp adjustment in this cycle.
2. Ineligible: Employees that did not fit the criteria and will not receive a comp adjustment in this cycle. Ineligible employees will still show up on the tables for context.
3. Hidden: Employees that are hidden from the process so they do not appear anywhere. This is most commonly used in cases where someone senior, like a CEO, doesn't want their compensation to show. Another potential use case is if there are hourly workers who should not be part of this cycle.

Admin users will be able to change the status on the table to override the eligibility rules via the dropdown.

Note: You can adjust individual employee eligibility during the active cycle.

Rating: Ratings will show whether or not an employee has a performance rating via a checkmark based on the selection made within the Rules and ratings page.

FIG. 267 is a schematic of a user interface displaying a promotion nomination modal for indicating promotions in a compensation cycle.

Promotion: Promotion indicates which individuals are going to be promoted via this cycle. Promotions can be added via CSV upload or manually within the cycle setup.

The following are steps to indicate promotions within the cycle setup:
1. Select the Promotion dropdown next to an eligible participant.
2. Within the Promotion nomination modal, select the following fields assigned to the employee post-promotion:
   Job function
   Job type
   Job level
   Job location
3. Select Save.

Note: Promotion handling will be unavailable for hidden or ineligible employees.

FIG. 268 is a schematic demonstration how to navigate a user interface to upload a CSV from within the participants page.

Bulk update eligibility or promotions: Admins can make bulk changes to the participants by uploading a CSV

The following are steps to upload a CSV and make bulk changes to the participants
1. Select Upload CSV.
2. Download the Promotion Decision CSV template.
3. Optionally, download the prefilled Compensation Bands Reference CSV to use as a reference to assign employees.
4. Under the Status column, add whether employees can or cannot receive a comp adjustment by inputting eligible, ineligible, or hidden.
5. Under the Promotion Decision (Y/N) column, add promotion decisions by inputting Y or N for each employee.
   Note: New, Track, New Level, and New Location are required for employees receiving a promotion.
6. Upload the updated CSV.
7. Select Save.

The Data check page of a compensation cycle setup allows admins to ensure all participants (except for hidden) have pay data and are assigned to a compensation band.

Data Check Page

FIG. 269 is a schematic of a user interface displaying a data check page for creating a compensation cycle.

If an employee is missing employee base salary and variable pay or compensation band assignments, a flag will be raised, and users will be directed to the Settings page to correct missing data before moving on to the next step.

The Data check page also shows some optional data for reference, but missing data here does not stop the cycle from progressing to the next step. Roles Page

FIG. 270 is a schematic of a user interface displaying a roles table for creating a compensation cycle.

Role table: All managers with eligible direct reports are included within the Roles table as a compensation recommender. Managers of managers will be listed as approvers of the managers who report to them.

The Roles table includes:
Name: The name of the recommender or approver
Department: The department the recommender or approver is in
Recommender of: The number of direct reports the recommender is responsible for creating a compensation change proposal for Click on the number to view the exact individuals.
Approver of: The number of manager recommendation proposals the employee can edit, comment on, and approve. Click on the number to view the exact individuals.

Admin users can remove managers from submitting in the cycle by unchecking their names from the list. Any employees they were responsible for recommending or approving will be assigned to that person's manager. If users choose to uncheck all managers and managers of managers along a reporting chain, the admin will be in charge of all of their recommendations.

The Budget page of a compensation cycle setup allows admins to set a budget and calculate the projected spend for the compensation cycle.

Budget Page

FIG. 271 is a schematic of a user interface displaying a budget page for creating a compensation cycle.

This budget guidance will help support recommenders in making compensation decisions. The following can be completed when setting a budget:
Set the budget: Calculate the overall target budget using an average percent (%) increase on total pay under Increase/employee for each eligible employee or entering a lump sum amount under Total budget.
Promotion raise guidance: Provide recommenders with an automatic calculation for raises for people who are promoted to their new band using a compa-ratio. Note that this option is only available if users have uploaded promotions within the Participants page.
Merit raise guidance: Provide recommenders with a raise guidance for each eligible employee by entering a target percent increase on total pay.
If users have linked performance reviews, they can set certain percent (%) merit increases based on scores.
If no performance reviews were linked, the percentage (%) would apply to all eligible employees.

FIG. 272 is a projected distribution chart showing a budget breakdown.

The Projected distribution chart shows the budget breakdown by the three existing categories: promotion guidance, raise guidance, and remaining budget.

If promotion and merit raise guidance exceeds the total budget, users will receive an exceeding budget error and be requested to adjust the budget or raise guidance.

The following are steps for Admins to bulk update the raise guidance by uploading a CSV:
1. Select Upload guidance.
2. Download the Raise Guidance CSV template.
3. Update the Raise Guidance column with custom values
4. Upload the updated CSV.
5. Select Save.

The Distribute page of a compensation cycle setup allows admins to distribute any remaining budget to select leaders.

Distribute Page

FIG. 273 is a schematic of a user interface displaying a distribute page for creating a compensation cycle.

Distribution is shown for the first two layers of the organization to give the leaders extra budget in addition to the guidance set. To allocate additional budget to a leader, add additional funds within the Additional column.

Note: Compensation admins can adjust and distribute budget during the active cycle.

The Verify page of a compensation cycle setup allows admins to review the compensation cycle configurations and launch the cycle.

Verify Page

FIG. 274 is a schematic of a user interface displaying a verify page for creating a compensation cycle.

At the end of the cycle setup process, users will have the option to verify their configurations and send a customizable launch notification to all managers who are participating in the cycle.

All participating managers will receive a notification via email, Slack, or Microsoft Teams, depending on the company's notification preference, and also receive a task on the homepage prompting them to complete their compensation review.

Once a compensation cycle has been launched, managers will receive a notification prompting them to complete their compensation review for their direct reports.

Note: In most cases, only direct line managers will see this view. However, in some cases, managers of managers may also get this view if their direct report managers are not recommending as part of the process, in which case all their direct report's reports will roll up to the manager of managers.

Complete a Compensation Review

The following are steps to create a compensation review:
1. Within the Home page, select the Complete your compensation review task.
OR
1. If you are an admin, enter the Your team tab within the compensation cycle.

FIG. 275 is a schematic of a user interface displaying compensation statistics.

The compensation review includes a summary of statistics for the team:
Eligible employees: the number of direct reports that are eligible for a comp change this cycle
Employees in band: the number of the eligible employees that are within their role's comp band
Spend: the current sum of the recommendation inputs on the page
Budget: the sum of the guidance of all eligible employees for eligible direct reports

FIG. 276 is a schematic of a user interface displaying a portion of an employee card.

Each member of the team will have an employee card with their information and places to fill in their compensation recommendation. Ineligible employees will also be included, but users will not be able to make recommendations for them.

The following contextual information is provided on each card:
Job Function: the job function the employee is in
Level: the job level of the employee in that function
Location: the location group the employee is a part of
Start date: the date the employee started at the company
Perf rating: the performance rating of the employee based on a recent review the admin connected to the merit cycle. Note: If a review was not connected, this column may not be visible
Last comp change: how long ago it's been since the employee's last cash comp change
Promotion: whether or not this employee is being promoted
Current pay: the current total cash pay of the employee (includes base and variable pay)
Current base: the current base pay of the employee
Current variable: the current variable pay of the employee, if applicable
Raise guidance: the raise guidance provided by the admins who set up the cycle
Band movement: the current total pay band of the employee with several indicators
Solid gray circle: current band position
Solid red circle: current band position is outside of the compensation band
Open gray circle: position based on guidance
Open red circle: position based on guidance is outside of the compensation band
Green triangle: manager's recommendation
Red triangle: manager's recommendation is outside compensation band

FIG. 277 is a schematic of example pay bands from an employee card. Write Compensation Recommendation

FIG. 278 is a schematic of a user interface displaying a raise recommendation section from an employee card.

To write in a compensation recommendation, input a raise recommendation as a percentage (%) or new total pay.

If an employee has a variable pay component, a manager can manually edit the amount of pay that belongs to base vs. variable, or they can enter a value into ‘Total’ and base and variable will be automatically calculated based on the existing ratio.

If users would like to use the guidance set by the admin, they can select Use Guidance to automatically input the recommendation.

FIG. 279 is a schematic of a user interface displaying the footer section from an employee card.

The page footer will track how many recommendations have been completed and how many are outstanding. The next person in the compensation process, the approver, will be shown here.

FIG. 280 is a schematic of a user interface displaying a popup modal for adding an explanation to a recommendation in an employee's card.

You can add in an explanation to a recommendation by clicking the ‘Add a note’ button on the employee's card. This explanation will be viewable by all managers approving this employee, as well as admins.

Submit Recommendations

Select Confirm recommendations to submit one or more recommendations. Note, that recommendations cannot be edited once submitted.

Once a compensation cycle has been launched, managers of managers will receive a notification prompting them to complete their compensation review for their direct and indirect reports.

Managers of managers are responsible for the approval of recommendations submitted by those in their organization and will see a view that includes approving, in addition to recommending.

Complete a Compensation Review

The following are steps to complete a compensation review:
1. Within the Home page, select the Complete your compensation review task.
OR
1. If you are an admin, enter the Your team tab within the compensation cycle.

FIG. 281 is a schematic of a user interface displaying the my direct reports section from an employee card.

Users will have the opportunity to provide recommendations for their own direct reports under the My direct reports section.

Note: Most of the information and tasks are similar to the manager recommender view. The key difference is that explanations that justify a user's recommendations are submitted by clicking on the Notes icon within the Actions column. Justifications will only be visible to those above the user within their reporting chain.

FIG. 282 is a schematic of a user interface displaying the my organization section from an employee card.

Under My organization, users will be able to view and approve all recommendations submitted by the team for their direct reports. Expand each manager's section to view a table of their direct reports and recommendations.

To submit this page, users will need to act on each person in their organization by either:
1. Writing in a recommendation if none was provided by a user's direct report
2. Approve a recommendation that was supplied by selecting the checkmark next to an individual's name or selecting the All approve button.
3. Override a recommendation that was supplied by re-inputting the new pay as a percentage (%) or new total pay.
4. Select Review recommendations to continue.

The page footer will track how many recommendations and approvals have been completed and how many are outstanding. The next person in the compensation process, the approver, will be shown here.

FIG. 283 is a schematic of a user interface displaying a confirmation page for reviewing compensation adjustments.

The Confirmation page allows users to review their compensation adjustments:
Reviewed and modified: Includes any employees the user adjusted compensation for. These will typically include the users' recommendations.
Reviewed without modification: Includes any employees the user approved compensation for without adjusting compensation. These will typically include the user's direct report's recommendations that the user approved.

Select Submit to finalize the recommendations. Note that approvals cannot be edited once submitted.

Once users have navigated to the Notification Center, there are a few options for how notifications can be sent when it comes to our Compensation tool-through Slack/Microsoft Teams and/or through email.

Compensation notifications are sent as follows:
When a compensation cycle launches.
When compensation cycle results are shared.

FIG. 284 is a schematic of a user interface displaying a notifications settings page with the option to send compensation notifications through Slack, Microsoft Teams, or email.

To send these through Slack/Microsoft Teams or email, users can check on the boxes to the right of Compensation, as shown in FIG. 283.

FIG. 285 is a schematic of a notification requesting a user to customize a launch message to compensation cycle participating managers.

Admins will have the opportunity to customize a launch message to compensation cycle participating managers during the setup.

This notification will be sent via email, Slack, or MS teams (depending on a user's notification settings). Participating managers will receive a task on their homepage prompting them to complete their compensation review when the cycle is launched.

FIG. 286 is a schematic of a notification that the results of a compensation cycle are available for review.

Once a compensation cycle ends, admins can share results with participating managers. Sharing results will prompt a notification to all managers.

This notification will be sent via email, Slack, or MS teams (depending on a user's notification settings). Participating managers will receive a task on their homepage prompting them to view their results.

FIG. 287 is a schematic demonstrating how to navigate a user interface to add admins to a compensation cycle.

Compensation cycle admins will be able to configure, launch, and run the compensation cycle they have been added to.

Note: Notifications will not be sent to admins once added to a compensation cycle

The following are steps to add admins to a compensation cycle:
1. Navigate to Admin>Compensation>Compensation Cycle.
2. Select View Progress to enter the desired cycle.
3. Under Manage Cycle, enter the Overview page.
4. Next to Comp cycle admins, select Edit.
5. To revoke access, select Remove next to the user to remove as an admin.
6. To add a new admin, search and select the user's name within the text bar.
7. Select Save changes.

Admins have the ability to change the status of a compensation cycle participant even after a cycle has been launched.

Note that if a participant is moved to hidden (i.e., removed from the cycle) they will not be able to be added back in. Some status changes may result in changes in budget guidance, which will be noted and will prompt a user to make adjustments to the user's budget.

Adjust Participant Status

FIG. 288 is a schematic demonstrating how to navigate a user interface to adjust the status of participants in a compensation cycle.

The following are steps to adjust the status of participants in a compensation cycle:
1. Navigate to Admin>Compensation>Compensation Cycle.
2. Select View Progress to enter the desired cycle.
3. Under Manage Cycle, enter the Participants page.
4. For the desired participant, change the Status on the table to override the eligibility rules via the dropdown.
5. A confirmation modal will appear—select Yes, change status.

Admins have the ability to adjust the compensation budget even after a cycle has been launched.

Note that this is based on the budget that was set up initially and does not reflect any actual recommendations that may be coming in.

FIG. 289 is a schematic of a user interface displaying a budget distribution chart from a budget page.

The Budget page includes a Budget distribution chart that shows the budget breakdown by the three existing categories: raise guidance, distributed, and remaining budget.

If the distribution ever goes over budget, the system will notify users via a callout; however, being over budget will not stop the cycle from running. To prevent going over, adjust the total or distributed budget using the steps below.

Adjust Budget in an Active Cycle

FIG. 290 is a schematic of a user interface displaying a budget page for an active compensation cycle.

The following are steps to adjust a budget in an active compensation cycle:
1. Navigate to Admin Compensation>Compensation Cycle.
2. Select View Progress to enter the desired cycle.
3. Under Manage Cycle, enter the Budget page.

Total Budget

The total budget shows the entire budget of the cycle. You can increase or decrease this total amount.

The following are steps to adjust the total budget of a cycle:
1. Next to Total budget, select Edit.
2. Calculate the overall target budget using an average percent (%) increase on total pay under Increase/employee for each eligible employee or entering a lump sum amount under Total budget.
3. Select Save changes.

Distributed Budget

The distributed budget shows how much of the post-raise and promoting guidance budget is being distributed to employees directly below the CEO as extra budget on top of the existing raise guidance allocation. You can increase or decrease the amount per leader.

The following are steps to adjust the distributed budget of a cycle:
1. Next to Distributed budget, select Edit.
2. Adjust the distribution of the budget to select leaders by entering an amount under Additional.
3. Select Save changes.

Once the compensation cycle setup makes it past the Data check page, a snapshot of the cycle data will be taken. This means that any changes to that data made after this point will not be reflected in the cycle

This data includes:
Changes to salary data (through upload or the Employee Pay table).
Changes to compensation bands data or assignments (through upload or compensation bands table).
Changes to salary or compensation band currencies.

Admins will also not be able to add promotions after this point.

Changes to eligibility statuses will be allowed during the active cycle. Admins will be able to change ineligible participants to eligible and vice versa.

Admin users will have visibility into all submissions across the compensation cycle.

Navigate to Compensation Changes

FIG. 291 is a schematic of a user interface displaying the all compensation changes tab for a compensation cycle page.

The following are steps to view compensation changes:
1. Navigate to Admin>Compensation>Compensation Cycle
2. Select View Progress to enter the desired cycle.
3. Enter the All compensation changes tab.

View Compensation Changes

The compensation review includes a summary of statics for the team:
Spend: the current sum of the recommendation inputs on the page
Budget: the total budget of this cycle
Spend/Budget: the percentage of the budget distributed

The compensation table includes a list of all employees, separated by team, that are eligible for a comp change along with the following contextual information:
Job Function: the job function the employee is in
Level: the job level of the employee in that function
Location: the location group the employee is a part of
Promotion: whether or not this employee is being promoted
Last change: how long ago it's been since the employee's last cash comp change
Perf rating: the performance rating of the employee based on a recent review the admin connected to the merit cycle. Note: If a review was not connected, this column may not be visible.
Current pay: the current total cash pay of the employee (includes base and variable pay)
Current base: the current base pay of the employee
Current variable: the current variable pay of the employee, if applicable
Current ratio: the ratio between base and variable, if applicable
Raise guidance: the raise guidance provided by the admins who set up the cycle
Guidance pay: the total new pay if the raise guidance is taken (current pay+raise guidance)
Band movement: the current total pay band of the employee with several indicators
Solid gray circle: current band position
Solid red circle: current band position is outside of the compensation band
Open gray circle: position based on guidance
Open red circle: position based on guidance is outside of the compensation band
Green triangle: manager's recommendation
Red triangle: manager's recommendation is outside compensation band
Compa-ratio movement: shows what the current compa-ratio of the employee is, and what the compa-ratio would be if guidance is followed, and what the ultimate compa-ratio based on the manager recommendation.
New pay: the new salary based on recommendations. This includes variable pay, if applicable. You will be notified if the employee has been marked as non-eligible to receive a compensation adjustment.
Total Cash: the total cash salary for the employee

FIG. 292 is a schematic of example pay bands from an employee card.

FIG. 293 is a schematic demonstrating how to navigate a user interface to group a compensation table by manager or none.

The Compensation table allows users to group by Manager or None. Choosing to Group By “None” will show all participants within the cycle. This can be filtered further by Department, Job Function, Job Level, or Location.

FIG. 294 is a schematic of a user interface displaying a portion of a compensation table where notes may be added regarding a change in an employee's compensation.

Under Actions, admins can provide admin notes around any changes made to compensation for each employee. Only admins who have visibility to the compensation tool will have visibility into the notes left.

Overriding New Pay

Admins have the ability to override all inputs for each employee by adjusting the new pay percentage or total pay. New pay will still be editable even after the cycle ends to allow a user to provide any final inputs or overrides.

Admins can end a compensation cycle to stop managers from submitting additional recommendations and approvals.

Cycles can be ended at any time, even if recommendations and approvals have not all been completed. Managers who have not submitted their recommendations will be unable to do so once the cycle is ended.

Admins can still edit comp changes after a cycle has ended within the All compensation changes tab. Once a comp cycle has ended, it cannot be reopened.

End a Compensation Cycle

FIG. 295 is a schematic demonstrating how to navigate a user interface to end a compensation cycle.

The following are steps to end a compensation cycle:
1. Navigate to Admin>Compensation>Compensation Cycle
2. Within any tab in the cycle, select End cycle.
3. A confirmation modal will appear—select End Cycle.

Final compensation changes can be shared with participating managers in the system after a cycle has ended. Managers will get view-only access to the compensation data of their direct reports.

Admins will be unable to share results until the compensation cycle ends.

Once the compensation changes are shared, users will be unable to revoke visibility access; however, users can continue to make edits to compensation changes that will automatically be reflected in the manager's view.

Share Results

FIG. 296 is a schematic demonstrating how to navigate a user interface to share the results of a compensation cycle.

The following are steps to share compensation cycle results:
1. Navigate to Admin>Compensation>Compensation Cycle.
2. Select View results to enter the desired cycle.
3. Under All compensation changes, select Share . . .
4. A confirmation modal will appear—select Share.

FIG. 297 is a schematic of a user interface displaying a task on the home page indicating that compensation cycle results have been shared.

Once results are shared, all managers who participated in the comp cycle will receive two forms of notification: an email, Slack, and/or MS Teams message (depending on the organization's custom notification settings). A homepage task will be created to allow managers to easily access the view within the system.

FIG. 298 is a schematic of a user interface displaying a matrix of compensation cycle results.

Once compensation cycle results have been shared by an admin, users will be able to view the results for their team.

The following are steps to view the results for a team:
1. Navigate to the Compensation cycle results have been shared! task on the home page.
2. Under My direct reports, view the Final New Total for the team.

As described herein, machine learning techniques may be used to, for example, improve the alignment of employee goals with company objectives and/or enhance compensation decisions.

Aligning Employee Goals Using Machine Learning

A machine learning model may be trained on historical goals data to generate predictions for aligning new employee goals.

Training Data Preparation

Historical goals data may be collected from various sources, including, for example, employee records, performance systems, and HR platforms. The raw goals data may include unstructured text descriptions of past employee goals. Natural language processing techniques may be used to extract structured information from the goals text.

For example, named entity recognition and relation extraction algorithms may be applied to identify key entities (e.g. employee, department, objective, metric) and/or relationships describing the alignment of goals. Text embedding algorithms may be used to convert the raw text into numerical vector representations encoding semantic meaning.

The processed goals data may be divided into training and holdout test sets. The training set may be used to train the machine learning model. The test set may be used to evaluate model performance.

Model Architecture

The machine learning model may comprise a neural network implementing an embedding layer, convolutional layers, pooling layers, and/or dense layers. A convolutional neural network architecture may be selected based on its proven effectiveness in text classification tasks.

The embedding layer converts input text vectors into dense vectors using a goals-specific word embedding matrix. The convolutional layers identify local patterns and motifs in the embedded vectors. The pooling layers reduce the dimensionality of the convolutional layers while preserving important information. The dense layers classify the extracted features into goal alignment predictions.

One skilled in the art will appreciate that various standard neural network architectures could be adapted for the goals alignment task.

Model Training

The neural network may be trained on the prepared goals data using standard backpropagation techniques. The network parameters are updated to minimize a loss function comparing the predicted goal alignments against the true labels in the training set.

Regularization methods like dropout and early stopping may be used to prevent overfitting. Hyperparameters like learning rate, epochs, and/or batch size may be tuned using the holdout test set to optimize prediction accuracy.

The result is a trained neural network model for predicting, for example, the alignment of new employee goals based on text descriptions.

Goal Alignment Deployment

In operation, the trained model may be deployed to, for example, align new employee goals with company objectives, for other uses described herein. For example, when an employee submits a new goal, the text description is passed to the trained model. The model generates a predicted alignment for the new goal with existing company objectives.

The predicted alignment can be presented to the employee or administrator to assist in linking the goal. The model's probabilistic predictions can also be thresholded to generate automated goal alignment recommendations. By leveraging the trained model, the system technically improves the goal alignment process.

Enhancing Compensation Using Machine Learning

Machine learning techniques may also be used to improve compensation decisions.

Compensation Training Data

Historical compensation data may be collected from company records. The raw data may include employee details like performance ratings, job function, experience level, past compensation, and/or demographic information.

Feature engineering may be used to extract relevant variables from the raw data. Categorical variables like job function are encoded into numeric representations. Text variables like performance feedback are embedded into vectors using natural language processing. The processed data is divided into training and test sets.

Compensation Model Architecture

A regression neural network may be used to predict appropriate compensation changes. The network has an input layer accepting the engineered features, hidden layers for processing, and/or an output layer predicting the compensation change amount.

Those skilled in the art will appreciate the wide range of applicable regression models.

Model Training Methodology

The network may be trained on the compensation data to minimize a loss may be comparing the predicted and actual compensation changes. Regularization methods are employed to prevent overfitting. The hyperparameters may be tuned on the holdout test to optimize prediction accuracy.

The result may be a trained regression model that can predict suitable compensation changes based on employee data.

Compensation Change Deployment

In operation, the trained model may be deployed to, for example, enhance compensation decisions or for other applications described herein. For example, when reviewing an employee, their details may be passed to the model to generate a predicted compensation change.

The prediction can assist reviewers in making fair, data-driven decisions. The model outputs can also be used to highlight potential discrepancies across groups with similar qualifications but differing predictions. By leveraging the trained model, the system provides a technological improvement to compensation determination.

Here are some examples of how machine learning could potentially be applied to enhance the compensation and goals features: Compensation

Predictive modeling to forecast future compensation trends and budgets. This can assist planning compensation cycles.

Anomaly detection models to identify unusual compensation changes and potentially fraudulent activities. This can augment auditing.

Bias detection algorithms to analyze compensation actions and outcomes for demographic disparities. This can promote pay equity.

Recommender systems to suggest appropriate compensation packages for open roles. This can improve hiring workflows.

Natural language processing of compensation adjustment rationale to ensure explanations are substantive. This provides oversight.

Sentiment analysis on employees' reactions to compensation outcomes to monitor engagement and fairness perceptions. This enables gaining insights.

Goals

Recommendation systems to suggest goals aligned to organizational objectives and employee strengths. This assists goal setting.

Prediction models to forecast goal progression and completion probability. This enables monitoring goal health.

Anomaly detection on goal progression to flag unusual trends. This facilitates oversight.

Natural language models to generate goal descriptions and key results from high-level objectives. This can boost productivity.

Prioritization algorithms to dynamically reorder goals based on importance and urgency. This helps focus efforts.

Sentiment analysis to assess employee sentiment on goals to detect frustration. This allows refinement.

Clustering and association rules to reveal correlations and patterns in goals data. This provides insights.

Thus, the system may be configured to leverage ML to enhance workflows through recommendations, forecasting, anomaly detection, text generation, prioritization, sentiment analysis, and data discovery.

### Compensation Insights

Here are some examples of insights that the machine learning described herein may be configured to reveal regarding compensation and goals:

Predictive Modeling for Budgeting: A regression model could forecast next year's payroll budget needs by analyzing historical trends in compensation changes, hiring forecasts, attrition predictions, and economic indicators. The predictions can help guide budget planning cycles.

Anomaly Detection for Auditing: An unsupervised anomaly detection model could identify highly unusual compensation actions by learning the expected patterns and magnitude of pay changes for each job type and level. Detected anomalies such as excessive bonuses or equity grants could trigger audits.

Bias Detection for Equity Analysis: A supervised classification model could predict compensation actions based on employee demographics and qualifications. Systematically lower pay predicted for certain demographic groups could indicate potential equity gaps needing intervention.

Recommendation Systems for Hiring: A content-based recommendation system could suggest appropriate pay packages for open roles by learning from historical compensation patterns and matching candidate credentials to similar past profiles. This can optimize hiring workflows.

Sentiment Analysis for Fairness: A natural language processing model could analyze employee feedback on compensation outcomes to gauge perceptions of fairness. Divergent sentiment across demographic groups could reveal areas needing improvement.

### Goals Insights

Recommendation Systems for Alignment: A collaborative filtering model could suggest goals for employees that align to organizational objectives and priorities by analyzing historical goal patterns and relationships. This helps focus efforts.

Prediction Models for Completion Forecasting: A time series forecasting model could predict the likelihood of on-time completion for goals based on historical progression trajectories. Managers can prioritize goals at risk of falling behind.

Anomaly Detection for Oversight: An unsupervised anomaly detection model could identify unusual goal progression trends like stalled advancement or abrupt surges. Anomalies could indicate potential issues needing intervention.

Natural Language Models for Productivity: A natural language generation model could draft low-level key results and milestones from high-level qualitative objectives. This accelerates goal planning and alignment.

Prioritization Algorithms for Focus: A reinforcement learning model could dynamically reprioritize goals based on changing organizational needs and employee workloads to focus efforts on the most critical areas.

Sentiment Analysis for Refinement: A text classification model could analyze employee feedback on goals to gauge frustration levels. Highly negative sentiment could indicate difficulties needing goal refinement.

Thus, application of machine learning may enhance compensation and goal analytics with actionable insights.

The operations described herein include unconventional elements that improve upon traditional enterprise goal tracking solutions. The novel aspects of the goals feature include, for example:

Configurable Goal Ontology. The system allows modeling goals with a flexible ontology to capture semantics and terminology specific to the organization. Goals are represented as a network of modular objective and key result entities with custom relationship types. Properties can be added to annotate goals for machine learning. This exceeds rigid predefined goal taxonomies. Declarative Goal Hierarchies. Hierarchical goal alignments are defined using declarative mapping rules as opposed to rigid manual goal tree constructions. This allows dynamically materializing hierarchical goal views on demand based on the current state of the flexible goal ontology. Goal hierarchies can be efficiently rebuilt in response to changes.

Responsive Goal Visualizations. Interactive graphical interfaces empower users to explore and manage goals leveraging the flexible ontology and dynamic hierarchies. Visualizations like expanding objective trees and relationship graphs provide intuitive visibility into goal alignment and progress monitoring. This delivers a more responsive exploration experience compared to static goal reports.

Granular Access Policies. The system allows defining fine-grained access control policies specific to goal data and actions based on parameters like user attributes, goal properties, and hierarchy depth. For example, control of setting organizational goals can be restricted, while employees can manage individual goals. This provides greater access control precision than coarse-grained role-based access.

Change Data Architecture. The system maintains goal data currency by incrementally capturing changes from integrated systems and propagating updates bidirectionally using change data capture, events, and messaging. This facilitates real-time synchronization as compared to bulk data transfers.

Continuous Compliance. Lightweight policy decision points are embedded throughout the architecture for consistent localized enforcement, and anomaly detection identifies potential violations to trigger reviews. This drives greater compliance with goal management policies compared to periodic audits.

MLOps for Goals. Machine learning model development, deployment, monitoring, and governance are operationalized using robust MLOps practices. Predictive models generate goal recommendations while explainability provides model transparency. This brings advanced ML techniques like privacy preservation and bias detection to goal recommendations.

Simulation-based Evaluation. Predictive goal recommendation models are evaluated offline using simulations based on anonymized historical data before being applied in production interfaces. This allows minimizing risks and harms from goal model automation. Most systems directly test models on users.

Embedded Analytics. Goal dashboards are contextually embedded in the interactive interfaces using visualizations tuned to user personas and contexts. This provides intuitive visibility by meeting users in their workflow instead of requiring accessing separate analytics systems.

The operations disclosed herein also include non-standard characteristics distinguishing them from incumbent compensation solutions. The unconventional compensation aspects that provide advantages over conventional systems include, for example:

Flexible Compensation Modeling. Compensation is modeled using an extensible ontology allowing organizations to define custom compensation components, relationships, formulas, and semantics. For example, complex equity award types can be represented. This exceeds hardcoded compensation element definitions.

Declarative Compensation Hierarchies. Hierarchical compensation data views like bands and grades are generated on demand by evaluating declarative mapping rules against the flexible compensation model. This allows dynamically materializing tailored compensation hierarchies.

Auditability. Compensation actions are logged in an immutable audit trail with user context and explanatory notes. Audit reports provide transparency into compensation decisions, answering questions like why an employee's pay changed. This exceeds basic change logging.

Explainable Compensation Actions. Managers can provide contextual notes explaining the rationale behind compensation actions which are persisted for review and auditing. Rationale helps identify potential biases and ensures equitable pay. Most systems lack contextual explainability.

Granular Access Policies. The system enables defining fine-grained access policies for compensation data and actions based on parameters like user attributes, compensation properties, and organization hierarchies. For example, manager compensation visibility can be limited. This facilitates access control precision exceeding coarse role-based access.

Change Data Architecture. Incremental compensation data changes are captured from upstream systems and propagated bidirectionally using change data capture and messaging for real-time synchronization. This delivers timelier update propagation compared to bulk data transfers.

Anomaly Detection. Analyzing access patterns allows detecting compensation policy violations to trigger reviews. For example, managers accessing subordinate pay outside review cycles may be flagged. This enables real-time compliance monitoring rather than periodic audits.

MLOps for Compensation. Applying machine learning to compensation actions follows robust MLOps methodologies for model development, deployment, monitoring, and governance. Responsible AI practices instill trust and fairness when leveraging ML predictions for compensation actions. Most systems cannot support ML appropriately.

Simulation-based Evaluation. Compensation simulations using synthetic data evaluate ML models offline prior to production deployment to minimize risks from compensation model automation. This exceeds testing models directly on employee data.

Embedded Analytics. Compensation dashboards are embedded directly into the interactive interfaces providing intuitive visibility into pay trends and outliers. This brings insights to managers rather than requiring accessing separate analytics systems.

The compensation management and goals tracking systems described herein may leverage flexible ontologies to model organizational data. These extensible ontologies empower advanced user interface capabilities that would be difficult to achieve using conventional rigid data models.

The flexible ontology utilized to model goals and compensation employs an extensible entity-relationship schema capable of capturing specialized semantics.

A schema accommodates configurable entity types such as Goal, Objective, KeyResult, Salary, Bonus etc. Relationships like AlignsWith, Measures, and ApprovedBy model associations between entities. Properties contain metadata like Status, Value, ReviewDate, etc.

This schema can be extended without modifications to core entity classes. New entities, relationships, and properties are added by declaration. For example:
Declare Entity Milestone subClassOf Goal
Declare Relationship dependsOn domain Milestone range Goal
Declare Property completionDate domain Milestone

The ontology may be stored in a graph database optimized for efficient traversal of arbitrary entity-relationship graphs. This enables dynamically materializing views like hierarchical compensation bands by querying relationships.

The flexible schema powering the ontology is unconventional. Hardcoded rigid data models cannot accommodate specialized semantics or extensibility.

### Compensation Ontology

The compensation system models the organization's total rewards structure using an adaptable ontology. The ontology consists of entities representing compensation components, relationships between the components, and properties describing the components.

Entities

The ontology supports configurable compensation component entities like:
Salary—Base pay with attributes for rate, currency, and frequency
Bonus—Variable incentive pay tied to performance.
Equity—Restricted stock units, stock options, and other equity awards.
Benefits—Health, dental, retirement, and other benefits.
Perks—Non-salary rewards like car allowance and tuition reimbursement.
Additional component entities can be added to the ontology via configuration vs. hardcoding to accommodate unique compensation structures.

Relationships

Relationships represent associations between compensation components. Sample relationships include:
Part of—Relates components that contribute to a total compensation package like salary part of total compensation Enables rollups.
Caused by—Links compensation changes to triggering events like promotion caused by salary increase Provides explainability
Limited by—Restrictions between components like bonus limited by salary cap. Implements compensation rules and formulas.
Approved by—Compensation actions requiring authorization like equity approved by board. Defines approval chains.
Configurable relationship types allow capturing complex compensation interdependencies and workflows.

Properties

Properties represent attributes of compensation components. Examples include:
Value—Monetary amount of a component like salary value.
Currency—Currency of a monetary value like bonus currency
Frequency—How often a component is awarded like benefits frequency annual.
Effective Date—Date a compensation change takes effect
Review Date—Next date a component will be reviewed like salary review date.
Job Title—Job associated with a salary.
Pay Grade—Compensation band for a job.
Custom properties accommodate component metadata needed for compensation calculations and workflows.

The adaptable ontology provides the backbone for the dynamic user interfaces allowing compensation administrators to configure tailored compensation models and hierarchies on the fly.

In example embodiments, one or more user interfaces may be caused to be presented that include advanced visualizations, embedded analytics, mobile optimization, drag-and-drop manipulation, visual cues, animations, recommendations, or simulations, as described herein. For example, one or more user interfaces my include one or more of the following features:
An interactive sidebar providing contextual actions on goals including creating, aligning, updating, editing, ending, deleting, and reactivating goals;
Expandable goal trees and relationship graphs visually depicting alignments, hierarchies, and interdependencies between goals;
Embedded goal analytics using visualizations tailored to user personas and contexts;
Role-based dashboard views surfacing key progress indicators and insights;
A mobile-optimized interface allowing quick access and editing of goals using minimal navigation and screens;
Drag-and-drop interfaces enabling intuitive re-organization and re-structuring of goals;
Visual cues highlighting goals requiring attention or action;
Animated microinteractions providing feedback on goal actions;
Accessible and internationalized interfaces supporting assistive technologies and localization;
Contextual recommendations of potentially relevant goals, structures, and associations; and/or
Simulated previews allowing previewing goal changes without impacting live data;
Recommendations generated by a machine learning model may be seamlessly integrated into the user interface to enhance goal workflows in a low-risk manner.

The user interface(s) may include, for example, contextual recommendations of potentially relevant goals, structures, and/or associations generated using a trained machine learning model. The machine learning model may be trained on historical goal data to identify patterns and correlations between goals, structures, and associations. The recommendations may suggest goals entities, mappings, hierarchies and representations to users and administrators to enhance goal definition workflows. The recommendations are provided via interactive overlays and previews allowing non-disruptive, low-risk exploration of recommendations. For example, the recommendations may aim to increase efficiency, alignment, and structure of goal definitions based on learned patterns and relationships between goals from organizational data.

### Goals Ontology

Similarly, the goals system may leverage a flexible ontology for modeling organizational goals and alignments. The key elements include: Entities

Custom goal entities can be defined including:
Objective—Qualitative goal like improve customer satisfaction
Key Result—Quantitative goal metric like reduce support wait times.
Milestone—Required steps for achieving a goal.
Project—An organizational project with aligned goals.
Strategy—High-level organizational priority.
Configurable entities allow capturing different goal abstraction levels and semantics.

Relationships

Relationships represent goal associations and alignments:
Aligns with—Links goals to higher level priorities like objective aligns with strategy.
Supports—Associations between supporting details and high-level goals like key result supports objective.
Depends on—Goals with prerequisite dependencies like milestone depends on key result.
Owns—Links goals to owners and teams.
Measures—Metrics used to evaluate goal progress.
Custom relationship types enable rich goal structures and metadata.
Properties
Properties provide attributes for goals:
Title—Goal name.
Description—Text elaborating the goal.
Status—Current achievement status like “in progress”.
Due Date—Target completion date.
Progress—Percentage of completion.
Priority—Relative importance
Additional properties capture goal metadata and state.

The adaptable goals ontology powers dynamic interfaces for navigating complex goal hierarchies and visualizing goal alignments tailored to users' specific roles and contexts.

### Ontologies Relation to Interfaces

The flexible compensation and goals ontologies directly facilitate customized user experiences not easily achievable with rigid, hardcoded data models.

Personalized Views: Interfaces can dynamically assemble personalized views of relevant goals and compensation tailored to each user's role and context by querying the ontology. For example, a manager may see a filtered view of subordinate goals.

Configurable Terminology: The ontology accommodates customized industry and organizational terminology for goals and compensation surfacing the appropriate language in the interfaces.

Access Control Integration: The extensible ontology integrates with access control rules to restrict interface data to authorized users. For example, salary information may be hidden from unauthorized employees.

Hierarchy Visualization: Interfaces can render interactive visualizations of tailored goal and compensation hierarchies by traversing relationships in the ontology. For example, drilling down through division and department goals.

Change Propagation: Bidirectional change propagation maintains ontology consistency across systems, keeping goal status and compensation data current in the interfaces.

The flexible ontologies enrich the adaptive user experiences by enabling personalized views, custom terminology, access control, interactive visualizations, and/or real-time data updates. The ontologies shift the interfaces from rigid, predefined views constrained by hardcoded data models to dynamic experiences tailored to each user and context.

The goals and compensation systems described herein may leverage declarative mapping rules to dynamically construct tailored hierarchical views for specific user contexts. This exceeds rigid manual hierarchy definition by enabling responsive goal trees and compensation bands adapted to users' needs.

Declarative Goal Hierarchies: The goals system allows users to explore and manage goals through hierarchical visualizations like expanding goal trees. However, manually defining rigid goal hierarchies limits flexibility. Instead, declarative hierarchy definition rules dynamically assemble customizable goal trees on demand.

Hierarchy Rules: Goal hierarchy rules declare mappings between goals based on properties and relationships in the flexible goals ontology. For example:

Goals related to strategy X with priority over 50 map under the “Top Priorities” tree.

Key results linked to an objective via “supports” relationship map under that objective.

Milestones required for a key result based on “depends on” relationship map under that key result.

Hierarchy rules can be logically chained together to construct multi-layered hierarchies.

A plurality of goal entity types may comprise objectives, key results, milestones, strategies, or projects. The goal entity types may be customizable via configuration to accommodate specific goal semantics of an organization.

A plurality of customizable relationship types may comprise alignment relationships, supporting relationships, dependency relationships, ownership relationships, or causality relationships, The relationship types may represent associations and workflows between the plurality of goal entity types.

A plurality of properties representing attributes associated with each of the plurality of goal entity types may comprise titles, descriptions, statuses, due dates, progress metrics, priorities, tags, timestamps, owners, sources, confidence scores, sentiment scores, activity metrics, versions, lifecycle stages, health indicators, and so on.

A plurality of mapping rules may declaratively define how goal entities should be structured based on, for example, the relationship types and properties, the mapping rules evaluated at runtime to dynamically assemble customized goal representations personalized to each user and optimized for specific user interfaces and workflows.

Thus, the flexible goal ontology may support one or more of customizable goal entity types, configurable relationship types between entities, versatile properties or metadata attributes, and/or declarative mapping rules that evaluate the ontology to generate customizable goal visualizations.

Responsive Materialization. When a user requests a goal hierarchy view like their team's goals, the rules are evaluated against the current ontology state to materialize a tailored tree structure. The hierarchy is assembled on demand in real time by resolving the rule-defined mappings.

This allows dynamically constructing personalized goal hierarchies optimized for specific user needs as opposed to prebuilt static hierarchies.

Incremental Updates. When the underlying goals change, affected hierarchies are incrementally updated by re-evaluating related rules. For example, if a goal priority changes, it may map to a different parent based on rules for prioritizing high goals. This incremental update approach is highly scalable compared to reprocessing all hierarchies on every change.

Contextual Hierarchies. Different users may see different hierarchies for the same underlying goal set based on their context. For example, managers may see expanded subordinate goals while peers see summarized views. Rules parameterize mapping logic using user attributes like role to drive personalized hierarchy views. Contextual parameters also include goal properties, organization attributes, and/or other factors.

Access Control Integration. Generated hierarchies respect access control rules, filtering restricted goals from unauthorized users. This avoids inadvertently exposing sensitive goals through hierarchies.

Hierarchy Caching. Materializing hierarchies on demand can be resource intensive. Caching optimizes performance by reusing recent hierarchy outputs when possible to avoid unnecessary rule re-evaluation.

Such declarative goal hierarchies provide a highly responsive and customizable visualization experience through dynamically generated goal trees adapted to each user's context and access level. Declarative Compensation Hierarchies

Similarly, the compensation system leverages declarative rules to construct tailored compensation hierarchies like bands and grades on demand.

Hierarchy Rules. Compensation hierarchy rules declare mappings between compensation data elements based on properties and relationships in the flexible compensation ontology. Examples include:
Salaries mapped to pay grades based on salary amount ranges.
Bonuses mapped under a bonus tier based on target bonus percentages.
Equity awards mapped to equity levels per award size thresholds.
Perks mapped to predefined perk categories by perk type.
Chained rules can assemble complex multi-layer hierarchies.
Responsive Materialization

When a user accesses a compensation hierarchy view, the current ontology state is evaluated against the rules to materialize a tailored structure matching the context. For example, generating an employee's specific total rewards hierarchy.

This provides responsive, personalized hierarchy views instead of rigid predefined hierarchies.

In example embodiments, evaluating the declarative mapping rules may comprise one or more of the following operations:
Receiving a request from a user to view a goal representation, the request comprising a user identifier indicating the requesting user and/or a user context parameter indicating a context of the requesting user;
Identifying applicable mapping rules from the declarative mapping rule set based on the user identifier and the user context parameter;
Applying the applicable mapping rules to the flexible goal ontology by, for example, traversing goal entities and relationships to identify goals relevant to the user based on the applicable mapping rules, filtering out goal entities inaccessible to the user based on access control policies associated with the user identifier, organizing and/or structuring the relevant, accessible goal entities into a goal representation customized for the user using organizational, hierarchical, chronological, or categorized structures defined in the applicable mapping rules; and/or

Dynamically updating the customized goal representation based on changes to the goal entities, relationships, properties, access policies, and/or user context by re-evaluating the applicable mapping rules.

Mapping rules may, for example, customize and tailor goal representations and hierarchies based on properties like priority, status, ownership, relationships like supporting/supported-by, and user context like department and access level. Examples include:
Map goals with priority over a threshold under a “High Priority Goals” section;
Map goals with statuses of “In Progress” under an “Active Goals” section;
Map goals associated with a strategy entity under a “Strategic Goals” section;
Map goals owned by direct reports of a manager under a “My Team Goals” section in the manager's view,
Map key results supporting an objective entity under that objective entity;
Map milestones supporting a key result entity under that key result entity;
Filter out goals unrelated to a user's department from the user's view;
Filter out private goals exceeding a user's access permissions from the user's view;
Chronologically order goals based on due date property in a user's view;
Categorize goals into sections based on tag properties.

Incremental Updates. Compensation changes trigger incremental hierarchy updates by re-evaluating related rules. For example, a salary change may map the employee to a new pay grade based on the updated salary amount. Incremental updates maintain performance as compensation data evolves.

Contextual Hierarchies. Compensation hierarchies are customized to specific user contexts via parameterized rules checking attributes like role. For example, managers may see subordinate compensation details while employees see summarized band-level data. Access controls are integrated to restrict any unauthorized sensitive pay data from generated views.

Caching Optimizations. Recently generated compensation hierarchies are cached and reused when applicable to optimize performance. Declarative compensation hierarchies deliver tailored, responsive pay data visualizations matching each user's context and access privileges by dynamically materializing views on demand.

Benefits of Declarative Hierarchies: Declarative hierarchies provide several key advantages over manual rigid hierarchy definition:
Personalization—Contextualized views matching user needs.
Maintainability—Consistent incremental updates to stay current.
Extensibility—Easily incorporate new mapping rules.
Flexibility—Dynamically adapt to new properties and relationships.
Performance—Optimized via caching.
Security—Integrates access control rules.

By using declarative hierarchy logic, the goals and compensation systems provide more responsive, customizable, and secure hierarchy views tailored to each user's specific context and access level.

Here are some example declarative mapping rules that could be defined to dynamically generate personalized goal hierarchies tailored to specific users:
Map goals with priority “High” under “Key Priorities” tree
Map goals with status “In Progress” under “Active Goals” tree
Map goals with due date in current quarter under “Quarterly Goals” tree
Map goals related to “Strategy A” under “Strategic Goals” tree
Map goals owned by user's direct reports under “My Team Goals” tree
Map goals containing tag “New Initiative” under “Key Initiatives” tree
Map key results supporting user's individual goals under those goals
Map milestones supporting user's team goals under those goals
Map company objectives under “Company Goals” tree
Map goals aligned to user's department objectives under “Department Goals” tree
Filter out goals unrelated to user's department from their view
Filter out private goals exceeding user's access level from their view

These examples demonstrate how declarative rules can be defined over properties like priority, status, and due date as well as relationships like supporting goals and aligned goals. The rules can filter, organize, and structure goals personalized to each user's context and access privileges.

When a user requests their goal hierarchy, these rules would be evaluated against the current state of goals and relationships to assemble a tailored tree structure optimized for that user. As goals change, incremental updates would re-evaluate related rules to maintain the hierarchy.

An advantage over rigid manually defined hierarchies is the ability to dynamically generate customizable goal trees personalized for each user that adapt as goals evolve.

Hierarchies may be defined using a declarative domain-specific language (DSL) that maps ontology elements based on property constraints and patterns. For example:
Map Goals where priority>0.8 under KeyGoals
Map Objectives alignedTo CompanyObjectives under CompanyTree
Map Salaries where amount>100000 as HighEarnerBand

A DSL compiler may convert mappings into executable query plans. Plans are incrementally re-evaluated on data changes.

The declarative nature enables adapting hierarchies by modifying mappings instead of hand-coding new queries. This provides more maintainable, customizable hierarchies compared to predefined views.

### Novel Data Structures for Goals and Compensation

In example embodiments, implementing the described robust goals management and compensation planning capabilities may require specialized data structures tailored to the complex information being modeled. Conventional generic data structures impose limitations. Examples of specialized data structures that may be used are described below.

Example Goals Data Structures

Objective Hierarchy Tree. The Objective Hierarchy Tree optimizes retrieving and traversing tree structures of business objectives and their aligned lower-level goals.

Structure:
Tree nodes represent objectives.
Nodes link to child nodes for aligned subordinate objectives.
Leaf nodes represent low-level key results and milestones.
Node properties capture objective attributes

Operations:
Insert objective nodes.
Efficiently query node descendants and ancestors.
Recursively traverse objective alignment chains.
Dynamically filter sub-trees.
Incrementally update properties and links.

Benefits:
Accelerates hierarchical goal visualization.
Enables drilling down/rolling up aligned goals.
Responsive to changes in goal alignments.

Goal Priority Queue. The Goal Priority Queue provides ordered access to goals based on priority attributes.

Structure:
Ordered queue with goals sorted by priority tier.
Goals mapped to queue positions based on priority.
New goals inserted in proper priority position.

Operations:
Efficiently query goals in priority order.
Dynamically reorder goals on priority changes
Insert new goals at appropriate priority.
Incrementally update goal priority attributes.

Benefits:
Access goals in priority order.
Maintain proper priority order as goals evolve.
Focus on highest priority goals.

Goal Timeline. The Goal Timeline maps goal progression events on a chronological timeline.

Structure:
Timeline of milestones representing goal progress events.
Milestones linked to goals.
Milestones tagged with progress attributes

Operations:
Insert milestone on goal progress events.
Efficiently query milestones by time range.
Traverse chronological progression of goals.
Dynamically filter timeline segments.

Benefits:
Chronologically tracks goal progress.
Analyze progression time series.
Audit goal advancement.

Goal Change Stream. The Goal Change Stream provides an append-only ordered log of changes to goals.

Structure:
Append-only log of timestamped goal change events.
Change events linked to associated goals.
Change details captured as event properties.

Operations:
Efficiently append goal change events.
Query change stream in time order.
Dynamically filter change stream segments.
Traverse chronological changes for a goal.

Benefits:
Audits edits and progression of goals
Analyze change patterns over time.
Replay changes to restore state.

Example Compensation Data Structures

Compensation History Tree. The Compensation History Tree tracks an employee's historical compensation actions and awards.

Structure:
Tree nodes represent compensation change events.
Nodes linked chronologically from old to new.
Properties describe compensation details.
Leaf nodes are current compensation state.

Operations:
Append new compensation change nodes.
Traverse compensation history chronologically.
Analyze trends over compensation lifecycle.
Dynamically filter history sub-trees.

Benefits:
Chronologically tracks pay changes.
Audit compensation progression.
Analyze career earnings trajectories.

Pay Equity Heat Map. The Pay Equity Heat Map visually summarizes compensation equity across demographic dimensions.

Structure:
Grid with rows for demographic criteria.
Columns for compensation metrics like pay ratio.
Cells colored by compensation equity score.

Operations:
Dynamically generate grid for configurations of demographics and metrics.
Color cells using equity algorithm.
Filter rows and columns.
Highlight anomalous data cells.

Benefits:
Visualize compensation equity across demographics.
Identify areas for potential bias investigation.
Guide interventions to refine equity.

Compensation Change Stream. The Compensation Change Stream provides an append-only ordered log of pay changes.

Structure:
Append-only log of timestamped compensation change events.
Change events linked to affected employees.
Change details captured as event properties.

Operations:
Efficiently append compensation change events.
Query event stream in time order.
Dynamically filter event stream segments.
Analyze trends in compensation changes.

Benefits:
Audit pay change history.
Replay changes to restore state.
Analyze change patterns over time.

Compensation Decision Tree. The Compensation Decision Tree traces the hierarchical decisions driving compensation actions.

Structure:
Tree nodes represent compensation decisions.
Nodes linked from parent decision to child details.
Properties describe decision context.
Leaf nodes are compensation actions.

Operations:
Append new decision nodes with context.
Traverse decision hierarchy for explainability.
Dynamically filter decision sub-trees.
Update properties on decision evolution.

Benefits:
Audit decision chains driving actions.
Analyze decision patterns over time.
Enhance explainability.

Specialized data structures like these purpose-built for goals and compensation data may be used enable next-generation experiences exceeding conventional limitations. The structures open capabilities like hierarchical visualization, chronological auditability, temporal analysis, animated replay, and/or contextual explainability.

### Example Mobile Device

FIG. 299 is a block diagram illustrating a mobile device 29900, according to an example embodiment.

The mobile device 29900 can include a processor 29902. The processor 29902 can be any of a variety of different types of commercially available processors suitable for mobile devices 29900 (for example, an XScale architecture microprocessor, a Microprocessor without Interlocked Pipeline Stages (MIPS) architecture processor, or another type of processor). A memory 29904, such as a random access memory (RAM), a Flash memory, or other type of memory, is typically accessible to the processor 29902. The memory 29904 can be adapted to store an operating system (OS) 29906, as well as application programs 29908, such as a mobile location-enabled application that can provide location-based services (LBSs) to a user. The processor 29902 can be coupled, either directly or via appropriate intermediary hardware, to a display 29910 and to one or more input/output (I/O) devices 29912, such as a keypad, a touch panel sensor, a microphone, and the like. Similarly, in some embodiments, the processor 29902 can be coupled to a transceiver 29914 that interfaces with an antenna 29916. The transceiver 29914 can be configured to both transmit and receive cellular network signals, wireless data signals, or other types of signals via the antenna 29916, depending on the nature of the mobile device 29900. Further, in some configurations, a GPS receiver 29918 can also make use of the antenna 29916 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 300 is a block diagram of an example computer system 30000 on which methodologies and operations described herein may be executed, in accordance with an example embodiment.

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 30000 includes a processor 30002 (e.g., a central processing unit (CPU), a graphics processing unit (GPU) or both), a main memory 30004 and a static memory 30006, which communicate with each other via a bus 30008. The computer system 30000 may further include a graphics display unit 30010 (e.g., a liquid crystal display (LCD) or a cathode ray tube (CRT)). The computer system 30000 also includes an alphanumeric input device 30012 (e.g., a keyboard or a touch-sensitive display screen), a user interface (UI) navigation device 30014 (e.g., a mouse), a storage unit 30016, a signal generation device 30018 (e.g., a speaker) and a network interface device 30020.

### Machine-Readable Medium

The storage unit 30016 includes a machine-readable medium 30022 on which is stored one or more sets of instructions and data structures (e.g., software) 30024 embodying or utilized by any one or more of the methodologies or functions described herein. The instructions 30024 may also reside, completely or at least partially, within the main memory 30004 and/or within the processor 30002 during execution thereof by the computer system 30000, the main memory 30004 and the processor 30002 also constituting machine-readable media.

While the machine-readable medium 30022 is shown in an example embodiment to be a single medium, the term “machine-readable medium” may include a single medium or multiple media (e.g., a centralized or distributed database, and/or associated caches and servers) that store the one or more instructions 30024 or data structures. The term “machine-readable medium” shall also be taken to include any tangible medium that is capable of storing, encoding or carrying instructions (e.g., instructions 30024) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 30024 may further be transmitted or received over a communications network 30026 using a transmission medium. The instructions 30024 may be transmitted using the network interface device 30020 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more computer processors;
one or more computer memories;
a set of instructions incorporated into one or more memories, the set of instructions configuring the one or more computer processors to perform operations, the operations comprising:
receiving a request from a user to view a goal representation;
accessing a flexible goal ontology comprising one or more goal entities, one or more goal relationships between the goal entities, and one or more goal properties, the one or more goal properties including one or more metadata attributes relating to the one or more goal entities;
obtaining a set of mapping rules defining mappings between one or more goals based on the one or more properties and the one or more relationships in the goal ontology;
evaluating the set of mapping rules to dynamically assemble a customized goal representation tailored to the user;
incrementally updating the customized goal representation based on a revaluation of the mapping rules affected by changes to the one or more goal entities, the one or more goal relationships, and the one or more properties; and
transmitting the customized goal representation to a client device associated with the user for graphical rendering based on a context of the user.

2. The system of claim 1, wherein the one or more goal relationships comprise one or more of alignment relationships, supporting relationships, dependency relationships, or ownership relationships.

3. The system of claim 1, wherein the one or more goal entities comprise one or more of objectives, key results, milestones, strategies, or projects.

4. The system of claim 1, wherein the one or more goal properties include one or more of titles, descriptions, statuses, due dates, progress metrics, priorities, or tags.

5. The system of claim 1, wherein the one or more metadata attributes include one or more of creation timestamps indicating when the goal entities were created; ownership identifiers indicating owners responsible for the goal entities; source identifiers indicating source systems or databases for the goal entities; confidence scores indicating reliability; accuracy, or trustworthiness of the goal entities; sentiments scores indicating attitudes, opinions, or emotions associated with the goal entities; activity metrics indicating access frequency, edit rates, or progress velocity for the goal entities; version identifiers indicating iterations or revisions of the goal entities; lifecycle stages indicating drafting, active, completed, or archived status of goal entities; health indicators providing summaries of advancement, risks, or blockers for the goal entities.

6. The system of claim 1, wherein the goal ontologies includes one or more goal entity types customizable via configuration to accommodate specific goals of an organization, one or more customizable relationships types, or one or more properties representing attributes associated with each of the one or more goal entity types.

7. The system of claim 1, wherein the set of mapping rules includes one or more rules for categorizing the one or more goals into sections of the customized goal representation based on the one or more goal properties.

8. The system of claim 1, wherein the user context is determined based on one or more of the following data items:
a user profile of the user, the user profile including one or more organizational attributes, the one or more organizational attributes including one or more of a department, a manager, direct reports, indirect reports, a location, a job function, or access permissions;
a user behavior pattern of the user, the user behavior pattern relating to one or more of frequently accessed goals, search queries, goal representations requested, or goal properties filtered;
a parameter of the client device, the parameter indicating one or more device capabilities, the one or more device capabilities including screen size, resolution, input modes, or bandwidth;
a user interface interaction, the user interface interaction relating to one or more of selected goals, search filters applied, representation views enabled, or graphical zoom levels;
an activity of the users, the activity relating to one or more of current workflow tasks, active software applications, recent user inputs, or time of day; or
a communication context, the communication content relating to one or more of discussion topics, messaging threads, chat participants, or meeting schedules.

9. The system of claim 1, wherein the dynamic updating comprises one or more of the following operations:
detecting changes to the flexible goal ontology, including added goal entities, modified goal properties, altered goal relationships, or removed goal entities. identifying affected mapping rules relevant to the changed goal entities, properties, and/or relationships;
re-evaluating the affected mapping rules in light of the changes to generate updated rule outputs;
modifying the customized goal representation based on the updated rule outputs, the modifying including adding, removing, or modifying goal entities in the representation based on added, removed, or altered goal entities referred to by the affected mapping rules;
re-organizing, re-categorizing, re-ordering, or re-structuring goal entities based on changes to properties and relationships evaluated by the affected mapping rules;
dynamically expanding, collapsing, highlighting, or filtering portions of the goal representation impacted by the updated mapping rule outputs;
propagating and maintaining updated links, paths, hierarchies, dependencies, or alignments between goals in the representation;
reflecting added, removed, or changed metadata and indicators in the representation;
or
re-validating access permissions and visibility filters based on updated mapping rules.

10. The system of claim 1, the operations further comprising:
training a machine learning model on historical goal data to generate goal recommendations, the historical goal data comprising past goal entities, properties, relationships, or user interactions, the training including:
extracting feature vectors representing salient features of the historical goal data;
associating the feature vectors with target labels indicating optimal goal alignments, mappings, hierarchies, or representations;
processing the feature vectors and target labels using machine learning algorithms to optimize model parameters and minimize a loss function;
evaluating the machine learning model using test data to measure generalization performance; and
deploying the trained machine learning model to predict goal recommendations based on new goal data instances.

11. The system of claim 10, wherein the predicted goal recommendations suggest potential goal entities, mappings, hierarchies or representations to users or administrators to enhance goal definition workflows.

12. The system of claim 11, wherein the goal definition workflow includes one or more of the following workflows:
a goal creation workflow configured to enable users to define new goal entities, including specifying goal properties like title, description, owners, or metrics;
a goal alignment workflow configured to enable users to define relationships between goals, including hierarchical alignments, supporting/supported-by relationships, or prerequisite dependencies;
a goal assignment workflow configured to enable users to assign ownership of goals to users or departments;
a goal planning workflow configured to enable users to associate goals with timelines, milestones, resources, budgets, or monitoring indicators;
a goal status workflow configured to enable users to track progress and update current status of goals;
a goal hierarchy workflow configured to enable users to organize goals into hierarchical representations, categories, roadmaps, or cascading alignments; or
a goal access workflow configured to control visibility and permissions for goals based on entity properties, user attributes, or organizational policies.

13. The system of claim 1, wherein the customized goal representation is included in a graphical user interface, the graphical user interface comprising an interactive sidebar displaying contextually relevant actions and information related to a selected goal associated with the customized goal representation, wherein the sidebar is displayed in response to a user selection of the selected goal from a list of goals, the sidebar provides direct access to relevant options and information for acting on the selected goal without requiring navigation to a separate screen, the sidebar content is determined dynamically based on properties and context of the selected goal, the sidebar enables contextually relevant actions on the goal including updating status, aligning to other goals, editing details, ending the goal, or deleting the goal.

14. The system of claim 1, wherein the customized goal representation is included in a graphical user interface that is configured for small screens through use of interactive sidebars providing context-specific navigation to access key actions.

15. The system of claim 1, the operations further comprising linking goal data items by storing associations between employee goal IDs and company objective IDs in a mapping table data structure within a data store.

16. The system of claim 1, the operations further comprising propagating updates between external systems and integrated data repositories in real time.

17. The system of claim 1, the operations further comprising training a neural network model on historical goals data to generate goal recommendations.

18. The system of claim 1, wherein the customized goal representation includes a visualization of a progress of the user with respect to one or more objectives of an organization.

19. A method comprising:
receiving a request from a user to view a goal representation;
accessing a flexible goal ontology comprising one or more goal entities, one or more goal relationships between the goal entities, and one or more goal properties, the one or more goal properties including one or more metadata attributes relating to the one or more goal entities;
obtaining a set of mapping rules defining mappings between one or more goals based on the one or more properties and the one or more relationships in the goal ontology;
evaluating the set of mapping rules to dynamically assemble a customized goal representation tailored to the user;
incrementally updating the customized goal representation based on a revaluation of the mapping rules affected by changes to the one or more goal entities, the one or more goal relationships, and the one or more properties; and
transmitting the customized goal representation to a client device associated with the user for graphical rendering based on a context of the user.

20. A non-transitory computer-readable storage medium storing a set of instructions that, when executed by one or more computer processors, causes the one or more computer processors to perform operations, the operations comprising:
receiving a request from a user to view a goal representation;
accessing a flexible goal ontology comprising one or more goal entities, one or more goal relationships between the goal entities, and one or more goal properties, the one or more goal properties including one or more metadata attributes relating to the one or more goal entities;
obtaining a set of mapping rules defining mappings between one or more goals based on the one or more properties and the one or more relationships in the goal ontology;
evaluating the set of mapping rules to dynamically assemble a customized goal representation tailored to the user;
incrementally updating the customized goal representation based on a revaluation of the mapping rules affected by changes to the one or more goal entities, the one or more goal relationships, and the one or more properties; and
transmitting the customized goal representation to a client device associated with the user for graphical rendering based on a context of the user.
